(19) United States
(12) Patent Application Publication
(10) Pub. No.: US 2023/0367773 A1
(43) Pub. Date: Nov. 16, 2023

(54) LOADING QUERY RESULT SETS FOR STORAGE IN DATABASE SYSTEMS

(71) Applicant: Ocient Holdings LLC, Chicago, IL (US)

(72) Inventors: George Kondiles, Chicago, IL (US); Natalia Marie Jenuwine, Chicago, IL (US); Alyssa Catherine Wagenmaker, Chicago, IL (US); Sarah Kate Schieferstein, Chicago, IL (US)

(73) Assignee: Ocient Holdings LLC, Chicago, IL (US)

(21) Appl. No.: 18/313,548

(22) Filed: May 8, 2023

Related U.S. Application Data
(60) Provisional application No. 63/364,455, filed on May 10, 2022.

(51) Int. Cl. G06F 16/2455; G06F 16/2453; G06F 16/248

(52) U.S. Cl. CPC G06F 16/24553; G06F 16/24542; G06F 16/248

(57) ABSTRACT

A database system is operable to generate and a first plurality of column-formatted segments from a first plurality of rows. A query indicates parameters for generating a result set, and further indicating an instruction to store the result set. A query operator execution flow that includes a loading operator is generated. The query is executed based on accessing at least one of the first plurality of rows, processing the at least one of the first plurality of rows to generate a second plurality of rows as the result set, and executing the loading operator. At least one new column-formatted segment is from the second plurality of rows based on execution of the loading operator. The at least one new column-formatted segment is stored access in future query executions.

### CROSS-REFERENCE TO RELATED APPLICATIONS

The present U.S. Utility patent application claims priority pursuant to 35 U.S.C. § 119(e) to U.S. Provisional Application No. 63/364,455, entitled “LOADING QUERY RESULT SETS FOR STORAGE IN DATABASE SYSTEMS”, filed May 10, 2022, which is hereby incorporated herein by reference in its entirety and made part of the present U.S. Utility patent application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to computer networking and more particularly to database system and operation.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function.

Of the many applications a computer can perform, a database system is one of the largest and most complex applications. In general, a database system stores a large amount of data in a particular way for subsequent processing. In some situations, the hardware of the computer is a limiting factor regarding the speed at which a database system can process a particular function. In some other instances, the way in which the data is stored is a limiting factor regarding the speed of execution. In yet some other instances, restricted co-process options are a limiting factor regarding the speed of execution.

### BRIEF DESCRIPTION OF THE SEVERAL VIEWS OF THE DRAWING(S)

FIG. 1 is a schematic block diagram of an embodiment of a large scale data processing network that includes a database system in accordance with the present invention;

FIG. 1A is a schematic block diagram of an embodiment of a database system in accordance with the present invention;

FIG. 2 is a schematic block diagram of an embodiment of an administrative sub-system in accordance with the present invention;

FIG. 3 is a schematic block diagram of an embodiment of a configuration sub-system in accordance with the present invention;

FIG. 4 is a schematic block diagram of an embodiment of a parallelized data input sub-system in accordance with the present invention;

FIG. 5 is a schematic block diagram of an embodiment of a parallelized query and response (Q&R) sub-system in accordance with the present invention;

FIG. 6 is a schematic block diagram of an embodiment of a parallelized data store, retrieve, and/or process (IO& P) sub-system in accordance with the present invention;

FIG. 7 is a schematic block diagram of an embodiment of a computing device in accordance with the present invention;

FIG. 8 is a schematic block diagram of another embodiment of a computing device in accordance with the present invention;

FIG. 9 is a schematic block diagram of another embodiment of a computing device in accordance with the present invention;

FIG. 10 is a schematic block diagram of an embodiment of a node of a computing device in accordance with the present invention;

FIG. 11 is a schematic block diagram of an embodiment of a node of a computing device in accordance with the present invention;

FIG. 12 is a schematic block diagram of an embodiment of a node of a computing device in accordance with the present invention;

FIG. 13 is a schematic block diagram of an embodiment of a node of a computing device in accordance with the present invention;

FIG. 14 is a schematic block diagram of an embodiment of operating systems of a computing device in accordance with the present invention;

FIGS. 15-23 are schematic block diagrams of an example of processing a table or data set for storage in the database system in accordance with the present invention;

FIG. 24A is a schematic block diagram of a query execution plan implemented via a plurality of nodes in accordance with various embodiments;

FIGS. 24B-24D are schematic block diagrams of embodiments of a node that implements a query processing module in accordance with various embodiments;

FIGS. 25A-25B are schematic block diagrams of embodiments of a database system that includes a record processing and storage system in accordance with various embodiments;

FIG. 25C is a is a schematic block diagrams of an embodiment of a page generator in accordance with various embodiments;

FIG. 25D is a schematic block diagrams of an embodiment of a page storage system of a record processing and storage system in accordance with various embodiments;

FIG. 25E is a schematic block diagrams of a node that implements a query processing module that reads records from segment storage and page storage in accordance with various embodiments;

FIG. 26A is a schematic block diagram of a segment generator of a record processing and storage system in accordance with various embodiments;

FIG. 26B is a schematic block diagram illustrating operation of a page conversion determination module over time in accordance with various embodiments;

FIG. 26C is a schematic block diagram of a cluster key-based grouping module of a segment generator in accordance with various embodiments;

FIG. 27A is a schematic block diagram illustrating communication between a record processing and storage system and a data source in accordance with various embodiments;

FIG. 27B is a schematic block diagram illustrating communication between a record processing and storage system and a plurality of data sources in accordance with various embodiments;

FIGS. 27C-27E are schematic block diagrams illustrating a data source that maintains a confirmation-pending row list in accordance with various embodiments;

FIG. 28A is a schematic embodiment of a database system that generates segments for storage from externally-generated record streams in accordance with various embodiments;

FIG. 28B illustrates structure of tables stored via segments of a segment storage in accordance with various embodiments;

FIG. 28C is a schematic embodiment of a database system that generates a result set of output rows based on a query request in accordance with various embodiments;

FIG. 28D is a schematic embodiment of a database system that sends query resultants to an external requesting entity based on a query request received from the external requesting entity in accordance with various embodiments;

FIG. 28E is a schematic embodiment of a database system that generates a result set of output rows for storage as new segments of a segment storage system in accordance with various embodiments;

FIG. 28F illustrates a segment storage system stores output rows generated via a query execution as a new database table in accordance with various embodiments;

FIG. 28G illustrates a segment storage system stores output rows generated via a query execution as new rows of an existing database table in accordance with various embodiments;

FIG. 28H is a schematic embodiment of a database system that facilitates storage of a result set generated in query execution by implementing a loading operator in accordance with various embodiments;

FIG. 28I is a schematic embodiment of a record processing system that processes an externally-generated record stream via a page generator in accordance with various embodiments;

FIG. 28J is a schematic embodiment of a record processing system that implements an input data format conversion module to process column data streams of a result set via a page generator in accordance with various embodiments;

FIG. 28K is a schematic embodiment of a database system that executes queries based on accessing segments generated from result sets produced via prior query executions in accordance with various embodiments;

FIGS. 28L-28Q are logic diagrams illustrating methods for execution in accordance with various embodiments;

FIG. 29A is a schematic embodiment of a database system that stores data groups having different scope identifiers with corresponding visibility flags in accordance with various embodiments;

FIGS. 29B-29D are a schematic embodiment of a database system illustrating and the visibility flag of a scope identifier for a data group having segments generated from data blocks of the data group over time in accordance with various embodiments;

FIG. 29E illustrates a timeline of updating data ownership information based on updates to scope visibility data via data ownership information generation processes in accordance with various embodiments;

FIG. 29F is a schematic block diagram of anode that executes queries based on data ownership information in accordance with various embodiments;

FIG. 29G illustrates deletion of a data group based on a delete scope request indicating a scope identifier for the data group in accordance with various embodiments;

FIG. 29H is a logic diagram illustrating a method for execution in accordance with various embodiments;

FIG. 30A is a schematic embodiment of a database system that performs loading coordination processes via a query execution module in accordance with various embodiments;

FIG. 30B is a schematic embodiment of a database system that performs loading coordination processes via a query execution module before and after performance of result set generation and transmission in accordance with various embodiments;

FIG. 30C is a schematic embodiment of a database system that executes a query by implementing at least one load coordination operator in accordance with various embodiments;

FIG. 30D is a schematic embodiment of a database system that performs sets of transactional exchanges with a metadata management system and a segment storage system via a query execution module prior to result set generation and transmission in accordance with various embodiments;

FIG. 30E illustrates a flow implemented by a query execution module performing loading coordination processes in accordance with various embodiments;

FIG. 30F is a schematic embodiment of a database system that performs sets of transactional exchanges with a metadata management system and a segment storage system via a query execution module prior to result set generation and transmission in accordance with various embodiments;

FIG. 30G illustrates a flow implemented by a query execution module performing loading coordination processes in accordance with various embodiments;

FIG. 30H illustrates a flow implemented by a query failure management module of a query execution module in accordance with various embodiments;

FIG. 30I is a logic diagram illustrating a method for execution in accordance with various embodiments;

FIG. 31A is a schematic embodiment of a database system that generates segments via a segment generator based on a threshold conversion size requirement in accordance with various embodiments;

FIG. 31B illustrates an example embodiment of a segment generator of a database system that generates segments based on a threshold conversion size requirement in accordance with various embodiments;

FIG. 31C is a schematic embodiment of a database system that generates segments via a segment generator based on all rows of a result set being stored in pages in accordance with various embodiments;

FIG. 31D illustrates an example embodiment of a segment generator of a database system that generates segments based on all rows of a result set being stored in pages in accordance with various embodiments;

FIG. 31E is a schematic embodiment of a database system that sends a segment generation trigger to initiate a conversion process based all rows of a result set being stored in pages in accordance with various embodiments;

FIG. 31F is a logic diagram illustrating a method for execution in accordance with various embodiments;

FIG. 32A a schematic embodiment of a database system that processes a data block stream via multiple loading modules of a record processing system in accordance with various embodiments;

FIG. 32B is a schematic embodiment of a database system implementing a data block routing module that processes subsets of a data block stream via corresponding loading modules of a record processing system based on loading module stream assignment data in accordance with various embodiments;

FIG. 32C is a schematic embodiment of a database system implementing a data block routing module that assigns stream source identifiers to data blocks for routing to loading modules based on loading module stream assignment data in accordance with various embodiments;

FIGS. 32D-32F are schematic embodiments of a database system implementing a data block routing module that adapts to loading module failure in accordance with various embodiments;

FIGS. 32G-321 are schematic embodiments of a database system implementing a data block routing module that adapts to a rate limit exceeded notification in accordance with various embodiments;

FIG. 32J is a schematic block diagram of a database system implementing a data block routing module that sends data blocks of a result set for processing via multiple loading modules in accordance with various embodiments;

FIG. 32K is a schematic block diagram of a database system implementing multiple data block routing modules that each sends data blocks of a corresponding subset of a result set for processing via multiple loading modules in accordance with various embodiments;

FIG. 32L is a logic diagram illustrating a method for execution in accordance with various embodiments;

FIG. 33A is a schematic block diagram of a database system that stores result sets of query executions based on implementing at least one type-casting operator in accordance with various embodiments;

FIG. 33B a schematic block diagram of a database system generates output rows of a for processing with column values generated during query execution having required output datatypes for storage in accordance with various embodiments;

FIG. 33C a schematic block diagram of a database system implementing a query execution plan generator module generating a query operator execution flow based on determining required output datatypes in accordance with various embodiments;

FIG. 33D a schematic block diagram of a database system performing an example query execution implementing type-casting operators to generate a result set for storage in accordance with various embodiments; and

FIG. 33E is a logic diagram illustrating a method for execution in accordance with various embodiments.

### DETAILED DESCRIPTION OF THE INVENTION

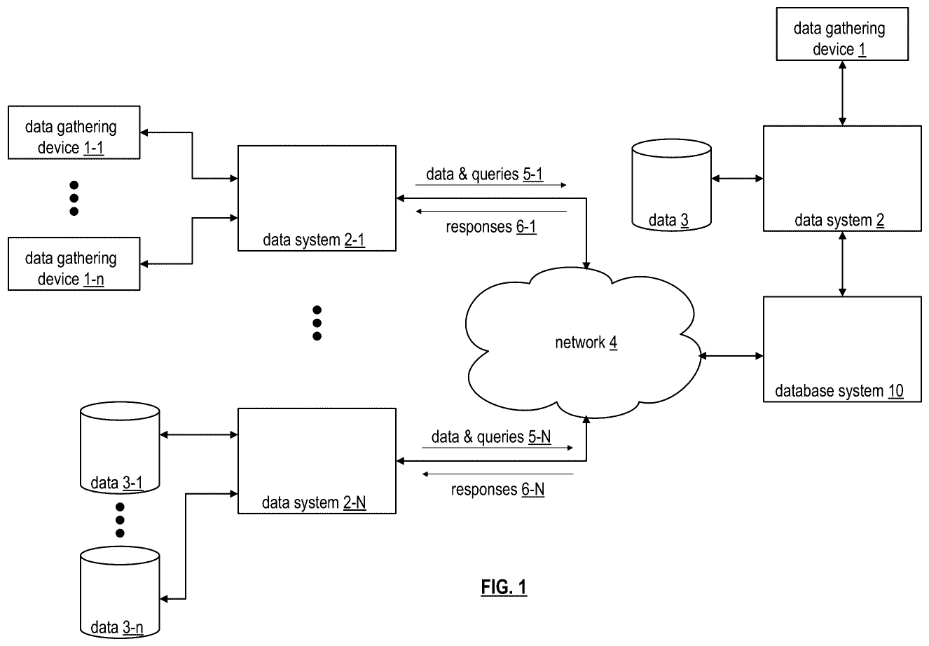

FIG. 1 is a schematic block diagram of an embodiment of a large-scale data processing network that includes data gathering devices (1, 1-1 through 1-n), data systems (2, 2-1 through 2-N), data storage systems (3, 3-1 through 3-n), a network 4, and a database system 10. The data gathering devices are computing devices that collect a wide variety of data and may further include sensors, monitors, measuring instruments, and/or other instrument for collecting data. The data gathering devices collect data in real-time (i.e., as it is happening) and provides it to data system 2-1 for storage and real-time processing of queries 5-1 to produce responses 6-1. As an example, the data gathering devices are computing in a factory collecting data regarding manufacturing of one or more products and the data system is evaluating queries to determine manufacturing efficiency, quality control, and/or product development status.

The data storage systems 3 store existing data. The existing data may originate from the data gathering devices or other sources, but the data is not real time data. For example, the data storage system stores financial data of a bank, a credit card company, or like financial institution. The data system 2-N processes queries 5-N regarding the data stored in the data storage systems to produce responses 6-N.

Data system 2 processes queries regarding real time data from data gathering devices and/or queries regarding non-real time data stored in the data storage system 3. The data system 2 produces responses in regard to the queries. Storage of real time and non-real time data, the processing of queries, and the generating of responses will be discussed with reference to one or more of the subsequent figures.

FIG. 1A is a schematic block diagram of an embodiment of a database system 10 that includes a parallelized data input sub-system 11, a parallelized data store, retrieve, and/or process sub-system 12, a parallelized query and response sub-system 13, system communication resources 14, an administrative sub-system 15, and a configuration sub-system 16. The system communication resources 14 include one or more of wide area network (WAN) connections, local area network (LAN) connections, wireless connections, wireline connections, etc. to couple the sub-systems 11, 12, 13, 15, and 16 together.

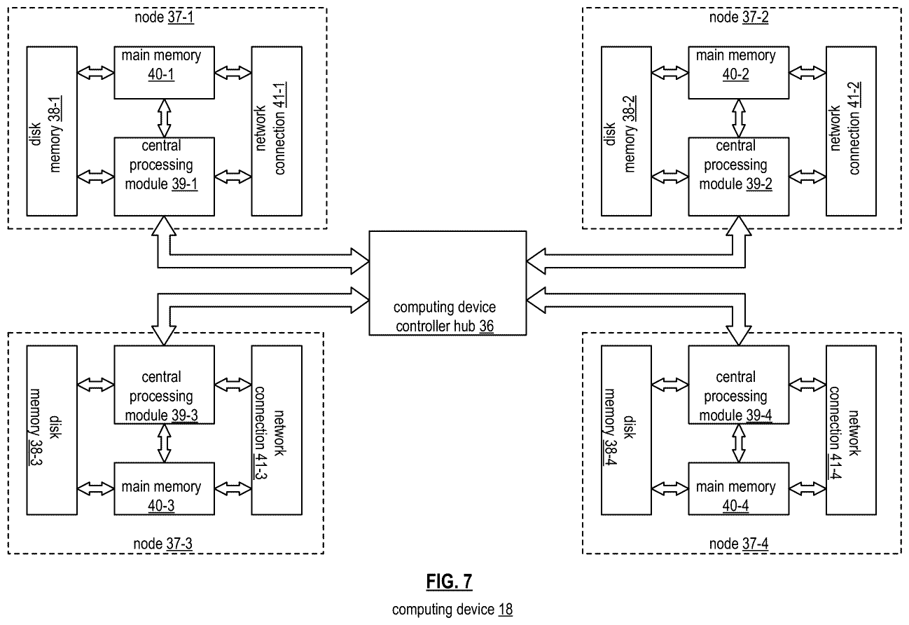

Each of the sub-systems 11, 12, 13, 15, and 16 include a plurality of computing devices; an example of which is discussed with reference to one or more of FIGS. 7-9. Hereafter, the parallelized data input sub-system 11 may also be referred to as a data input sub-system, the parallelized data store, retrieve, and/or process sub-system may also be referred to as a data storage and processing sub-system, and the parallelized query and response sub-system 13 may also be referred to as a query and results sub-system.

In an example of operation, the parallelized data input sub-system 11 receives a data set (e.g., a table) that includes a plurality of records. A record includes a plurality of data fields. As a specific example, the data set includes tables of data from a data source. For example, a data source includes one or more computers. As another example, the data source is a plurality of machines. As yet another example, the data source is a plurality of data mining algorithms operating on one or more computers.

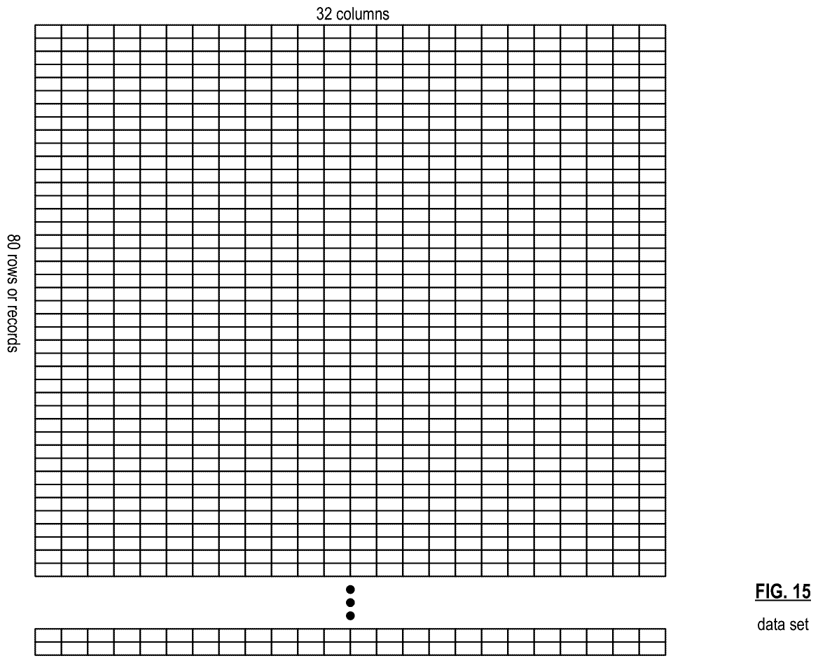

As is further discussed with reference to FIG. 15, the data source organizes its records of the data set into a table that includes rows and columns. The columns represent data fields of data for the rows. Each row corresponds to a record of data. For example, a table include payroll information for a company's employees. Each row is an employee's payroll record. The columns include data fields for employee name, address, department, annual salary, tax deduction information, direct deposit information, etc.

The parallelized data input sub-system 11 processes a table to determine how to store it. For example, the parallelized data input sub-system 11 divides the data set into a plurality of data partitions. For each partition, the parallelized data input sub-system 11 divides it into a plurality of data segments based on a segmenting factor. The segmenting factor includes a variety of approaches divide a partition into segments. For example, the segment factor indicates a number of records to include in a segment. As another example, the segmenting factor indicates a number of segments to include in a segment group. As another example, the segmenting factor identifies how to segment a data partition based on storage capabilities of the data store and processing sub-system. As a further example, the segmenting factor indicates how many segments for a data partition based on a redundancy storage encoding scheme.

As an example of dividing a data partition into segments based on a redundancy storage encoding scheme, assume that it includes a 4 of 5 encoding scheme (meaning any 4 of 5 encoded data elements can be used to recover the data). Based on these parameters, the parallelized data input sub-system 11 divides a data partition into 5 segments: one corresponding to each of the data elements).

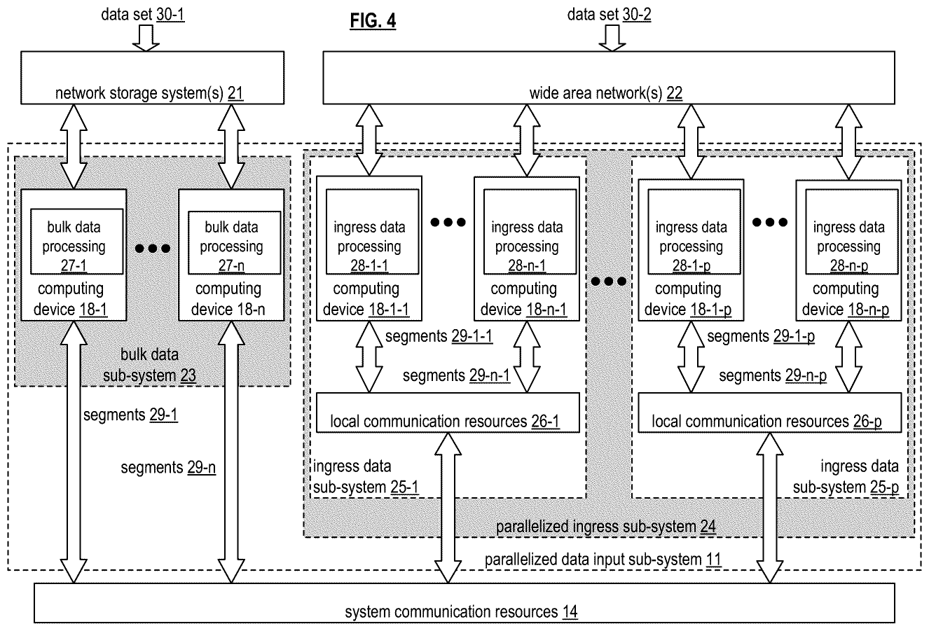

The parallelized data input sub-system 11 restructures the plurality of data segments to produce restructured data segments. For example, the parallelized data input sub-system 11 restructures records of a first data segment of the plurality of data segments based on a key field of the plurality of data fields to produce a first restructured data segment. The key field is common to the plurality of records. As a specific example, the parallelized data input sub-system 11 restructures a first data segment by dividing the first data segment into a plurality of data slabs (e.g., columns of a segment of a partition of a table). Using one or more of the columns as a key, or keys, the parallelized data input sub-system 11 sorts the data slabs. The restructuring to produce the data slabs is discussed in greater detail with reference to FIG. 4 and FIGS. 16-18.

The parallelized data input sub-system 11 also generates storage instructions regarding how sub-system 12 is to store the restructured data segments for efficient processing of subsequently received queries regarding the stored data. For example, the storage instructions include one or more of: a naming scheme, a request to store, a memory resource requirement, a processing resource requirement, an expected access frequency level, an expected storage duration, a required maximum access latency time, and other requirements associated with storage, processing, and retrieval of data.

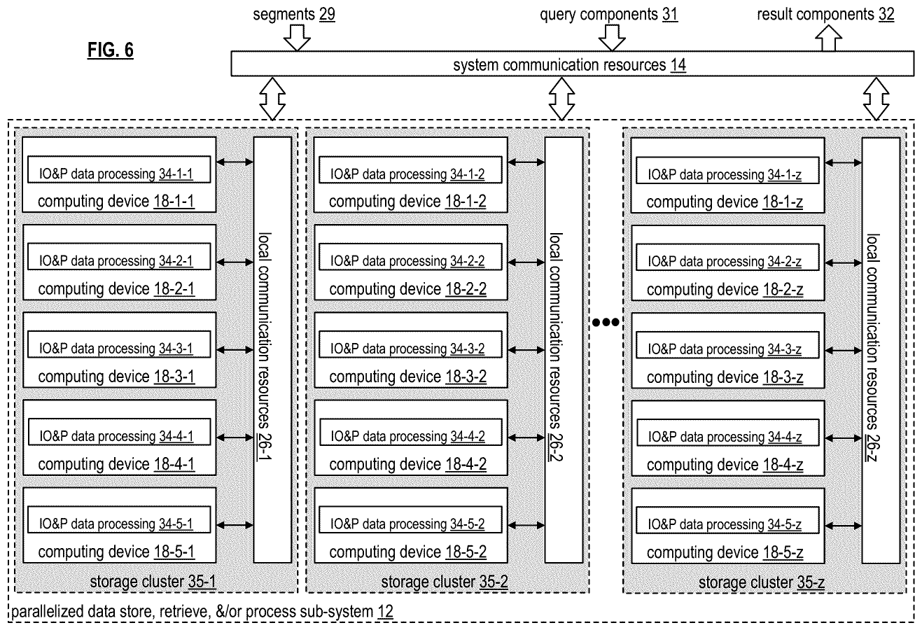

A designated computing device of the parallelized data store, retrieve, and/or process sub-system 12 receives the restructured data segments and the storage instructions. The designated computing device (which is randomly selected, selected in a round robin manner, or by default) interprets the storage instructions to identify resources (e.g., itself, its components, other computing devices, and/or components thereof) within the computing device's storage cluster. The designated computing device then divides the restructured data segments of a segment group of a partition of a table into segment divisions based on the identified resources and/or the storage instructions. The designated computing device then sends the segment divisions to the identified resources for storage and subsequent processing in accordance with a query. The operation of the parallelized data store, retrieve, and/or process sub-system 12 is discussed in greater detail with reference to FIG. 6.

The parallelized query and response sub-system 13 receives queries regarding tables (e.g., data sets) and processes the queries prior to sending them to the parallelized data store, retrieve, and/or process sub-system 12 for execution. For example, the parallelized query and response sub-system 13 generates an initial query plan based on a data processing request (e.g., a query) regarding a data set (e.g., the tables). Sub-system 13 optimizes the initial query plan based on one or more of the storage instructions, the engaged resources, and optimization functions to produce an optimized query plan.

For example, the parallelized query and response sub-system 13 receives a specific query no. 1 regarding the data set no. 1 (e.g., a specific table). The query is in a standard query format such as Open Database Connectivity (ODBC), Java Database Connectivity (JDBC), and/or SPARK. The query is assigned to a node within the parallelized query and response sub-system 13 for processing. The assigned node identifies the relevant table, determines where and how it is stored, and determines available nodes within the parallelized data store, retrieve, and/or process sub-system 12 for processing the query.

In addition, the assigned node parses the query to create an abstract syntax tree. As a specific example, the assigned node converts an SQL (Structured Query Language) statement into a database instruction set. The assigned node then validates the abstract syntax tree. If not valid, the assigned node generates a SQL exception, determines an appropriate correction, and repeats. When the abstract syntax tree is validated, the assigned node then creates an annotated abstract syntax tree. The annotated abstract syntax tree includes the verified abstract syntax tree plus annotations regarding column names, data type(s), data aggregation or not, correlation or not, sub-query or not, and so on.

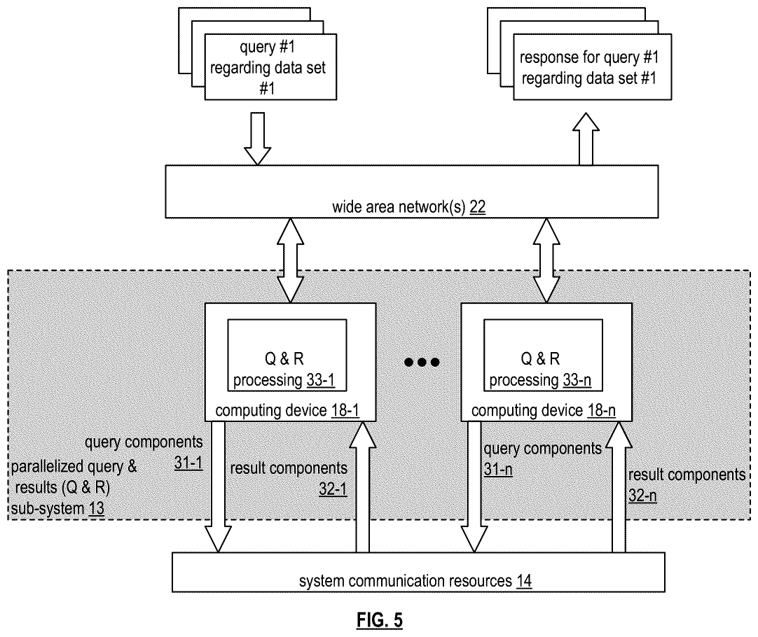

The assigned node then creates an initial query plan from the annotated abstract syntax tree. The assigned node optimizes the initial query plan using a cost analysis function (e.g., processing time, processing resources, etc.) and/or other optimization functions. Having produced the optimized query plan, the parallelized query and response sub-system 13 sends the optimized query plan to the parallelized data store, retrieve, and/or process sub-system 12 for execution. The operation of the parallelized query and response sub-system 13 is discussed in greater detail with reference to FIG. 5.

The parallelized data store, retrieve, and/or process sub-system 12 executes the optimized query plan to produce resultants and sends the resultants to the parallelized query and response sub-system 13. Within the parallelized data store, retrieve, and/or process sub-system 12, a computing device is designated as a primary device for the query plan (e.g., optimized query plan) and receives it. The primary device processes the query plan to identify nodes within the parallelized data store, retrieve, and/or process sub-system 12 for processing the query plan. The primary device then sends appropriate portions of the query plan to the identified nodes for execution. The primary device receives responses from the identified nodes and processes them in accordance with the query plan.

The primary device of the parallelized data store, retrieve, and/or process sub-system 12 provides the resulting response (e.g., resultants) to the assigned node of the parallelized query and response sub-system 13. For example, the assigned node determines whether further processing is needed on the resulting response (e.g., joining, filtering, etc.). If not, the assigned node outputs the resulting response as the response to the query (e.g., a response for query no. 1 regarding data set no. 1). If, however, further processing is determined, the assigned node further processes the resulting response to produce the response to the query. Having received the resultants, the parallelized query and response sub-system 13 creates a response from the resultants for the data processing request.

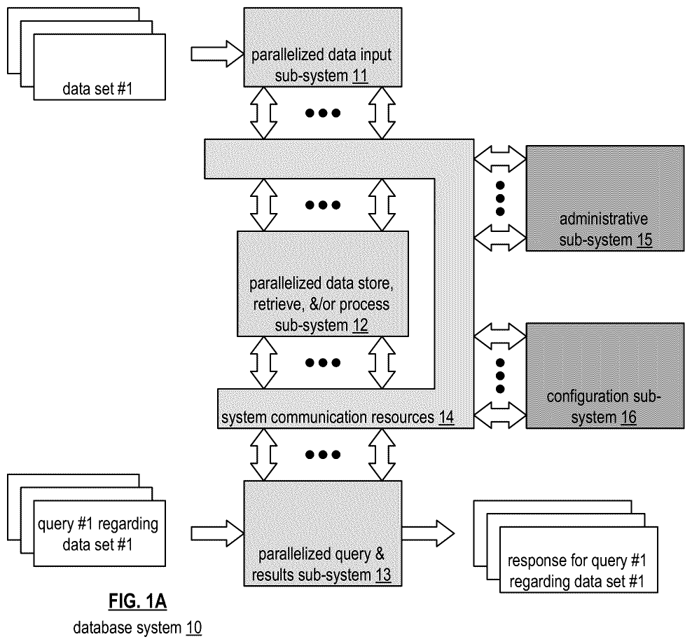

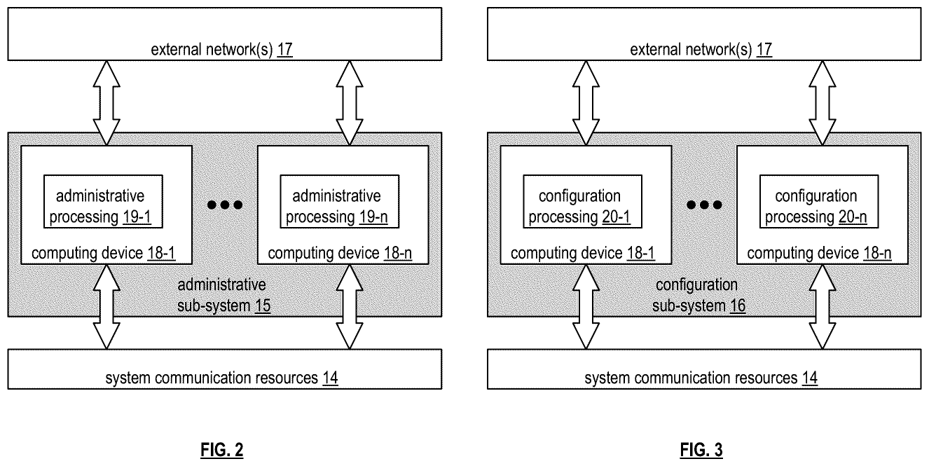

FIG. 2 is a schematic block diagram of an embodiment of the administrative sub-system 15 of FIG. 1A that includes one or more computing devices 18-1 through 18-n. Each of the computing devices executes an administrative processing function utilizing a corresponding administrative processing of administrative processing 19-1 through 19-n (which includes a plurality of administrative operations) that coordinates system level operations of the database system. Each computing device is coupled to an external network 17, or networks, and to the system communication resources 14 of FIG. 1A.

As will be described in greater detail with reference to one or more subsequent figures, a computing device includes a plurality of nodes and each node includes a plurality of processing core resources. Each processing core resource is capable of executing at least a portion of an administrative operation independently. This supports lock free and parallel execution of one or more administrative operations.

The administrative sub-system 15 functions to store metadata of the data set described with reference to FIG. 1A. For example, the storing includes generating the metadata to include one or more of an identifier of a stored table, the size of the stored table (e.g., bytes, number of columns, number of rows, etc.), labels for key fields of data segments, a data type indicator, the data owner, access permissions, available storage resources, storage resource specifications, software for operating the data processing, historical storage information, storage statistics, stored data access statistics (e.g., frequency, time of day, accessing entity identifiers, etc.) and any other information associated with optimizing operation of the database system 10.

FIG. 3 is a schematic block diagram of an embodiment of the configuration sub-system 16 of FIG. 1A that includes one or more computing devices 18-1 through 18-n. Each of the computing devices executes a configuration processing function 20-1 through 20-n (which includes a plurality of configuration operations) that coordinates system level configurations of the database system. Each computing device is coupled to the external network 17 of FIG. 2, or networks, and to the system communication resources 14 of FIG. 1A.

FIG. 4 is a schematic block diagram of an embodiment of the parallelized data input sub-system 11 of FIG. 1A that includes a bulk data sub-system 23 and a parallelized ingress sub-system 24. The bulk data sub-system 23 includes a plurality of computing devices 18-1 through 18-n. A computing device includes a bulk data processing function (e.g., 27-1) for receiving a table from a network storage system 21 (e.g., a server, a cloud storage service, etc.) and processing it for storage as generally discussed with reference to FIG. 1A.

The parallelized ingress sub-system 24 includes a plurality of ingress data sub-systems 25-1 through 25-p that each include a local communication resource of local communication resources 26-1 through 26-p and a plurality of computing devices 18-1 through 18-n. A computing device executes an ingress data processing function (e.g., 28-1) to receive streaming data regarding a table via a wide area network 22 and processing it for storage as generally discussed with reference to FIG. 1A. With a plurality of ingress data sub-systems 25-1 through 25-p, data from a plurality of tables can be streamed into the database system 10 at one time.

In general, the bulk data processing function is geared towards receiving data of a table in a bulk fashion (e.g., the table exists and is being retrieved as a whole, or portion thereof). The ingress data processing function is geared towards receiving streaming data from one or more data sources (e.g., receive data of a table as the data is being generated). For example, the ingress data processing function is geared towards receiving data from a plurality of machines in a factory in a periodic or continual manner as the machines create the data.

FIG. 5 is a schematic block diagram of an embodiment of a parallelized query and results sub-system 13 that includes a plurality of computing devices 18-1 through 18-n. Each of the computing devices executes a query (Q) & response (R) processing function 33-1 through 33-n. The computing devices are coupled to the wide area network 22 to receive queries (e.g., query no. 1 regarding data set no. 1) regarding tables and to provide responses to the queries (e.g., response for query no. 1 regarding the data set no. 1). For example, a computing device (e.g., 18-1) receives a query, creates an initial query plan therefrom, and optimizes it to produce an optimized plan. The computing device then sends components (e.g., one or more operations) of the optimized plan to the parallelized data store, retrieve, &/or process sub-system 12.

Processing resources of the parallelized data store, retrieve, &/or process sub-system 12 processes the components of the optimized plan to produce results components 32-1 through 32-n. The computing device of the Q&R sub-system 13 processes the result components to produce a query response.

The Q&R sub-system 13 allows for multiple queries regarding one or more tables to be processed concurrently. For example, a set of processing core resources of a computing device (e.g., one or more processing core resources) processes a first query and a second set of processing core resources of the computing device (or a different computing device) processes a second query.

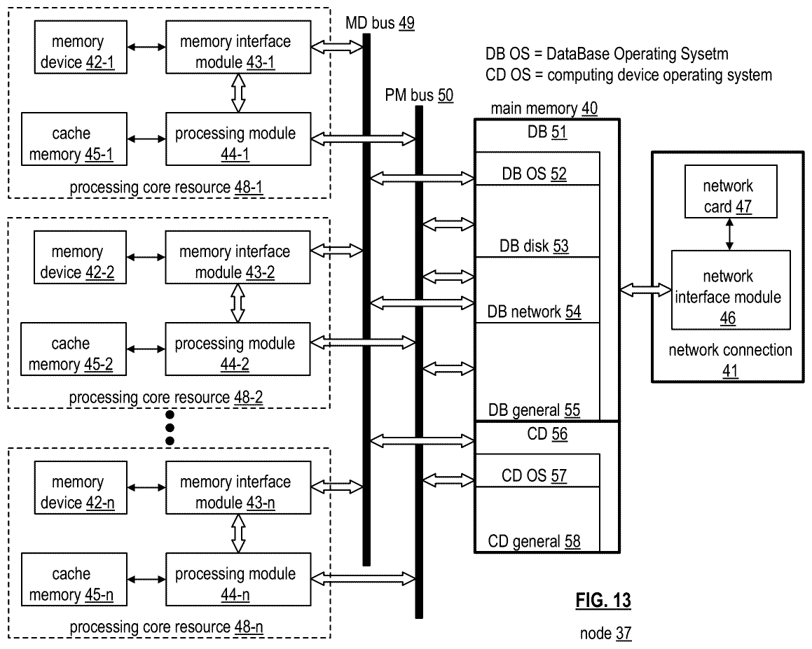

As will be described in greater detail with reference to one or more subsequent figures, a computing device includes a plurality of nodes and each node includes multiple processing core resources such that a plurality of computing devices includes pluralities of multiple processing core resources A processing core resource of the pluralities of multiple processing core resources generates the optimized query plan and other processing core resources of the pluralities of multiple processing core resources generates other optimized query plans for other data processing requests. Each processing core resource is capable of executing at least a portion of the Q & R function. In an embodiment, a plurality of processing core resources of one or more nodes executes the Q & R function to produce a response to a query. The processing core resource is discussed in greater detail with reference to FIG. 13.

FIG. 6 is a schematic block diagram of an embodiment of a parallelized data store, retrieve, and/or process sub-system 12 that includes a plurality of computing devices, where each computing device includes a plurality of nodes and each node includes multiple processing core resources. Each processing core resource is capable of executing at least a portion of the function of the parallelized data store, retrieve, and/or process sub-system 12. The plurality of computing devices is arranged into a plurality of storage clusters. Each storage cluster includes a number of computing devices.

In an embodiment, the parallelized data store, retrieve, and/or process sub-system 12 includes a plurality of storage clusters 35-1 through 35-z. Each storage cluster includes a corresponding local communication resource 26-1 through 26-z and a number of computing devices 18-1 through 18-5. Each computing device executes an input, output, and processing (IO &P) processing function 34-1 through 34-5 to store and process data.

The number of computing devices in a storage cluster corresponds to the number of segments (e.g., a segment group) in which a data partitioned is divided. For example, if a data partition is divided into five segments, a storage cluster includes five computing devices. As another example, if the data is divided into eight segments, then there are eight computing devices in the storage clusters.

To store a segment group of segments 29 within a storage cluster, a designated computing device of the storage cluster interprets storage instructions to identify computing devices (and/or processing core resources thereof) for storing the segments to produce identified engaged resources. The designated computing device is selected by a random selection, a default selection, a round-robin selection, or any other mechanism for selection.

The designated computing device sends a segment to each computing device in the storage cluster, including itself. Each of the computing devices stores their segment of the segment group. As an example, five segments 29 of a segment group are stored by five computing devices of storage cluster 35-1. The first computing device 18-1-1 stores a first segment of the segment group; a second computing device 18-2-1 stores a second segment of the segment group; and so on. With the segments stored, the computing devices are able to process queries (e.g., query components from the Q&R sub-system 13) and produce appropriate result components.

While storage cluster 35-1 is storing and/or processing a segment group, the other storage clusters 35-2 through 35-n are storing and/or processing other segment groups. For example, a table is partitioned into three segment groups. Three storage clusters store and/or process the three segment groups independently. As another example, four tables are independently stored and/or processed by one or more storage clusters. As yet another example, storage cluster 35-1 is storing and/or processing a second segment group while it is storing/or and processing a first segment group.

FIG. 7 is a schematic block diagram of an embodiment of a computing device 18 that includes a plurality of nodes 37-1 through 37-4 coupled to a computing device controller hub 36. The computing device controller hub 36 includes one or more of a chipset, a quick path interconnect (QPI), and an ultra path interconnection (UPI). Each node 37-1 through 37-4 includes a central processing module 39-1 through 39-4, a main memory 40-1 through 40-4 (e.g., volatile memory), a disk memory 38-1 through 38-4 (non-volatile memory), and a network connection 41-1 through 41-4. In an alternate configuration, the nodes share a network connection, which is coupled to the computing device controller hub 36 or to one of the nodes as illustrated in subsequent figures.

In an embodiment, each node is capable of operating independently of the other nodes. This allows for large scale parallel operation of a query request, which significantly reduces processing time for such queries. In another embodiment, one or more node function as co-processors to share processing requirements of a particular function, or functions.

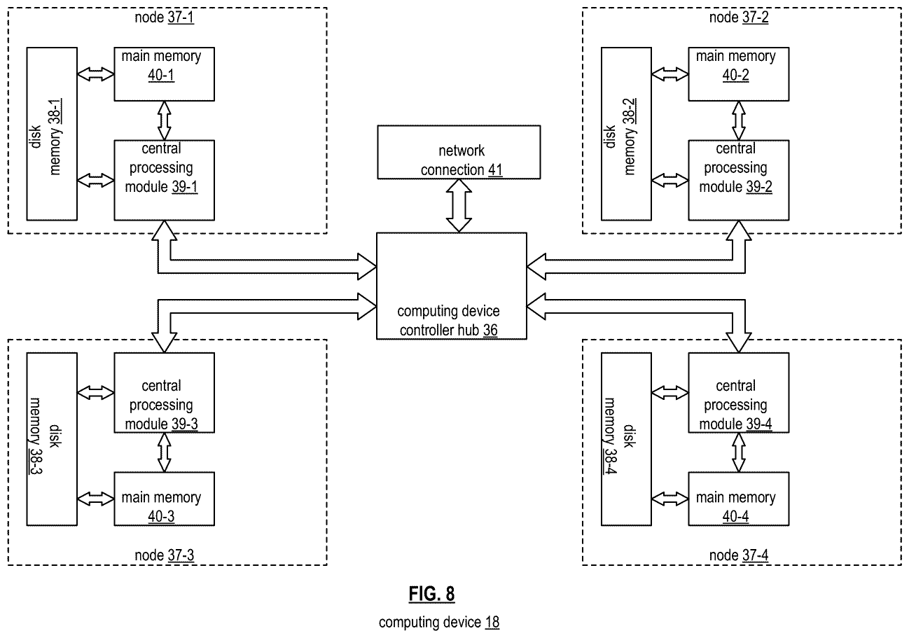

FIG. 8 is a schematic block diagram of another embodiment of a computing device that is similar to the computing device of FIG. 7 with an exception that it includes a single network connection 41, which is coupled to the computing device controller hub 36. As such, each node coordinates with the computing device controller hub to transmit or receive data via the network connection.

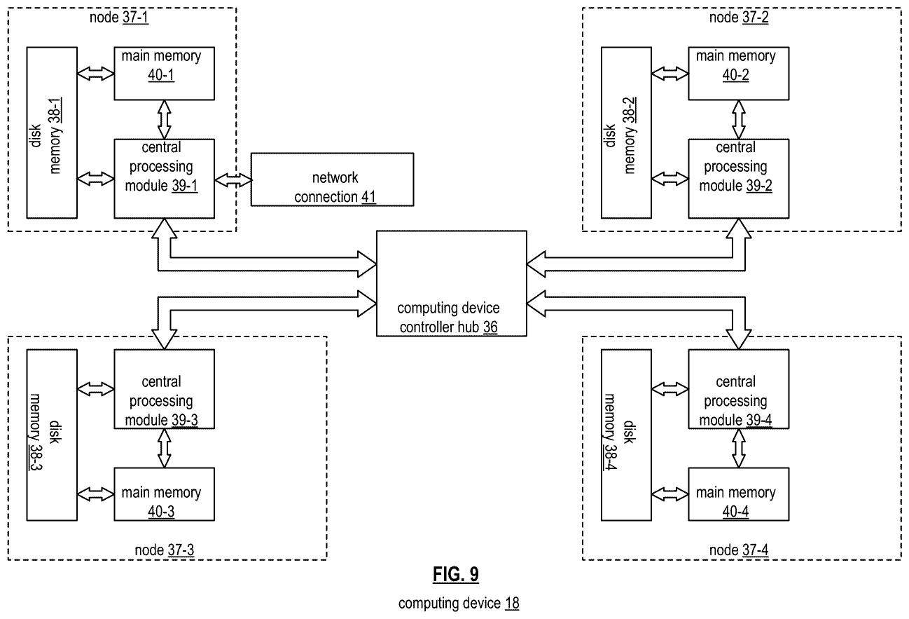

FIG. 9 is a schematic block diagram of another embodiment of a computing device is similar to the computing device of FIG. 7 with an exception that it includes a single network connection 41, which is coupled to a central processing module of a node (e.g., to central processing module 39-1 of node 37-1). As such, each node coordinates with the central processing module via the computing device controller hub 36 to transmit or receive data via the network connection.

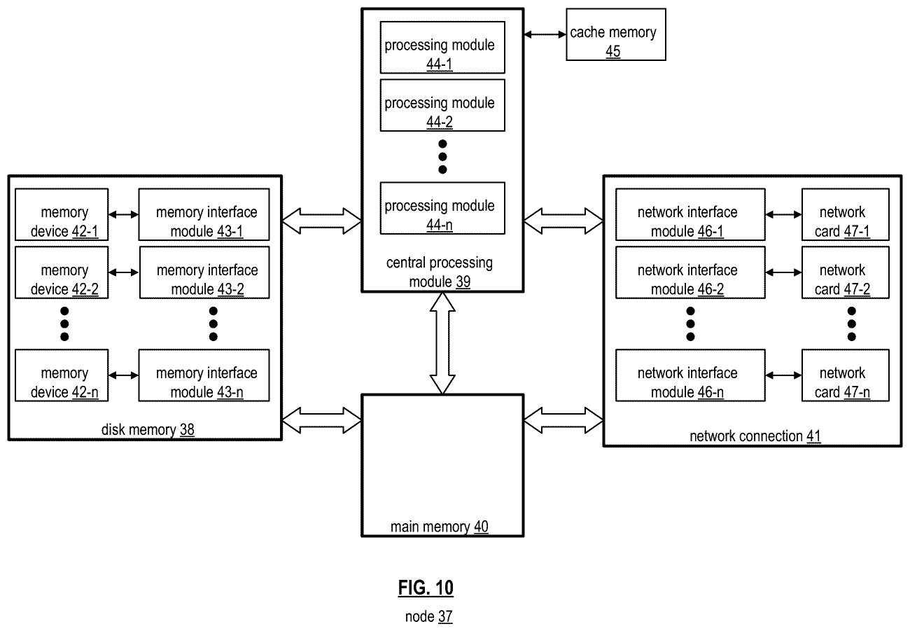

FIG. 10 is a schematic block diagram of an embodiment of a node 37 of computing device 18. The node 37 includes the central processing module 39, the main memory 40, the disk memory 38, and the network connection 41. The main memory 40 includes read only memory (RAM) and/or other form of volatile memory for storage of data and/or operational instructions of applications and/or of the operating system. The central processing module 39 includes a plurality of processing modules 44-1 through 44-n and an associated one or more cache memory 45. A processing module is as defined at the end of the detailed description.

The disk memory 38 includes a plurality of memory interface modules 43-1 through 43-n and a plurality of memory devices 42-1 through 42-n (e.g., non-volatile memory). The memory devices 42-1 through 42-n include, but are not limited to, solid state memory, disk drive memory, cloud storage memory, and other non-volatile memory. For each type of memory device, a different memory interface module 43-1 through 43-n is used. For example, solid state memory uses a standard, or serial, ATA (SATA), variation, or extension thereof, as its memory interface. As another example, disk drive memory devices use a small computer system interface (SCSI), variation, or extension thereof, as its memory interface.

In an embodiment, the disk memory 38 includes a plurality of solid state memory devices and corresponding memory interface modules. In another embodiment, the disk memory 38 includes a plurality of solid state memory devices, a plurality of disk memories, and corresponding memory interface modules.

The network connection 41 includes a plurality of network interface modules 46-1 through 46-n and a plurality of network cards 47-1 through 47-n. A network card includes a wireless LAN (WLAN) device (e.g., an IEEE 802.11n or another protocol), a LAN device (e.g., Ethernet), a cellular device (e.g., CDMA), etc. The corresponding network interface modules 46-1 through 46-n include a software driver for the corresponding network card and a physical connection that couples the network card to the central processing module 39 or other component(s) of the node.

The connections between the central processing module 39, the main memory 40, the disk memory 38, and the network connection 41 may be implemented in a variety of ways. For example, the connections are made through a node controller (e.g., a local version of the computing device controller hub 36). As another example, the connections are made through the computing device controller hub 36.

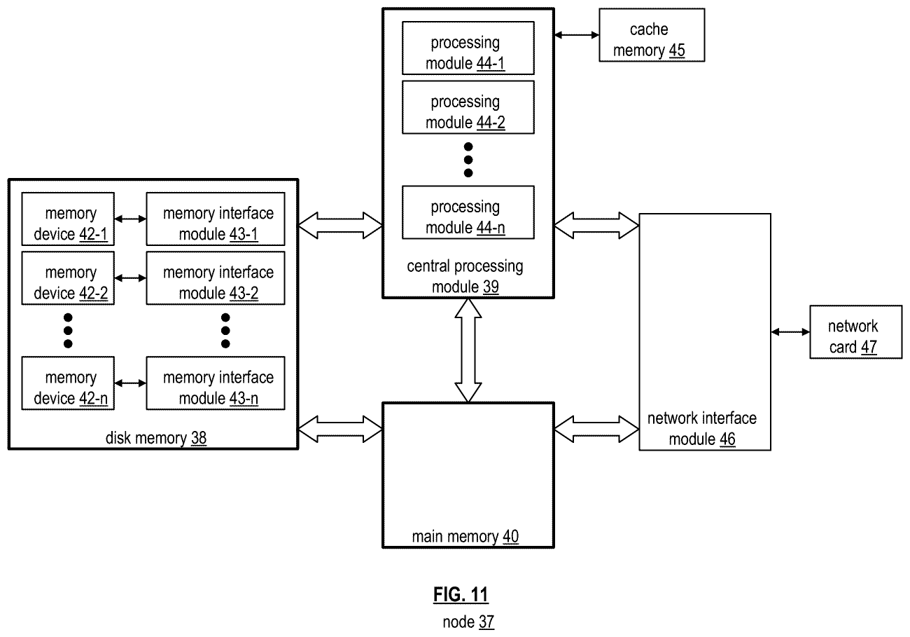

FIG. 11 is a schematic block diagram of an embodiment of a node 37 of a computing device 18 that is similar to the node of FIG. 10, with a difference in the network connection. In this embodiment, the node 37 includes a single network interface module 46 and a corresponding network card 47 configuration.

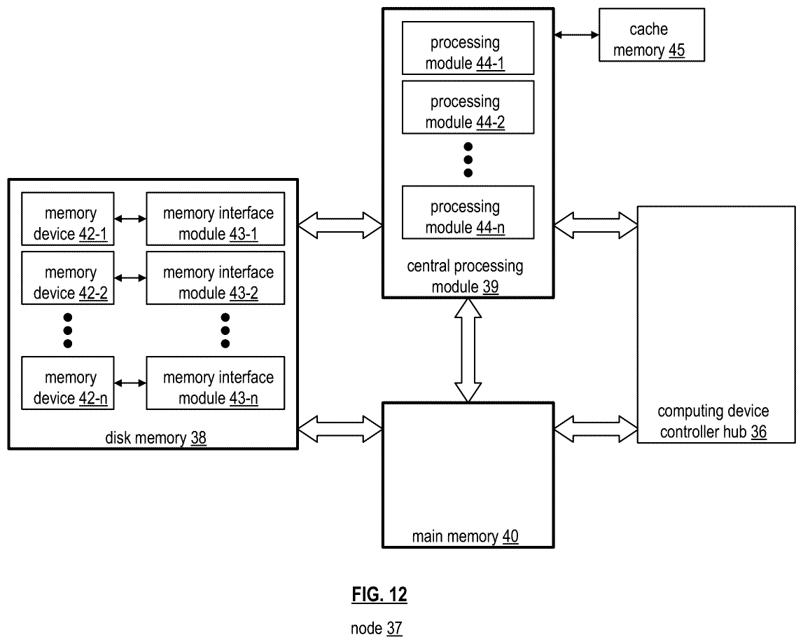

FIG. 12 is a schematic block diagram of an embodiment of a node 37 of a computing device 18 that is similar to the node of FIG. 10, with a difference in the network connection. In this embodiment, the node 37 connects to a network connection via the computing device controller hub 36.

FIG. 13 is a schematic block diagram of another embodiment of a node 37 of computing device 18 that includes processing core resources 48-1 through 48-n, a memory device (MD) bus 49, a processing module (PM) bus 50, a main memory 40 and a network connection 41. The network connection 41 includes the network card 47 and the network interface module 46 of FIG. 10. Each processing core resource 48 includes a corresponding processing module 44-1 through 44-n, a corresponding memory interface module 43-1 through 43-n, a corresponding memory device 42-1 through 42-n, and a corresponding cache memory 45-1 through 45-n. In this configuration, each processing core resource can operate independently of the other processing core resources. This further supports increased parallel operation of database functions to further reduce execution time.

The main memory 40 is divided into a computing device (CD) 56 section and a database (DB) 51 section. The database section includes a database operating system (OS) area 52, a disk area 53, a network area 54, and a general area 55. The computing device section includes a computing device operating system (OS) area 57 and a general area 58. Note that each section could include more or less allocated areas for various tasks being executed by the database system.

In general, the database OS 52 allocates main memory for database operations. Once allocated, the computing device OS 57 cannot access that portion of the main memory 40. This supports lock free and independent parallel execution of one or more operations.

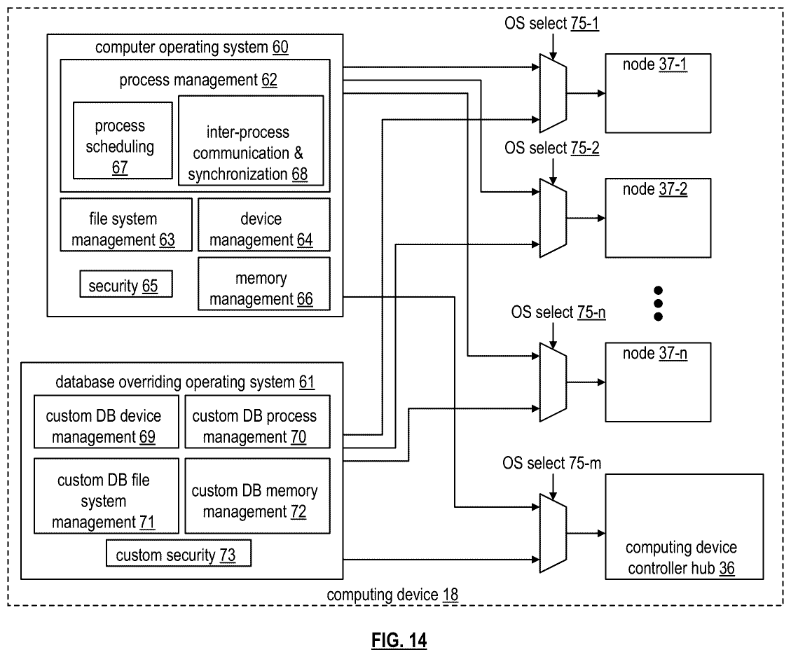

FIG. 14 is a schematic block diagram of an embodiment of operating systems of a computing device 18. The computing device 18 includes a computer operating system 60 and a database overriding operating system (DB OS) 61. The computer OS 60 includes process management 62, file system management 63, device management 64, memory management 66, and security 65. The processing management 62 generally includes process scheduling 67 and inter-process communication and synchronization 68. In general, the computer OS 60 is a conventional operating system used by a variety of types of computing devices. For example, the computer operating system is a personal computer operating system, a server operating system, a tablet operating system, a cell phone operating system, etc.

The database overriding operating system (DB OS) 61 includes custom DB device management 69, custom DB process management 70 (e.g., process scheduling and/or inter-process communication & synchronization), custom DB file system management 71, custom DB memory management 72, and/or custom security 73. In general, the database overriding OS 61 provides hardware components of a node for more direct access to memory, more direct access to a network connection, improved independency, improved data storage, improved data retrieval, and/or improved data processing than the computing device OS.

In an example of operation, the database overriding OS 61 controls which operating system, or portions thereof, operate with each node and/or computing device controller hub of a computing device (e.g., via OS select 75-1 through 75-n when communicating with nodes 37-1 through 37-n and via OS select 75-m when communicating with the computing device controller hub 36). For example, device management of a node is supported by the computer operating system, while process management, memory management, and file system management are supported by the database overriding operating system. To override the computer OS, the database overriding OS provides instructions to the computer OS regarding which management tasks will be controlled by the database overriding OS. The database overriding OS also provides notification to the computer OS as to which sections of the main memory it is reserving exclusively for one or more database functions, operations, and/or tasks. One or more examples of the database overriding operating system are provided in subsequent figures.

The database system 10 can be implemented as a massive scale database system that is operable to process data at a massive scale. As used herein, a massive scale refers to a massive number of records of a single dataset and/or many datasets, such as millions, billions, and/or trillions of records that collectively include many Gigabytes, Terabytes, Petabytes, and/or Exabytes of data. As used herein, a massive scale database system refers to a database system operable to process data at a massive scale. The processing of data at this massive scale can be achieved via a large number, such as hundreds, thousands, and/or millions of computing devices 18, nodes 37, and/or processing core resources 48 performing various functionality of database system 10 described herein in parallel, for example, independently and/or without coordination.

Such processing of data at this massive scale cannot practically be performed by the human mind. In particular, the human mind is not equipped to perform processing of data at a massive scale. Furthermore, the human mind is not equipped to perform hundreds, thousands, and/or millions of independent processes in parallel, within overlapping time spans. The embodiments of database system 10 discussed herein improves the technology of database systems by enabling data to be processed at a massive scale efficiently and/or reliably.

In particular, the database system 10 can be operable to receive data and/or to store received data at a massive scale. For example, the parallelized input and/or storing of data by the database system 10 achieved by utilizing the parallelized data input sub-system 11 and/or the parallelized data store, retrieve, and/or process sub-system 12 can cause the database system 10 to receive records for storage at a massive scale, where millions, billions, and/or trillions of records that collectively include many Gigabytes, Terabytes, Petabytes, and/or Exabytes can be received for storage, for example, reliably, redundantly and/or with a guarantee that no received records are missing in storage and/or that no received records are duplicated in storage. This can include processing real-time and/or near-real time data streams from one or more data sources at a massive scale based on facilitating ingress of these data streams in parallel. To meet the data rates required by these one or more real-time data streams, the processing of incoming data streams can be distributed across hundreds, thousands, and/or millions of computing devices 18, nodes 37, and/or processing core resources 48 for separate, independent processing with minimal and/or no coordination. The processing of incoming data streams for storage at this scale and/or this data rate cannot practically be performed by the human mind. The processing of incoming data streams for storage at this scale and/or this data rate improves database system by enabling greater amounts of data to be stored in databases for analysis and/or by enabling real-time data to be stored and utilized for analysis. The resulting richness of data stored in the database system can improve the technology of database systems by improving the depth and/or insights of various data analyses performed upon this massive scale of data.

Additionally, the database system 10 can be operable to perform queries upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to retrieve stored records at a massive scale and/or to and/or filter, aggregate, and/or perform query operators upon records at a massive scale in conjunction with query execution, where millions, billions, and/or trillions of records that collectively include many Gigabytes, Terabytes, Petabytes, and/or Exabytes can be accessed and processed in accordance with execution of one or more queries at a given time, for example, reliably, redundantly and/or with a guarantee that no records are inadvertently missing from representation in a query resultant and/or duplicated in a query resultant. To execute a query against a massive scale of records in a reasonable amount of time such as a small number of seconds, minutes, or hours, the processing of a given query can be distributed across hundreds, thousands, and/or millions of computing devices 18, nodes 37, and/or processing core resources 48 for separate, independent processing with minimal and/or no coordination. The processing of queries at this massive scale and/or this data rate cannot practically be performed by the human mind. The processing of queries at this massive scale improves the technology of database systems by facilitating greater depth and/or insights of query resultants for queries performed upon this massive scale of data.

Furthermore, the database system 10 can be operable to perform multiple queries concurrently upon data at a massive scale. For example, the parallelized retrieval and processing of data by the database system 10 achieved by utilizing the parallelized query and results sub-system 13 and/or the parallelized data store, retrieve, and/or process sub-system 12 can cause the database system 10 to perform multiple queries concurrently, for example, in parallel, against data at this massive scale, where hundreds and/or thousands of queries can be performed against the same, massive scale dataset within a same time frame and/or in overlapping time frames. To execute multiple concurrent queries against a massive scale of records in a reasonable amount of time such as a small number of seconds, minutes, or hours, the processing of a multiple queries can be distributed across hundreds, thousands, and/or millions of computing devices 18, nodes 37, and/or processing core resources 48 for separate, independent processing with minimal and/or no coordination. A given computing devices 18, nodes 37, and/or processing core resources 48 may be responsible for participating in execution of multiple queries at a same time and/or within a given time frame, where its execution of different queries occurs within overlapping time frames. The processing of many, concurrent queries at this massive scale and/or this data rate cannot practically be performed by the human mind. The processing of concurrent queries improves the technology of database systems by facilitating greater numbers of users and/or greater numbers of analyses to be serviced within a given time frame and/or over time.

FIGS. 15-23 are schematic block diagrams of an example of processing a table or data set for storage in the database system 10. FIG. 15 illustrates an example of a data set or table that includes 32 columns and 80 rows, or records, that is received by the parallelized data input-subsystem. This is a very small table, but is sufficient for illustrating one or more concepts regarding one or more aspects of a database system. The table is representative of a variety of data ranging from insurance data, to financial data, to employee data, to medical data, and so on.

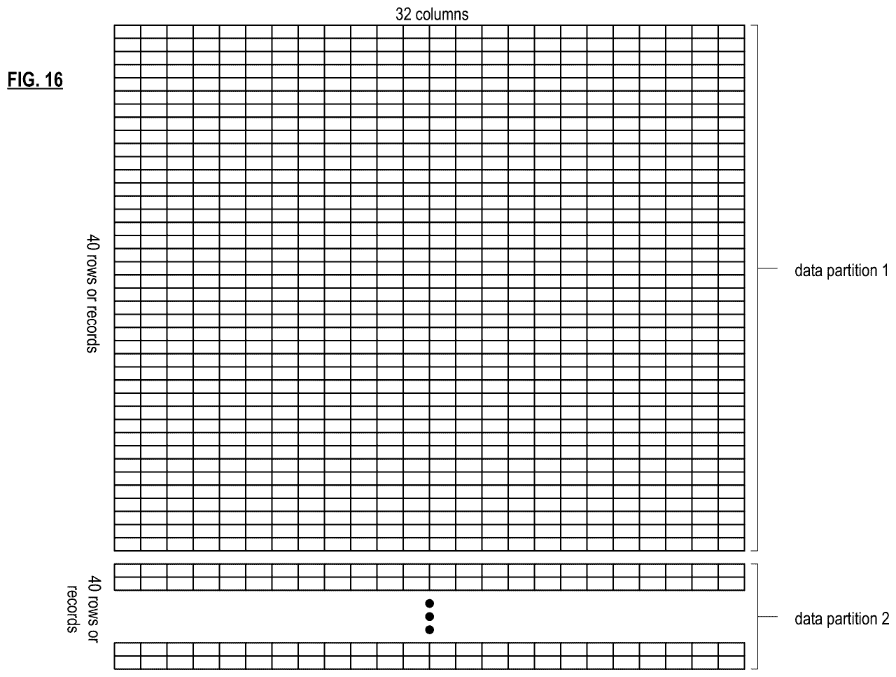

FIG. 16 illustrates an example of the parallelized data input-subsystem dividing the data set into two partitions. Each of the data partitions includes 40 rows, or records, of the data set. In another example, the parallelized data input-subsystem divides the data set into more than two partitions. In yet another example, the parallelized data input-subsystem divides the data set into many partitions and at least two of the partitions have a different number of rows.

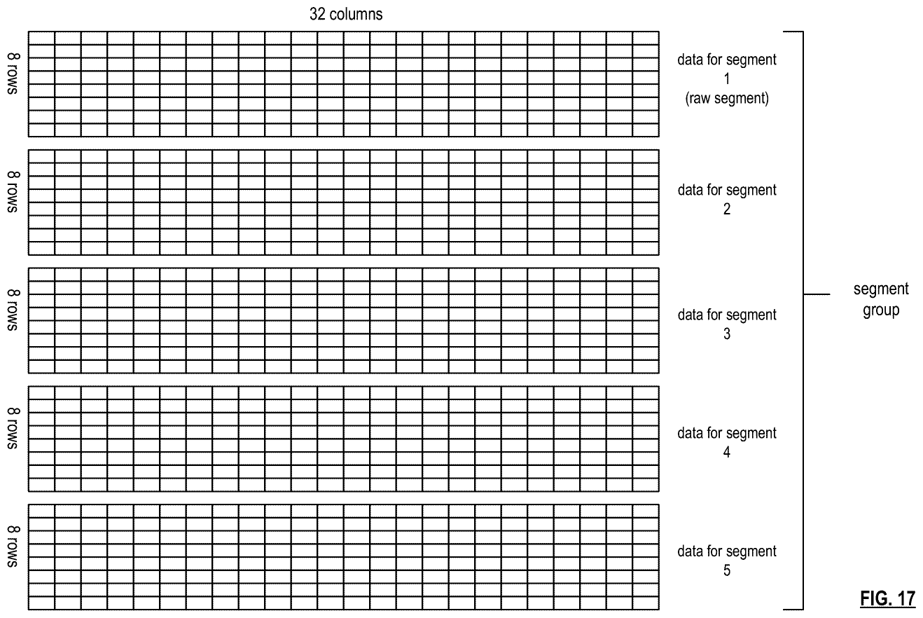

FIG. 17 illustrates an example of the parallelized data input-subsystem dividing a data partition into a plurality of segments to form a segment group. The number of segments in a segment group is a function of the data redundancy encoding. In this example, the data redundancy encoding is single parity encoding from four data pieces; thus, five segments are created. In another example, the data redundancy encoding is a two parity encoding from four data pieces; thus, six segments are created. In yet another example, the data redundancy encoding is single parity encoding from seven data pieces; thus, eight segments are created.

FIG. 18 illustrates an example of data for segment 1 of the segments of FIG. 17. The segment is in a raw form since it has not yet been key column sorted. As shown, segment 1 includes 8 rows and 32 columns. The third column is selected as the key column and the other columns store various pieces of information for a given row (i.e., a record). The key column may be selected in a variety of ways. For example, the key column is selected based on a type of query (e.g., a query regarding a year, where a data column is selected as the key column). As another example, the key column is selected in accordance with a received input command that identified the key column. As yet another example, the key column is selected as a default key column (e.g., a date column, an ID column, etc.)

As an example, the table is regarding a fleet of vehicles. Each row represents data regarding a unique vehicle. The first column stores a vehicle ID, the second column stores make and model information of the vehicle. The third column stores data as to whether the vehicle is on or off. The remaining columns store data regarding the operation of the vehicle such as mileage, gas level, oil level, maintenance information, routes taken, etc.

With the third column selected as the key column, the other columns of the segment are to be sorted based on the key column. Prior to being sorted, the columns are separated to form data slabs. As such, one column is separated out to form one data slab.

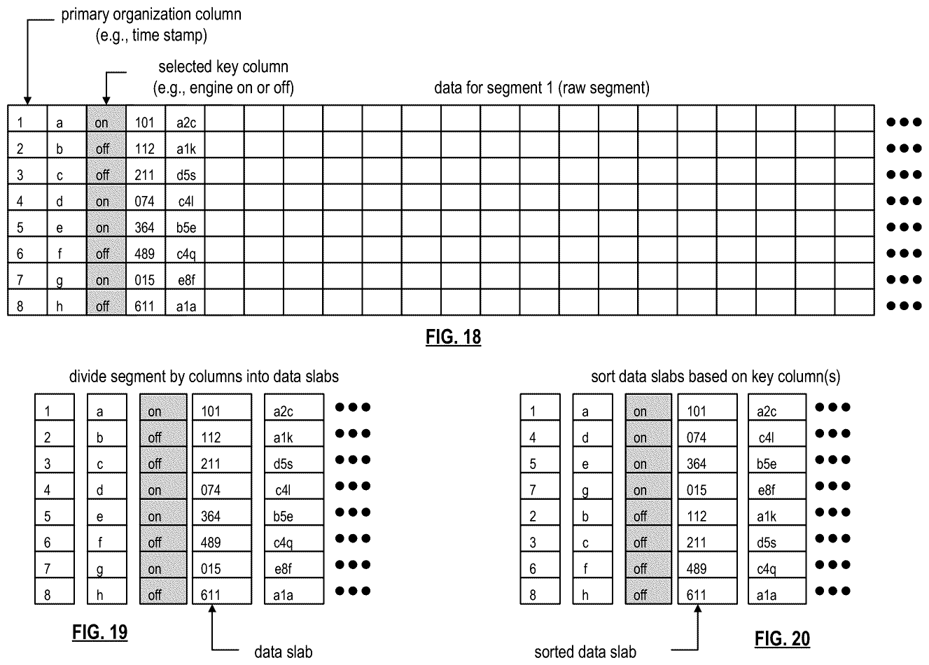

FIG. 19 illustrates an example of the parallelized data input-subsystem dividing segment 1 of FIG. 18 into a plurality of data slabs. A data slab is a column of segment 1. In this figure, the data of the data slabs has not been sorted. Once the columns have been separated into data slabs, each data slab is sorted based on the key column. Note that more than one key column may be selected and used to sort the data slabs based on two or more other columns.

FIG. 20 illustrates an example of the parallelized data input-subsystem sorting the each of the data slabs based on the key column. In this example, the data slabs are sorted based on the third column which includes data of “on” or “off”. The rows of a data slab are rearranged based on the key column to produce a sorted data slab. Each segment of the segment group is divided into similar data slabs and sorted by the same key column to produce sorted data slabs.

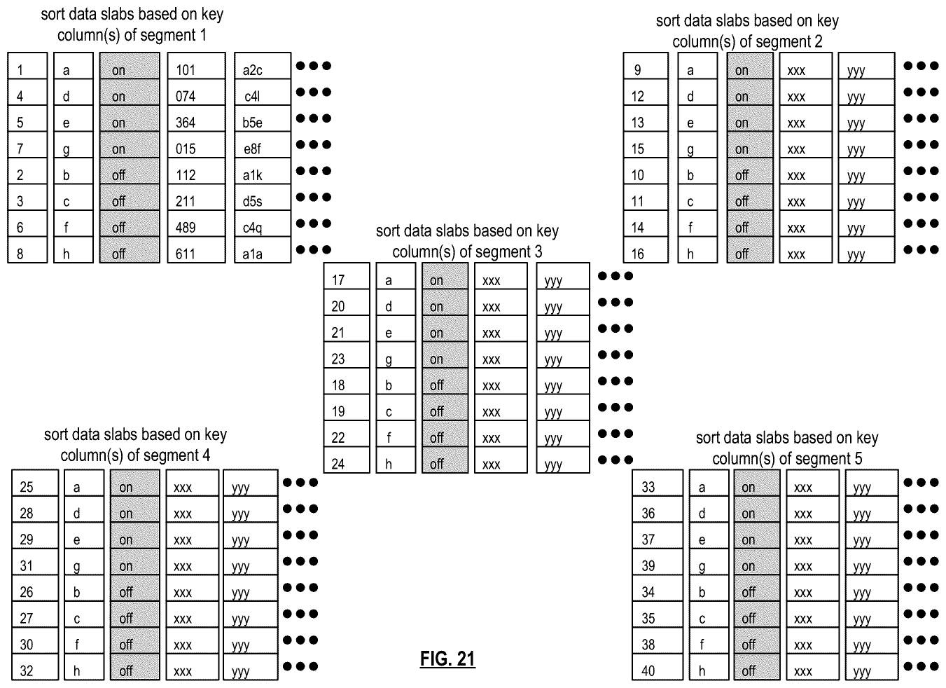

FIG. 21 illustrates an example of each segment of the segment group sorted into sorted data slabs. The similarity of data from segment to segment is for the convenience of illustration. Note that each segment has its own data, which may or may not be similar to the data in the other sections.

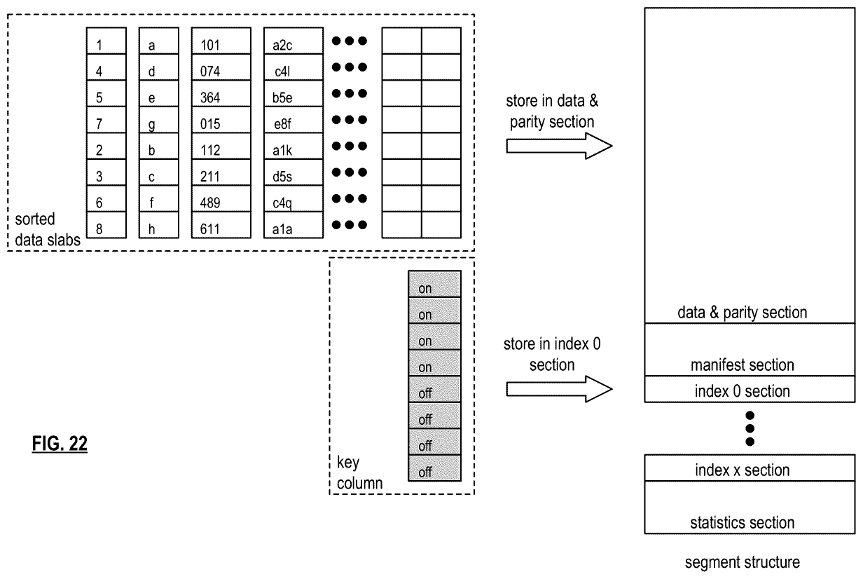

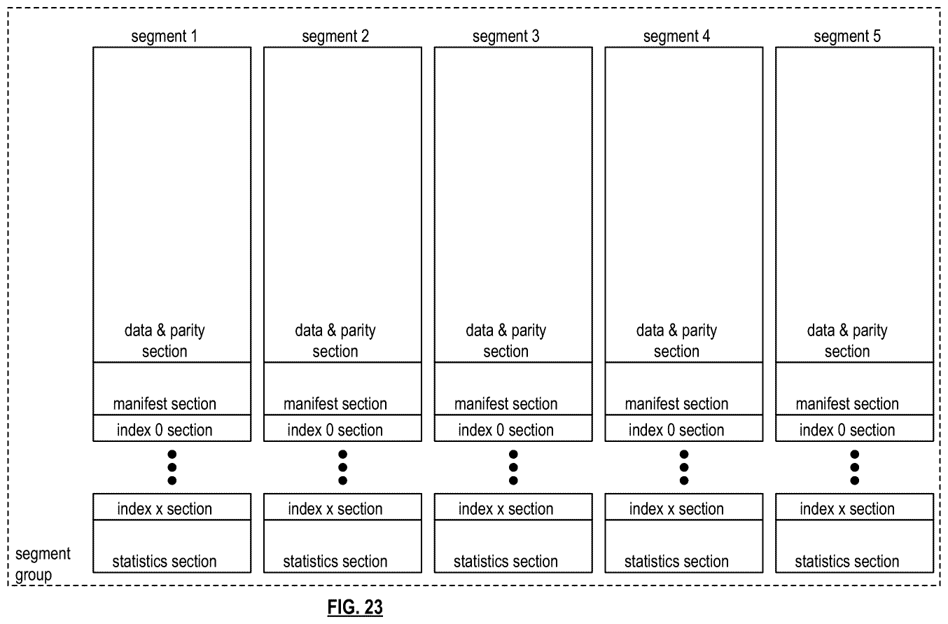

FIG. 22 illustrates an example of a segment structure for a segment of the segment group. The segment structure for a segment includes the data & parity section, a manifest section, one or more index sections, and a statistics section. The segment structure represents a storage mapping of the data (e.g., data slabs and parity data) of a segment and associated data (e.g., metadata, statistics, key column(s), etc.) regarding the data of the segment. The sorted data slabs of FIG. 16 of the segment are stored in the data & parity section of the segment structure. The sorted data slabs are stored in the data & parity section in a compressed format or as raw data (i.e., non-compressed format). Note that a segment structure has a particular data size (e.g., 32 Giga-Bytes) and data is stored within coding block sizes (e.g., 4 Kilo-Bytes).

Before the sorted data slabs are stored in the data & parity section, or concurrently with storing in the data & parity section, the sorted data slabs of a segment are redundancy encoded. The redundancy encoding may be done in a variety of ways. For example, the redundancy encoding is in accordance with RAID 5, RAID 6, or RAID 10. As another example, the redundancy encoding is a form of forward error encoding (e.g., Reed Solomon, Trellis, etc.). As another example, the redundancy encoding utilizes an erasure coding scheme.

The manifest section stores metadata regarding the sorted data slabs. The metadata includes one or more of, but is not limited to, descriptive metadata, structural metadata, and/or administrative metadata. Descriptive metadata includes one or more of, but is not limited to, information regarding data such as name, an abstract, keywords, author, etc. Structural metadata includes one or more of, but is not limited to, structural features of the data such as page size, page ordering, formatting, compression information, redundancy encoding information, logical addressing information, physical addressing information, physical to logical addressing information, etc. Administrative metadata includes one or more of, but is not limited to, information that aids in managing data such as file type, access privileges, rights management, preservation of the data, etc.

The key column is stored in an index section. For example, a first key column is stored in index #0. If a second key column exists, it is stored in index #1. As such, for each key column, it is stored in its own index section. Alternatively, one or more key columns are stored in a single index section.

The statistics section stores statistical information regarding the segment and/or the segment group. The statistical information includes one or more of, but is not limited, to number of rows (e.g., data values) in one or more of the sorted data slabs, average length of one or more of the sorted data slabs, average row size (e.g., average size of a data value), etc. The statistical information includes information regarding raw data slabs, raw parity data, and/or compressed data slabs and parity data.

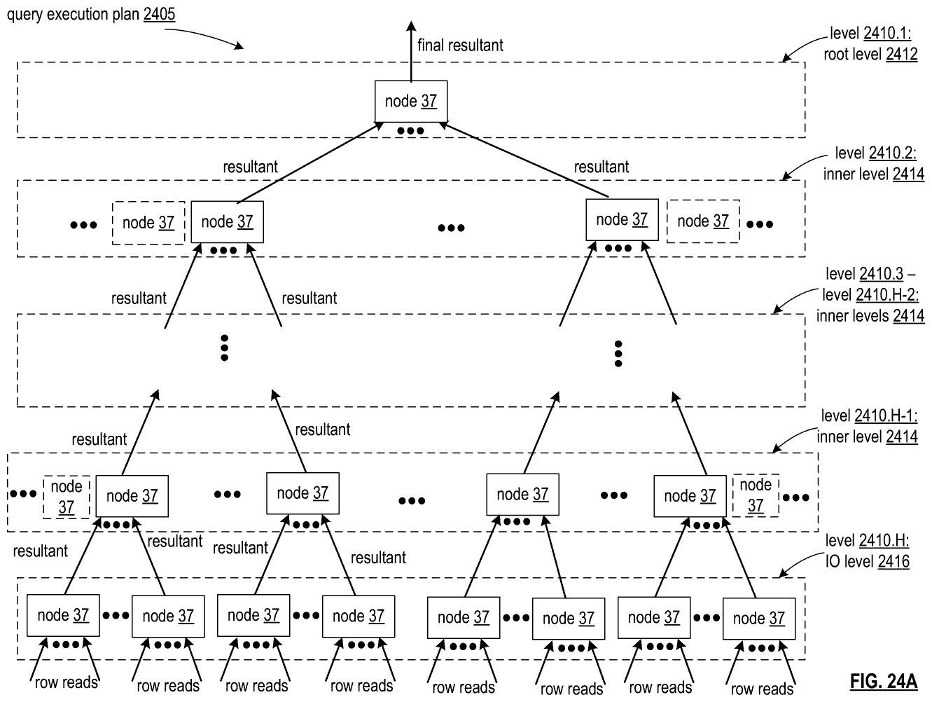

FIG. 23 illustrates the segment structures for each segment of a segment group having five segments. Each segment includes a data & parity section, a manifest section, one or more index sections, and a statistic section. Each segment is targeted for storage in a different computing device of a storage cluster. The number of segments in the segment group corresponds to the number of computing devices in a storage cluster. In this example, there are five computing devices in a storage cluster. Other examples include more or less than five computing devices in a storage cluster.

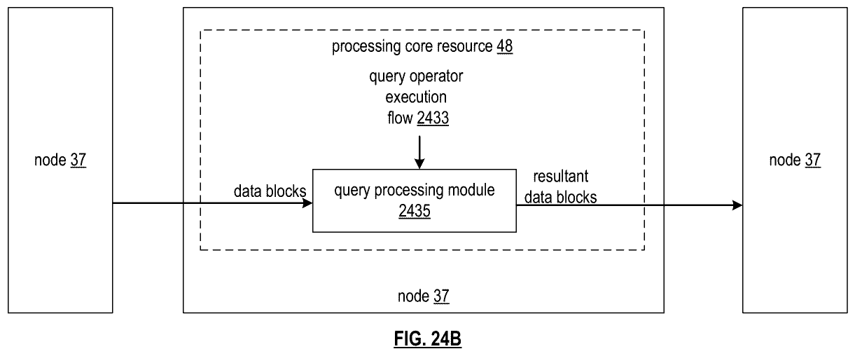

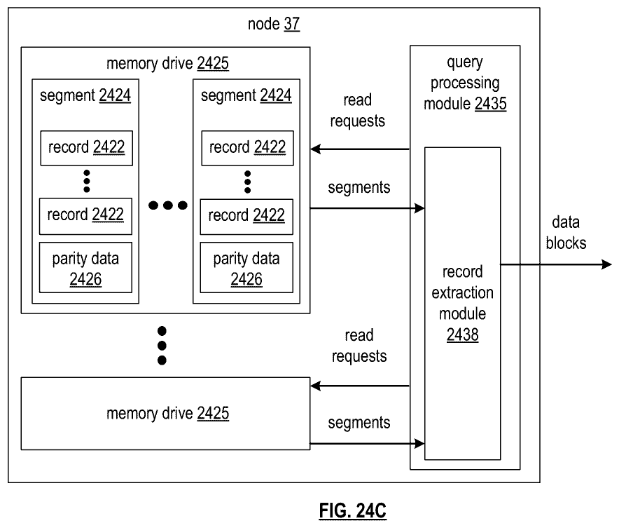

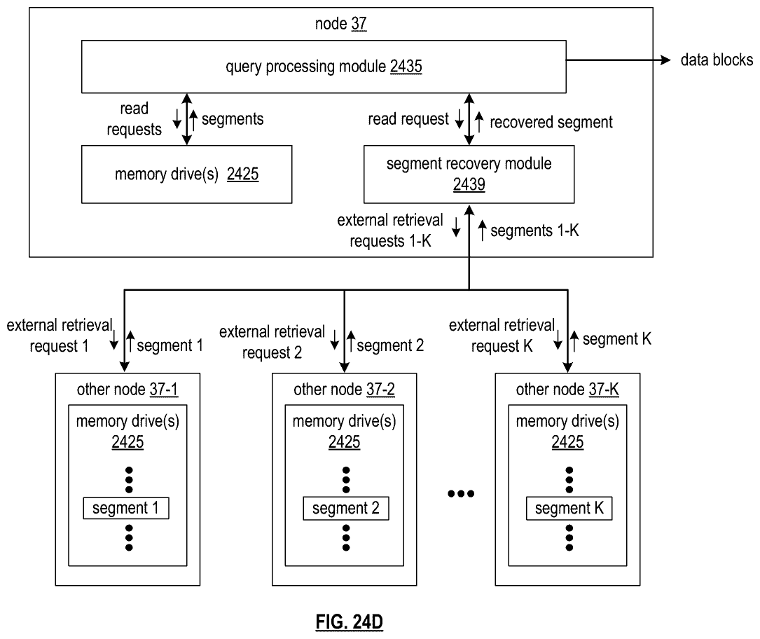

FIG. 24A illustrates an example of a query execution plan 2405 implemented by the database system 10 to execute one or more queries by utilizing a plurality of nodes 37. Each node 37 can be utilized to implement some or all of the plurality of nodes 37 of some or all computing devices 18-1-18-n, for example, of the of the parallelized data store, retrieve, and/or process sub-system 12, and/or of the parallelized query and results sub-system 13. The query execution plan can include a plurality of levels 2410. In this example, a plurality of H levels in a corresponding tree structure of the query execution plan 2405 are included. The plurality of levels can include a top, root level 2412; a bottom, IO level 2416, and one or more inner levels 2414. In some embodiments, there is exactly one inner level 2414, resulting in a tree of exactly three levels 2410.1, 2410.2, and 2410.3, where level 2410.H corresponds to level 2410.3. In such embodiments, level 2410.2 is the same as level 2410.H-1, and there are no other inner levels 2410.3-2410.H-2. Alternatively, any number of multiple inner levels 2414 can be implemented to result in a tree with more than three levels.

This illustration of query execution plan 2405 illustrates the flow of execution of a given query by utilizing a subset of nodes across some or all of the levels 2410. In this illustration, nodes 37 with a solid outline are nodes involved in executing a given query. Nodes 37 with a dashed outline are other possible nodes that are not involved in executing the given query, but could be involved in executing other queries in accordance with their level of the query execution plan in which they are included.

Each of the nodes of IO level 2416 can be operable to, for a given query, perform the necessary row reads for gathering corresponding rows of the query. These row reads can correspond to the segment retrieval to read some or all of the rows of retrieved segments determined to be required for the given query. Thus, the nodes 37 in level 2416 can include any nodes 37 operable to retrieve segments for query execution from its own storage or from storage by one or more other nodes; to recover segment for query execution via other segments in the same segment grouping by utilizing the redundancy error encoding scheme; and/or to determine which exact set of segments is assigned to the node for retrieval to ensure queries are executed correctly.

IO level 2416 can include all nodes in a given storage cluster 35 and/or can include some or all nodes in multiple storage clusters 35, such as all nodes in a subset of the storage clusters 35-1-35-z and/or all nodes in all storage clusters 35-1-35-z. For example, all nodes 37 and/or all currently available nodes 37 of the database system 10 can be included in level 2416. As another example, IO level 2416 can include a proper subset of nodes in the database system, such as some or all nodes that have access to stored segments and/or that are included in a segment set 35. In some cases, nodes 37 that do not store segments included in segment sets, that do not have access to stored segments, and/or that are not operable to perform row reads are not included at the IO level, but can be included at one or more inner levels 2414 and/or root level 2412.

The query executions discussed herein by nodes in accordance with executing queries at level 2416 can include retrieval of segments; extracting some or all necessary rows from the segments with some or all necessary columns; and sending these retrieved rows to a node at the next level 2410.H-1 as the query resultant generated by the node 37. For each node 37 at IO level 2416, the set of raw rows retrieved by the node 37 can be distinct from rows retrieved from all other nodes, for example, to ensure correct query execution. The total set of rows and/or corresponding columns retrieved by nodes 37 in the IO level for a given query can be dictated based on the domain of the given query, such as one or more tables indicated in one or more SELECT statements of the query, and/or can otherwise include all data blocks that are necessary to execute the given query.

Each inner level 2414 can include a subset of nodes 37 in the database system 10. Each level 2414 can include a distinct set of nodes 37 and/or some or more levels 2414 can include overlapping sets of nodes 37. The nodes 37 at inner levels are implemented, for each given query, to execute queries in conjunction with operators for the given query. For example, a query operator execution flow can be generated for a given incoming query, where an ordering of execution of its operators is determined, and this ordering is utilized to assign one or more operators of the query operator execution flow to each node in a given inner level 2414 for execution. For example, each node at a same inner level can be operable to execute a same set of operators for a given query, in response to being selected to execute the given query, upon incoming resultants generated by nodes at a directly lower level to generate its own resultants sent to a next higher level. In particular, each node at a same inner level can be operable to execute a same portion of a same query operator execution flow for a given query. In cases where there is exactly one inner level, each node selected to execute a query at a given inner level performs some or all of the given query's operators upon the raw rows received as resultants from the nodes at the IO level, such as the entire query operator execution flow and/or the portion of the query operator execution flow performed upon data that has already been read from storage by nodes at the IO level. In some cases, some operators beyond row reads are also performed by the nodes at the IO level. Each node at a given inner level 2414 can further perform a gather function to collect, union, and/or aggregate resultants sent from a previous level, for example, in accordance with one or more corresponding operators of the given query.

The root level 2412 can include exactly one node for a given query that gathers resultants from every node at the top-most inner level 2414. The node 37 at root level 2412 can perform additional query operators of the query and/or can otherwise collect, aggregate, and/or union the resultants from the top-most inner level 2414 to generate the final resultant of the query, which includes the resulting set of rows and/or one or more aggregated values, in accordance with the query, based on being performed on all rows required by the query. The root level node can be selected from a plurality of possible root level nodes, where different root nodes are selected for different queries. Alternatively, the same root node can be selected for all queries.

As depicted in FIG. 24A, resultants are sent by nodes upstream with respect to the tree structure of the query execution plan as they are generated, where the root node generates a final resultant of the query. While not depicted in FIG. 24A, nodes at a same level can share data and/or send resultants to each other, for example, in accordance with operators of the query at this same level dictating that data is sent between nodes.

In some cases, the IO level 2416 always includes the same set of nodes 37, such as a full set of nodes and/or all nodes that are in a storage cluster 35 that stores data required to process incoming queries. In some cases, the lowest inner level corresponding to level 2410.H-1 includes at least one node from the IO level 2416 in the possible set of nodes. In such cases, while each selected node in level 2410.H-1 is depicted to process resultants sent from other nodes 37 in FIG. 24A, each selected node in level 2410.H-1 that also operates as a node at the IO level further performs its own row reads in accordance with its query execution at the IO level, and gathers the row reads received as resultants from other nodes at the IO level with its own row reads for processing via operators of the query. One or more inner levels 2414 can also include nodes that are not included in IO level 2416, such as nodes 37 that do not have access to stored segments and/or that are otherwise not operable and/or selected to perform row reads for some or all queries.

The node 37 at root level 2412 can be fixed for all queries, where the set of possible nodes at root level 2412 includes only one node that executes all queries at the root level of the query execution plan. Alternatively, the root level 2412 can similarly include a set of possible nodes, where one node selected from this set of possible nodes for each query and where different nodes are selected from the set of possible nodes for different queries. In such cases, the nodes at inner level 2410.2 determine which of the set of possible root nodes to send their resultant to. In some cases, the single node or set of possible nodes at root level 2412 is a proper subset of the set of nodes at inner level 2410.2, and/or is a proper subset of the set of nodes at the IO level 2416. In cases where the root node is included at inner level 2410.2, the root node generates its own resultant in accordance with inner level 2410.2, for example, based on multiple resultants received from nodes at level 2410.3, and gathers its resultant that was generated in accordance with inner level 2410.2 with other resultants received from nodes at inner level 2410.2 to ultimately generate the final resultant in accordance with operating as the root level node.

In some cases where nodes are selected from a set of possible nodes at a given level for processing a given query, the selected node must have been selected for processing this query at each lower level of the query execution tree. For example, if a particular node is selected to process a node at a particular inner level, it must have processed the query to generate resultants at every lower inner level and the IO level. In such cases, each selected node at a particular level will always use its own resultant that was generated for processing at the previous, lower level, and will gather this resultant with other resultants received from other child nodes at the previous, lower level. Alternatively, nodes that have not yet processed a given query can be selected for processing at a particular level, where all resultants being gathered are therefore received from a set of child nodes that do not include the selected node.

The configuration of query execution plan 2405 for a given query can be determined in a downstream fashion, for example, where the tree is formed from the root downwards. Nodes at corresponding levels are determined from configuration information received from corresponding parent nodes and/or nodes at higher levels, and can each send configuration information to other nodes, such as their own child nodes, at lower levels until the lowest level is reached. This configuration information can include assignment of a particular subset of operators of the set of query operators that each level and/or each node will perform for the query. The execution of the query is performed upstream in accordance with the determined configuration, where IO reads are performed first, and resultants are forwarded upwards until the root node ultimately generates the query result.

FIG. 24B illustrates an embodiment ofa node 37 executing a query in accordance with the query execution plan 2405 by implementing a query processing module 2435. The query processing module 2435 can be operable to execute a query operator execution flow 2433 determined by the node 37, where the query operator execution flow 2433 corresponds to the entirety of processing of the query upon incoming data assigned to the corresponding node 37 in accordance with its role in the query execution plan 2405. This embodiment of node 37 that utilizes a query processing module 2435 can be utilized to implement some or all of the plurality of nodes 37 of some or all computing devices 18-1-18-n, for example, of the of the parallelized data store, retrieve, and/or process sub-system 12, and/or of the parallelized query and results sub-system 13.

As used herein, execution of a particular query by a particular node 37 can correspond to the execution of the portion of the particular query assigned to the particular node in accordance with full execution of the query by the plurality of nodes involved in the query execution plan 2405. This portion of the particular query assigned to a particular node can correspond to execution plurality of operators indicated by a query operator execution flow 2433. In particular, the execution of the query for a node 37 at an inner level 2414 and/or root level 2412 corresponds to generating a resultant by processing all incoming resultants received from nodes at a lower level of the query execution plan 2405 that send their own resultants to the node 37. The execution of the query for a node 37 at the IO level corresponds to generating all resultant data blocks by retrieving and/or recovering all segments assigned to the node 37.

Thus, as used herein, a node 37's full execution of a given query corresponds to only a portion of the query's execution across all nodes in the query execution plan 2405. In particular, a resultant generated by an inner level node 37's execution of a given query may correspond to only a portion of the entire query result, such as a subset of rows in a final result set, where other nodes generate their own resultants to generate other portions of the full resultant of the query. In such embodiments, a plurality of nodes at this inner level can fully execute queries on different portions of the query domain independently in parallel by utilizing the same query operator execution flow 2433. Resultants generated by each of the plurality of nodes at this inner level 2414 can be gathered into a final result of the query, for example, by the node 37 at root level 2412 if this inner level is the top-most inner level 2414 or the only inner level 2414. As another example, resultants generated by each of the plurality of nodes at this inner level 2414 can be further processed via additional operators of a query operator execution flow 2433 being implemented by another node at a consecutively higher inner level 2414 of the query execution plan 2405, where all nodes at this consecutively higher inner level 2414 all execute their own same query operator execution flow 2433.

As discussed in further detail herein, the resultant generated by a node 37 can include a plurality of resultant data blocks generated via a plurality of partial query executions. As used herein, a partial query execution performed by a node corresponds to generating a resultant based on only a subset of the query input received by the node 37. In particular, the query input corresponds to all resultants generated by one or more nodes at a lower level of the query execution plan that send their resultants to the node. However, this query input can correspond to a plurality of input data blocks received over time, for example, in conjunction with the one or more nodes at the lower level processing their own input data blocks received over time to generate their resultant data blocks sent to the node over time. Thus, the resultant generated by a node's full execution of a query can include a plurality of resultant data blocks, where each resultant data block is generated by processing a subset of all input data blocks as a partial query execution upon the subset of all data blocks via the query operator execution flow 2433.

As illustrated in FIG. 24B, the query processing module 2435 can be implemented by a single processing core resource 48 of the node 37. In such embodiments, each one of the processing core resources 48-1-48-n of a same node 37 can be executing at least one query concurrently via their own query processing module 2435, where a single node 37 implements each of set of operator processing modules 2435-1-2435-n via a corresponding one of the set of processing core resources 48-1-48-n. A plurality of queries can be concurrently executed by the node 37, where each of its processing core resources 48 can each independently execute at least one query within a same temporal period by utilizing a corresponding at least one query operator execution flow 2433 to generate at least one query resultant corresponding to the at least one query.

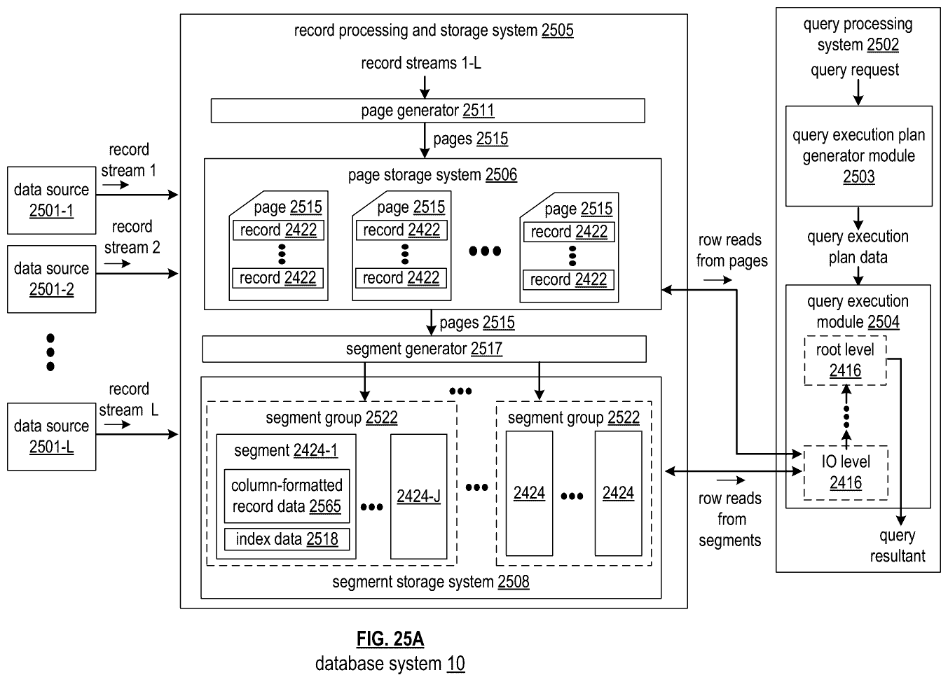

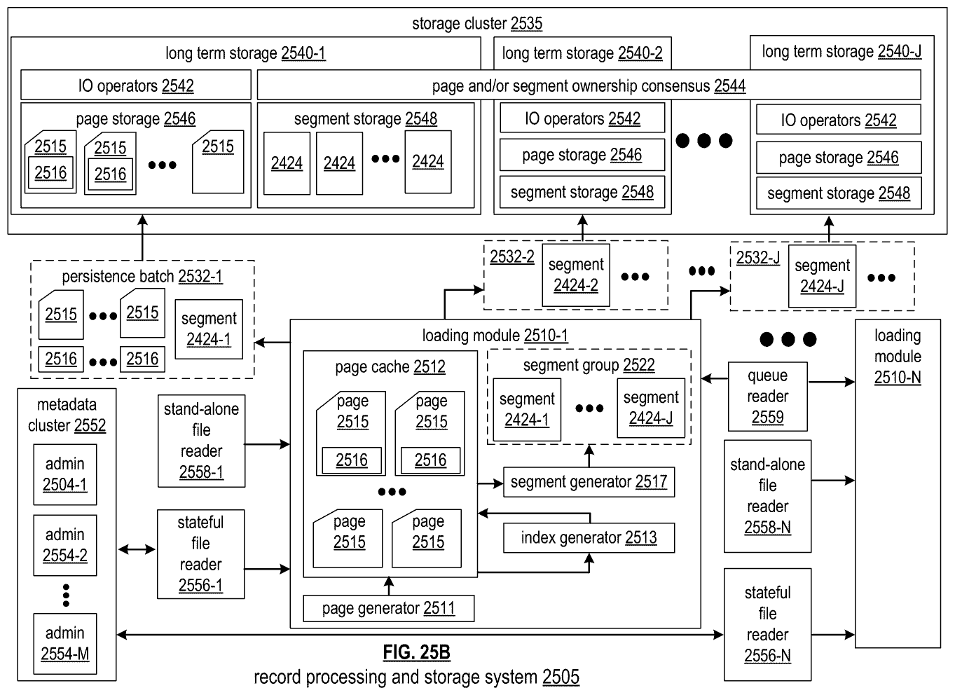

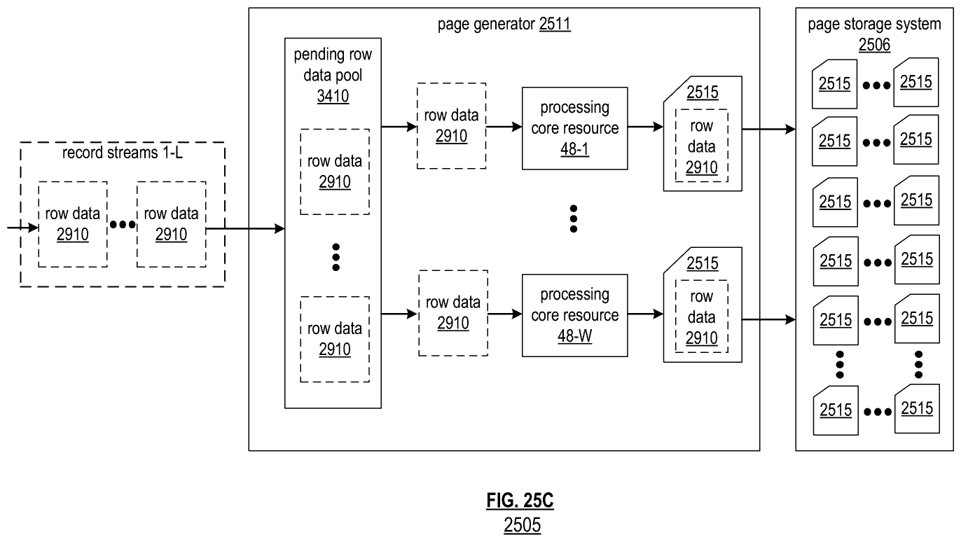

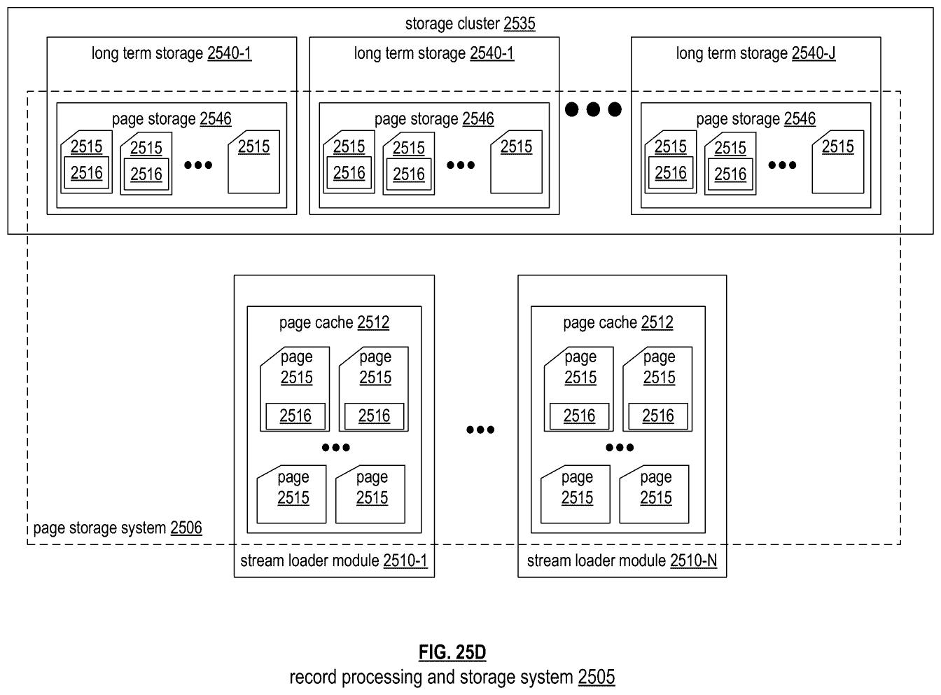

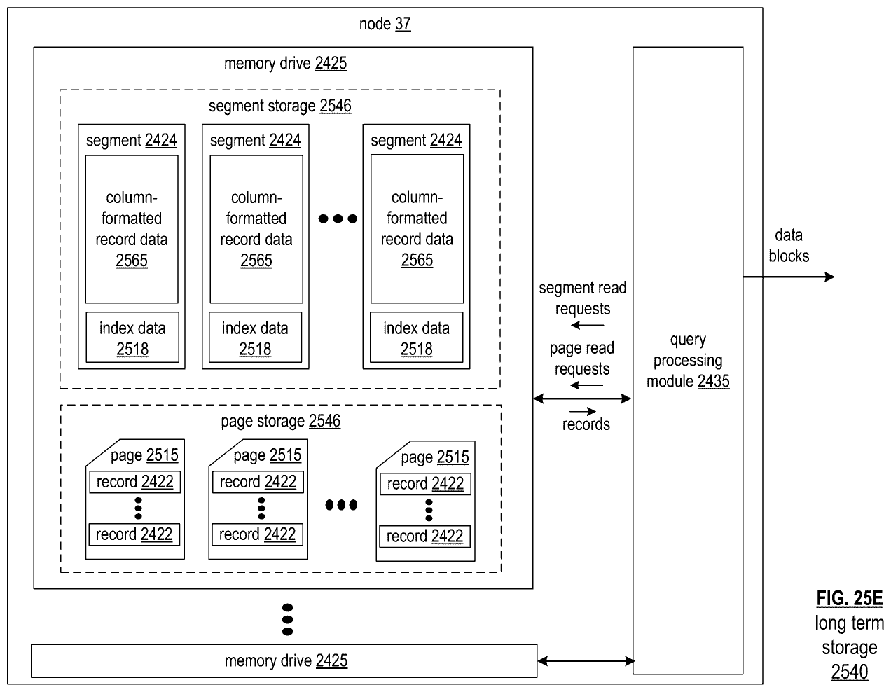

FIG. 25C illustrates a particular example of a node 37 at the IO level 2416 of the query execution plan 2405 of FIG. 24A. A node 37 can utilize its own memory resources, such as some or all of its disk memory 38 and/or some or all of its main memory 40 to implement at least one memory drive 2425 that stores a plurality of segments 2424. Memory drives 2425 of a node 37 can be implemented, for example, by utilizing disk memory 38 and/or main memory 40. In particular, a plurality of distinct memory drives 2425 of a node 37 can be implemented via the plurality of memory devices 42-1-42-n of the node 37's disk memory 38.

Each segment 2424 stored in memory drive 2425 can be generated as discussed previously in conjunction with FIGS. 15-23. A plurality of records 2422 can be included in and/or extractable from the segment, for example, where the plurality of records 2422 of a segment 2424 correspond to a plurality of rows designated for the particular segment 2424 prior to applying the redundancy storage coding scheme as illustrated in FIG. 17. The records 2422 can be included in data of segment 2424, for example, in accordance with a column-format and/or other structured format. Each segments 2424 can further include parity data 2426 as discussed previously to enable other segments 2424 in the same segment group to be recovered via applying a decoding function associated with the redundancy storage coding scheme, such as a RAID scheme and/or erasure coding scheme, that was utilized to generate the set of segments of a segment group.

Thus, in addition to performing the first stage of query execution by being responsible for row reads, nodes 37 can be utilized for database storage, and can each locally store a set of segments in its own memory drives 2425. In some cases, a node 37 can be responsible for retrieval of only the records stored in its own one or more memory drives 2425 as one or more segments 2424. Executions of queries corresponding to retrieval of records stored by a particular node 37 can be assigned to that particular node 37. In other embodiments, a node 37 does not use its own resources to store segments. A node 37 can access its assigned records for retrieval via memory resources of another node 37 and/or via other access to memory drives 2425, for example, by utilizing system communication resources 14.

The query processing module 2435 of the node 37 can be utilized to read the assigned by first retrieving or otherwise accessing the corresponding redundancy-coded segments 2424 that include the assigned records its one or more memory drives 2425. Query processing module 2435 can include a record extraction module 2438 that is then utilized to extract or otherwise read some or all records from these segments 2424 accessed in memory drives 2425, for example, where record data of the segment is segregated from other information such as parity data included in the segment and/or where this data containing the records is converted into row-formatted records from the column-formatted row data stored by the segment. Once the necessary records of a query are read by the node 37, the node can further utilize query processing module 2435 to send the retrieved records all at once, or in a stream as they are retrieved from memory drives 2425, as data blocks to the next node 37 in the query execution plan 2405 via system communication resources 14 or other communication channels.

FIG. 24D illustrates an embodiment of a node 37 that implements a segment recovery module 2439 to recover some or all segments that are assigned to the node for retrieval, in accordance with processing one or more queries, that are unavailable. Some or all features of the node 37 of FIG. 24D can be utilized to implement the node 37 of FIGS. 24B and 24C, and/or can be utilized to implement one or more nodes 37 of the query execution plan 2405 of FIG. 24A, such as nodes 37 at the IO level 2416. A node 37 may store segments on one of its own memory drives 2425 that becomes unavailable, or otherwise determines that a segment assigned to the node for execution of a query is unavailable for access via a memory drive the node 37 accesses via system communication resources 14. The segment recovery module 2439 can be implemented via at least one processing module of the node 37, such as resources of central processing module 39. The segment recovery module 2439 can retrieve the necessary number of segments 1-K in the same segment group as an unavailable segment from other nodes 37, such as a set of other nodes 37-1-37-K that store segments in the same storage cluster 35. Using system communication resources 14 or other communication channels, a set of external retrieval requests 1-K for this set of segments 1-K can be sent to the set of other nodes 37-1-37-K, and the set of segments can be received in response. This set of K segments can be processed, for example, where a decoding function is applied based on the redundancy storage coding scheme utilized to generate the set of segments in the segment group and/or parity data of this set of K segments is otherwise utilized to regenerate the unavailable segment. The necessary records can then be extracted from the unavailable segment, for example, via the record extraction module 2438, and can be sent as data blocks to another node 37 for processing in conjunction with other records extracted from available segments retrieved by the node 37 from its own memory drives 2425.

Note that the embodiments of node 37 discussed herein can be configured to execute multiple queries concurrently by communicating with nodes 37 in the same or different tree configuration of corresponding query execution plans and/or by performing query operations upon data blocks and/or read records for different queries. In particular, incoming data blocks can be received from other nodes for multiple different queries in any interleaving order, and a plurality of operator executions upon incoming data blocks for multiple different queries can be performed in any order, where output data blocks are generated and sent to the same or different next node for multiple different queries in any interleaving order. IO level nodes can access records for the same or different queries any interleaving order. Thus, at a given point in time, a node 37 can have already begun its execution of at least two queries, where the node 37 has also not yet completed its execution of the at least two queries.

A query execution plan 2405 can guarantee query correctness based on assignment data sent to or otherwise communicated to all nodes at the IO level ensuring that the set of required records in query domain data of a query, such as one or more tables required to be accessed by a query, are accessed exactly one time: if a particular record is accessed multiple times in the same query and/or is not accessed, the query resultant cannot be guaranteed to be correct. Assignment data indicating segment read and/or record read assignments to each of the set of nodes 37 at the IO level can be generated, for example, based on being mutually agreed upon by all nodes 37 at the IO level via a consensus protocol executed between all nodes at the IO level and/or distinct groups of nodes 37 such as individual storage clusters 35. The assignment data can be generated such that every record in the database system and/or in query domain of a particular query is assigned to be read by exactly one node 37. Note that the assignment data may indicate that a node 37 is assigned to read some segments directly from memory as illustrated in FIG. 24C and is assigned to recover some segments via retrieval of segments in the same segment group from other nodes 37 and via applying the decoding function of the redundancy storage coding scheme as illustrated in FIG. 24D.

Assuming all nodes 37 read all required records and send their required records to exactly one next node 37 as designated in the query execution plan 2405 for the given query, the use of exactly one instance of each record can be guaranteed. Assuming all inner level nodes 37 process all the required records received from the corresponding set of nodes 37 in the IO level 2416, via applying one or more query operators assigned to the node in accordance with their query operator execution flow 2433, correctness of their respective partial resultants can be guaranteed. This correctness can further require that nodes 37 at the same level intercommunicate by exchanging records in accordance with JOIN operations as necessary, as records received by other nodes may be required to achieve the appropriate result of a JOIN operation. Finally, assuming the root level node receives all correctly generated partial resultants as data blocks from its respective set of nodes at the penultimate, highest inner level 2414 as designated in the query execution plan 2405, and further assuming the root level node appropriately generates its own final resultant, the correctness of the final resultant can be guaranteed.

In some embodiments, each node 37 in the query execution plan can monitor whether it has received all necessary data blocks to fulfill its necessary role in completely generating its own resultant to be sent to the next node 37 in the query execution plan. A node 37 can determine receipt of a complete set of data blocks that was sent from a particular node 37 at an immediately lower level, for example, based on being numbered and/or have an indicated ordering in transmission from the particular node 37 at the immediately lower level, and/or based on a final data block of the set of data blocks being tagged in transmission from the particular node 37 at the immediately lower level to indicate it is a final data block being sent. A node 37 can determine the required set of lower level nodes from which it is to receive data blocks based on its knowledge of the query execution plan 2405 of the query. A node 37 can thus conclude when a complete set of data blocks has been received each designated lower level node in the designated set as indicated by the query execution plan 2405. This node 37 can therefore determine itself that all required data blocks have been processed into data blocks sent by this node 37 to the next node 37 and/or as a final resultant if this node 37 is the root node. This can be indicated via tagging of its own last data block, corresponding to the final portion of the resultant generated by the node, where it is guaranteed that all appropriate data was received and processed into the set of data blocks sent by this node 37 in accordance with applying its own query operator execution flow 2433.

In some embodiments, if any node 37 determines it did not receive all of its required data blocks, the node 37 itself cannot fulfill generation of its own set of required data blocks. For example, the node 37 will not transmit a final data block tagged as the “last” data block in the set of outputted data blocks to the next node 37, and the next node 37 will thus conclude there was an error and will not generate a full set of data blocks itself. The root node, and/or these intermediate nodes that never received all their data and/or never fulfilled their generation of all required data blocks, can independently determine the query was unsuccessful. In some cases, the root node, upon determining the query was unsuccessful, can initiate re-execution of the query by re-establishing the same or different query execution plan 2405 in a downward fashion as described previously, where the nodes 37 in this re-established query execution plan 2405 execute the query accordingly as though it were a new query. For example, in the case of a node failure that caused the previous query to fail, the new query execution plan 2405 can be generated to include only available nodes where the node that failed is not included in the new query execution plan 2405.

FIG. 25A illustrates an embodiment of a database system 10 that implements a record processing and storage system 2505. The record processing and storage system 2505 can be operable to generate and store the segments 2424 discussed previously by utilizing a segment generator 2517 to convert sets of row-formatted records 2422 into column-formatted record data 2565. These row-formatted records 2422 can correspond to rows of a database table with populated column values of the table, for example, where each record 2422 corresponds to a single row as illustrated in FIG. 15. For example, the segment generator 2517 can generate the segments 2424 in accordance with the process discussed in conjunction with FIGS. 15-23. The segments 2424 can be generated to include index data 2518, which can include a plurality of index sections such as the index sections 0-X illustrated in FIG. 23. The segments 2424 can optionally be generated to include other metadata, such as the manifest section and/or statistics section illustrated in FIG. 23.

The generated segments 2424 can be stored in a segment storage system 2508 for access in query executions. For example, the records 2422 can be extracted from generated segments 2424 in various query executions performed by via a query processing system 2502 of the database system 10, for example, as discussed in FIGS. 25A-25D. In particular, the segment storage system 2508 can be implemented by utilizing the memory drives 2425 of a plurality of IO level nodes 27 that are operable to store segments. As discussed previously, nodes 37 at the IO level 2416 can store segments 2424 in their memory drives 2425 as illustrated in FIG. 24C. These nodes can perform IO operations in accordance with query executions by reading rows from these segments 2424 and/or by recovering segments based on receiving segments from other nodes as illustrated in FIG. 24D. The records 2422 can be extracted from the column-formatted record data 2565 for these IO operations of query executions by utilizing the index data 2518 of the corresponding segment 2424.

To enhance the performance of query executions via access to segments 2424 to read records 2422 in this fashion, the sets of rows included in each segment are ideally clustered well. In the ideal case, rows sharing the same cluster key are stored together in the same segment or same group of segments. For example, rows having matching values of key columns(s) of FIG. 18 utilized to sort the rows into groups for conversion into segments are ideally stored in the same segments. As used herein, a cluster key can be implemented as any one or more columns, such as key columns(s) of FIG. 18, that are utilized to cluster records into segment groups for segment generation. As used herein, more favorable levels of clustering correspond to more rows with same or similar cluster keys being stored in the same segments, while less favorable levels of clustering correspond to less rows with same or similar cluster keys being stored in the same segments. More favorable levels of clustering can achieve more efficient query performance. In particular, query filtering parameters of a given query can specify particular sets of records with particular cluster keys be accessed, and if these records are stored together, fewer segments, memory drives, and/or nodes need to be accessed and/or utilized for the given query.

These favorable levels of clustering can be hard to achieve when relying upon the incoming ordering of records in record streams 1-L from a set of data sources 2501-1-2501-L. No assumptions can necessarily be made about the clustering, with respect to the cluster key, of rows presented by external sources as they are received in the data stream. For example, the cluster key value of a given row received at a first time t₁ gives no information about the cluster key value of a row received at a second time t₂ after t₁. It would therefore be unideal to frequently generate segments by performing a clustering process to group the most recently received records by cluster key. In particular, because records received within a given time frame from a particular data source may not be related and have many different cluster key values, the resulting record groups utilized to generate segments would render unfavorable levels of clustering.

To achieve more favorable levels of clustering, the record processing and storage system 2505 implements a page generator 2511 and a page storage system 2506 to store a plurality of pages 2515. The page generator 2511 is operable to generate pages 2515 from incoming records 2422 of record streams 1-L, for example, as is discussed in further detail in conjunction with FIG. 25C. Each page 2515 generated by the page generator 2511 can include a set of records, for example, in their original row format and/or in a data format as received from data sources 2501-1-2501-L. Once generated, the pages 2515 can be stored in a page storage system 2506, which can be implemented via memory drives and/or cache memory of one or more computing devices 18, such as some or all of the same or different nodes 37 storing segments 2424 as part of the segment storage system 2508.

This generation and storage of pages 2515 stored by can serve as temporary storage of the incoming records as they await conversion into segments 2424. Pages 2515 can be generated and stored over lengthy periods of time, such as hours or days. During this length time frame, pages 2515 can continue to be accumulated as one or more record streams of incoming records 1-L continue to supply additional records for storage by the database system.

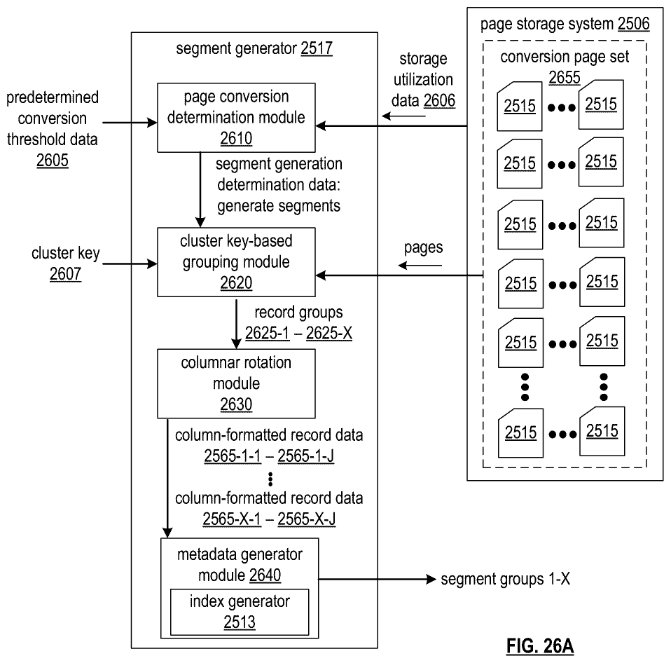

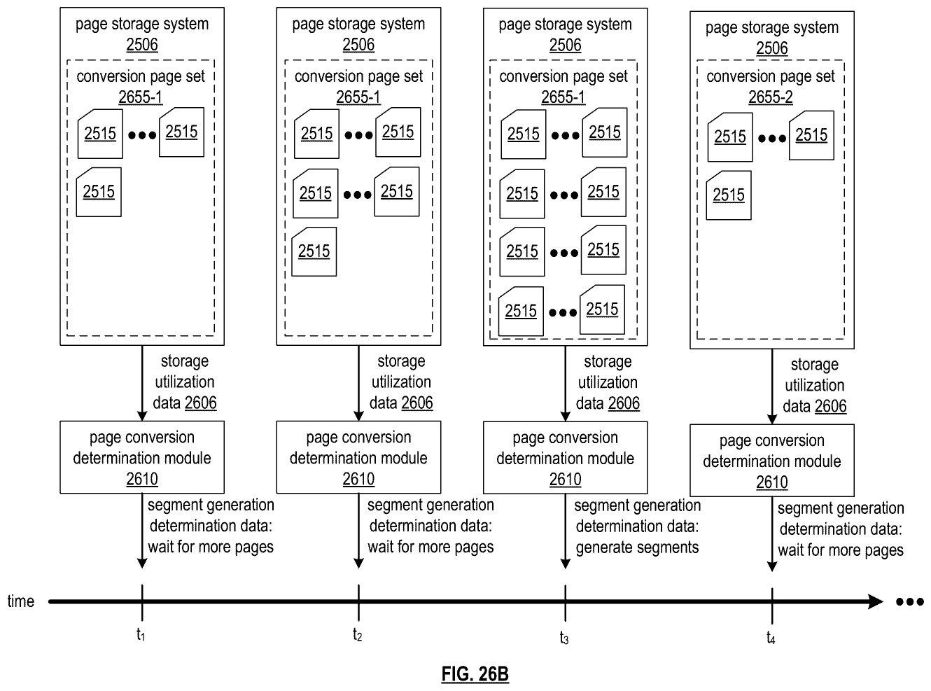

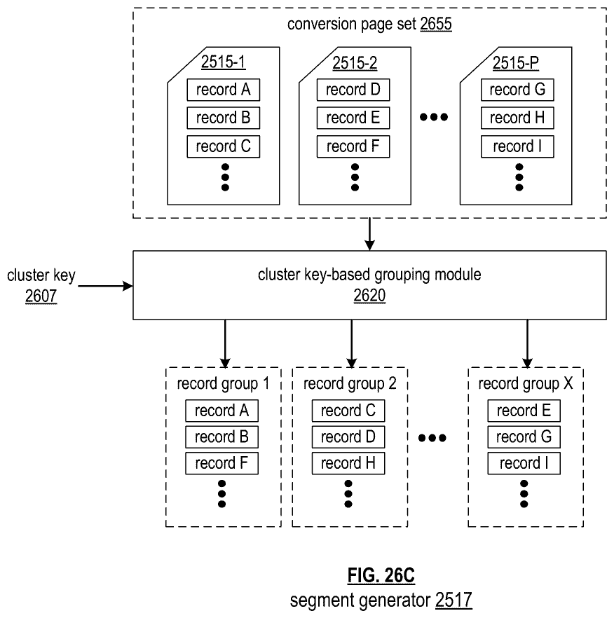

The plurality of pages generated and stored over this period of time can be converted into segments, for example once a sufficient amount of records have been received and stored as pages, and/or once the page storage system 2506 runs out of memory resources to store any additional pages. It can be advantageous to accumulate and store as many records as possible in pages 2515 prior to conversion to achieve more favorable levels of clustering. In particular, performing a clustering process upon a greater numbers of records, such as the greatest number of records possible can achieve more favorable levels of clustering, For example, greater numbers of records with common cluster keys are expected to be included in the total set of pages 2515 of the page storage system 2506 when the page storage system 2506 accumulates pages over longer periods of time to include a greater number of pages. In other words. delaying the grouping of rows into segments as long as possible increases the chances of having sufficient numbers of records with same and/or similar cluster keys to group together in segments. Determining when to generate segments such that the conversion from pages into segments is delayed as long as possible, and/or such that a sufficient amount of records are converted all at once to induce more favorable levels of cluster, is discussed in further detail in conjunction with FIGS. 26A-26D. Alternatively, the conversion of pages into segments can occur at any frequency, for example, where pages are converted into segments more frequently and/or in accordance with any schedule or determination in other embodiments of the record processing and storage system 2505.

This mechanism of improving clustering levels in segment generation by delaying the clustering process required for segment generation as long as possible can be further leveraged to reduce resource utilization of the record processing and storage system 2505. As the record processing and storage system 2505 is responsible for receiving records streams from data sources for storage, for example, in the scale of terabyte per second load rates, this process of generating pages from the record streams should therefore be as efficient as possible. The page generator 2511 can be further implemented to reduce resource consumption of the record processing and storage system 2505 in page generation and storage by minimizing the processing of, movement of, and/or access to records 2422 of pages 2515 once generated as they await conversion into segments.

To reduce the processing induced upon the record processing and storage system 2505 during this data ingress, sets of incoming records 2422 can be included in a corresponding page 2515 without performing any clustering or sorting. For example, as clustering assumptions cannot be made for incoming data, incoming rows can be placed into pages based on the order that they are received and/or based on any order that best conserves resources. In some embodiments, the entire clustering process is performed by the segment generator 2517 upon all stored pages all at once, where the page generator 2511 does not perform any stages of the clustering process.

In some embodiments, to further reduce the processing induced upon the record processing and storage system 2505 during this data ingress, incoming record data of data streams 1-L undergo minimal reformatting by the page generator 2511 in generating pages 2515. In some cases, the incoming data of record streams 1-L is not reformatted and is simply “placed” into a corresponding page 2515. For example, a set of records are included in given page in accordance with formatted row data received from data sources.

While delaying segment generation in this fashion improves clustering and further improves ingress efficiency, it can be unideal to wait for records to be processed into segments before they appear in query results, particularly because the most recent data may be of the most interest to end users requesting queries. The record processing and storage system 2505 can resolve this problem by being further operable to facilitate page reads in addition to segment reads in facilitating query executions.

As illustrated in FIG. 25A, a query processing system 2502 can implement a query execution plan generator module 2503 to generate query execution plan data based on a received query request. The query execution plan data can be relayed to nodes participating in the corresponding query execution plan 2405 indicated by the query execution plan data, for example, as discussed in conjunction with FIG. 24A. A query execution module 2504 can be implemented via a plurality of nodes participating in the query execution plan 2405, for example, where data blocks are propagated upwards from nodes at IO level 2416 to a root node at root level 2412 to generate a query resultant. The nodes at IO level 2416 can perform row reads to read records 2422 from segments 2424 as discussed previously and as illustrated in FIG. 24C. The nodes at IO level 2416 can further perform row reads to read records 2422 from pages 2515. For example, once records 2422 are durably stored by being stored in a page 2515, and/or by being duplicated and stored in multiple pages 2515, the record 2422 can be available to service queries, and will be accessed by nodes 37 at IO level 2416 in executing queries accordingly. This enables the availability of records 2422 for query executions more quickly, where the records need not be processed for storage in their final storage format as segments 2424 to be accessed in query requests. Execution of a given query can include utilizing a set of records stored in a combination of pages 2515 and segments 2424. An embodiment of an IO level node that stores and accesses both segments and pages is illustrated in FIG. 25E.

The record processing and storage system 2505 can be implemented utilizing the parallelized data input sub-system 11 and/or the parallelized ingress sub-system 24 of FIG. 4. The record processing and storage system 2505 can alternatively or additionally be implemented utilizing the parallelized data store, retrieve, and/or process sub-system 12 of FIG. 6. The record processing and storage system 2505 can alternatively or additionally be implemented by utilizing one or more computing devices 18 and/or by utilizing one or more nodes 37.

The record processing and storage system 2505 can be otherwise implemented utilizing at least one processor and at least one memory. For example, the at least one memory can store operational instructions that, when executed by the at least one processor, cause the record processing and storage system to perform some or all of the functionality described herein, such as some or all of the functionality of the page generator 2511 and/or of the segment generator 2517 discussed herein. In some cases, one or more individual nodes 37 and/or one or more individual processing core resources 48 can be operable to perform some or all of the functionality of the record processing and storage system 2505, such as some or all of the functionality of the page generator 2511 and/or of the segment generator 2517, independently or in tandem by utilizing their own processing resources and/or memory resources.

The query processing system 2502 can be alternatively or additionally implemented utilizing the parallelized query and results sub-system 13 of FIG. 5. The query processing system 2502 can be alternatively or additionally implemented utilizing the parallelized data store, retrieve, and/or process sub-system 12 of FIG. 6. The query processing system 2502 can alternatively or additionally be implemented by utilizing one or more computing devices 18 and/or by utilizing one or more nodes 37.

The query processing system 2502 can be otherwise implemented utilizing at least one processor and at least one memory. For example, the at least one memory can store operational instructions that, when executed by the at least one processor, cause the record processing and storage system to perform some or all of the functionality described herein, such as some or all of the functionality of the query execution plan generator module 2503 and/or of the query execution module 2504 discussed herein. In some cases, one or more individual nodes 37 and/or one or more individual processing core resources 48 can be operable to perform some or all of the functionality of the query processing system 2502, such as some or all of the functionality of query execution plan generator module 2503 and/or of the query execution module 2504, independently or in tandem by utilizing their own processing resources and/or memory resources.

In some embodiments, one or more nodes 37 of the database system 10 as discussed herein can be operable to perform multiple functionalities of the database system 10 illustrated in FIG. 25A. For example, a single node can be utilized to implement the page generator 2511, the page storage system 2506, the segment generator 2517, the segment storage system 2508, the query execution plan generator module, and/or the query execution module 2504 as a node 37 at one or more levels 2410 of a query execution plan 2405. In particular, the single node can utilize different processing core resources 48 to implement different functionalities in parallel, and/or can utilize the same processing core resources 48 to implement different functionalities at different times.

Some or all data sources 2501 can implemented utilizing at least one processor and at least one memory. Some or all data sources 2501 can be external from database system 10 and/or can be included as part of database system 10. For example, the at least one memory of a data source 2501 can store operational instructions that, when executed by the at least one processor of the data source 2501, cause the data source 2501 to perform some or all of the functionality of data sources 2501 described herein. In some cases, data sources 2501 can receive application data from the database system 10 for download, storage, and/or installation. Execution of the stored application data by processing modules of data sources 2501 can cause the data sources 2501 to execute some or all of the functionality of data sources 2501 discussed herein.

In some embodiments, system communication resources 14, external network(s) 17, local communication resources 25, wide area networks 22, and/or other communication resources of database system 10 can be utilized to facilitate any transfer of data by the record processing and storage system 2505. This can include, for example: transmission of record streams 1-L from data sources 2501 to the record processing and storage system 2505; transfer of pages 2515 to page storage system 2506 once generated by the page generator 2511; access to pages 2515 by the segment generator 2517; transfer of segments 2424 to the segment storage system 2508 once generated by the segment generator 2517; communication of query execution plan data to the query execution module 2504, such as the plurality of nodes 37 of the corresponding query execution plan 2405; reading of records by the query execution module 2504, such as IO level nodes 37, via access to pages 2515 stored page storage system 2506 and/or via access to segments 2424 stored segment storage system 2508; sending of data blocks generated by nodes 37 of the corresponding query execution plan 2405 to other nodes 37 in conjunction with their execution of the query; and/or any other accessing of data, communication of data, and/or transfer of data by record processing and storage system 2505 and/or within the record processing and storage system 2505 as discussed herein.

The record processing and storage system 2505 and/or the query processing system 2502 of FIG. 25A, and/or any other embodiment of record processing and storage system 2505 and/or the query processing system 2502 described herein, can be implemented at a massive scale, for example, by being implemented by a database system 10 that is operable to receive, store, and perform queries against a massive number of records of one or more datasets, such as millions, billions, and/or trillions of records stored as many Terabytes, Petabytes, and/or Exabytes of data as discussed previously. In particular, the record processing and storage system 2505 and/or the query processing system 2502 can each be implemented by a large number, such as hundreds, thousands, and/or millions of computing devices 18, nodes 37, and/or processing core resources 48 that perform independent processes in parallel, for example, with minimal or no coordination, to implement some or all of the features and/or functionality of the record processing and storage system 2505 and/or the query processing system 2502 at a massive scale.

Some or all functionality performed by the record processing and storage system 2505 and/or the query processing system 2502 as described herein cannot practically be performed by the human mind, particularly when the database system 10 is implemented to store and perform queries against records at a massive scale as discussed previously. In particular, the human mind is not equipped to perform record processing, record storage, and/or query execution for millions, billions, and/or trillions of records stored as many Terabytes, Petabytes, and/or Exabytes of data. Furthermore, the human mind is not equipped to distribute and perform record processing, record storage, and/or query execution as multiple independent processes, such as hundreds, thousands, and/or millions of independent processes, in parallel and/or within overlapping time spans.

FIG. 25B illustrates an example embodiment of the record processing and storage system 2505 of FIG. 25A. Some or all of the features illustrated and discussed in conjunction with the record processing and storage system 2505 FIG. 25B can be utilized to implement the record processing and storage system 2505 and/or any other embodiment of the record processing and storage system 2505 described herein.

The record processing and storage system 2505 can include a plurality of loading modules 2510-1-2510-N. Each loading module 2510 can be implemented via its own processing and/or memory resources. For example, each loading module 2510 can be implemented via its own computing device 18, via its own node 37, and/or via its own processing core resource 48. The plurality of loading modules 2510-1-2510-N can be implemented to perform some or all of the functionality of the record processing and storage system 2505 in a parallelized fashion.

The record processing and storage system 2505 can include queue reader 2559, a plurality of stateful file readers 2556-1-2556-N, and/or stand-alone file readers 2558-1-2558-N. For example, the queue reader 2559, a plurality of stateful file readers 2556-1-2556-N, and/or stand-alone file readers 2558-1-2558-N are utilized to enable each loading modules 2510 to receive one or more of the record streams 1-L received from the data sources 2501-1-2501-L as illustrated in FIG. 25A. For example, each loading module 2510 receives a distinct subset of the entire set of records received by the record processing and storage system 2505 at a given time.

Each loading module 2510 can receive records 2422 in one or more record streams via its own stateful file reader 2556 and/or stand-alone file reader 2558. Each loading module 2510 can optionally receive records 2422 and/or otherwise communicate with a common queue reader 2559. Each stateful file reader 2556 can communicate with a metadata cluster 2552 that includes data supplied by and/or corresponding to a plurality of administrators 2554-1-2554-M. The metadata cluster 2552 can be implemented by utilizing the administrative processing sub-system 15 and/or the configuration sub-system 16. The queue reader 2559, each stateful file reader 2556, and/or each stand-alone file reader 2558 can be implemented utilizing the parallelized ingress sub-system 24 and/or the parallelized data input sub-system 11. The metadata cluster 2552, the queue reader 2559, each stateful file reader 2556, and/or each stand-alone file reader 2558 can be implemented utilizing at least one computing device 18 and/or at least one node 37. In cases where a given loading module 2510 is implemented via its own computing device 18 and/or node 37, the same computing device 18 and/or node 37 can optionally be utilized to implement the stateful file reader 2556, and/or each stand-alone file reader 2558 communicating with the given loading module 2510.

Each loading module 2510 can implement its own page generator 2511, its own index generator 2513, and/or its own segment generator 2517, for example, by utilizing its own processing and/or memory resources such as the processing and/or memory resources of a corresponding computing device 18. For example, the page generator 2511 of FIG. 25A can be implemented as a plurality of page generators 2511 of a corresponding plurality of loading modules 2510 as illustrated in FIG. 25B. Each page generator 2511 of FIG. 25B can process its own incoming records 2422 to generate its own corresponding pages 2515.

As pages 2515 are generated by the page generator 2511 of a loading module 2510, they can be stored in a page cache 2512. The page cache 2512 can be implemented utilizing memory resources of the loading module 2510, such as memory resources of the corresponding computing device 18. For example, the page cache 2512 of each loading module 2010-1-2010-N can individually or collectively implement some or all of the page storage system 2506 of FIG. 25A.

The segment generator 2517 of FIG. 25A can similarly be implemented as a plurality of segment generators 2517 of a corresponding plurality of loading modules 2510 as illustrated in FIG. 25B. Each segment generator 2517 of FIG. 25B can generate its own set of segments 2424-1-2424-J included in one or more segment groups 2522. The segment group 2522 can be implemented as the segment group of FIG. 23, for example, where J is equal to five or another number of segments configured to be included in a segment group. In particular, J can be based on the redundancy storage encoding scheme utilized to generate the set of segments and/or to generate the corresponding parity data 2426.

The segment generator 2517 of a loading module 2510 can access the page cache 2512 of the loading module 2510 to convert the pages 2515 previously generated by the page generator 2511 into segments. In some cases, each segment generator 2517 requires access to all pages 2515 generated by the segment generator 2517 since the last conversion process of pages into segments. The page cache 2512 can optionally store all pages generated by the page generator 2511 since the last conversion process, where the segment generator 2517 accesses all of these pages generated since the last conversion process to cluster records into groups and generate segments. For example, the page cache 2512 is implemented as a write-through cache to enable all previously generated pages since the last conversion process to be accessed by the segment generator 2517 once the conversion process commences.

In some cases, each loading module 2510 implements its segment generator 2517 upon only the set of pages 2515 that were generated by its own page generator 2511, accessible via its own page cache 2512. In such cases, the record grouping via clustering key to create segments with the same or similar cluster keys are separately performed by each segment generator 2517 independently without coordination, where this record grouping via clustering key is performed on N distinct sets of records stored in the N distinct sets of pages generated by the N distinct page generators 2511 of the N distinct loading modules 2510. In such cases, despite records never being shared between loading modules 2510 to further improve clustering, the level of clustering of the resulting segments generated independently by each loading module 2510 on its own data is sufficient, for example, due to the number of records in each loading module's 2510 set of pages 2515 for conversion being sufficiently large to attain favorable levels of clustering.

In such embodiments, each loading modules 2510 can independently initiate its own conversion process of pages 2515 into segments 2424 by waiting as long as possible based on its own resource utilization, such as memory availability of its page cache 2512. Different segment generators 2517 of the different loading modules 2510 can thus perform their own conversion of the corresponding set of pages 2515 into segments 2424 at different times, based on when each loading modules 2510 independently determines to initiate the conversion process, for example, based on each independently making the determination to generate segments as discussed in conjunction with FIG. 26A. Thus, as discussed herein, the conversion process of pages into segments can correspond to a single loading module 2510 converting all of its pages 2515 generated by its own page generator 2511 since its own last the conversion process into segments 2424, where different loading modules 2510 can initiate and execute this conversion process at different times and/or with different frequency.

In other cases, it is ideal for even more favorable levels of clustering to be attained via sharing of all pages for conversion across all loading modules 2510. In such cases, a collective decision to initiate the conversion process can be made across some or all loading modules 2510, for example, based on resource utilization across all loading modules 2510. The conversion process can include sharing of and/or access to all pages 2515 generated via the process, where each segment generator 2517 accesses records in some or all pages 2515 generated by and/or stored by some or all other loading modules 2510 to perform the record grouping by cluster key. As the full set of records is utilized for this clustering instead of N distinct sets of records, the levels of clustering in resulting segments can be further improved in such embodiments. This improved level of clustering can offset the increased page movement and coordination required to facilitate page access across multiple loading modules 2510. As discussed herein, the conversion process of pages into segments can optionally correspond to multiple loading modules 2510 converting all of their collectively generated pages 2515 since their last conversion process into segments 2424 via sharing of their generated pages 2515.

An index generator 2513 can optionally be implemented by some or all loading modules 2510 to generate index data 2516 for some or all pages 2515 prior to their conversion into segments. The index data 2516 generated for a given page 2515 can be appended to the given page, can be stored as metadata of the given page 2515, and/or can otherwise be mapped to the given page 2515. The index data 2516 for a given page 2515 correspond to page metadata, for example, indexing records included in the corresponding page. As a particular example, the index data 2516 can include some or all of the data of index data 2518 generated for segments 2424 as discussed previously, such as index sections 0-x of FIG. 23. As another example, the index data 2516 can include indexing information utilized to determine the memory location of particular records and/or particular columns within the corresponding page 2515.

In some cases, the index data 2516 can be generated to enable corresponding pages 2515 to be processed by query IO operators utilized to read rows from pages, for example, in a same or similar fashion as index data 2518 is utilized to read rows from segments. In some cases, index probing operations can be utilized by and/or integrated within query IO operators to filter the set of rows returned in reading a page 2515 based on its index data 2516 and/or to filter the set of rows returned in reading a segment 2424 based on its index data 2518.

In some cases, index data 2516 is generated by index generator 2513 for all pages 2515, for example, as each page 2515 is generated, or at some point after each page 2515 is generated. In other cases, index data 2516 is only generated for some pages 2515, for example, where some pages do not have index data 2516 as illustrated in FIG. 25B. For example, some pages 2515 may never have corresponding index data 2516 generated prior to their conversion into segments. In some cases, index data 2516 is generated for a given page 2515 with its records are to be read in execution of a query by the query processing system 2502. For example, a node 37 at IO level 2416 can be implemented as a loading module 2510 and can utilize its index generator 2513 to generate index data 2516 for a particular page 2515 in response to having query execution plan data indicating that records 2422 be read the particular page from the page cache 2512 of the loading module in conjunction with execution of a query. The index data 2516 can be optionally stored temporarily for the life of the given query to facilitate reading of rows from the corresponding page for the given query only. The index data 2516 alternatively be stored as metadata of the page 2515 once generated, as illustrated in FIG. 25B. This enables the previously generated index data 2516 of a given page to be utilized in subsequent queries requiring reads from the given page.

As illustrated in FIG. 25B, each loading modules 2510 can generate and send pages 2515, corresponding index data 2516, and/or segments 2424 to long term storage 2540-1-2540-J of a particular storage cluster 2535. For example, system communication resources 14 can be utilized to facilitate sending of data from loading modules 2510 to storage cluster 2535 and/or to facilitate sending of data from storage cluster 2535 to loading modules 2510.

The storage cluster 2535 can be implemented by utilizing a storage cluster 35 of FIG. 6, where each long term storage 2540-1-2540-J is implemented by a corresponding computing device 18-1-18-J and/or by a corresponding node 37-1-37-J. In some cases, each storage cluster 35-1-35-z of FIG. 6 can receive pages 2515, corresponding index data 2516, and/or segments 2424 from its own set of loading modules 2510-1-2510-N, where the record processing and storage system 2505 of FIG. 25B can include z sets of loading modules 2510-1-2510-N that each generate pages 2515, segments 2524, and/or index data 2516 for storage in its own corresponding storage cluster 35.

The processing and/or memory resources utilized to implement each long term storage 2540 can be distinct from the processing and/or memory resources utilized to implement the loading modules 2510. Alternatively, some loading modules can optionally share processing and/or memory resources long term storage 2540, for example, where a same computing device 18 and/or a same node 37 implements a particular long term storage 2540 and also implements a particular loading modules 2510.

Each loading module 2510 can generate and send the segments 2424 to long term storage 2540-1-2540-J in a set of persistence batches 2532-1-2532-J sent to the set of long term storage 2540-1-2540-J as illustrated in FIG. 25B. For example, upon generating a segment group 2522 of J segments 2424, a loading module 2510 can send each of the J segments in the same segment group to a different one of the set of long term storage 2540-1-2540-J in the storage cluster 2535. For example, a particular long term storage 2540 can generate recovered segments as necessary for processing queries and/or for rebuilding missing segments due to drive failure as illustrated in FIG. 24D, where the value K of FIG. 24D is less than the value J and wherein the nodes 37 of FIG. 24D are utilized to implement the long term storage 2540-1-2540-J.

As illustrated in FIG. 25B, each persistence batch 2532-1-2532-J can optionally or additionally include pages 2515 and/or their corresponding index data 2516 generated via index generator 2513. Some or all pages 2515 that are generated via a loading module 2510's page generator 2511 can be sent to one or more long term storage 2540-1-2540-J. For example, a particular page 2515 can be included in some or all persistence batches 2532-1-2532-J sent to multiple ones of the set of long term storage 2540-1-2540-J for redundancy storage as replicated pages stored in multiple locations for the purpose of fault tolerance. Some or all pages 2515 can be sent to storage cluster 2535 for storage prior to being converted into segments 2424 via segment generator 2517. Some or all pages 2515 can be stored by storage cluster 2535 until corresponding segments 2424 are generated, where storage cluster 2535 facilitates deletion of these pages from storage in one or more long term storage 2540-1-2540-J once these pages are converted and/or have their records 2422 successfully stored by storage cluster 2535 in segments 2424.

In some cases, a loading module 2510 maintains storage of pages 2515 via page cache 2512, even if they are sent to storage cluster 2535 in persistence batches 2532. This can enable the segment generator 2517 to efficiently read pages 2515 during the conversion process via reads from this local page cache 2512. This can be ideal in minimizing page movement, as pages do not need to be retrieved from long term storage 2540 for conversion into segments by loading modules 2510 and can instead be locally accessed via maintained storage in page cache 2512. Alternatively, a loading module 2510 removes pages 2515 from storage via page cache 2512 once they are determined to be successfully stored in long term storage 2540. This can be ideal in reducing the memory resources required by loading module 2510 to store pages, as only pages that are not yet durably stored in long term storage 2540 need be stored in page cache 2512.

Each long term storage 2540 can include its own page storage 2546 that stores received pages 2515 generated by and received from one or more loading modules 2010-1-2010-N, implemented utilizing memory resources of the long term storage 2540. For example, the page storage 2546 of each long term storage 2540-1-2540-J can individually or collectively implement some or all of the page storage system 2506 of FIG. 25A. The page storage 2546 can optionally store index data 2516 mapped to and/or included as metadata of its pages 2515. Each long term storage 2540 can alternatively or additionally include its own segment storage 2548 that stores segments generated by and received from one or more loading modules 2010-1-2010-N. For example, the segment storage 2548 of each long term storage 2540-1-2540-J can individually or collectively implement some or all of the segment storage system 2508 of FIG. 25A.

The pages 2515 stored in page storage 2546 of long term storage 2540 and/or the segments 2424 stored in segment storage 2548 of long term storage 2540 can be accessed to facilitate execution of queries. As illustrated in FIG. 25B, each long term storage 2540-1-2540-J can perform IO operators 2542 to facilitate reads of records in pages 2515 stored in their page storage 2546 and/or to facilitate reads of records in segments 2424 stored in their segment storage 2548. For example, some or all long term storage 2540-1-2540-J can be implemented as nodes 37 at the IO level 2416 of one or more query execution plans 2405. In particular, the some or all long term storage 2540-1-2540-J can be utilized to implement the query processing system 2502 by facilitating reads to stored records via IO operators 2542 in conjunction with query executions.

Note that at a given time, a given page 2515 may be stored in the page cache 2512 of the loading module 2510 that generated the given page 2515, and may alternatively or additionally be stored in one or more long term storage 2540 of the storage cluster 2535 based on being sent to the in one or more long term storage 2540. Furthermore, at a given time, a given record may be stored in a particular page 2515 in a page cache 2512 of a loading module 2510, may be stored the particular page 2515 in page storage 2546 of one or more long term storage 2540, and/or may be stored in exactly one particular segment 2424 in segment storage 2548 of one long term storage 2540.

Because records can be stored in multiple locations of storage cluster 2535, the long term storage 2540 of storage cluster 2535 can be operable to collectively store page and/or segment ownership consensus 2544. This can be useful in dictating which long term storage 2540 is responsible for accessing each given record stored by the storage cluster 2535 via IO operators 2542 in conjunction with query execution. In particular, as a query resultant is only guaranteed to be correct if each required record is accessed exactly once, records reads to a particular record stored in multiple locations could render a query resultant as incorrect. The page and/or segment ownership consensus 2544 can include one or more versions of ownership data, for example, that is generated via execution of a consensus protocol mediated via the set of long term storage 2540-1-2540-J. The page and/or segment ownership consensus 2544 can dictate that every record is owned by exactly one long term storage 2540 via access to either a page 2515 storing the record or a segment 2424 storing the record, but not both. The page and/or segment ownership consensus 2544 can indicate, for each long term storage 2540 in the storage cluster 2535, whether some or all of its pages 2515 or some or all of its segments 2424 are to be accessed in query executions, where each long term storage 2540 only accesses the pages 2515 and segments 2424 indicated in page and/or segment ownership consensus 2544.

In such cases, all record access for query executions performed by query execution module 2504 via nodes 37 at IO level 2416 can optionally be performed via IO operators 2542 accessing page storage 2546 and/or segment storage 2548 of long term storage 2540, as this access can guarantee reading of records exactly once via the page and/or segment ownership consensus 2544. For example, the long term storage 2540 can be solely responsible for durably storing the records utilized in query executions. In such embodiments, the cached and/or temporary storage of pages and/or segments of loading modules 2510, such as pages 2515 in page caches 2512, are not read for query executions via accesses to storage resources of loading modules 2510.

Any embodiment of the consensus protocol described herein can be implemented via the raft consensus protocol, or any other consensus protocol. Any embodiment of the consensus protocol described herein can be based on distributing a state machine across a plurality of nodes, ensuring that each node in the cluster agrees upon the same series of state transitions and/or ensuring that each node operates in accordance with the currently agreed upon state transition.

FIG. 25C illustrates an example embodiment of a page generator 2511. The page generator 2511 of FIG. 25C can be utilized to implement the page generator 2511 of FIG. 25A, can be utilized to implement each page generator 2511 of each loading module 2510 of FIG. 25B, and/or can be utilized to implement any embodiments of page generator 2511 described herein.

A single incoming record stream, or multiple incoming record streams 1-L, can include the incoming records 2422 as a stream of row data 2910. Each row data 2910 can be transmitted as an individual packet and/or a set of packets by the corresponding data source 2501 to include a single record 2422, such as a single row of a database table. Alternatively each row data 2910 can be transmitted by the corresponding data source 2501 as an individual packet and/or a set of packets to include a batched set of multiple records 2422, such as multiple rows of a database table. Row data 2910 received from the same or different data source over time can each include a same number of rows or a different number of rows, and can be sent in accordance with a particular format. Row data 2910 received from the same or different data source over time can include records with the same or different numbers of columns, with the same or different types and/or sizes of data populating its columns, and/or with the same or different row schemas. In some cases, row data 2910 is received in a stream over time for processing by a loading module 2510 via a stateful file reader 2556 and/or via a stand-alone file reader 2558.

Incoming rows can be stored in a pending row data pool 3410 while they await conversion into pages 2515. The pending row data pool 3410 can be implemented as an ordered queue or an unordered set. The pending row data pool 3410 can be implemented by utilizing storage resources of the record processing and storage system. For example, each loading module 2510 can have its own pending row data pool 3410. Alternatively, multiple loading modules 2510 can access the same pending row data pool 3410 that stores all incoming row data 2910, for example, by utilizing queue reader 2559.

The page generator 2511 can facilitate parallelized page generation via a plurality of processing core resources 48-1-48-W. For example, each loading module 2510 has its own plurality of processing core resources 48-1-48-W, where the processing core resources 48-1-48-W of a given loading module 2510 is implemented via the set of processing core resources 48 of one or more nodes 37 utilized to implement the given loading module 2510. As another example, the plurality of processing core resources 48-1-48-W are each implemented by a corresponding one of the set of each loading module 2510-1-2510-N, for example, where each loading module 2510-1-2510-N is implemented via its own processing core resources 48-1-48-W.

Over time, each processing core resource 48 can retrieve and/or can be assigned pending row data 2910 in the pending row data pool 3410. For example, when a given processing core resource 48 has finished another job, such as completed processing of another row data 2910, the processing core resource 48 can fetch a new row data 2910 for processing into a page 2515. For example, the processing core resource 48 retrieves a first ordered row data 2910 from a queue of the pending row data pool 3410, retrieves a highest priority row data 2910 from the pending row data pool 3410, retrieves an oldest row data 2910 from the pending row data pool 3410, and/or retrieves a random row data 2910 from the pending row data pool 3410. Once one processing core resource 48 retrieves and/or otherwise utilizes a particular row data 2910 for processing into a page, the particular row data 2910 is removed from the pending row data pool 3410 and/or is otherwise not available for processing by other processing core resources 48.

Each processing core resource 48 can generate pages 2515 from the row data received over time. As illustrated in FIG. 25C, the pages 2515 are depicted to include only one row data, such as a single row or multiple rows batched together in the row data 2910. For example, each page is generated directly from corresponding row data 2910. Alternatively, a page 2515 can include multiple row data 2910, for example, in sequence and/or concatenated in the page 2515. The page can include multiple row data 2910 from a single data source 2501 and/or can include multiple row data 2910 from multiple different data sources 2501. For example, the processing core resource 48 can retrieve one row data 2910 from the pending row data pool 3410 at a time, and can append each row data 2910 to a given page until the page 2515 is complete, where the processing core resource 48 appends subsequently retrieved row data 2910 to a new page. Alternatively, the processing core resource 48 can retrieve multiple row data 2910 at once, and can generate a corresponding page 2515 to include this set of multiple row data 2910.

Once a page 2515 is complete, the corresponding processing core resource 48 can facilitate storage of the page in page storage system 2506. This can include adding the page 2515 to the page cache 2512 of the corresponding loading module 2510. This can include facilitating sending of the page 2515 to one or more long term storage 2540 for storage in corresponding page storage 2546. Different processing core resources 48 can each facilitate storage of the page via common resources, or via designated resources specific to each processing core resources 48, of the page storage system 2506.

FIG. 25D illustrates an example embodiment of the page storage system 2506. As used herein, the page storage system 2506 can include page cache 2512 of a single loading module 2510; can include page caches 2512 of some or all loading module 2510-1-2510-N; can include page storage 2546 of a single long term storage 2540 of a storage cluster 2535; can include page storage 2546 of some or all long term storage 2540-1-2540-J of a single storage cluster 2535; can include page storage 2546 of some or all long term storage 2540-1-2540-J of multiple different storage clusters, such as some or all storage clusters 35-1-35-z; and/or can include any other memory resources of database system 10 that are utilized to temporarily and/or durably store pages.

FIG. 25E illustrates an example embodiment of a node 37 utilized to implement a given long term storage 2540 of FIG. 25B. The node 37 of FIG. 25E can be utilized to implement the node 37 of FIG. 25B, FIG. 25C, 25D, some or all nodes 37 at the IO level 2416 of a query execution plan 2405 of FIG. 24A, and/or any other embodiments of node 37 described herein. As illustrated a given node 37 can have its own segment storage 2548 and/or its own page storage 2546 by utilizing one or more of its own memory drives 2425. Note that while the segment storage 2548 and page storage 2546 are segregated in the depiction of a memory drives 2425, any resources of a given memory drive or set of memory drives can be allocated for and/or otherwise utilized to store either pages 2515 or segments 2424. Optionally, some particular memory drives 2425 and/or particular memory locations within a particular memory drive can be designated for storage of pages 2515, while other particular memory drives 2425 and/or other particular memory locations within a particular memory drive can be designated for storage of segments 2424.

The node 37 can utilize its query processing module 2435 to access pages and/or records in conjunction with its role in a query execution plan 2405, for example, at the IO level 2416. For example, the query processing module 2435 generates and sends segment read requests to access records stored in segments of segment storage 2548, and/or generates and sends page read requests to access records stored in pages 2515 of page storage 2546. In some cases, in executing a given query, the node 37 reads some records from segments 2424 and reads other records from pages 2515, for example, based on assignment data indicated in the page and/or segment ownership consensus 2544. The query processing module 2435 can generate its data blocks to include the raw row data of the read records and/or can perform other query operators to generate its output data blocks as discussed previously. The data blocks can be sent to another node 37 in the query execution plan 2405 for processing as discussed previously, such as a parent node and/or a node in a shuffle node set within the same level 2410.

FIG. 26A illustrates an example embodiment of a segment generator 2517. The segment generator 2517 of FIG. 26A can be utilized to implement the segment generator 2517 of FIG. 25A, can be utilized to implement each segment generator 2517 of each loading module 2510 of FIG. 25B, and/or can be utilized to implement any embodiments of segment generator 2517 described herein.

As discussed previously, the record processing and storage system 2505 can be operable to delay the conversion of pages into segments. Rather than frequently clustering rows and converting rows into column format, movement and/or processing of rows can be minimized by delaying the clustering and conversion process required to generate segments 2424, for example, as long as possible. This delaying of the conversion process “as long as possible” can be bounded by resource availability, such as disk and/or memory capacity of the record processing and storage system 2505. In particular, the conversion process can be delayed to accumulate as many pages as possible in the page storage system 2506 that page storage system 2506 is capable of storing.

Maximizing the delay until pages are processed as enabled by storage resources of the record processing and storage system 2505 improves the technology of database systems by improving query efficiency. In particular, delaying the decision of which rows to group together into segments as long as possible increased the chances of having many records with common cluster keys to group together, as cluster key-based groups are formed from a largest possible set of records. These more favorable levels of clustering enable queries to be performed more efficiently as discussed previously. For example, rows that need be accessed in a given query as dictated by filtering parameters of the query are more likely to be stored together, and fewer segments and/or memory locations need to be accessed.

Maximizing the delay until pages are processed as enabled by storage resources of the record processing and storage system 2505 improves the technology of database systems by improving data ingress efficiency. By placing rows directly into pages without regard for clustering as they are received, this delayed approach minimizes the number of times a row “moves” through the system, such as from disk, to memory, and/or through the processor. In particular, by delaying all clustering until segment generation for the received rows all at once, the rows are moved exactly once, to their final resting place as a segment 2424. This conserves resources of the record processing and storage system 2505, enabling higher rates of records to be received and processed for storage via data sources 2501 and thus enabling a richer, denser database to be generated over time. For example, this can enable the record processing and storage system 2505 to effectively process incoming records at a scale of terabits per second.

This delay can be accomplished via a page conversion determination module 2610 implemented by the segment generator 2517 and/or implemented via other processing resources of the record processing and storage system 2505. The page conversion determination module 2610 can be utilized to generate segment generation determination data indicating whether the conversion process of pages into segments should be commenced at a given time. For example, the page conversion determination module 2610 generates an interrupt or notification that includes the generate segment generation determination data indicating it is time to generate segments based on determining to generate segments at the given time. The page conversion determination module 2610 can otherwise trigger the commencement of converting pages into segments once it deems the conversion process appropriate, for example, based on delaying as long as possible. The segment generator 2517 can commence the conversion process accordingly in response to the segment generation determination data indicating it is time to generate segments, for example, via a cluster key-based grouping module 2620, a columnar rotation module 2630, and/or a metadata generator module 2640. The delay of converting pages into segments via the page conversion determination module 2610 and the repeating of this process over time is discussed in further detail in conjunction with the example timeline of FIG. 26B.

In some cases, the page conversion determination module 2610 optionally generates some segment generation determination data indicating it is not yet time to generate segments. In some embodiments, this information may not be communicated if it is determined that is not yet time to generate segments, where only notifications instructing the conversion process be commenced is communicated to initiate the process via cluster key-based grouping module 2620, a columnar rotation module 2630, and/or a metadata generator module 2640.

The page conversion determination module 2610 can generate segment generation determination data: in predetermined intervals; in accordance with a schedule; in response to determining a new page has been generated and stored in page storage system 2506; in response determining at least a threshold number of new pages have been generated and stored in page storage system 2506; in response to determining the storage space and/or memory utilization of page storage system 2506 has changed; in response to determining the total storage capacity of page storage system 2506 has changed; in response to determining at least one memory drive of the page storage system 2506 has failed or gone offline; in response to receiving storage utilization data from page storage system 2506; based on instruction supplied via user input, for example, via administration sub-system 15 and/or configuration sub-system 16; based on receiving a request; and/or based on another determination.

The page conversion determination module 2610 can generate its segment generation determination data based on comparing storage utilization data 2606 to predetermined conversion threshold data 2605. The storage utilization data can optionally be generated by the page storage system 2506. The record processing and storage system 2505 can indicate and/or be based on one or more storage utilization metrics indicating: an amount and/or percentage of storage resources of the page storage system 2506 that are currently being utilized to store pages 2515; an amount and/or percentage of available resources of the page storage system 2506 that are not currently being utilized to store pages 2515; a number of pages 2515 currently stored by the page storage system 2506; a data size, such as a number of bytes, of the set of pages 2515 currently stored by the page storage system 2506; an expected amount of time until storage resources of the page storage system 2506 are expected to become fully utilized for page storage based on current and/or historical data rates of record streams 1-L; current health data and/or failure data of storage resources of the page storage system 2506; an amount of time since the last conversion process was initiated and/or was completed; and/or other information regarding the storage utilization of the page storage system 2506.

In some cases, the storage utilization data 2606 can relate specifically to storage utilization of a page cache 2512 of a loading module 2510 of FIG. 25B, where the segment generator 2517 of FIG. 26A is implemented by the corresponding loading module 2510 and where the segment generator 2517 of FIG. 26A is operable to perform the conversion process only upon pages 2515 in the page cache 2512. In some cases, the storage utilization data 2606 can relate specifically to storage utilization across all page caches 2512 of all loading modules 2510-1-2510-N, where the page conversion determination module 2610 of FIG. 26A is implemented to dictate whether the conversion process be commenced across all corresponding loading modules 2510. In some cases, the storage utilization data 2606 can alternatively or include storage utilization of page storage 2546 of one or more of the long term storage 2540-1-2540-J of FIG. 25B. The storage utilization data 2606 can relate to any combination of storage resources of page storage system 2506 as discussed in conjunction with FIG. 25D that are utilized to store a particular set of pages to be converted into segments in tandem via the conversion process performed by segment generator 2517.

The storage utilization data 2606 can be sent to and/or requested by the segment generator 2517: in predefined intervals; in accordance with scheduling data; based on the page conversion determination module 2610 determining to generate the segment generation determination data; based on a determination, notification, and/or instruction that the page conversion determination module 2610 should generate the segment generation determination data; and/or based on another determination. In some cases, some or all of the page conversion determination module 2610 is implemented via processing resources and/or memory resources of the page storage system 2506, for example, to enable the page conversion determination module 2610 to monitor and/or measure the storage utilization data 2606 of its own resources included in page storage system 2506.

The predetermined conversion threshold data 2605 can indicate one or more threshold metrics or other threshold conditions that, when met by one or more corresponding metrics of the storage utilization data 2606 at a given time, trigger the commencement of the conversion process. In particular, the page conversion determination module generates the segment generation determination data indicating that segments be generated when the at least one metric of the storage utilization data 2606 meets the threshold metrics and/or conditions of the predetermined conversion threshold data 2605 and/or otherwise compares favorably to a condition for page conversion indicated by the predetermined conversion threshold data 2605. If the none of the metrics of the storage utilization data 2606 compare favorably to corresponding threshold metrics of predetermined conversion threshold data 2605, the page conversion determination module generates the segment generation determination data indicating that segments not be generated at this time, or otherwise does not generate the segment generation determination data in this case as no instruction to commence conversion need be communicated.

In some cases, the page conversion determination module generates the segment generation determination data indicating that segments be generated only when at least a predetermined threshold number of metrics of the storage utilization data 2606 compare favorably to the corresponding threshold metrics of the predetermined conversion threshold data 2605. In such cases, if less than the predetermined threshold number of metrics of the storage utilization data 2606 compare favorably to corresponding threshold metrics of predetermined conversion threshold data 2605, the page conversion determination module generates the segment generation determination data indicating that segments not be generated at this time, or otherwise does not generate the segment generation determination data in this case as no instruction to commence conversion need be communicated.

In some cases, there is only one metric in the storage utilization data 2606 that is compared to a corresponding metric of the predetermined conversion threshold data 2605, and the page conversion determination module generates the segment generation determination data when the metric in the storage utilization data 2606 meets or otherwise compares favorably to the corresponding metric of the predetermined conversion threshold data 2605.

As used herein, the storage utilization data 2606 compares favorably to the predetermined conversion threshold data 2605 when the conditions indicated in the predetermined conversion threshold data 2605 that dictate the conversion process be initiated are met by corresponding metrics of the storage utilization data 2606. As used herein, the storage utilization data 2606 compares unfavorably to the predetermined conversion threshold data 2605 when the conditions indicated in the predetermined conversion threshold data 2605 that dictate the conversion process be initiated are not met by corresponding metrics of the storage utilization data 2606. In some embodiments, the page conversion determination module 2610 generates the segment generation determination data indicating that segments be generated and/or otherwise indicating that the conversion process be initiated only when the storage utilization data 2606 compares favorably to the predetermined conversion threshold data 2605.

The predetermined conversion threshold data 2605 can indicate one or more conditions that trigger the conversion process such as: a total memory capacity of page storage system 2506; a threshold maximum amount and/or percentage of storage resources of the page storage system 2506 that can be utilized to store pages 2515; a threshold minimum amount and/or percentage of resources page storage system that must remain available; a threshold minimum number of pages 2515 that must be included in the set of pages for conversion; a threshold maximum number of pages 2515 that can be converted in a single conversion process; a threshold maximum and/or threshold a data size of the set of pages that can be converted in a single conversion process; a threshold minimum amount of time that storage resources of the page storage system can be expected to become fully utilized for page storage based on current and/or historical data rates of record streams 1-L; threshold requirements for health data and/or failure data of storage resources of the page storage system 2506; a threshold minimum and/or threshold maximum amount of time at which a new conversion process must commence since the last conversion process was initiated and/or was completed; and/or other information regarding the requirements and/or conditions for initiation of the conversion process.

The predetermined conversion threshold data 2605 can be received and/or configured based on user input, for example, via administrative sub-system 15 and/or via configuration sub-system 16. The predetermined conversion threshold data 2605 can alternatively or additionally be determined automatically by the record processing and storage system 2505. For example, the predetermined conversion threshold data 2605 can be determined automatically to indicate and/or be based on determining a threshold memory capacity of the page storage system 2506; based on determining a threshold amount of bytes worth of pages 2515 the page storage system 2506 can store; and/or based on determining a threshold expected and/or average amount of time that pages can be generated and stored in the page storage system 2506 by the page generator 2511 until the page storage system 2506 becomes full. Note that these thresholds can be automatically buffered to account for a threshold percentage of drive failures, a historical expected rate of drive failures, a threshold amount of additional pages data that may be stored in communication lag since the storage utilization data 2606 was sent, a threshold amount of additional pages data that may be stored in processing lag to perform some or all of the conversion process, and/or other buffering to ensure that segment generation is completed before page storage system 2506 reaches its capacity.

As another example, the predetermined conversion threshold data 2605 can be determined automatically based on determining a sufficient number of records 2422 and/or a sufficient number of pages 2515 that can achieve sufficiently favorable levels of clustering. For example, this can be based on tracking and/or measuring clustering metrics for records in previous iterations of the conversion process and/or based on analysis of the measuring clustering metrics for records in previous iterations of the process to determine and/or estimate these thresholds. The storage utilization data 2606 can also be measured and/or tracked for each of this plurality of previous conversion processes to determine average and/or estimated storage utilization metrics that rendered conversion processes with favorable levels of clustering based on the corresponding clustering metrics measured for these previous conversion processes.

The clustering metrics can be based on a total or average number and/or proportion of records in each segment that: match cluster key of at least a threshold proportion of other records in the segment, are within a threshold vector distance and/or other similarity measure from at least a threshold number of other records in the segment. The clustering metrics can alternatively or additionally be based on an average and/or total number of segments whose records have a variance and/or standard deviation of their cluster key values that compare favorably to a threshold. The clustering metrics can alternatively or additionally be determined in accordance with any other similarity metrics and/or clustering algorithms.

Once the page conversion determination module 2610 generates segment generation determination data indicating that segments be generated via the conversion process, the segment generator 2517 can initiate the process of generating stored pages into segments. This can include identifying the pages for conversion in the conversion process. For example, all pages currently stored by the page storage system 2506 and awaiting their conversion into segments 2424 at the time when segment generation determination data is generated to indicating that the conversion process commence are identified for conversion. This set of pages can constitute a conversion page set 2655, where only the set of pages identified for conversion in the conversion page set 2655 are processed by segment generator 2517 for a given conversion process. For example, the record processing and storage system 2505 may continue to receive records from data sources 2501, and rather than buffering all of these records until after this conversion process is completed, additional pages can be generated at this time for storage in page storage system 2506. However, as processing of pages into segments has already commenced, these pages may not be clustered and converted during this conversion process, and can await their conversion in the next iteration of the conversion process. As another example, the page storage system 2506 may still be storing some other pages that were previously converted into segments but were not yet deleted. These pages are similarly not included in the conversion page set 2655 because their records are already included in segments via the prior conversion.

The segment generator can implement a cluster key-based grouping module 2620 to generate a plurality of record groups 2625-1-2625-X from the plurality of records 2422 included in the conversion page set 2655. The cluster key-based grouping module 2620 can receive and/or determine a cluster key 2607, which can be automatically determined by the cluster key-based grouping module 2620, can be stored in memory, can be received from another computing device, and/or can be configured via user input. The cluster key can indicate one or more columns, such as the key column(s) of FIGS. 18-22, by which the records are to be sorted and segregated into the record groups. For example, the plurality of records 2422 included in the conversion page set 2655 are sorted and/or grouped by cluster key, where records 2422 with matching cluster keys and/or similar cluster keys are grouped together in the resulting record groups 2625-1-2625-X. The record groups 2625-1-2625-X can be a fixed size, or can be dynamic in size, for example, based on including only records that have matching and/or similar cluster keys. An example of generating the record groups 2625-1-2625-X via the cluster key-based grouping module 2620 is illustrated in FIG. 26C.

The records 2422 of each record group in the set of record groups 2625-1-2625-X generated by the cluster key-based grouping module 2620 are ultimately included in one segment 2424 of a corresponding segment group in the set of segment groups 1-X generated by the segment generator 1-X. For example, segment group 1 includes a set of segments 2424-1-2424-J that include the records 2422 from record groups 2625-1, segment group 2 includes another set of segments 2424-1-2424-J that include the records 2422 from record groups 2625-2, and so on. The identified record groups 2625-1-2625-X can be converted into segments in a same or similar fashion as discussed in conjunction with FIGS. 18-23.

The record groups are processed into segments via a columnar rotation module 2630 of the segment generator 2517. Once the plurality of record groups 2625-1-2625-X are formed, the columnar rotation module 2630 can be implemented to generate column-formatted record data 2565 for each record group 2625. For example, the records 2422 of each record group are extracted from pages 2515 as row-formatted data. In particular, the records 2422 can be received from data sources 2501 as row-formatted data and/or can be stored in pages 2515 as row-formatted data. All records 2422 in the same record group 2625 are converted into column-formatted row data 2565 in accordance with a column-based format, for example, by performing a columnar rotation of the row-formatted data of the records 2422 in the given record group 2625. The column-formatted row data 2565 generated for a given record group 2625 can be divided into a set of column-formatted row data 2565-1-2565-J, for example, where the column-formatted row data 2565 is redundancy storage error encoded by the segment generator 2517 as discussed previously, and where each column-formatted row data 2565-1-2565-J is included in a corresponding segment of a set of J segments 2424 of a segment group 2522.

The final segments can be formed from the column-formatted row data 2565 to include metadata generated via a metadata generator module 2640. The metadata generator module 2640 can be operable to generate the manifest section, statistics section, and/or the set of index sections 0-x for each segment as illustrated in FIG. 23. The metadata generator module 2640 can generate the index data 2518 for each segment 2424 by utilizing the same or different index generator 2513 of FIG. 25B, where index data 2518 generated for segments 2424 via the metadata generator module 2640 is the same as or similar to the index data 2516 generated for pages as discussed in conjunction with FIG. 25B. The column-formatted row data 2565 and its metadata generated via metadata generator module 2640 can be combined to form a final corresponding segment 2424.

FIG. 26B depicts an example timeline illustrating when the conversion process is determined to be conducted and how this process is iterated over time. The page conversion determination module 2610, and/or the determinations to delay conversion versus initiate conversion over time as illustrated in FIG. 26B, can be utilized to implement the segment generator 2517 of FIG. 26A and/or any other embodiment of the segment generator 2517 discussed herein.

First, a first conversion page set 2655-1 accumulates pages 2515 over time until the page conversion determination module 2610 determines a conversion page set 2655-1 is ready for conversion. At time t₁, the conversion page set 2655-1 includes a small number of pages 2515, where the storage resources of page storage system 2506 are not yet fully utilized. This small number of pages relative to the page storage capacity of page storage system 2506 renders the storage utilization data 2606 at time t₁ to compare unfavorably to the predetermined conversion threshold data. The segment generation determination data generated by the page conversion determination module 2610 at time t₁ therefore delays the conversion process, indicating to wait for more pages 2515 rather than generating segments from the current conversion page set 2655-1 at time t₁.

At time t₂, more pages 2515 have been accumulated since time t₁ based on additional pages having been generated by the page generator 2511 from incoming records of one or more record streams. However, the storage resources of page storage system 2506 are still not yet fully utilized at this time, causing the storage utilization data 2606 at time t₂ to again compare unfavorably to the predetermined conversion threshold data. The segment generation determination data generated by the page conversion determination module 2610 at time t₂ again delays the conversion process, indicating to wait for more pages 2515 rather than generating segments from the current conversion page set 2655-1 at time t₂.

At time t₃, even more pages 2515 have been accumulated since time t₂, and storage resources of page storage system 2506 are fully utilized and/or sufficiently utilized as dictated by the predetermined conversion threshold data. Thus, enough pages have been accumulated to cause storage utilization data 2606 at time t₃ to compare favorably to the predetermined conversion threshold data. The segment generation determination data generated by the page conversion determination module 2610 at time t₃ initiates the conversion process by indicating that segments be generated from the current conversion page set 2655-1 at time t₃.

After time t₃, the pages of the conversion page set 2655-1 can be flushed to other storage and/or can be removed from page storage system 2506. For example, once the segments are successfully generated from conversion page set 2655-1, the pages of conversion page set 2655-1 are deleted from page storage system 2506. The storage utilization data 2606 can indicate that more pages be accumulated for the a next conversion page set 2655-2, for example, due to the storage resources of page storage system 2506 again becoming available for storing new pages once the pages of conversion page set 2655-1 are removed.

At time t₄, after some or all of the pages of conversion page set 2655-1 have been removed from storage by page storage system 2506, new pages have been generated and stored in page storage system 2506 for conversion in the next conversion page set 2655-2. For example, the next conversion page set 2655-2 can include some pages that were generated while the conversion process of conversion page set 2655-2 was in progress and/or while the resulting segments were being stored in to segment storage system 2508. At this time, the storage resources of page storage system 2506 are not yet fully utilized at this time, causing the storage utilization data 2606 at time t₄ to compare unfavorably to the predetermined conversion threshold data.

At some later time after t₄, enough pages are accumulated in this next conversion page set 2655-2 to cause the storage utilization data 2606 at time t₄ to compare favorably to the predetermined conversion threshold data and to initiate another conversion process of converting the conversion page set 2655-2 into segments. This process can continue accumulating and converting subsequent conversion page sets 2655 over time.

Note that the predetermined conversion threshold data can change over time, for example, based on different user configurations, based on changes to storage capacity of the page storage system 2506, based on adding or removal of memory devices of page storage system 2506, based on failures of page storage system 2506, based on trends in clustering levels that can be attained by different numbers of pages at different times, based on changes in amount of different data stored by the resources of the page storage system 2506, based on resource assignment changes in the record processing and storage system 2505, and/or based on other determinations made over time causing the predetermined conversion threshold data to be adjusted accordingly. For example, the predetermined conversion threshold data that triggers initiation of the conversion process for conversion page set 2655-1 at time t₃ can be the same as or different from the predetermined conversion threshold data that eventually triggers initiation of the conversion process for conversion page set 2655-2 at some later time after t₄.

FIG. 26C illustrates an example embodiment of a cluster key-based grouping module 2620 implemented by segment generator 2517. This example serves to illustrate that the grouping of sets of records in pages does not necessarily correlate with the sets of records in the record groups generated by the cluster key-based grouping module 2620. In particular, in embodiments where the pages can be generated directly from sets of incoming records as they arrive without any initial clustering, the grouping of sets of records in pages may have no bearing on the record groups generated by the cluster key-based grouping module 2620 due to the timestamp and/or receipt time of various records not necessarily having a correlation with cluster key. The embodiment of cluster key-based grouping module 2620 of FIG. 26C can be utilized to implement the segment generator 2517 of FIG. 26A and/or any other embodiment of the segment generator 2517 discussed herein.

In this example, a plurality of P pages 2515-1-2515-P of conversion page set 2655 include records received from one or more sources over time up until the page conversion determination module 2610 dictated that conversion of this conversion page set 2655 commence. The plurality of records in pages 2515-1-2515-P can be considered an unordered set of pages to be clustered into record groups. Regardless of which pages these records may belong to, records are grouped into their record groups in accordance with cluster key. In this example, records of page 2515-1 are dispersed across at least record groups 1 and 2; records of page 2515-2 are dispersed across at least record groups 1, 2, and X, and records of page 2515-P are dispersed across at least record groups 2 and X.

The value of X can be: predetermined prior to clustering, can be the same or different for different conversion page sets 2655; can be determined based on a predetermined minimum and/or maximum number of records that are included per record group; can be determined based on a predetermined minimum and/or maximum data size per record group; can be determined based on each record group having a predetermined level of clustering, for example, in accordance with at least one clustering metric, and/or can be determined based on other information. In some cases, different record groups of the set of record groups 1-X can include different numbers of records, for example, based on maximizing a clustering metric across each record group.

For example, all records with a matching cluster key, such as having one or more columns corresponding to the cluster key with matching values, can be included in a same record group. As another example, a set of records having similar cluster keys can all be included in a same record group. As another example, if the value of the cluster key can be represented as a continuous variable, numeric variable, or other variable with an inherent ordering with respect to a cluster key domain, the cluster key domain can be subdivided into a plurality of discrete intervals. In such cases, a given record group, or a given set of record groups, can include records with cluster keys having values in the same discrete interval of the cluster key domain. As another example, a record group has cluster key values that are within a predefined distance from, or otherwise compare favorably to, an average cluster key value of cluster keys within the record group. In such cases, a Euclidian distance metric, another vector distance metric, and/or any other similarity and/or distance metric can be utilized to measure distance between cluster key values of the record group. In some cases, a clustering algorithm and/or an unsupervised machine learning model can be utilized to form record groups 1-X.

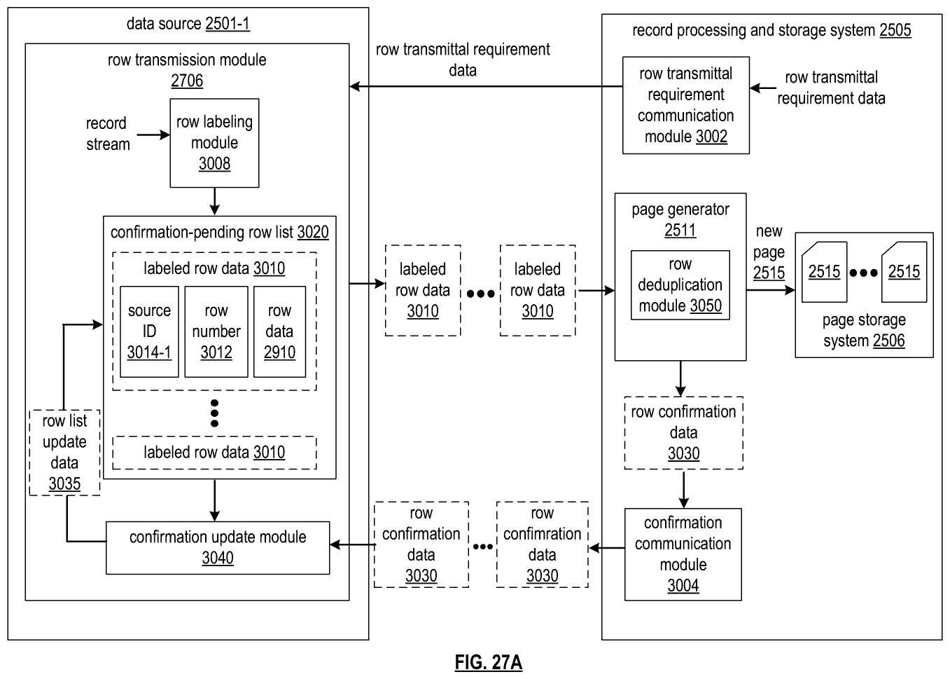

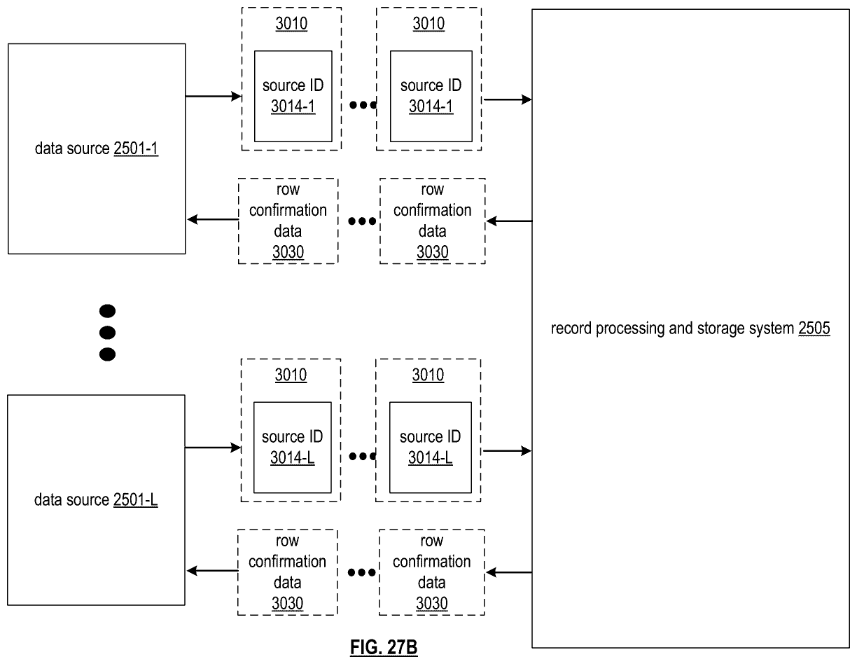

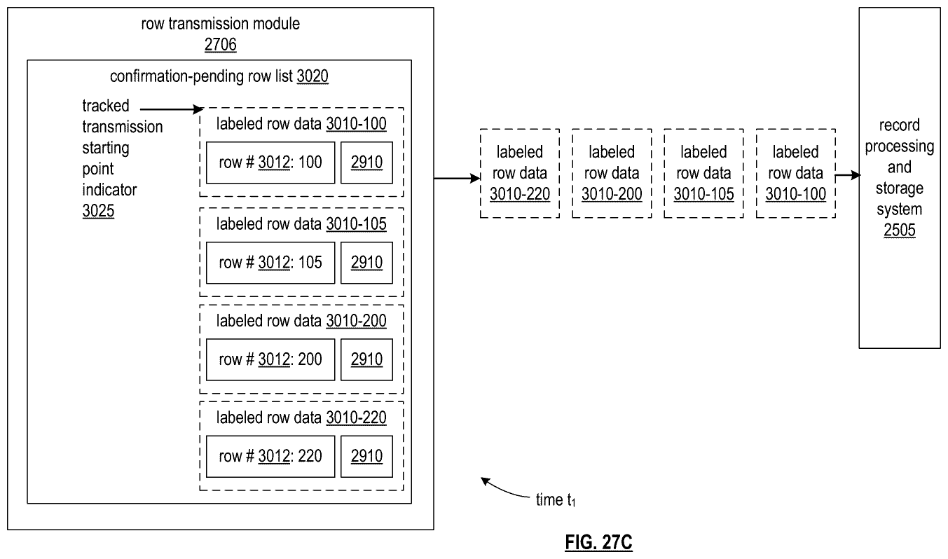

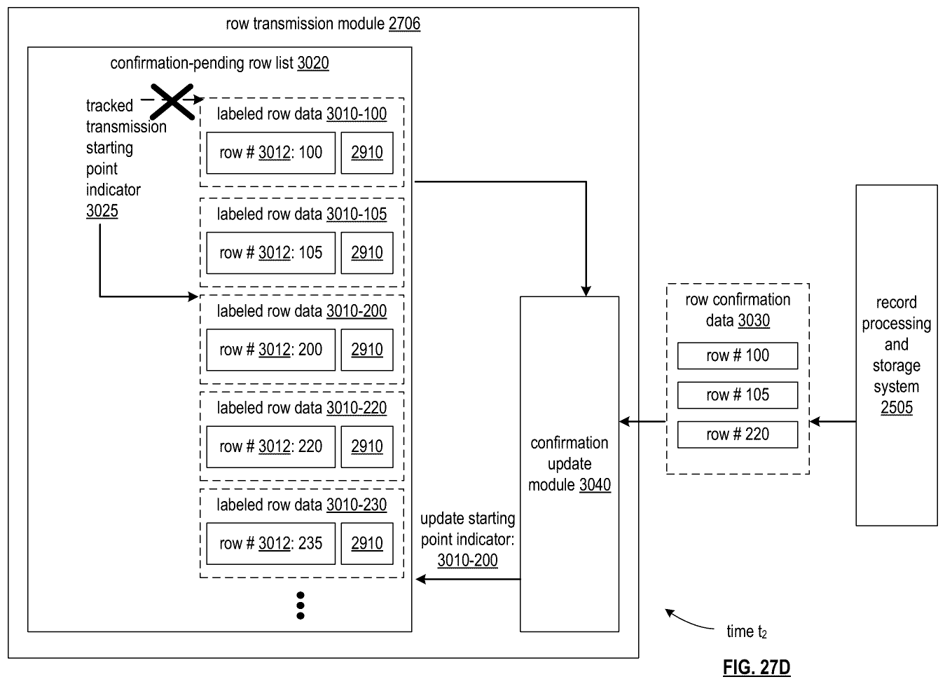

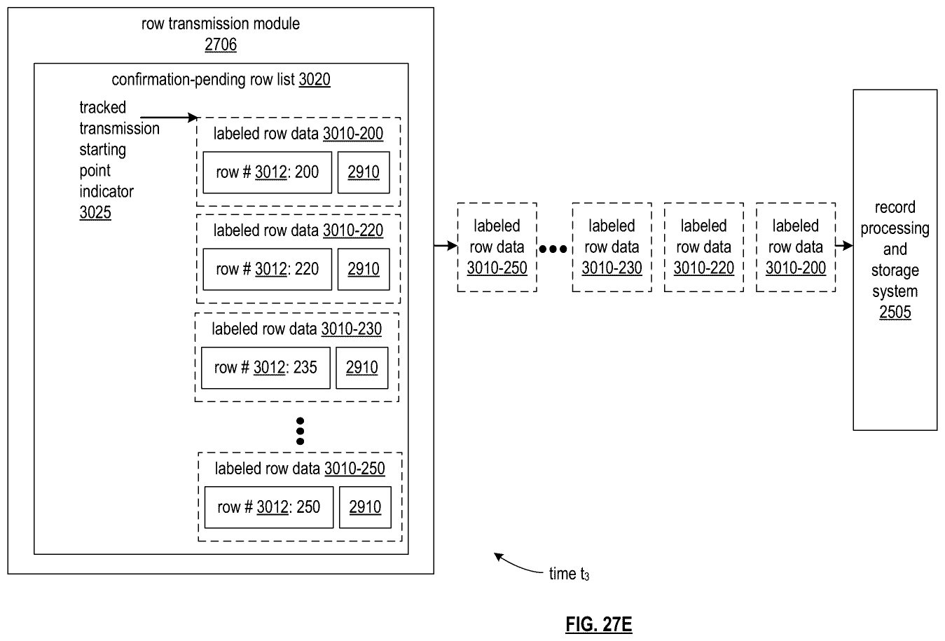

FIGS. 27A-27E illustrate embodiments of a record processing and storage system 2505 that communicates row confirmation data with one or more data sources 2501 based on confirming receipt of, generating pages from, and/or storing records 2422 received from these data sources 2501. Over time, data sources 2501 can resend certain records 2422 as necessary based on row confirmation data indicating these records were not successfully received and/or stored, for example, due to failures in their transmission, failures in their storage, or failures in transmission of the corresponding row confirmation data. Due this retransmission of certain records 2422 by data sources, the record processing and storage system 2505 can further perform page deduplication as pages are generated over time to ensure that duplicated rows are removed from pages 2515 and/or will not be read from more than one page 2515.

This mechanism of both confirming that all records 2422 are successfully stored in pages and also deduplicating any records that were retransmitted over time improves database systems by ensuring that all required records 2422 will be read exactly once from pages 2515. In particular, this “exactly once” guarantee of record reads ensures that queries performed on records 2422 stored by the database system 10 are guaranteed to be correct, where each required record is included in processing queries, but is only read one time in processing queries. Furthermore, by shifting the responsibility of deduplicating rows to the record processing and storage system 2505, data sources can be conservative in their transmission of rows by sending and possibly resending rows. This improves for example, starting from a tracked transmission starting point indicator that is simple for data sources to maintain. This also further improves database systems by simplifying the processing required to confirm transmittal of records by allowing data sources to send records multiple times, while still guaranteeing these records will be deduplicated in durable storage as pages and/or as segments.

Some or all of the features and/or functionality of embodiments of the record processing and storage system 2505 discussed in conjunction with FIGS. 27A-27E can be utilized to implement the record processing and storage system 2505 of FIG. 25A and/or to implement any other embodiments of record processing and storage system 2505 discussed herein. Some or all of the features and/or functionality of embodiments of the record processing and storage system 2505 discussed in conjunction with FIGS. 27A-27E can be utilized to implement a particular loading module 2510 of FIG. 25B and/or to implement any other embodiments of loading module 2510 discussed herein. Some or all of the features and/or functionality of embodiments of a data source 2501 discussed in conjunction with FIGS. 27A-27E can be utilized to implement some or all of the data sources 2501-1-2501-L of FIG. 25A and/or to implement any other embodiments of a data source 2501 discussed herein.

FIG. 27A illustrates such an embodiment of communication between a record processing and storage system 2505 and a particular data source 2501-1. The data source 2501 can implement a row transmission module 2706 to transmit records 2422 of a record stream to the record processing and storage system 2505 over time. The row transmission module 2706 can utilize a row labeling module 3008 to generate a stream of labeled row data 3010 for transmission from a record stream of records 2422. Each labeled row data 3010 can be generated by data source 2501 to include a data source identifier 3014, a row number 3012, and/or row data 2910.

The labeled row data 3010 can be generated in accordance with row transmittal requirement data. The row transmittal requirement data indicates instructions and/or rules for generating the labeled row data 3010 from a stream of records. For example, embodiments of the labeled row data 3010 described herein can be generated by data sources 2501 based on the row transmittal requirement data. In some cases, the row transmittal requirement data includes application data that is downloaded and/or installed by the data source 2501. For example, the row transmittal requirement data can be stored in memory of the data source 2501 and can include operational instructions. These operational instructions, when executed by at least one processor of the data source 2501, can cause the data source 2501 to 2501 to execute some or all of the functionality of the row labeling module 3008 and/or to execute some or all other functionality of the row transmission module 2706.

As illustrated in FIG. 27A, the row transmittal requirement data can be received from the record processing and storage system 2505 via a row transmittal requirement communication module 3002. In such cases, the row transmittal requirement data can be transmitted to one or more data sources 2501 by the record processing and storage system 2505. The record processing and storage system 2505 can determine this row transmittal requirement data, for example, based on generating the row transmittal requirement data, based on receiving the row transmittal requirement data, based on the row transmittal requirement data being configured via user input, based on retrieving the row transmittal requirement data from memory, and/or by otherwise determining the row transmittal requirement data. Alternatively, the row transmittal requirement data is otherwise determined by some or all data sources 2501, for example, where data sources 2501 determine the row transmittal requirement data based on generating the row transmittal requirement data, based on receiving the row transmittal requirement data, based on the row transmittal requirement data being configured via user input, based on retrieving the row transmittal requirement data from memory, and/or by otherwise determining the row transmittal requirement data.

The row numbers 3012 generated over time by a data source 2501 can each be distinct from all other row numbers 3012 generated by this data source 2501 to uniquely identify the corresponding row data 2910, thus enabling deduplication of row data 2910 with same row numbers 3012 from the same data source 2501. The row numbers 3012 generated over time can further maintain an ordering in accordance with an ordering scheme. In particular, the row transmission requirement data can dictate an ordering scheme that indicates rules regarding generation of and/or ordering of row numbers 3012 included in labeled row data 3010 generated by a data source 2501. For example, the row numbers 3012 for each corresponding labeled row data 3010 can be generated by the data source 2501 as a function of when the labeled row data 3010 is generated and/or as a function of the placement of the corresponding one or more rows in the record stream, in accordance with the ordering scheme. As discussed in further detail herein, adherence to such a row number ordering that is known to both the data source 2501 and the record processing and storage system 2505 can enable the data source 2501 to determine which records to retransmit to the record processing and storage system 2505, while allowing the record processing and storage system 2505 to leverage the known ordering to more easily deduplicate records included in its pages 2515.

In the examples discussed herein, the row numbers 3012 are generated as strictly increasing numeric values in each subsequently generated labeled row data 3010 from records in the record stream. In such ordering schemes, row number 3012 included in each labeled row data 3010 can be generated in accordance with a monotonically increasing function, where newer labeled row data 3010 has row numbers that are strictly greater than older labeled row data. In such ordering schemes, the row number 3012 is not necessarily required to increase in fixed intervals, where each row number 3012 can increase from a previous row number 3012 by any amount. As a particular example, the row numbers 3012 can be generated to be equal to, based on, and/or a function of the bit offset of the corresponding records 2422 in the record stream, such the bit offset of the first record or last record included in the row data 2910 of the labeled row data. As another particular example, the row numbers 3012 can be generated to be equal to, based on, and/or a function of a timestamp associated with the corresponding records in the record stream and/or associated with the generating of the corresponding labeled row data 3010.

In other embodiments, row numbers can be generated in accordance with another ordering scheme, for example, where row numbers are generated instead strictly decrease over time. Alternatively, row numbers can be generated as any data type in accordance with any other ordering scheme that is known to both the data source and to the record processing and storage system 2505, for example, based on being indicated in the row transmittal requirement data sent by the record processing and storage system 2505. Row numbers can be numeric values, can be a data type that can be converted to and/or represented as numeric values, and/or can be any data type that can be compared to other values of the data type to determine an ordering. Different data sources can generate and/or increment their row numbers in the same or different fashion and/or in accordance with a same or different function, while all adhering to the same ordering scheme.

As used herein, first row data is older than second row data based on being generated before the second row data and/or based on its one or more records 2422 being received and/or generated previous to the one or more records 2422 in the record stream. In the examples discussed herein, a first row number is more favorably ordered than a second row number when the first row number is less than the second row number, based on the first row number corresponding to row data that is therefore older than the row data denoted by the second row number. In other embodiments, where the row numbers are instead generated to strictly decrease, a first row number is more favorably ordered than a second row number when the first row number is greater than the second row number, based on the first row number corresponding to row data that is therefore older than the row data denoted by the second row number. For any other types ordering and/or labeling scheme for row numbers 3012 in other embodiments, a first row number is more favorably ordered than a second row number when the first row number is otherwise determined to correspond to row data that is older than the row data denoted by the second row number in accordance with the corresponding ordering.

As labeled row data 3010 is generated from rows of the corresponding record stream over time by the row labeling module 3008, the generated labeled row data 3010 is included in a confirmation-pending row list 3020. The confirmation-pending row list 3020 can be implemented by at least one memory such as cache memory of the data source 2501 to store the labeled row data 3010 as it awaits transmission, confirmation, and possibly retransmission one or more additional times. The data source 2501 can send labeled row data 3010 included in the confirmation-pending row list 3020, for example, based on an ordering of the labeled row data 3010 in the confirmation-pending row list 3020 in accordance with row numbers 3012 and/or based on row list update data 3035 generated over time. An example embodiment of sending labeled row data 3010 from the confirmation-pending row list 3020 over time is discussed in further detail in conjunction with FIGS. 27B-27E.

In response to labeled row data 3010 received overtime, the record processing and storage system 2505 can implement page generator 2511 as discussed previously to generate new pages 2515 for storage in page storage system 2506, for example, to await conversion into segments and/or to service queries as discussed previously. The page generator 2511 can further implement a row deduplication module 3050 to remove duplicated records from pages and/or to otherwise ensure that any records received in multiple labeled row data 3010 over time are read exactly once in reads to pages 2515, even if these records are stored in multiple pages 2515 generated by page generator 2511.

In various embodiments, the row deduplication module 3050, and/or any performance of row deduplication of pages discussed herein, can be implemented via any features and/or functionality of the row deduplication module, and/or via any functionality of deduplicating pages, disclosed by U.S. Utility application Ser. No. 16/985,930, entitled “RECORD DEDUPLICATION IN DATABASE SYSTEMS”, filed Aug. 5, 2020, which is hereby incorporated herein by reference in its entirety and made part of the present U.S. Utility patent application for all purposes.

As various labeled row data 3010 are received over time and/or as pages 2515 are generated over time, the record processing and storage system 2505 can generate row confirmation data 3030. The row confirmation data 3030 can indicate row data 2910 that is confirmed by the record processing and storage system 2505, where this row data 2910 that is confirmed will not need to be retransmitted by the corresponding data source 2501. The data source 2501 can receive various row confirmation data 3030 over time, and can utilize a confirmation update module 3040 to generate row list update data 3035 as each new row confirmation data is received. Each new row list update data 3035 can be applied to the confirmation-pending row list 3020 over time to update labeled row data included in the confirmation-pending row list and/or to update a transmission starting point indicator of the confirmation-pending row list.

In some cases, confirmed row data corresponds to row data that is successfully received. The record processing and storage system 2505 can generate row confirmation data indicating that one or more particular row data 2910 is successfully received based receiving this particular row data 2910 in a particular labeled row data 3010.

Alternatively or in addition, confirmed row data corresponds to row data 2910 that is successfully included in a page 2515 generated by the page generator 2511. The record processing and storage system 2505 can generate row confirmation data indicating that one or more particular row data 2910 is successfully included in a page 2515 based on generating one or more pages 2515 to include this particular row data 2910, based on deduplicating the one or more pages into a deduplicated page, and/or based on storing these one or more pages 2515 in page storage system 2506. Ensuring the row data 2910 was successfully converted into a page before indicating this row data 2910 in row confirmation data can be ideal to account for failure that may occur after the row data 2910 is received and before the row data 2910 is included in a page 2515.

Alternatively or in addition, confirmed row data corresponds to row data 2910 that is durably stored in page storage system 2506. As used herein, a record 2422 can be considered “durably stored” if at least a threshold level of fault tolerance is attained in storing of the record. For example, after the row data 2910 is durably stored and thus is stored in accordance with the threshold level of fault tolerance, failure that would render the row data 2910 irrecoverable is not expected to occur. Because row data 2910 is only considered to be immune from expected levels of failure once it is durably stored, ensuring the row data 2910 is durably stored before indicating this row data 2910 in row confirmation data can be ideal to account for failure that may occur prior to durable storage of the row data 2910. In such cases, the processing and storage system 2505 can generate row confirmation data indicating that one or more particular row data 2910 is durably stored in the page storage system 2506 based on successfully storing one or more pages 2515 that include the particular row data 2910 durably in page storage system 2506.

In some cases, durable storage of a record requires more fault-tolerant means of storage than being stored in page cache 2512 after being generated by a page generator 2511. For example, replicating a given page 2515 into a set of replicas and storing the set of replicas in different locations to enable recovery of the given page 2515 for up to a threshold number of storage failures can render records 2422 in the given page 2515 as durably stored. As another example, records included in a page 2515 are considered durably stored when the page 2515 is successfully stored in page storage 2546 of a long term storage 2540. As another example, records included in a page 2515 are considered durably stored when a threshold number of replicas of the page 2515 are successfully stored in page storage 2546 of a corresponding number of different long term storage 2540. As another example, generating a segment group 2522 from a set of records 2422 in a record group 2625 in accordance with a redundancy storage coding scheme and storing each segment 2424 of the segment group 2522 in different locations renders this set of records 2422 as durably stored.

Each row confirmation data 3030 can indicate one or more row data that is confirmed. In particular, the row confirmation data 3030 can be generated by the record processing and storage system 2505 to include or otherwise indicate one or more row numbers 3012 that correspond to row data 2910 that is designated as confirmed row data. Each row confirmation data 3030 generated by the record processing and storage system 2505 for a data source 2501 over time can indicate row numbers 3012 of any new row data that has been received since most previously generated and transmitted row confirmation data 3030 for the data source.

For example, the record processing and storage system 2505 generates the row confirmation data 3030 to indicate the row numbers 3012 included in labeled row data 3010 that include row data 2910 that is confirmed by the record processing and storage system 2505. In particular, the row confirmation data 3030 for a given data source 2501 can include and/or otherwise indicate all row numbers 3012 for all row data 2910 that was confirmed since the last generation and transmission of row confirmation data 3030 for the given data source 2501.

As another example, the record processing and storage system 2505 alternatively or additionally generates the row confirmation data 3030 to indicate a span of row numbers 3012, such as only maximum and/or minimum row number, with corresponding row data 2910 that is confirmed by the record processing and storage system 2505. In particular, the row confirmation data 3030 can indicate a span of row numbers 3012 based on row data 2910 that was most-recently confirmed and/or that was confirmed since the last generation and transmission of row confirmation data 3030. In some cases, the row confirmation data 3030 can further include a number of different row data 2910 that are included in this span of row numbers to further indicate the number of different row data 2910 that is confirmed, enabling the data source 2501 to determine whether or not all row data 2910 with row numbers 3012 in the corresponding span of row numbers 3012 were confirmed.

As another example, the record processing and storage system 2505 alternatively or additionally generates the row confirmation data 3030 to include a horizon row number, where all row data 2910 with row numbers 3012 that are more favorably ordered than the horizon row number in an ordering of the corresponding row numbers 3012 are guaranteed to be confirmed. A particular example embodiment of this horizon row number is implemented as a durability value, where all row data 2910 with row numbers 3012 that are more favorably ordered than the durability value in an ordering of the corresponding row numbers 3012 are guaranteed to be durably stored.

Each row confirmation data 3030 can be generated by the page generator 2511 as illustrated in FIG. 27A. For example, the page generator 2511 generates the source's row confirmation data 3030 based on the labeled row data 3010 that it receives, that is generates pages from, that it facilitates durable storage of, and/or otherwise confirms. Alternatively, other processing resources of the record processing and storage system 2505 can be utilized to generate some or all row confirmation data 3030 the based on the labeled row data 3010 that it receives, generates pages from, durably stores, and/or otherwise confirms.

Each row confirmation data 3030 can be generated for transmission back to the corresponding data source 2501 based on: a predefined schedule of generating the row confirmation data 3030; predefined time intervals for generating the row confirmation data 3030; receiving an instruction to generate the row confirmation data 3030; determining a threshold amount of time has passed since generating the most recent row confirmation data 3030 for the data source 2501; determining a new row data with the data source's data source identifier 3014 has been confirmed, where each row confirmation data 3030 indicates one row number for one corresponding row data; determining at least a threshold number of new row data with the data source's data source identifier 3014 has been confirmed; and/or based on another determination to generate each row confirmation data 3030 over time.

A confirmation communication module 3004 of the record processing and storage system 2505 can be implemented via at least one transmitter and/or communication interface of the record processing and storage system 2505. The confirmation communication module 3004 can send each row confirmation data 3030 to the corresponding data source 2501 as it is generated by the record processing and storage system 2505.

FIG. 27B illustrates an embodiment where multiple data sources 2501 communicate with the record processing and storage system 2505 as discussed in conjunction with FIG. 27A. In embodiments with multiple data sources 2501-1-2501-L, each labeled row data 3010 generated and transmitted by a given data source 2501 indicates a same data source identifier 3014. For example, all labeled row data 3010 sent by data source 2501-1 indicates a first data source identifier 3014-1, all labeled row data 3010 sent by data source 2501-2 indicates a second source identifier 3014-2, and so on.

Different corresponding row confirmation data 3030 can be generated and transmitted to each data sources 2501-1-2501-L over time. For example, the data source identifier 3014 of confirmed row data can indicate which particular data source's row confirmation data 3030 will indicate corresponding row numbers 3012. Each row confirmation data 3030 thus indicates only row numbers for a corresponding one of a plurality of data sources to which the row confirmation data 3030 is transmitted.

Furthermore, each data source can independently generate its own row numbers to generate its labeled row data 3010, for example, in accordance with the row transmittal requirement data. Because labeled row data 3010 includes data source identifiers 3014, identical row numbers received from different data sources 2501 will not be confused and the ordering of row numbers received from each data sources 2501 can be maintained. This enables data sources to generate row numbers without coordination, while ensuring that records can be deduplicated by the record processing and storage system. Each data source 2501 can further adhere to the same row number ordering scheme, for example, where all data sources 2501 generate their own row numbers over time that strictly increase in value.

In some cases, a same computing device and/or corresponding transmitter can implement multiple data sources 2501. For example, each data source 2501 corresponds to a different table and/or different types of records in corresponding different record streams of a same computing device and/or a same entity. A same transmitter and/or communication interface can receive and/or generate these multiple record streams, and can generate and send labeled row data for each of its record streams to the record processing and storage system 2505. In such cases, this same computing device can assign different source IDs to different labeled row data based on including records 2422 from different ones of its record streams to differentiate the different record streams.

FIGS. 27C-27E illustrate an example of a row transmission module 2706 of a data source 2501 that maintains its confirmation-pending row list 3020 to send labeled row data 3010 over time. The confirmation-pending row list 3020 is updated over time based on the row confirmation data 3030 received over time from the record processing and storage system 2505.

A data source 2501 can maintain its confirmation-pending row list 3020 as a sorted list of labeled row data 3010 by row number 3012. For example, the confirmation-pending row list 3020 can be implemented as and/or based on a queue and/or priority queue that is populated with labeled row data 3010 as it its generated. The ordering of the labeled row data 3010 is in accordance with the ordering scheme utilized to generate the row numbers 3012. In this example, row numbers are generated with an ordering scheme to strictly increase over time, and thus labeled row data is sorted by row number 3012 where lower row numbers 3012 are ordered before higher row numbers 3012 based on the labeled row data 3010 with the lower row numbers 3012 having been generated prior to labeled row data 3010 with the higher row numbers 3012. At a given time, the confirmation-pending row list 3020 may include some labeled row data 3010 that has already been transmitted at least once, and/or may include other labeled row data 3010 that has not been transmitted yet.

The labeled row data 3010 is transmitted in an ordered stream over time based on their corresponding ordering in the confirmation-pending row list 3020, where the labeled row data 3010 with the most favorably ordered row data is sent first. The data source 2501 can continue to send labeled row data 3010 in accordance with a corresponding ordering in the confirmation-pending row list 3020, for example, until a predetermined number of labeled row data 3010 are transmitted and/or until row confirmation data 3030 is received to cause the confirmation-pending row list 3020 to be updated.

When row confirmation data 3030 is received, the confirmation update module 3040 can update the confirmation-pending row list 3020 to update a tracked transmission starting point indicator 3025 to indicate labeled row data 3010 in the confirmation-pending row list 3020 to become the first ordered labeled row data 3010 in the confirmation-pending row list 3020 for resuming retransmission of the labeled row data 3010 in the confirmation-pending row list 3020. This identified starting labeled row data 3010 is selected based on all other labeled row data prior to this labeled row data 3010 having been confirmed in row confirmation data 3030. For example, this identified starting labeled row data is selected to be the least favorably ordered labeled row data 3010 that meets this condition. All labeled row data 3010 with more favorably ordered row numbers than the updated tracked transmission starting point indicator 3025 can be removed from and/or ignored in the confirmation-pending row list 3020 based on being indicated as confirmed, and are not retransmitted.

In some embodiments, as illustrated in the example of FIGS. 27C-27E, only the tracked transmission starting point indicator 3025 is changed in updates to the confirmation-pending row list 3020. In such cases, one or more labeled row data 3010 after the tracked transmission starting point indicator 3025 may have been confirmed in row confirmation data 3030 and/or may otherwise already be received, stored, and/or durably stored, but it still retransmitted based on being after the a tracked transmission starting point indicator 3025 in the confirmation-pending row list 3020. This can be ideal, as the update simply involves shifting the position of the tracked transmission starting point indicator 3025, and can be easier to maintain by the data source as it queues large numbers of labeled row data 3010 for transmission at high transmission rates. This also leverages the deduplication responsibilities of the record processing and storage system by conservatively retransmitting records. In some cases, this can be further ideal by reducing the amount of information required in row confirmation data 3030. For example, the row confirmation data 3030 can be generated by the record processing and storage system 2505 in some cases to depict conservative confirmation information, and not necessarily indicate all confirmed rows.

FIG. 27C illustrates a confirmation-pending row list 3020 at a first time t₁. At this time, the confirmation-pending row list 3020 includes a set of labeled row data 3010-100, 3010-105, 3010-200, and 3010-220. These labels depicted in FIG. 27B are based on corresponding numbers of labeled row data 3010 in this example being equal to 100, 105, 200, and 220. Based on the tracked transmission starting point indicator 3025 indicating labeled row data 3010-100, the labeled row data 3010 is transmitted by row transmission module 2706, starting with labeled row data 3010-100 in accordance with the ordering scheme by row number, as sorted in the confirmation-pending row list 3020.

FIG. 27D illustrates this confirmation-pending row list 3020 at a second time t₂ after transmission of labeled row data 3010-100, 3010-105, 3010-200, and 3010-220. At this time, row confirmation data 3030 is received indicating row numbers 100, 105, and 220. Because row number 200 was not indicated in the row confirmation data 3030, labeled row data 3010-200 is identified as the new starting point by confirmation update module 3040 based on all previous labeled row data 3010 having been confirmed. This is reflected in the update to tracked transmission starting point indicator 3025 to indicate labeled row data 3010-200. In this case, labeled row data 3010-220 will be retransmitted despite having been confirmed based on more favorably ordered labeled row data 3010-200 requiring retransmission. In other embodiments, labeled row data 3010-220 is removed from the confirmation-pending row list 3020 based on having been confirmed and is not retransmitted.

FIG. 27E illustrates this confirmation-pending row list 3020 at a third time t₃ after the tracked transmission starting point indicator 3025 is updated. Based on the tracked transmission starting point indicator 3025 indicating labeled row data 3010-200, the row transmission module 2706 sends labeled row data, starting with labeled row data 3010-200, in accordance with the ordering. Note that labeled row data 3010-200 and labeled row data 3010-200 are retransmitted, while new labeled row data including row data 3010-230 and labeled row data 3010-250 are transmitted for the first time. This process of transmitting labeled row data 3010 over time based on the ordering of labeled row data 3010 in the confirmation-pending row list 3020 and further based on updates to the tracked transmission starting point indicator 3025 of the confirmation-pending row list 3020 over time can be continued over time.

While FIGS. 27C-27E illustrate the case where updates to confirmation-pending row list 3020 are achieved via a simple shift of a tracked transmission starting point indicator 3025, other embodiments of confirmation update module 3040 can involve other updates to the confirmation-pending row list 3020. In some cases, all labeled row data 3010 indicated in row confirmation data 3030 is removed from the confirmation-pending row list 3020, regardless of its ordering in confirmation-pending row list 3020. For example, labeled row data 3010-220 is removed from the confirmation-pending row list 3020 in updating the confirmation-pending row list 3020 based on having been confirmed in the row confirmation data 3030. This can be ideal to minimize the number of retransmissions required by the row transmission module 2706 to more quickly populate the database system 10 with new data rather than retransmitting redundant data that will be deduplicated.

In some cases where the confirmation-pending row list 3020 is updated in this fashion, the only labeled row data 3010 that need be deduplicated by the record processing and storage system 2505 corresponds to labeled row data 3010 with row numbers that were confirmed, but whose row confirmation data 3030 encountered some delay, some transmission failure, and/or was otherwise not communicated and/or processed by the corresponding data source 2501. This causes the data source to re-send this labeled row data 3010 that was actually confirmed because the data source was never made aware that this labeled row data 3010 was confirmed. This retransmitted labeled row data 3010 can be deduplicated by the record processing and storage system 2505.

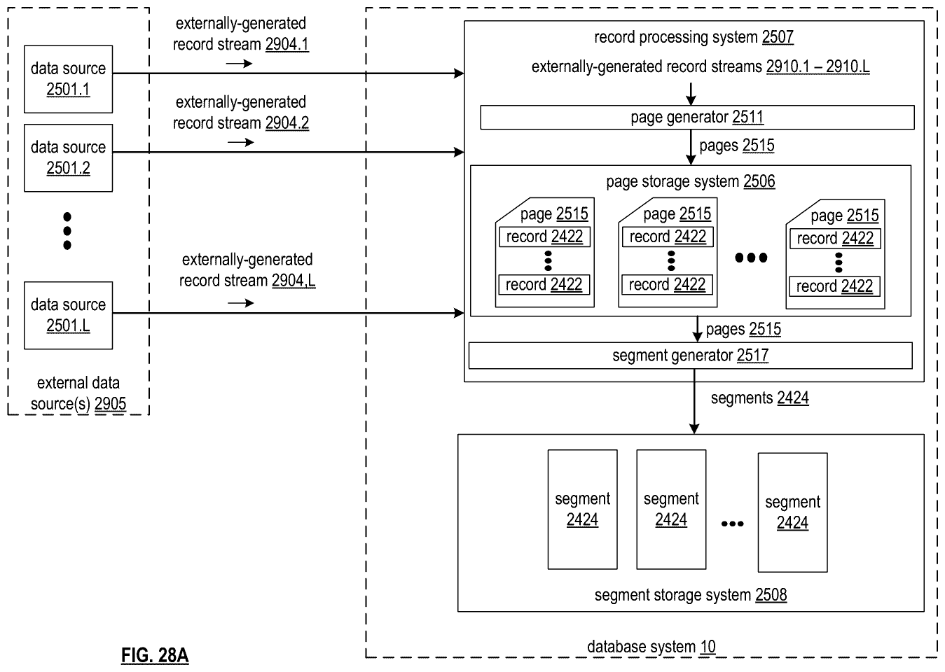

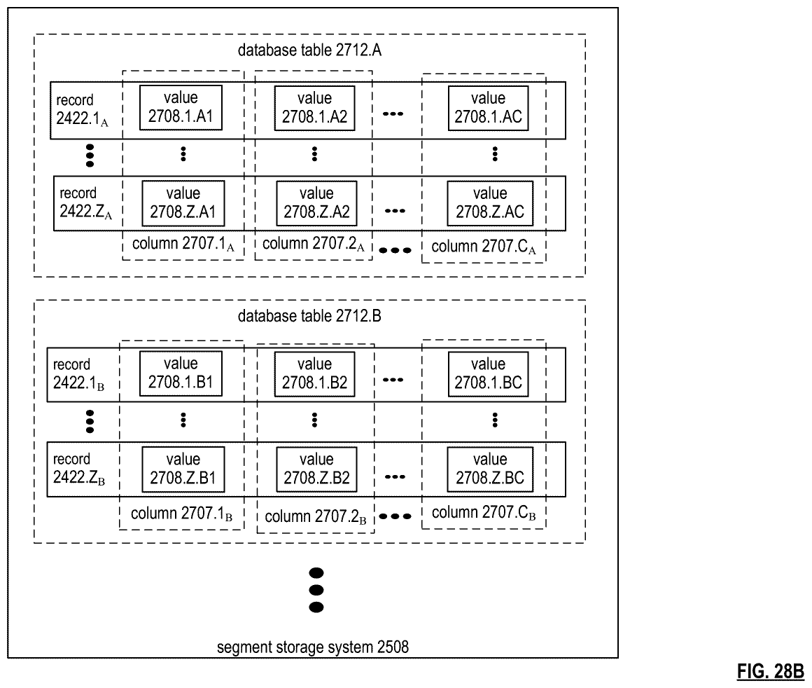

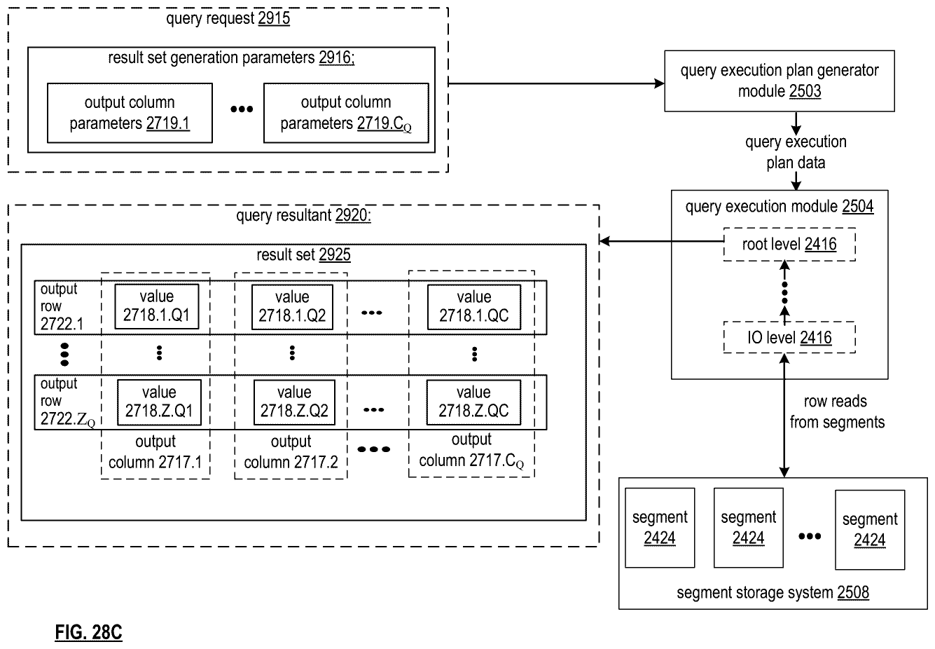

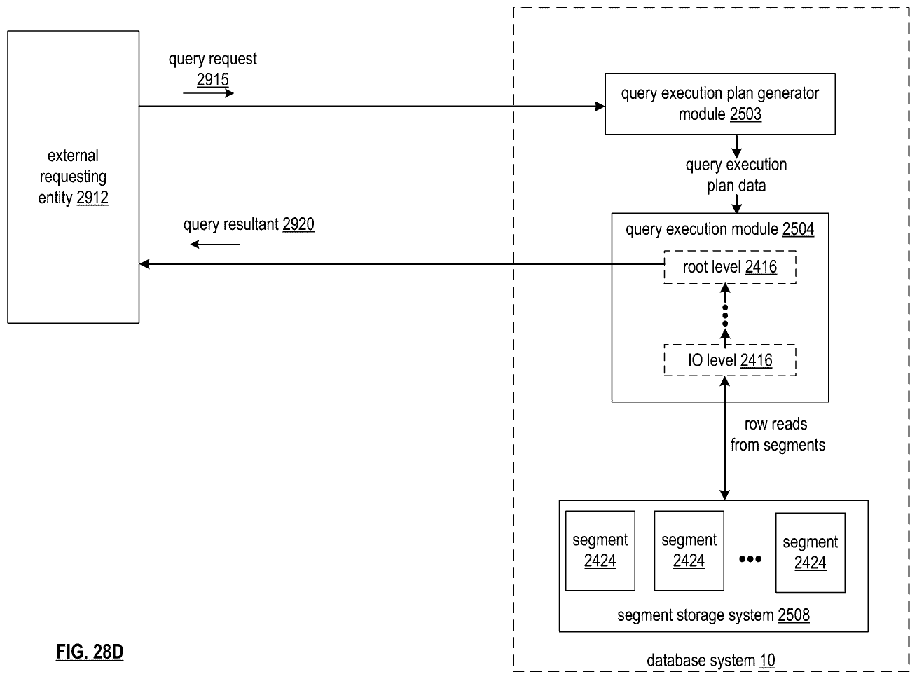

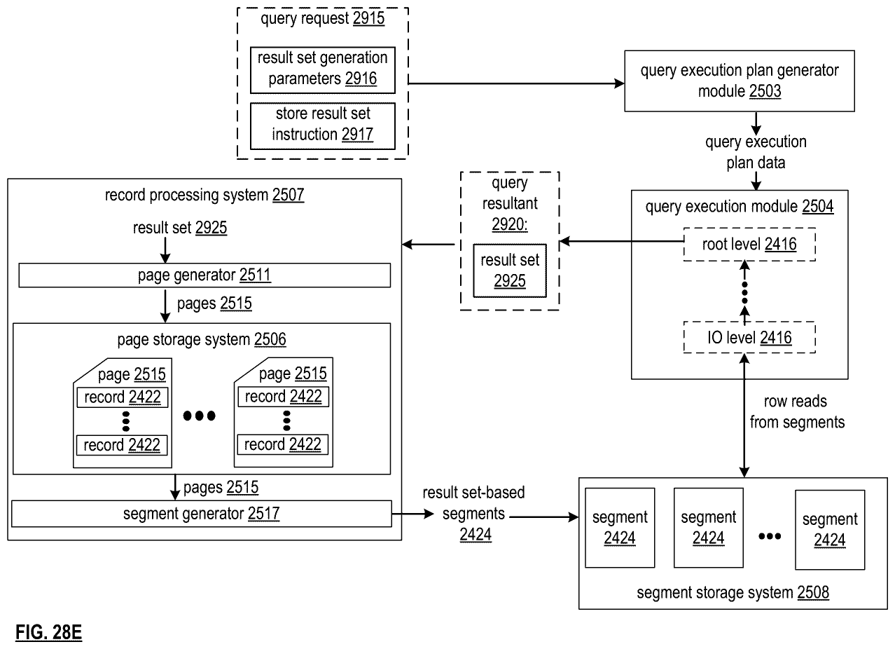

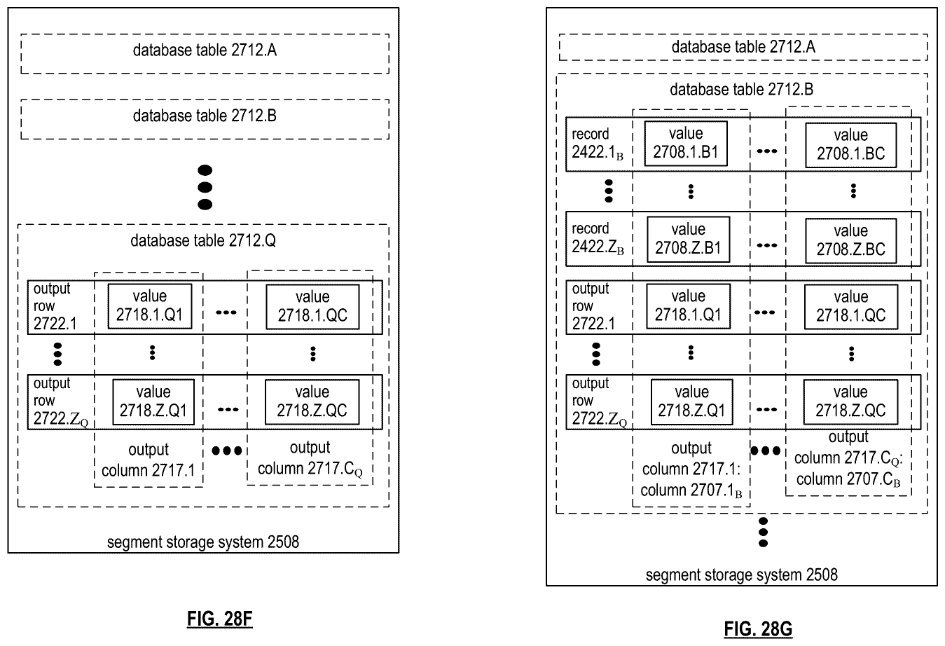

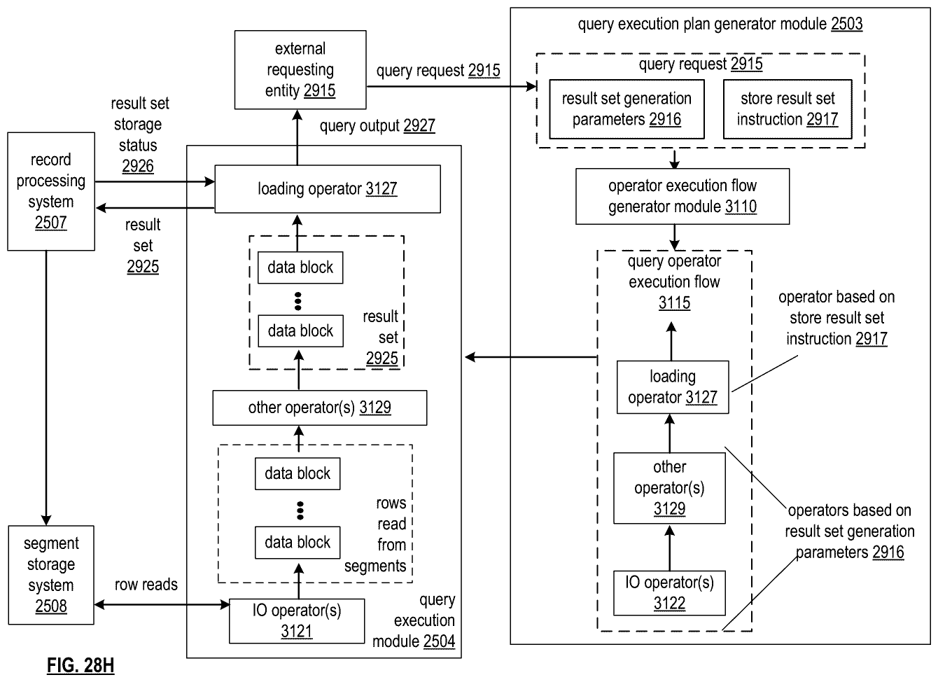

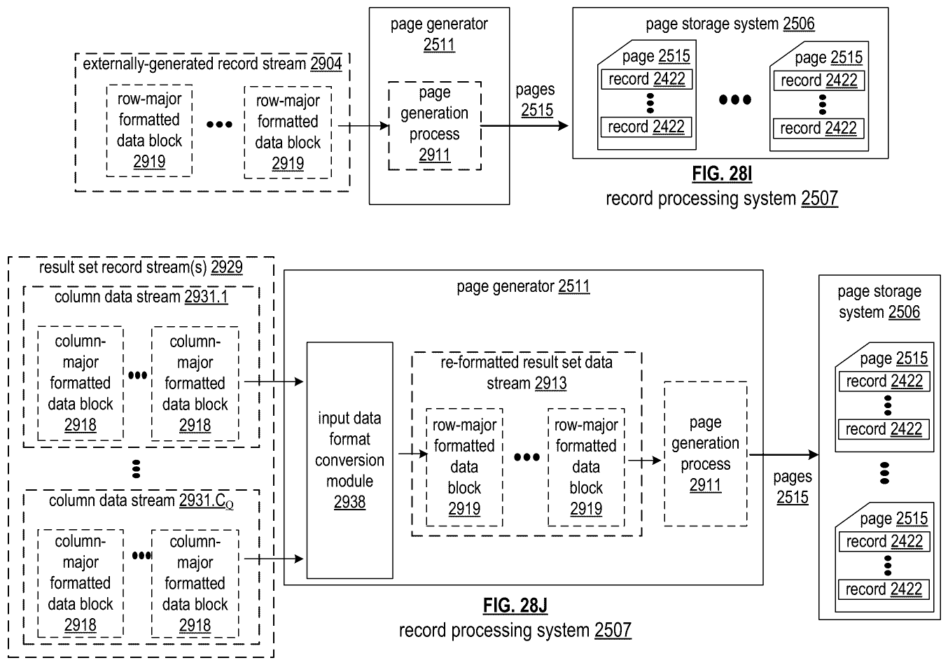

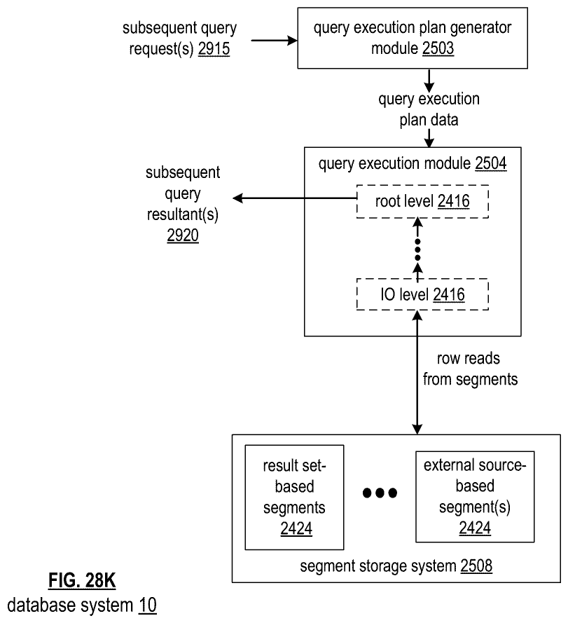

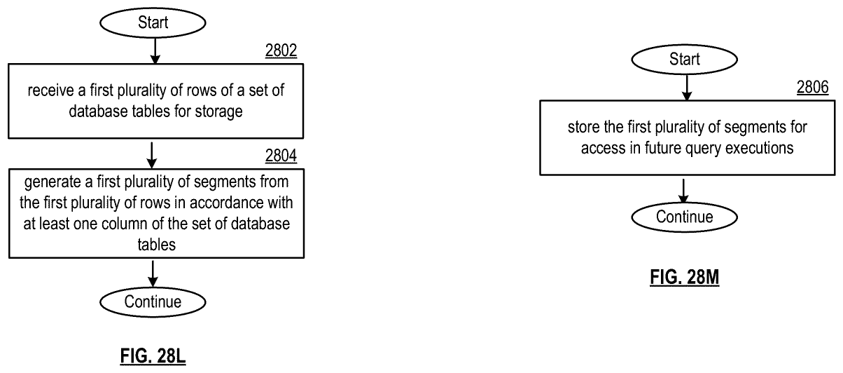

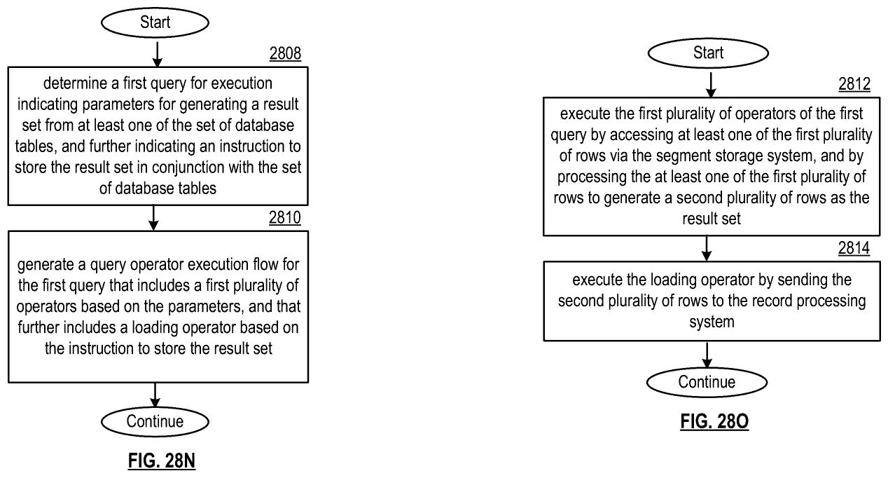

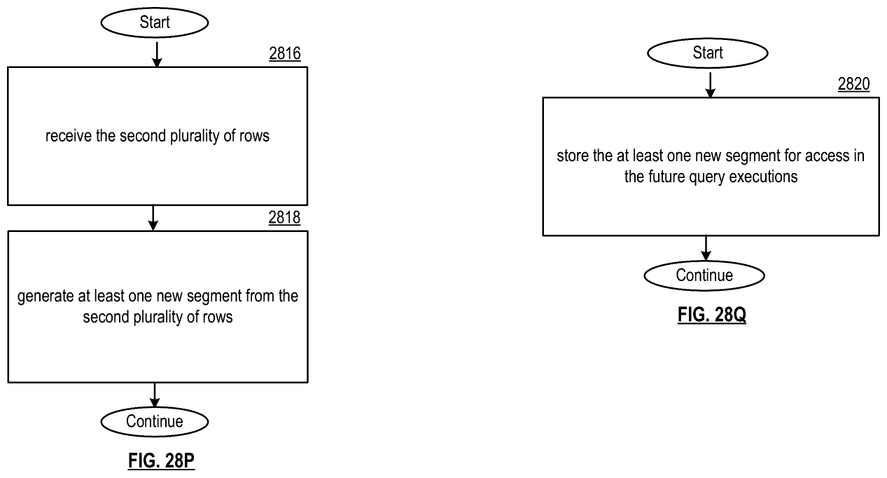

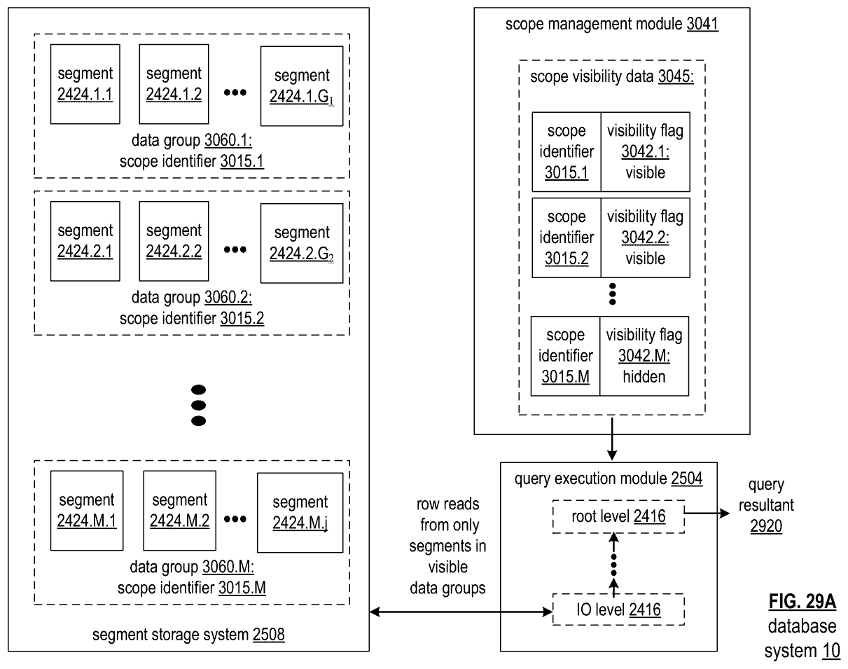

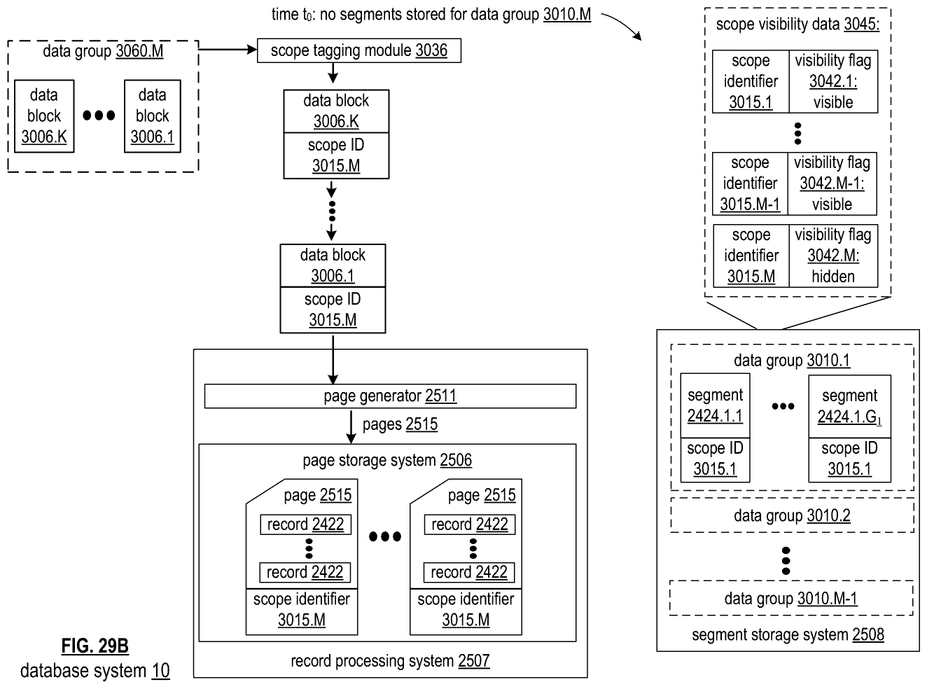

FIGS. 28A-28K present embodiments of a database system 10 operable to generate and store segments that include new records for use in query execution from data not only received from data sources that are external to the database system, but also from data generated automatically by the database system itself in query executions. Some or all features and/or functionality of the database system 10 of FIGS. 28A-28M can be utilized to implement any other embodiment of database system 10 described herein.

FIG. 28A presents an embodiment of database system 10 that receives data from data sources in record streams for processing by a record processing system 2507. The record processing system 2507 can generates pages 2515 from these record streams via a page generator 2511 for storage in a page storage system 2506, and pages are ultimately converted into segments 2424 via a segment generator 2517 for storage in a segment storage system 2508.

This process can be implemented via some or all features and/or functionally discussed previously in some or all of FIGS. 25A-27E. In particular, the record processing and storage system 2506 can be implemented as a record processing system 2507 and segment storage system 2508, which can optionally be implemented via distinct sets of processing and/or memory resources. The page generator 2511, page storage system 2506, and/or segment generator 2517 of the record processing and storage system 2506 described previously can be implemented by the record processing system 2507.

The record processing system 2507 can be implemented via a plurality of parallelized processes, such as a plurality of loading modules 2510 implemented via some or all features and/or functionality of the loading modules 2510 of FIG. 25B. The plurality of loading module 2510 can be implemented as a corresponding plurality of nodes 37, computing devices 18, and/or processing core resources 48. The segment storage system 2508 can be implemented via a plurality of long term storage of a storage cluster, such as a plurality of long term storage implemented via some or all features and/or functionality of the plurality of long term storage 2540-1-2540-J of the storage cluster 2535 of FIG. 25B. The plurality of long term storage can be implemented as a corresponding plurality of nodes 37, for example, implementing their memory drives to store segments in their own segment storage 2425 implementing segment storage 2548.

As illustrated in FIG. 28A, data sources 2501.1-2501.L can be implemented as external data sources 2905 that are external to the database system 10. Rather than being components of the database system 10 itself, these external data sources can be other entities that generate and/or transmit data to be stored by the database system 10 for access in query executions by the database system 10. The data sources 2501.1-2501.L can alternatively be part of the database system 10, but can generate its data in another means than generating result sets via query executions. The data sources 2501.1-2501.L of FIG. 28A can implement the data sources 2501.1-2501.L of some or all of FIGS. 25A-27E.

FIG. 28B illustrates an example set of database tables stored by the segment storage system 2508, for example, based on having generated corresponding segments from record streams as discussed in conjunction with FIG. 28A. While the segment storage system 2508 can be operable to store segments 2424 in accordance with a column-based format as described previously, groups of segments can collectively include sets of records of one or more database tables, such as relational database tables. Some or all features and/or functionality of the database tables 2712 stored in segment storage system 2508 can implement any data stored in segments 2424 described herein and/or accessed during query executions described herein.

A given record 2422 can be implemented as a row having a set of values 2708 corresponding to values of a set of columns of the corresponding table. Different database tables can include the same or different numbers of records, where database table 2712.A in this example includes Z_{A} records and where database table 2712.B in this example includes Z_{B} records. Different database tables can include the same or different numbers of columns, where database table 2712.A in this example includes C_{A} columns and where database table 2712.B in this example includes C_{B} columns. Columns of different tables can correspond to distinct fields and/or overlapping fields that can be utilized to relate and/or join tables. A given column can be populated with data of a given datatype, which can be different from the datatype of other columns of the same table and/or other tables.

Some or all tables 2712 stored in segments 2424 for access in query executions can correspond to datasets of data received in record streams received from external data sources 2501. For example, the row data received from external data sources 2501 includes sets of values 2708 of rows of one or more tables 2712, and once the row data received over time is stored as pages and ultimately converted into segments, these rows are accessible via access to segments during query executions against the dataset, such as queries indicating operations be performed upon one or more columns of one or more table to generate a corresponding query resultant.

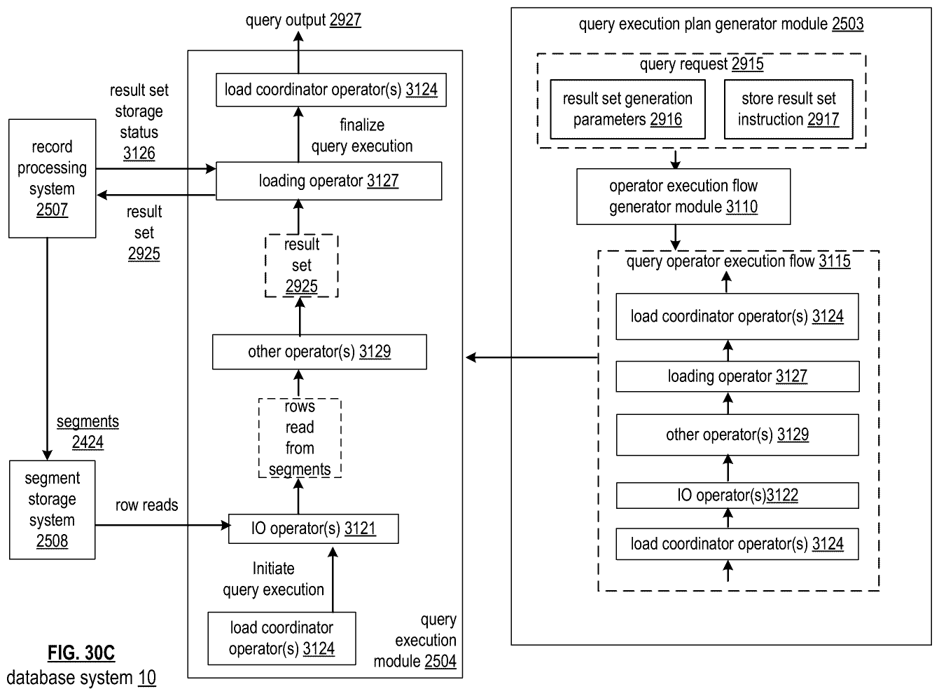

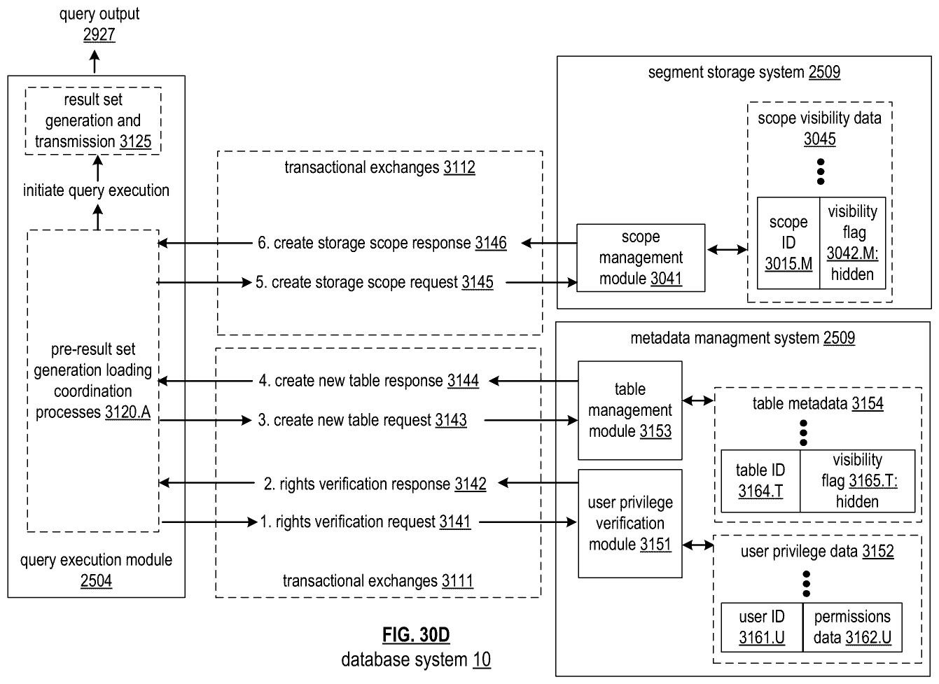

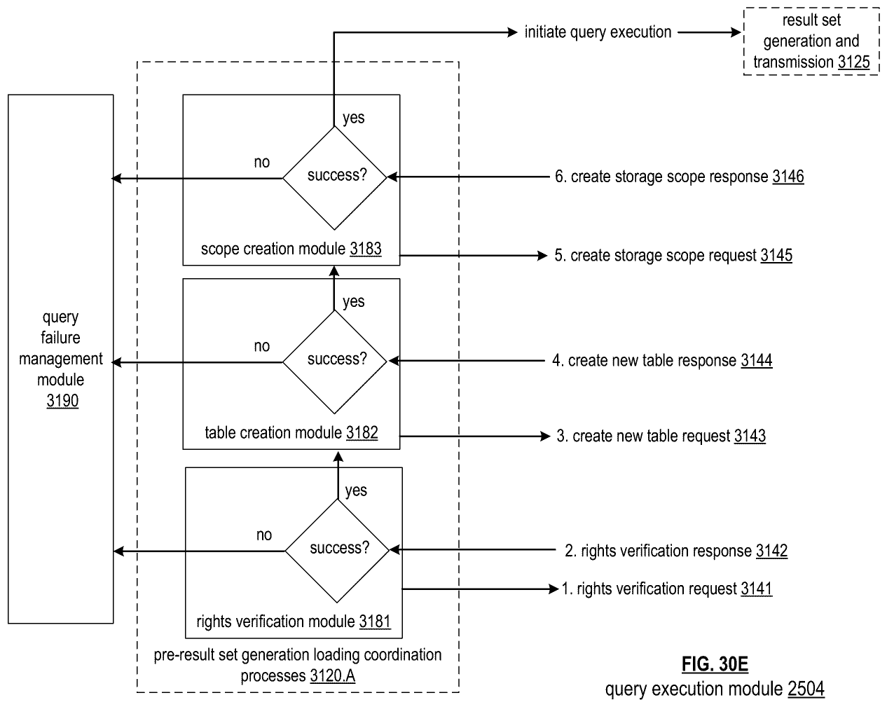

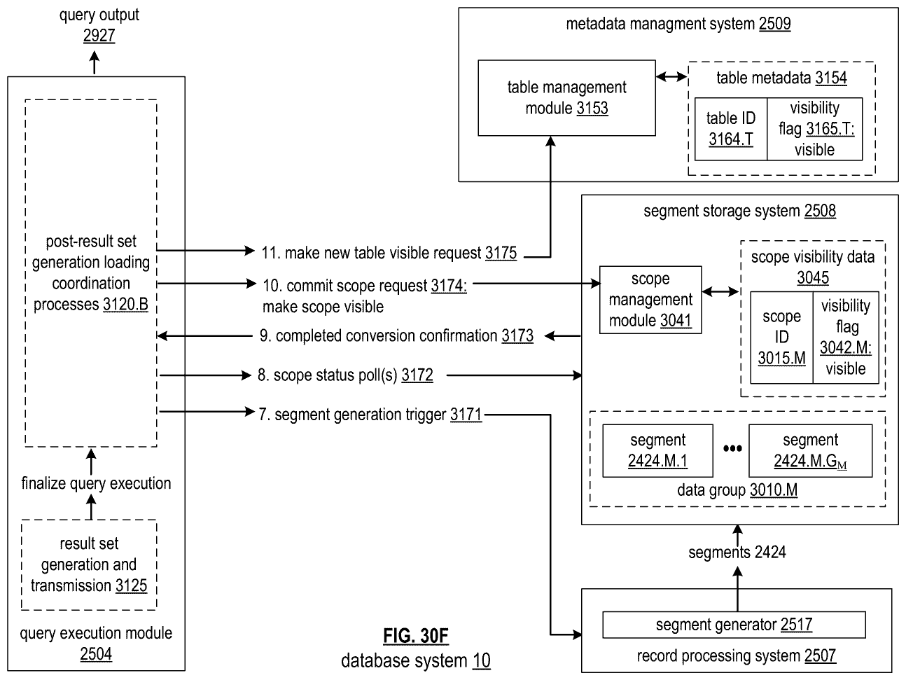

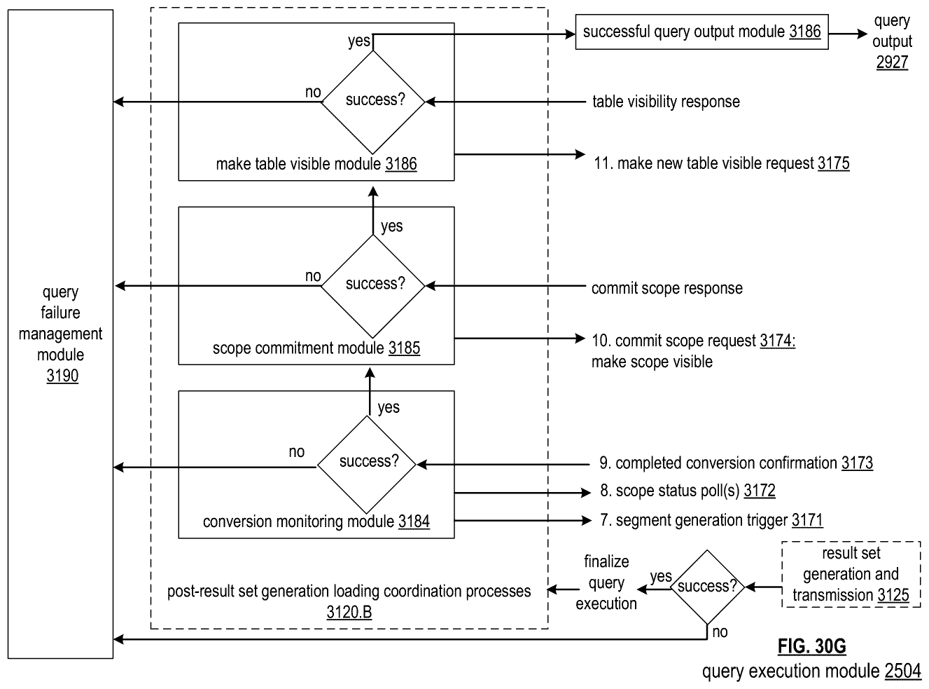

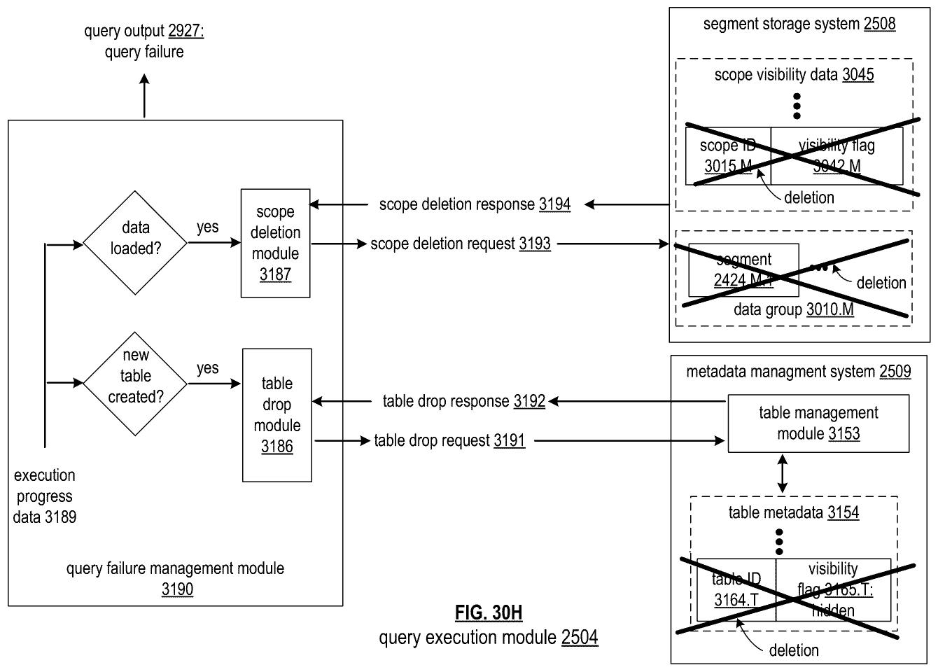

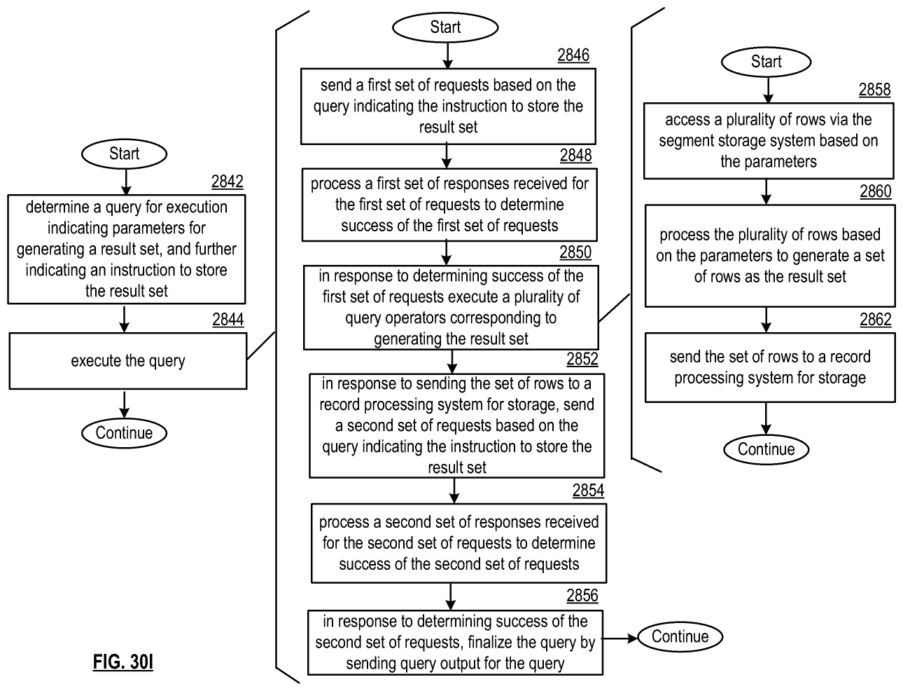

Information regarding tables 2712, such as their name, their column names and/or types, and/or existence as part of the dataset for query access, can be stored and/or maintained by a metadata management system storing corresponding table metadata, for example, for use in validating queries for execution and/or determining which segments be accessed in query execution based on their reference to particular tables and/or columns. Embodiments of the metadata management system are discussed in further detail in conjunction with FIGS. 30A-30I.

FIG. 28C illustrates an example of executing a query to generate a query resultant that includes a result set based on accessing database tables stored in segments 2424, for example, as discussed in conjunction with FIG. 28B. Some or all features and/or functionality of the query request, query execution plan generator module, query execution module, segment storage system, and/or query resultant of FIG. 28C can implement the query request, query execution plan generator module, query execution module, segment storage system, and/or query resultant of FIG. 25A and/or any other embodiment of performing query executions described herein.

As illustrated in FIG. 28C, a query resultant 2920 generated via query execution can include a result set 2925 that includes its own set of output rows 2722, which can include values 2718 for one or more output columns 2717. The result set 2925 can be generated as indicated in result set generation parameters of a corresponding query request 2915. In particular, the query request 2915 can indicate output column parameters 2719.1-2719.C_{Q} for a set of C_{Q} output columns 2717 to be included in the result set. The query request 2915 can further indicate parameters for selecting rows that are utilized to select which records be accessed and/or transformed to generate corresponding output rows having values for these output columns.

The output columns and corresponding values can correspond to unaltered values read from segments. For example, the C_{Q} output columns 2717 can correspond to some or all unaltered columns 2707 of one or more database tables, where some or all corresponding records 2422 are included as output rows 2722, based on the query request 2915. Alternatively, the output columns and corresponding values can correspond to transformed values generated based on values read from segments. For example, a given output columns 2717 can correspond to a transformation of data in one or more columns of one or more tables, over one or more rows, based on the query request 2915.

As illustrated in FIG. 28C, the rows accessed to generate the query resultant 2920 are all read from segments 2424. For example, the database system 10 is operable to access rows during query executions only once they are included in segments, where IO reads to pages are not implemented during some or all query executions. Such an embodiment where row reads are only performed via access to segments 2424 and not pages 2515 can be utilized to implement some or all query executions discussed in conjunction with FIGS. 28D-33E. The segment storage system 2508 of FIG. 28C can be implemented as the segment storage system of FIG. 28A.

FIG. 28D illustrates an embodiment of a database system that receives some or all query requests from one or more external requesting entities 2912. The external requesting entities 2912 can be implemented as a client device such as a personal computer and/or device, a server system, or other external system that generates and/or transmits query requests 2920. A query resultant 2920 can optionally be transmitted back to the same or different external requesting entity 2912. Some or all query requests processed by database system 10 as described herein can be received from external requesting entities 2912 and/or some or all query resultants generated via query executions described herein can be transmitted to external requesting entities 2912.

For example, a user types or otherwise indicates a query for execution via interaction with a computing device associated with and/or communicating with an external requesting entity. The computing device generates and transmits a corresponding query request 2915 for execution via the database system 10, where the corresponding query resultant 2920 is transmitted back to the computing device, for example, for storage by the computing device and/or for display to the corresponding user via a display device.

FIG. 28E illustrates an embodiment of database system 10 that further loads result sets 2925 of query resultants 2920 generated as discussed in conjunction with FIG. 28C as new result set-based segments 2424 for storage. Some or all features and/or functionality of the database system 10 of FIG. 28E can be implemented by any embodiment of the database system 10 described herein. The record processing system 2507 of FIG. 28E can be implemented via some or all of the same resources implementing the record processing system 2507 of FIG. 28A.

A query request 2915 can indicate a store result set instruction 2917 indicating that a corresponding result set generated in accordance with the result set generation parameters 2916 be stored in the database system 10. For example, the store result set instruction 2917 is indicated by a Create Table As Select (CTAS) statement and/or an Insert Into Select statement of a corresponding SQL query. The store result set instruction 2917 can otherwise indicate the result set be stored, for example, as a new database table 2712 or as new rows of an existing database table 2712.

The database system 10 can thus be operable to new data in the system via operations such as Create Table As Select (CTAS) and Insert Into Select operations, in addition to loading record streams received from external data sources. These operations can be unique in that the set of rows to be inserted is the result set of an arbitrary query, with data coming from the system itself.

Based on the query request indicating the store result set instruction 2917, the corresponding result set 2925 generated based on the result set generation parameters 2916 can be processed by the record processing system 2507. In particular, the record processing system 2507 can generate segments 2424 by processing the output rows 2722 of result set 2925 in a same or similar fashion as generating segments 2424 by processing the records in record streams received from data sources 2501.1-2501.L as illustrated in FIG. 28A and/or as discussed in conjunction with FIGS. 25A-27E.

In some embodiments, the loading components of record processing system 2507 run on dedicated loader nodes which avoids having to coordinate resource management with query processes run on query execution module 2504. For example, a plurality of loading modules 2510 of record processing system 2507 are implemented via a set of corresponding nodes 37 that are distinct from the plurality of other nodes 37 participating in query execution plans 2405 of the query execution module 2504. In other embodiments, loading components run alongside queries on nodes participating in query execution plans 2405 of the query execution module 2504, allowing hardware resources to be shared. In such embodiments, these nodes 37 coordinate resource management implementing the loading components with the query processes on the node.

As discussed in conjunction with some or all Figures to follow, the database system 10 can be operable to handle the loading of query result sets as segments for storage based on implementing functionality to: convert the data in result set form to be turned back into segments for storage in the system, handle data format differences; perform load balancing for where the data is finally stored, and/or mediate how and when the storage layer learns of the new data. Implementing the database system 10 to load query resultants in a same fashion as loading externally generated record streams can improve the technology of database systems by reducing the need for resource sharing, as resource sharing between loading and queries is not necessary, since loading work is delegated to existing loading hardware of record processing system 2507.

FIG. 28F illustrates an embodiment where a result set 2925 is stored as a new database table 2712.Q. The result set 2925 can be generated and stored as illustrated in FIG. 28E to create the new table 2712.Q, for example, based on the corresponding query request indicating a CTAS instruction or otherwise indicating a new table be created from the result set. This table can optionally be formatted in a same fashion as and/or can be indistinguishable from features of tables generated from record streams received from external data sources. This new table and/or its corresponding columns can be referenced in result set generation parameters of subsequent queries, and/or can otherwise have the values 2718 of its records accessed in future query executions.

FIG. 28G illustrates an embodiment where the result set 2925 is stored as new rows of an existing database table 2712.B. The result set 2925 can be generated and stored as illustrated in FIG. 28E to create the new table 2712.Q, for example, based on the corresponding query request indicating an Insert Into Select instruction or otherwise indicating the result set be stored as new rows of an existing table. These new rows can optionally be formatted in a same fashion as and/or can be indistinguishable from other rows of this existing table that were generated from record streams received from external data sources. These new rows can be accessed in future query executions, for example, when the existing table 2712.B and/or its columns are referenced in result set generation parameters of subsequent queries.

FIG. 28H illustrates an example of a query execution module 2504 that executes a query based on implementing a query operator execution flow 3115 generated by a query execution plan generator module 2503 based on the query request 2915. In particular, the query operator execution flow 3115 includes a loading operator 3127 that operates to facilitate loading of the result set by the record processing system 2507 for storage based on the query indicating the store result set instruction 2917. Some or all features and/or functionality of the query execution plan generator module 2503 and/or the query execution module 2504 of FIG. 28H to facilitate loading of query result sets can be implemented by the query execution plan generator module 2503 and/or the query execution module 2504 of FIG. 28E and/or of any other embodiment of database system 10 described herein.

Executing queries that include instructions to store the result set, such as queries with CTAS or Insert Into Select statements, can include generating a plan for the base query, and at the root, after all data has been assembled, inserting a loading operator. The plan can be run by the query execution module 2504, for example, implemented as a virtual machine. When data reaches the loading operator, instead of forwarding it on to its parent, the data can be sent to the record processing system, such as individual loading modules 2510 of the record processing system. The record processing system can accept input data in the format returned by the query, and can generate pages by converting the input data to page format. The record processing module can then proceed with the standard loading process, for example, that is used when loading record streams received from external data sources. The loading operator can be implemented to sends status polls to the record processing system to determine when all data has been made durable, for example, as many polls over time, such as one every second or another short, fixed time frame As rows are made durable, the loading operator can forward the number of rows loaded to its parent as output data.

As illustrated in FIG. 28H, an operator execution flow generator module 3110 can generate a query operator execution flow 3115 to be executed by the query execution module 2504 to facilitate proper execution of the corresponding query. Generating the query operator execution flow 3115 can be based on building an abstract syntax tree for a query expression indicated by the query request, performing an optimization, performing a validation, or otherwise determining an ordering of operators for execution. The query operator execution flow 3115 can include one or more serialized operators and/or one or more parallelized branches of operators.

The query operator execution flow 3115 can include at least one IO operator 3122 to read records from segments in conjunction with the query execution. The at least one IO operator 3122 and/or use of indexes can be determined based on the result set generation parameters 2916 and/or other parameters of the query request 2915. The IO operator, when executed, can output data blocks corresponding to rows read from segments.

The query operator execution flow 3115 can further include at least one other operator 3129, for example, serially after the at least one IO operator 3122, to filter, transform, and/or otherwise process the records read from segments in conjunction with the query execution. The at least one other operator 3129 can be determined based on the result set generation parameters 2916 and/or other parameters of the query request 2915. The at least one other operator 3129 can include a plurality of operators, for example, in multiple parallelized flows and/or with multiple operators in series. The other operators 3129, when executed, can each output data blocks for further processing by subsequent other operators 3129 serially after prior other operators 3129, where a serially last one or more other operators 3129 output data blocks of result set 2925.

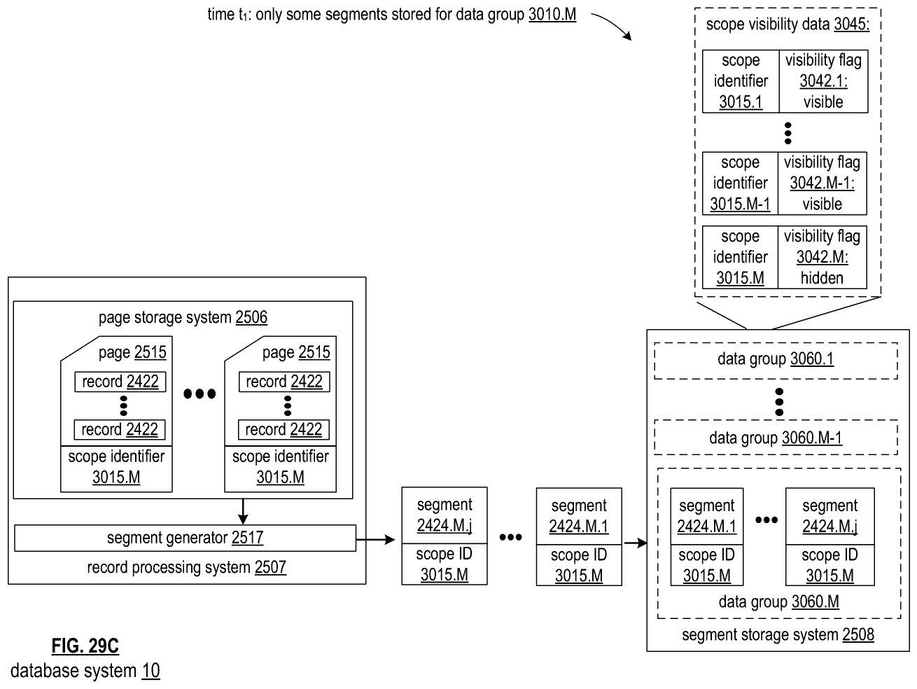

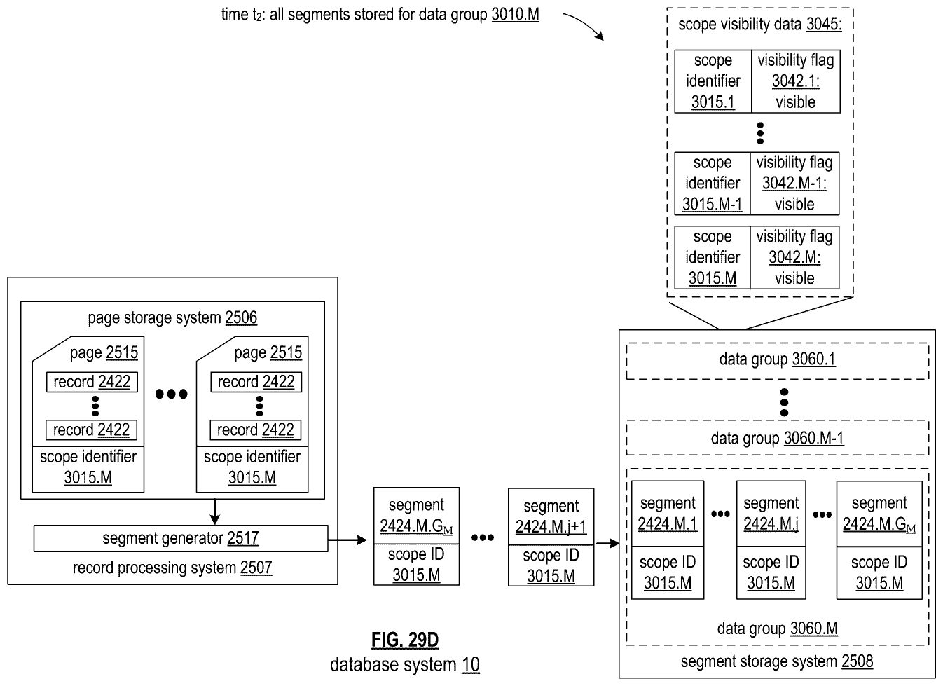

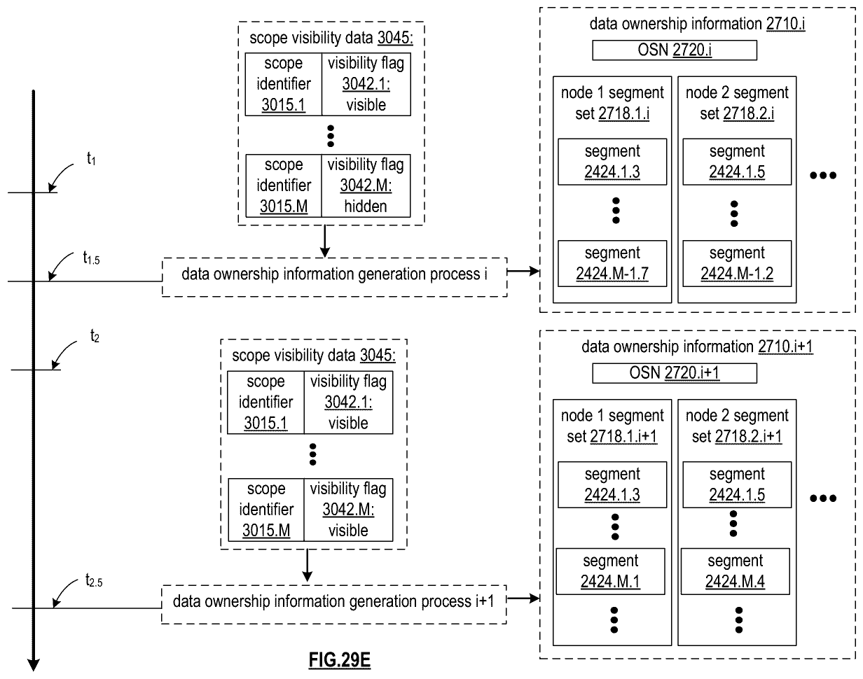

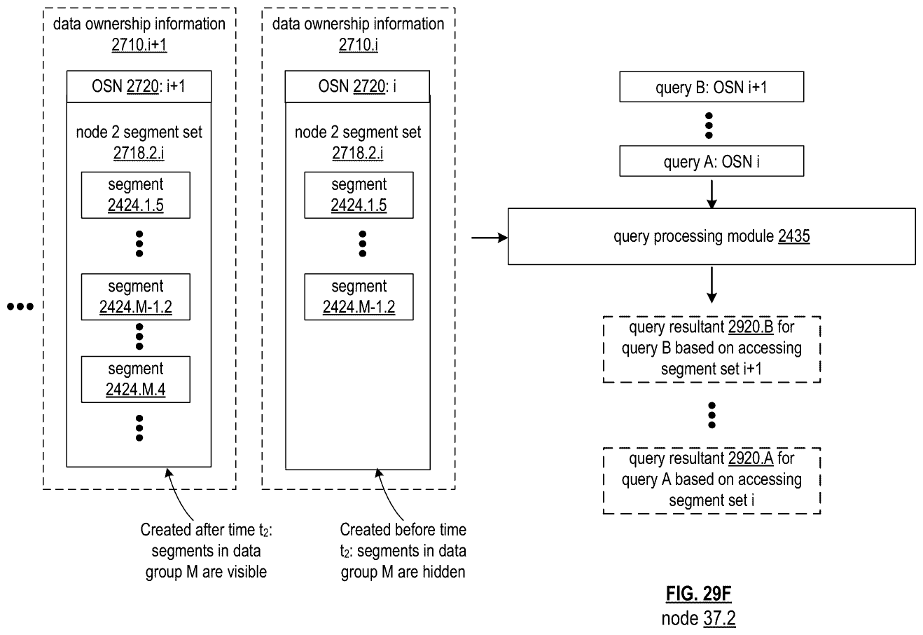

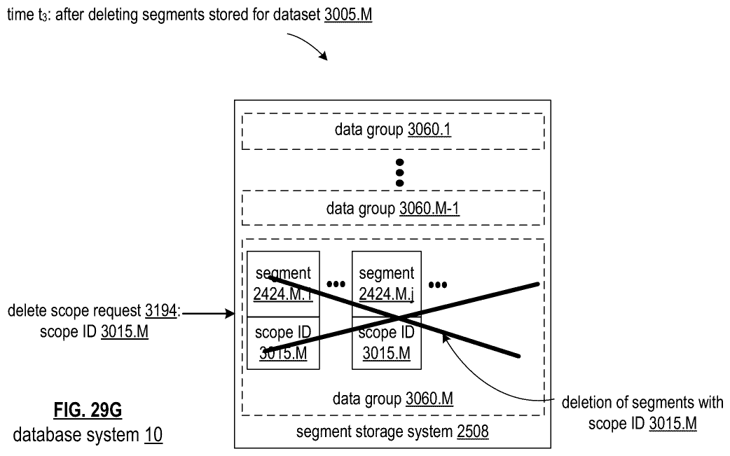

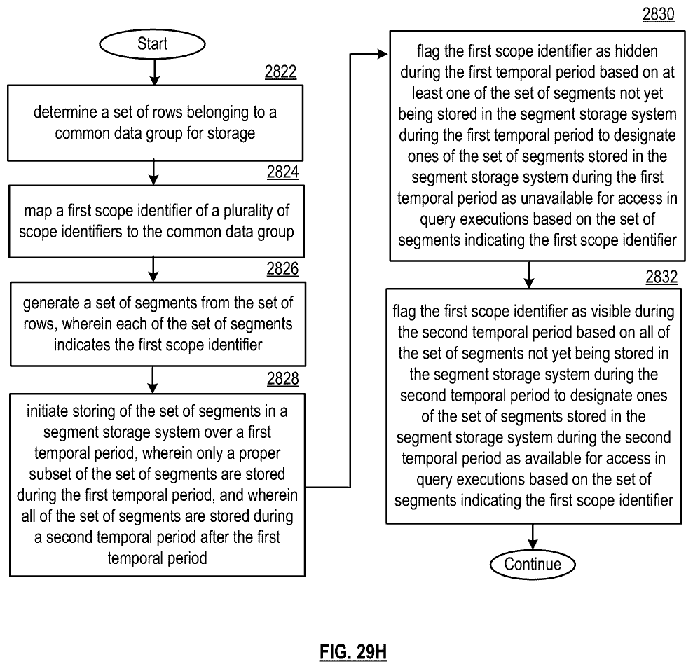

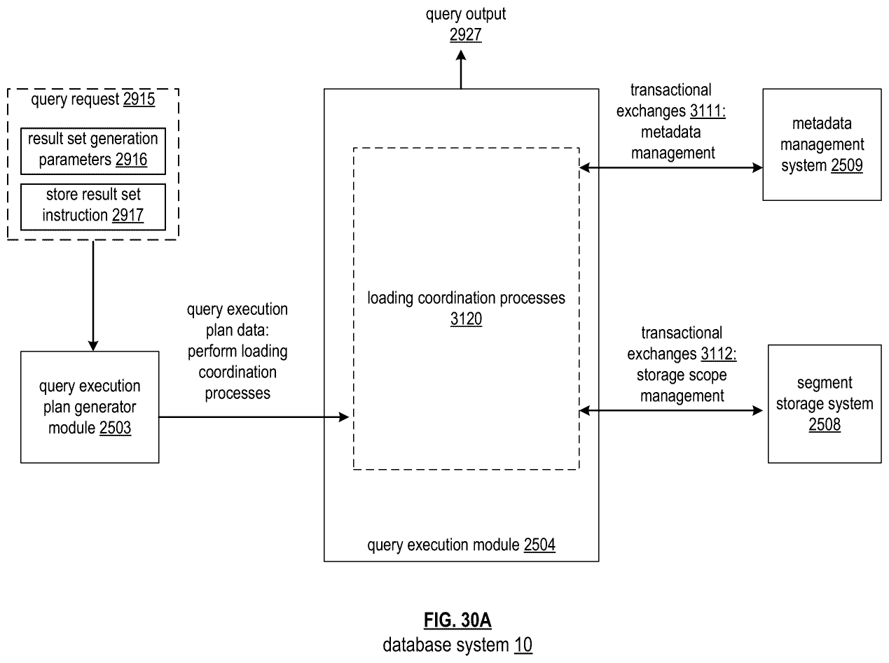

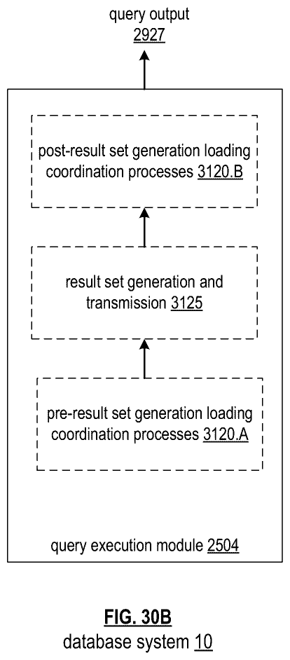

The query operator execution flow 3115 can further include a loading operator 3127 to facilitate loading of the result set by the record processing system 2507 for ultimate storage in segments. Execution of the loading operator 3127 can include sending of the result set 2925 to the record processing system 2507 and/or can include waiting for result set storage status 2926 from the record processing system indicating when all rows of the result set are stored in pages, when all rows of the result set are stored durably, and/or when all rows of the result set are included in segments stored in the segment storage system. This can include sending a stream of status polls to the record processing system 2507, for example, once every second or another short, fixed time frame, where the result set storage status 2926 is received in response. Transactional coordination by the query execution module when executing queries that indicate result sets be loaded into storage is discussed in further detail in conjunction with FIGS. 29A-30I.

Once all rows are determined to be stored durably based on the result set storage status 2926, the loading operator can further emit query output 2927. The query output 2927 optionally includes no rows of the result set, but only confirmation that the result set was stored and/or information regarding size of the result set that was loaded. The query output 2927 can alternatively include the rows of the result set.

The operators of the query operator execution flow 3115 can be executed by the query execution module 2504, for example, via a plurality of nodes 37 participating in a corresponding query execution plan 2405. Serialized operators can be divided for execution across nodes at different levels of the query execution plan 2405. For example, a set of IO operators 3121 are executed by all nodes of an IO level of the query execution plan 2405 to produce data blocks sent to parent nodes that execute some or all of the other operators 3129 from the received data blocks. In some embodiments, nodes at the IO level of the query execution plan 2405 each execute IO operators 3121 implement their own query processing module 2435 to read records from segments in their memory drives 2425, and/or nodes at inner levels and/or the root level of the query execution plan 2405 each implement their own query processing module 2435 to execute query operator execution flows 2433 that include some or all other operators 3129 of the query operator execution flow 3115 for the full query.

The loading operator 3127 can be processed by the root node, or by each of a set of nodes at an inner level that each send their respective portions of the result set to the record processing system 2507 based on executing the loading operator 3127. For example, once each node at the inner level receive result set storage status 2926 from the record processing system indicating all rows of the result set are stored in pages, all rows of the result set are stored durably, and/or all rows of the result set are included in segments stored in the segment storage system, the loading operator execution by these inner level nodes further includes forwarding loading confirmation data, and/or a number rows loaded by that node in its portion of the result set, to a parent node, such as the root node. For example, the root node emits final query output 2927 once confirmation of rows being made durable is received from all child nodes executing the loading operator, and/or the root node emits the value indicating a number of rows loaded in the query output 2927 based on an aggregation on the number of rows indicated to have been loaded by each child node via their loading operator based on receiving the emitted value of the number of rows from each child node.

Sending the result set 2925 to the record processing system 2507 can include sending data blocks of the result set to one or more particular loading modules 2510 of the record processing system 2507, where each loading module 2510 can be operable to generate its own pages from data blocks of the result set. Result set storage status 2926 can optionally be received from one or more given loading modules 2510.

FIG. 28I illustrates generation of pages by a record processing system, such as by one or more loading modules 2510 of a record processing system 2507, when processing externally-generated record streams 2904. Some or all features and/or functionality of the record processing system 2507 of FIG. 28I can be utilized to implement the record processing system of FIG. 28A and/or any other embodiment of the record processing system 2507 described herein. Some or all features and/or functionality of the record processing system 2507 of FIG. 28I can be implemented via an individual loading module 2510, where a plurality of loading modules 2510 of a record processing system 2507 each implement the functionality of FIG. 28I to generate their own respective pages.

As illustrated in FIG. 28I, when processing an externally generated record stream 2904 received from an external data source, its row-major formatted data blocks 2919 are processed via a page conversion process 2911 implemented by the page generator that is operable to handle the processing of data blocks in this row-major format. For example, the row-major format corresponds to lists of rows or indication of rows serially, where each row's values of all of the corresponding columns are included for each row in this serial ordering. The generation of pages 2515 can include maintaining the row-major format, where new rows are appended in pages, and where new pages are created as necessary.

Pages can further be deduplicated and/or otherwise made durable as discussed previously via the record processing system 2507 as part of the page conversion process 29111 and/or subsequent processes. For example, the row-major formatted data blocks 2919 are optionally implemented via some or all features of the labeled row data 3010 of FIGS. 27A-27E to facilitate deduplication of pages. The page conversion process 2911 and/or these subsequent processes can be implemented via some or all embodiments of page generation by the page generator 2511 described herein.

FIG. 28J illustrates generation of pages by a record processing system, such as by one or more loading modules 2510 of a record processing system 2507, when processing result set record streams 2929. Some or all features and/or functionality of the record processing system 2507 can be utilized to implement the record processing system of FIG. 28E and/or any other embodiment of the record processing system 2507 described herein. Some or all features and/or functionality of record processing system of FIG. 28J can be implemented via an individual loading module 2510, where a plurality of loading modules 2510 of a record processing system 2507 each implement the functionality of FIG. 28J to generate their own respective pages.

As discussed previously, the record processing system 2507 can be adapted to handle the result set data in the format in which it is generated to load the data into pages for conversion into segments for storage. This can include processing a plurality of column data streams 2931.1-2931.C_{Q} of the result set, where the page generator 2511 iterates over each column stream to turn column-major data blocks into row-major output pages.

Each column data stream 2931.1 can correspond to one of the output columns 2717 of the result set 2925 and include column-major formatted data blocks 2918, where data is serially included by column rather than by row. For example, each column-major formatted data block indicates the value of a given column for a given row, with an identifier for the given row.

The page generator 2511 can be adapted to implement an input data format conversion module 2938 to process the incoming data of the result set into the format required to implement the remainder of the page conversion process 2911 normally, in a same or similar fashion as when performing the page conversion process 2911 upon externally-generated record streams 2904 as illustrated in FIG. 28I. For example, the input data format conversion module 2938 of the page generator 2511 generates a re-formatted result set data stream 2913 that includes row-major formatted data blocks 2919. This can include iterating over each column data stream 2931 to generate the row-major formatted data blocks 2919, where the row-major formatted data blocks 2919 indicate the output rows 2722 in a serialized ordering, where each row entry in the row-major formatted data blocks 2919 includes all of its column values 2718 which were previously dispersed across different column data streams 2931.

As the row-major formatted data blocks 2919 of the a re-formatted result set data stream 2913 match the format of the row-major formatted data blocks 2919 of the externally-generated record streams 2904 of FIG. 28I, the page generator 2511 can proceed with performing the same or similar page generation process 2911 upon the re-formatted result set data stream 2913 to generate pages in a same or similar fashion as generating the pages from the externally-generated record stream, where pages 2515 of FIG. 28J are deduplicated and/or otherwise made durable as part of the same page conversion process 2911 and/or same subsequent processes performed in FIG. 28I. For example, the row-major formatted data blocks 2919 of the re-formatted result set data stream 2913 are optionally implemented via some or all features of the labeled row data 3010 of FIGS. 27A-27E to facilitate deduplication of pages.

As illustrated in FIG. 28K, after new result-set based segments 2424 are generated as discussed in conjunction with FIG. 28E, subsequent query results 2915 can be received and processed via database system 10 in a same or similar fashion as discussed in conjunction with FIG. 28D and/or as discussed herein. These queries can be executed based on accessing the result-set based segments 2424 previously generated as illustrated in FIGS. 28E and/or 28J in addition to other external-source based segments 2424 previously generated as illustrated in FIGS. 28A and/or 28I. For example, result-set based segments 2424 are accessed based on a corresponding query indicating selection of rows in new table and/or the existing table in which these result-set based segments are included for processing.

FIGS. 28L-28Q illustrate methods for execution by at least one processing module of a database system 10. For example, the database system 10 can utilize at least one processing module of one or more loading modules 2510 of a record processing and storage system 2505 and/or of one or more nodes 37 of one or more computing devices 18, where the one or more nodes and/or loading modules execute operational instructions stored in memory accessible by the one or more nodes and/or loading modules, and where the execution of the operational instructions causes the one or more nodes 37 and/or loading modules to execute, independently or in conjunction, the steps of FIGS. 28L, 28M, 28N, 28O, 28P, and/or 28Q. As a particular example, a node 37 can utilize the query processing module 2435 to execute some or all of the steps of FIG. 28O, where multiple nodes 37 implement their own query processing modules 2435 to independently execute some or all step some or all the steps of FIG. 28O, for example, to facilitate execution of a query as participants in a query execution plan 2405. As another example, a loading module 2510 can execute some or all of the steps of FIGS. 28L and/or 28P, where multiple loading modules independently execute some or all step some or all the steps of FIGS. 28L and/or 28P, for example, to collectively load datasets of records to generate segments for storage. Some or all steps of FIGS. 28L, 28M, 28N, 28O, 28P, and/or 28Q can be performed by any one or more processing modules database system 10 in accordance with other embodiments of the database system 10 discussed herein. The methods of FIGS. 28L, 28M, 28N, 28O, 28P, and/or 28Q can optionally be performed sequentially as part of one larger method, where the steps of FIG. 28L are performed first and where the steps of FIG. 28Q are performed last. Some or all steps of FIGS. 28L, 28M, 28N, 28O, 28P, and/or 28Q can be performed in conjunction with performing any other method described herein.

Step 2802 includes receiving a first plurality of rows of a set of database tables for storage. Step 2804 includes generating a first plurality of segments from the first plurality of rows in accordance with at least one column of the set of database tables. In some embodiments, step 2802 and/or 2804 are performed by a record processing system 2507. For example, at least one processing module of one or more nodes 37 of one or more computing devices 18 of the record processing system 2507, where the one or more nodes execute operational instructions stored in memory accessible by the one or more nodes, and where the execution of the operational instructions causes the one or more nodes 37 to execute, independently or in conjunction, some or all steps of FIG. 28L. The steps of FIG. 28L can be performed via any other one or more processing modules of database system 10.

Step 2806 includes storing the first plurality of segments for access in future query executions. In some embodiments, step 2806 is performed by processing and/or storage resources that are distinct from some or all processing resources that performed the method of FIG. 28L. In some embodiments, step 2806 is performed by a segment storage system 2508. For example, at least one processing module of one or more nodes 37 of one or more computing devices 18 of the segment storage system 2508 perform the method of FIG. 28M, where the one or more nodes execute operational instructions stored in memory accessible by the one or more nodes, and where the execution of the operational instructions causes the one or more nodes 37 to execute, independently or in conjunction, some or all steps of FIG. 28M. In some embodiments, the segment storage system 2508 performs the method of FIG. 28M based on a record processing system 2507 performing the steps of FIG. 28L and/or based on the record processing system 2507 sending the first plurality of segments to the segment storage system 2508.

Step 2808 includes determining a first query for execution indicating parameters for generating a result set from at least one of the set of database tables, and further indicating an instruction to store the result set in conjunction with the set of database tables. Step 2810 includes generating a query operator execution flow for the first query that includes a first plurality of operators based on the parameters, and that further includes a loading operator based on the instruction to store the result set. In some embodiments, steps 2808 and/or 2810 are performed by processing and/or storage resources that are distinct from some or all processing resources that performed the method of FIG. 28L and/or that performed the method of FIG. 28M. In some embodiments, step 2808 and/or step 2810 is performed by a query execution plan generator module 2503. For example, at least one processing module of one or more nodes 37 of one or more computing devices 18 of the query execution plan generator module 2503 perform the method of FIG. 28N, where the one or more nodes execute operational instructions stored in memory accessible by the one or more nodes, and where the execution of the operational instructions causes the one or more nodes 37 to execute, independently or in conjunction, some or all steps of FIG. 28N. In some embodiments, the query execution plan generator module 2503 performs the method of FIG. 28N after a record processing system 2507 performs the steps of FIG. 28L and/or after a segment storage system 2508 performs the method of FIG. 28M.

Step 2812 includes executing the first plurality of operators of the first query by accessing at least one of the first plurality of rows via the segment storage system, and/or by processing the at least one of the first plurality of rows to generate a second plurality of rows as the result set. Step 2814 includes executing the loading operator by sending the second plurality of rows to the record processing system. In some embodiments, step 2812 and/or 2814 are performed by processing and/or storage resources that are distinct from some or all processing resources that performed the method of FIG. 28L, that performed the method of FIG. 28M, and/or that performed the method of FIG. 28N. In some embodiments, step 2812 and/or step 2814 is performed by a query execution module 2504. For example, at least one processing module of one or more nodes 37 of one or more computing devices 18 of the query execution module 2504 perform the method of FIG. 28O, where the one or more nodes execute operational instructions stored in memory accessible by the one or more nodes, and where the execution of the operational instructions causes the one or more nodes 37 to execute, independently or in conjunction, some or all steps of FIG. 28O. In some embodiments, the query execution module 2504 performs the method of FIG. 28O after a record processing system 2507 performs the steps of FIG. 28L, after a segment storage system 2508 performs the method of FIG. 28M, and/or after a query execution plan generator module 2503 performs the method of FIG. 28N. For example, the query execution module 2504 performs the method of FIG. 28O based on the query execution plan generator module 2503 communicating the query operator execution flow to the query execution module 2504, where the steps of FIG. 28O implement the query operator execution flow generated by the query execution plan generator module 2503.

Step 2816 includes receiving the second plurality of rows. Step 2818 includes generating at least one new segment from the second plurality of rows. In some embodiments, step 2816 and/or 2818 are performed by processing and/or storage resources that are distinct from some or all processing resources that performed the method of FIG. 28M, that performed the method of FIG. 28N, and/or that performed the method of FIG. 28O. In some embodiments, step 2816 and/or step 2818 is performed by some or all same processing resources that previously performed the method of FIG. 28L. In particular, a same record processing system 2507 that performs the method of FIG. 28L can further perform the method of FIG. 28P. For example, at least one processing module of one or more nodes 37 of one or more computing devices 18 of the record processing system 2507 perform the method of FIG. 28P, where the one or more nodes execute operational instructions stored in memory accessible by the one or more nodes, and where the execution of the operational instructions causes the one or more nodes 37 to execute, independently or in conjunction, some or all steps of FIG. 28P. In some embodiments, the record processing system 2507 performs the method of FIG. 28O after this record processing system 2507 performs the steps of FIG. 28L, after a segment storage system 2508 performs the method of FIG. 28M, after a query execution plan generator module 2503 performs the method of FIG. 28N, and/or after a query execution module 2504 performs the method of FIG. 28O. For example, the record processing system 2507 performs the method of FIG. 28P based on the query execution module 2504 generating and sending the second plurality of rows to the record processing system 2507.

Step 2820 includes storing the at least one new segment for access in the future query executions. In some embodiments, step 2820 is performed by processing and/or storage resources that are distinct from some or all processing resources that performed the method of FIG. 28L, that performed the method of FIG. 28N, that performed the method of FIG. 28O, and/or that performed the method of FIG. 28P. In some embodiments, step 2820 is performed by some or all same processing resources that previously performed the method of FIG. 28M. In particular, a same segment storage system 2508 that performs the method of FIG. 28M can further perform the method of FIG. 28Q. For example, at least one processing module of one or more nodes 37 of one or more computing devices 18 of the segment storage system 2508 perform the method of FIG. 28Q, where the one or more nodes execute operational instructions stored in memory accessible by the one or more nodes, and where the execution of the operational instructions causes the one or more nodes 37 to execute, independently or in conjunction, some or all steps of FIG. 28Q. In some embodiments, the record processing system 2507 performs the method of FIG. 28O after a record processing system 2507 performs the steps of FIG. 28L, after this segment storage system 2508 performs the method of FIG. 28M, after a query execution plan generator module 2503 performs the method of FIG. 28N, after a query execution module 2504 performs the method of FIG. 28O, and/or after the record processing system 2507 performs the method of FIG. 28Q. For example, the segment storage system 2508 performs the method of FIG. 28Q based on the on the record processing system 2507 generating and sending the at least one new segment to the segment storage system 2508.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIGS. 28L-28Q described above.

In various embodiments, a database system includes a record processing system, a segment storage system, a query execution plan generator module, and/or a query execution module. In various embodiments, the database system is operable to perform some or all steps of FIGS. 28L-28Q.

The record processing system of the database system can be operable to receive a first plurality of rows of a set of database tables for storage; and/or generate a first plurality segments from the first plurality of rows in accordance with at least one column of the set of database tables. In various embodiments, the first plurality of segments are column-formatted segments generated in accordance with a column-based format. The segment storage system can be operable to store the first plurality of segments for access in future query executions.

The query execution plan generator module of the database system can be operable to determine a first query for execution indicating parameters for generating a result set from at least one of the set of database tables, and/or further indicating an instruction to store the result set in conjunction with the set of database tables. The query execution plan generator module can be further operable to generate a query operator execution flow for the first query that includes a first plurality of operators based on the parameters, and/or that further includes a loading operator, serially after the first plurality of operators, based on the instruction to store the result set. In various embodiments, the loading operator is serially after the first plurality of operators in the query operator execution flow.

The query execution module can be operable to execute the first query. The executing of the first query by the query execution module can be based on executing the first plurality of operators of the first query by accessing at least one of the first plurality of rows via the segment storage system; and/or by processing the at least one of the first plurality of rows to generate a second plurality of rows as the result set. The executing of the first query by the query execution module can be further based on executing the loading operator by sending the second plurality of rows to the record processing system.

The record processing system can be further operable to receive the second plurality of rows from the query execution module and/or generate at least one new segment from the second plurality of rows. The segment storage system can be further operable to store the at least one new segment for access in the future query executions. In various embodiments, the at least one new segments is at least one new column-formatted segment generated in accordance with the column-based format.

In various embodiments, the first query is executed and the at least one new segment is stored during a first temporal period. In a second temporal period after the first temporal period, the query execution plan generator module can be further operable to: determine a second query for execution indicating second parameters for generating a second result set from another at least one of the set of database tables; and/or generate a query operator execution flow for the second query that includes a second plurality of operators based on the second parameters. The query execution module can be further operable to execute the second query based on executing the second plurality of operators of the second query by accessing at least one of the second plurality of rows via the segment storage system and/or processing the at least one of the second plurality of rows to generate a third plurality of rows as the second result set.

In various embodiments, the second query further indicates an instruction to store the second result set in conjunction with the set of database tables. In various embodiments, the query operator execution flow for the second query is generated to further include the loading operator, serially after the second plurality of operators, based on the instruction to store the second result set. the query execution module executes the second query further based on executing the loading operator by sending the third plurality of rows to the record processing system. In various embodiments, the record processing system is further operable to receive the third plurality of rows from the query execution module and to generate another at least one new segment from the third plurality of rows. In various embodiments, the segment storage system is further operable to store the another at least one new segment for access in future query executions.

In various embodiments, the at least one new segment includes a second plurality of segments, and wherein the second plurality of segments are only made visible for access in the future query executions once all of the second plurality of segments are stored via the segment storage system, and wherein the at least one of the second plurality of rows is accessed via the segment storage system based on the second plurality of segments being made visible for the future query executions.

In various embodiments, the database system is further operable to receive a command that includes a query expression generated via user input that indicates the first query in accordance with a query language. In various embodiments, the query language is the Structured Query Language (SQL). In various embodiments, the instruction to store the result set is based on a Create Table As Select (CTAS) statement and/or an Insert statement.

In various embodiments, the instruction to store the result set in conjunction with the set of database tables indicates the result set be stored as a new database table of the set of database tables. In various embodiments, the at least one new segment is generated from the second plurality of rows in accordance with at least one column of the new database table.

In various embodiments, the database system further includes a metadata management system operable to receive metadata management instructions from the query execution module regarding the new database table in conjunction with execution of the first query by the query execution module; and/or perform at least one metadata management operation for the new database table based on the metadata management instructions. The at least one metadata management operation can include creating the new database table in system metadata, altering visibility of the new database table, and/or verifying user privileges for the new database table. Examples of the metadata management system are discussed in conjunction with FIGS. 30A-30I. The metadata management instructions can be implemented as transactional exchanges regarding metadata management discussed in conjunction with FIGS. 30A-30I.

In various embodiments, the first plurality of rows are included in multiple tables of the set of database tables. The parameters of the first query can indicate column identifiers for at least two of the multiple tables. The at least one of the first plurality of rows can include rows from the at least two of the multiple tables. In various embodiments, the record processing system generates the first plurality of segments based on generating a first plurality of pages from the first plurality of rows for storage via a page storage system, and/or performing a page conversion process upon the first plurality of pages to generate the first plurality of segments in accordance with a column-based format. The record processing system can generate the at least one new segment based o:generating a second plurality of pages from the second plurality of rows for storage via the page storage system by converting data blocks indicating the second plurality of rows and/or performing the page conversion process upon the first plurality of pages to generate the at least one new segment in accordance with the column-based format. Examples of the page conversion process are discussed in conjunction with FIGS. 26A-26C.

In various embodiments, the first plurality of pages and the second plurality of pages are in accordance with a row-major format. The second plurality of rows can include a set of columns. The record processing system can generate the second plurality of pages from the second plurality of rows based on: receiving the second plurality of rows from the query execution module as a plurality of column-major data blocks of a plurality of column streams corresponding to the set of columns; and/or convert the column-major data blocks into the second plurality of pages in accordance with the row-major format based on iterating over each column stream of the plurality of column streams.

In various embodiments, the first plurality of rows are received in a stream of row data from at least one external data source that generates and transmits the stream of row data to the database system, and wherein the record processing system generates the first plurality of pages from the first plurality of rows based on preserving the row-major format of the stream of row data.

In various embodiments, the record processing system generates the first plurality of segments in parallel via a first plurality of parallelized resources during a first temporal period. The a query execution module can execute the first query in parallel via a second first plurality of parallelized recourses distinct from the first plurality of parallelized resources in a second temporal period after the first temporal period. The record processing system can generate the at least one new segment in parallel via the first plurality of parallelized resources during a third temporal period after the second temporal period.

In various embodiments, the query execution module is implemented via a plurality of nodes in a plurality of hierarchical levels of a query execution plan. A first plurality of nodes at an IO level of the query execution plan can access the at least one of the first plurality of rows via the segment storage system in conjunction with executing at least one IO operator of the first plurality of operators in accordance with the query execution plan; and/or a second plurality of nodes at an inner level of the query execution plan send the second plurality of rows to the record processing system in in conjunction with executing the loading operator of the first plurality of operators in accordance with the query execution plan.

In various embodiments, the execution of the loading operator by the query execution module includes determining when the second plurality of rows is durably stored and/or sending the second plurality of rows as output data. In various embodiments determining when the second plurality of rows is durably stored is based on sending at least one status poll to the record processing system in conjunction with executing the loading operator; and/or receiving at least one response from the record processing system indicating the second plurality of rows is durably stored based on the segment storage system storing the at least one new segment.

In various embodiments, generating the second plurality of rows includes determining a datatype for at least one column of the second plurality of rows and/or casting the at least one column of the second plurality of rows as the datatype. The at least one new segment can be generated in accordance with values of the at least one column being stored in accordance with the datatype.

FIGS. 29A-29G illustrate embodiments of a database system 10 that maintains visibility data for scopes of data loaded and stored by the database system to indicate whether data be accessed during query executions. In particular, result sets 2925 loaded into the system as new segments for future query access are only made visible to queries in atomic transactions once the entire result set is included in segments. Some or all features and/or functionality of the database system 10 of FIGS. 29A-29G can implement the database system 10 of some or all of FIGS. 28A-28K, and/or any other embodiment of the database system 10 described herein.

Some operations, such as CTAS or Insert Into Select, load data overtime but require that the data be treated as a group for certain steps in its lifetime, e.g. being made visible to queries. The record loading infrastructure of record processing system 2507 supports data trickling into the storage layer over time, where new segments are generated and stored for a given result set over a time and not all at once are generated. It can be unideal to include each new segment included in queries as soon as it is durable in the system, as queries run against only the portions of the result set that are available could render incorrect results. Instead, none of the data should be visible to queries until the operation is completed—at which point it should all appear atomically. With data streaming in over time, visibility of the new data must be managed for operations requiring consistency across the group, such as CTAS or Insert Into Select operations, to facilitate this functionality.

To enable managing visibility for a common group of data, such as a result set, storage created for a specific load operation that requires this consistency can be scoped to a given unique identifier. At the start of a load operation, the scope can be created. The contents of the scope can be tracked in the state as the loader creates data and appends it to the scope. All data sent to the loader for the load operation can be tagged with the scope, and the loading process can ensure that the data is separated by scope when generating pages and then segments. Pages written in the scope and later the segments that replace them can specify the scope ID when added to the segment storage system. The segment storage system can include scope information when communicating with the loader about segment ownership.

Data that is in a scope can be hidden from queries upon creation. This can be done by marking the new segment groups as “hidden”, which can result in skipping segment activation, or otherwise effectively hiding the existence of the segments from the IO layer. Once a load operation completes, it can commit its scope, where all data in the scope will atomically be made visible to queries and the scope may no longer be appended to. Data can be made visible by updating the “hidden” flag on every segment group to “visible”. These segments can now be activated and made available to queries. A scope can also be deleted atomically, causing its contents to be cleaned up and preventing the scope from being appended to in future.

Tracking scoped storage in the storage layer consensus state as soon as it is loaded improves the technology of database systems because the state of the storage layer is still fully observable and manageable while scoped load operations are ongoing. Furthermore, associating all data in a group of data with a single scope identifier further improves the technology of database systems because it makes cleanup on failure a single, straightforward operation to, rather than error prone mechanisms that may be required via more complex requests to ensure everything is cleaned up if all data was not associated with a single scope identifier. Additionally, associating all data with a single scope identifier allows it to be isolated throughout the loading process, which further improves the technology of database systems by creating greater flexibility when managing this data, rather than having no ability to intervene in the process without affecting other unrelated loading if this data was not isolated throughout the loading process.

FIG. 29A illustrates a database system 10 that executes queries via accessing segments in a segment storage system as described previously based on scope visibility data maintained via a scope management module 3041. Segment storage system 2508 can store segments belonging to different data groups 3060. Different segment groups can have the same or different number G of segments, for example, based on the number of records in corresponding data sets, respective data types of their values, or other factors. Some or all segments 2424 in segment storage system 2508 belonging to different segment groups can be tagged with and/or otherwise indicate one of a plurality of scope identifiers 3015, based on which of a corresponding plurality of data groups 3010 they belong.

Scope visibility data 3045 can indicate a visibility flag for each scope identifier denoting whether the segments belonging to the corresponding data group 3060 be accessed during query executions. For example, when executing a given query, IO level nodes only access segments from memory drives that have scope identifiers flagged as visible in the scope visibility data 3045. The scope visibility data 3045 can be determined via a segment ownership consensus 2544 and/or can be maintained in a corresponding storage layer consensus state. The contents of the scope can be tracked in the storage layer consensus state as the record processing system creates segments and appends them to the scope.

FIGS. 29B-29B illustrate loading of records in a given common data group 3060.M of FIG. 29A as segments 2424 over time via a record processing module. For example, the common data group 3060.M corresponds to a query resultant generated in execution of a corresponding query as discussed in conjunction with FIG. 28E.

FIG. 29B illustrates time to, prior to storage of any segments for data group 3060.M, but after loading of data group 3060.M is initiated. Data blocks 3006 of a given data group 3060.M are received in a stream over time, for example, as they are emitted by a query execution module 2504 for loading.

A scope tagging module 3036 tags these data blocks 3006 with a scope identifier 3015. The scope tagging module 3036 can be implemented by resources of the record processing system to tag data block as they are received, where the scope identifier is tagged is based on information regarding the data group and/or the entity from which the data blocks are received. The scope tagging module 3036 can be implemented by resources of the query execution module to tag data blocks as they are transmitted for loading, where a same scope identifier is tagged for data blocks for the query resultant. Alternatively, these data blocks are not tagged with the scope identifier and are otherwise known by the record processing system to be part of the same result set or other data group.

The record processing system 2507 can group incoming data blocks belonging to the same data group, for example, as indicated by their scope identifier 3015, into their own pages 2515 by page generator 2511 accordingly, even if other data is being received and loaded concurrently by the record processing system 2507. For example, each page 2515 can be generated to include data belonging to only one data group, regardless of whether data is being received and loaded concurrently by the record processing system 2507.

This scope identifier 3015.M for the data group 3060.M can be indicated in scope visibility data 3045 with its visibility flag 3042 marked as hidden based on initiating loading of the data group 3060.M and the data group being tagged with this scope identifier 3015. Initiation of a new storage scope during execution of a query generating a corresponding result set is discussed in further detail in conjunction with FIGS. 30D and 30E. Optionally, the scope visibility data does not yet indicate this scope identifier 3015.M based on no segments having scope identifier 3015.M being stored yet at time to.

FIG. 29C illustrates a time t₁ after time t₀ where only j segments have been generated and stored for data group 3060.M. These segments 2424 can be tagged with scope ID 3015.M. The scope visibility data can indicate a visibility flag 3042.M for this scope identifier 3015.M as being hidden based on not all rows yet being stored as segments. Query executions occurring during this time frame will be performed without accessing these segments, even if their corresponding tables are referenced in corresponding query requests, due to their scope identifier being flagged as hidden.

FIG. 29D illustrates a time t₂ after time t₁ where all G_{M} segments have been generated and stored for data group 3060.M, where all segments 2424 are tagged with scope ID 3015.M. The scope visibility data can indicate the visibility flag 3042.M for this scope identifier 3015.M as being visible all rows having been stored as segments. Query executions occurring during this time frame will be performed based on accessing these segments, if applicable, due to their scope identifier being flagged as visible.

FIGS. 29E and 29F illustrate an embodiment where scope visibility data 3045 is reflected in data ownership information 2710, generated via a given data ownership information generation process and tagged with a corresponding ownership sequence number (OSN). The data ownership information 2710 can be implemented as the scope visibility data 3045 of FIGS. 29A-29D.

As illustrated in FIG. 29E, a given data ownership information 2710 can be tagged with given ownership sequence number (OSN) 2720, and can indicate which segments are visible for query executions of queries tagged with this given OSN 2720. For example, as illustrated in FIG. 29E given data ownership information 2710 can further assign particular segments to particular nodes for access in respective query executions, for example, via direct access from memory drives and/or via rebuilding in a recovery process. Further iterations of the data ownership information generation process can be performed over time to activate access of new segments, for example, based on new scopes being flagged as visible and/or based on other changes to the storage of segments. Each data ownership information generation process can optionally be implemented via execution of a consensus protocol medicated by a plurality of nodes in a storage cluster of the segment storage system.

Data that is in a scope will be hidden from queries upon creation by marking the new segment groups as “hidden” in the given OSN 2720.i and skipping segment activation to hide the existence of the segments from the IO layer. In this example, the data ownership information 2710.i generated at time t_{1.5} does not indicate ownership of segments in data group 3060.M based on its scope identifier 3015.M being flagged as hidden at time t_{1.5} after some of the segments in this data group 3060.M have been stored at time t₁ and before all the segments in this data group 3060.M have been stored at time t₂.

Once all of the data group is loaded into segments, data is made visible by updating the “hidden” flag on every segment group of the data group 3060 to “visible”, starting at the next OSN 2720.i+1. The segments will now be activated and made available to queries from that OSN and onwards. In this example, the data ownership information 2710.i+1 generated at time t_{2.5} does indicate ownership of segments in data group 3060.M based on its scope identifier 3015.M being flagged as visible at time t_{2.5} after all the segments in this data group 3060.M have been stored at time t₂.

FIG. 29F illustrates execution of queries by a given node 37.2 using its data ownership information. Query resultant 2920. The node generates its own portion of the query resultant 2920.A for query A based on accessing segment set i due to the query A being tagged with OSN i. where segments of data group 3060.M are not accessed by the node, even if the node stores these segments in its memory drives. The node generates its own portion of the query resultant 2920.B for query N based on accessing segment set i+1 due to the query B being tagged with OSN i+1, where segments of data group 3060.M assigned to this node in the data ownership information are accessed by the node, for example, via access to its memory drives and/or via recovering the segments via segment recovery module 2439.

In various embodiments, generation of data ownership information over time with different corresponding OSNs and/or the tagging of queries with OSNs to dictate which segments that be accessed during execution of the query, for example, by each of a plurality of nodes participating at the IO level of the query execution, can be implemented via any features and/or functionality of the data ownership information, OSNs, execution of consensus protocols mediated via a plurality of nodes of a storage cluster to update data ownership over time, and/or any other functionality of determining segments that be accessed by nodes during query executions utilizing OSNs tagged to queries disclosed by U.S. Utility application Ser. No. 16/778,194, entitled “SERVICING CONCURRENT QUERIES VIA VIRTUAL SEGMENT RECOVERY”, filed Jan. 31, 2020, and issued as U.S. Pat. No. 11,061,910 on Jul. 13, 2021, which is hereby incorporated herein by reference in its entirety and made part of the present U.S. Utility patent application for all purposes.

FIG. 29G illustrates an embodiment of performing an atomic deletion of all segments in the same data group 3060.M based on a delete scope request 3193 indicating the corresponding scope ID 3015.M. All segments tagged with the given scope ID can be deleted, while all other segments having other scope IDs are not deleted. Such an atomic deletion can be performed prior to all G segments of the segment group being stored, for example, due to detecting a loading failure. Such an atomic deletion can be performed after all G segments of the segment group are stored.

FIG. 29H illustrates a method for execution by at least one processing module of a database system 10. Some or all of the method of FIG. 29H can be performed by the record processing system 2507, the segment storage system 2508, the scope tagging module 3036, and/or the scope management module 3041 of FIGS. 29A-29G. Some or all steps of FIG. 29H can be performed by any one or more processing modules database system 10 in accordance with other embodiments of the database system 10 discussed herein.

In some embodiments, the database system 10 can utilize at least one processing module of one or more loading modules 2510 of a record processing and storage system 2505 and/or of one or more nodes 37 of one or more computing devices 18, where the one or more nodes and/or loading modules execute operational instructions stored in memory accessible by the one or more nodes and/or loading modules, and where the execution of the operational instructions causes the one or more nodes 37 and/or loading modules to execute, independently or in conjunction, the steps of FIG. 29H. As a particular example, a loading module 2510 can execute some or all of the steps of FIG. 29H, where multiple loading modules independently execute some or all step some or all the steps of FIG. 29H, for example, to collectively load datasets of records to generate segments for storage. As another example, a node 37 can execute some or all of the steps of FIG. 29H, where multiple nodes 37 independently execute some or all step some or all the steps of FIG. 29H, for example, to execute at least one consensus protocol to determine data ownership information and/or to process the data ownership information in conjunction with query executions. Some or all steps of FIG. 29H can be performed in conjunction with performing some or all steps of FIGS. 28O, 28P, and/or 28Q. Some or all steps of FIG. 29H can be performed in conjunction with performing any other method described herein.

Step 2822 includes determining a set of rows belonging to a common data group for storage. Step 2824 includes mapping a first scope identifier of a plurality of scope identifiers to the common data group. Step 2826 includes generating a set of segments from the set of rows, where each of the set of segments indicates the first scope identifier. Step 2828 includes initiating storing of the set of segments in a segment storage system over a first temporal period, where only a proper subset of the set of segments are stored during the first temporal period, and where all of the set of segments are stored during a second temporal period after the first temporal period. Step 2830 includes flagging the first scope identifier as hidden during the first temporal period based on at least one of the set of segments not yet being stored in the segment storage system during the first temporal period to designate ones of the set of segments stored in the segment storage system during the first temporal period as unavailable for access in query executions based on the set of segments indicating the first scope identifier. Step 2832 includes flagging the first scope identifier as visible during the second temporal period based on all of the set of segments not yet being stored in the segment storage system during the second temporal period to designate ones of the set of segments stored in the segment storage system during the second temporal period as available for access in query executions based on the set of segments indicating the first scope identifier.

In various embodiments, the method further includes executing a first query during the first temporal period based on accessing a first plurality of rows stored in segments of the segment storage system based on first parameters of the first query, wherein at least one of the set of rows meets the first parameters of the first query, and wherein the at least one of the set of rows is not accessed in execution of the first query based on a corresponding at least one of the set of segments storing the at least one of the set of rows having the first scope identifier that is flagged as hidden during the first temporal period.

In various embodiments, the method further includes executing a second query during the second temporal period based on accessing a second plurality of rows stored in segments of the segment storage system based on second parameters of the second query. The at least one of the set of rows meets the second parameters of the second query, and/or the at least one of the set of rows is accessed in execution of the second query based on the corresponding at least one of the set of segments storing the at least one of the set of rows having the first scope identifier that is flagged as visible during the second temporal period.

In various embodiments, the method further includes generating first data ownership information mapped to a first ownership sequence number prior to the second temporal period indicating a first subset of a plurality segments stored by the segment storage system to be accessed during query executions, where the first subset of the plurality of segments does not include the proper subset of the set of segments. The method can further include generating second data ownership information mapped to a second ownership sequence number during the second temporal period indicating a second subset of a plurality segments stored by the segment storage system to be accessed during query executions, where the second subset of the plurality of segments includes all of the set of segments based on the first scope identifier being flagged as visible during the second temporal period. The method can further include determining the first query indicates the first ownership sequence number and accessing the first plurality of rows by accessing only segments in the first subset of the plurality of segments based on utilizing the first data ownership information to execute the first query. The method can further include determining the second query indicates the second ownership sequence number and accessing the second plurality of rows by accessing only segments in the second subset of the plurality of segments based on the utilizing the second data ownership information to execute the second query.

In various embodiments, the first query is executed via a plurality of nodes of a query execution plan accessing the accessing a first plurality of rows. The first data ownership information can indicate a first mapping of each given one of the first subset of the plurality of segments to exactly one corresponding one of the plurality of nodes. The second data ownership information can indicate a second mapping of each given one of the second subset of the plurality of segments to exactly one corresponding one of the plurality of nodes. Executing the first query can further include, for each node in the plurality of nodes, accessing a corresponding proper subset of the first plurality of rows by accessing only segments mapped to the each node in the first data ownership information. Executing the second query can further include, for each node in the plurality of nodes, accessing a corresponding proper subset of the second plurality of rows by accessing only segments mapped to the each node in the second data ownership information.

In various embodiments, the method further includes performing, via the plurality of nodes, first execution of a consensus protocol mediated between the plurality of nodes to generate the first data ownership information. The method can further include performing, via the plurality of nodes, second execution of the consensus protocol mediated between the plurality of nodes to generate the second data ownership information.

In various embodiments, all of the first plurality of rows are accessed in execution of the first query based on being stored in corresponding segments of the segment storage system having other ones of the plurality of scope identifiers flagged as visible.

In various embodiments, the set of segments are each generated and stored during a corresponding one of a set of time windows, wherein at least two of the set of time windows are non-overlapping. In various embodiments, another at least two of the set of time windows are overlapping.

In various embodiments, the set of rows are received during a first temporal period. The method can further include receiving a second set of rows of a second common data group during the first temporal period, where at least one of the second set of rows is received after a first one of the set of rows is received, and where the at least one of the second set of rows is received before at least one other one of the set of rows is received. The method can further include mapping the second set of rows to a second scope identifier. The method can further include generating a second set of segments from the second set of rows that is distinct from the set of segments based on the second scope identifier being different from the first scope identifier, where the second set of segments indicate only second scope identifier, and/or where the set of segments indicate only the first scope identifier. The method can further include storing the second set of segments in the segment storage system during a third temporal period overlapping with the first temporal period and the second temporal period, where only a proper subset of the second set of segments during the third temporal period, and/or where all of the second set of segments are stored during a fourth temporal period after the third temporal period. The method can further include flagging the second scope identifier as hidden during the third temporal period based on at least one of the second set of segments not yet being stored in the segment storage system during the third temporal period to designate ones of the second set of segments stored in the segment storage system during the third temporal period as unavailable for access in query executions based on the second set of segments indicating the second scope identifier. The method can further include flagging the second scope identifier as visible during the fourth temporal period based on all of the set of segments being stored in the segment storage system during the fourth temporal period to designate ones of the second set of segments stored in the segment storage system during the fourth temporal period as available for access in query executions based on the second set of segments indicating the second scope identifier.

In various embodiments, the method further includes generating a first set of pages from the set of rows, where each of the first set of pages identify the first scope identifier based on including only rows corresponding to the common data group. The set of segments can be generated based on performing a page conversion process upon the first set of pages, and wherein each of the set of segments identify the first scope identifier based on including only rows corresponding to the common data group. Each of the set of segments can include only rows corresponding to the common data group based on the page conversion process being performed upon only pages in the first set of pages having the first scope identifier.

In various embodiments, the method further includes determining to delete the common data group, and deleting the common data group from storage based on deleting only ones of a plurality of segments stored in the segment storage system having the first scope identifier from storage in the segment storage system, where all of the set of segments are deleted from the segment storage system based on all having the first scope identifier.

In various embodiments, the method further includes receiving a query prior to the first temporal period indicating parameters for generating a result set, and further indicating an instruction to store the result set. The method can further include executing the query prior to the first temporal period based on the parameters of the query by accessing another plurality of rows stored in segments of the segment storage system; and generating the result set from the plurality of rows, where the set of rows are determined as the result set. The another plurality of rows can be accessed based on being stored only in corresponding segments of the segment storage system flagged as visible prior to the first temporal period.

In various embodiments, receive a command that includes a query expression generated via user input that indicates the query in accordance with the Structured Query Language (SQL), wherein the instruction to store the result set is based on a Create Table As Select (CTAS) statement and/or an Insert statement.

In various embodiments, the method further includes creating a new database table corresponding to the common data group in system metadata, where the new database table is mapped to the first scope identifier. The method can further include changing visibility of the new database table in the system metadata from hidden to visible based on changing the first scope identifier from being tagged as hidden to being tagged as visible.

In various embodiments, the method further includes sending at least one status poll regarding progress in storing of the common data group; where the first scope identifier is flagged in response to receiving a response indicating all of the common data group is durably stored as the set of segments.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 29H described above.

In various embodiments, a database system includes at least one processor and at least one memory storing operational instructions. The operational instructions, when executed by the at least one processor, can cause the database system to perform some or all steps of FIG. 29H. The operational instructions, when executed by the at least one processor, can cause the database system to: determine a set of rows belonging to a common data group for storage; and/or map a first scope identifier of a plurality of scope identifiers to the common data group; generate a set of segments from the set of rows, wherein each of the set of segments indicates the first scope identifier; initiate storing of the set of segments in a segment storage system over a first temporal period, where only a proper subset of the set of segments are stored during the first temporal period, and wherein all of the set of segments are stored during a second temporal period after the first temporal period; flag the first scope identifier as hidden during the first temporal period based on at least one of the set of segments not yet being stored in the segment storage system during the first temporal period to designate ones of the set of segments stored in the segment storage system during the first temporal period as unavailable for access in query executions based on the set of segments indicating the first scope identifier; and/or flag the first scope identifier as visible during the second temporal period based on all of the set of segments not yet being stored in the segment storage system during the second temporal period to designate ones of the set of segments stored in the segment storage system during the second temporal period as available for access in query executions based on the set of segments indicating the first scope identifier.

FIGS. 30A-30G present embodiments of a database system 10 that performs loading coordination and manages corresponding transactions for loading of a query result set via the query execution module while executing a corresponding query to generate and load the result set. Some or all features and/or functionality of the database system 10 of FIGS. 29A-29G can implement the database system 10 of some or all of FIGS. 28A-28K, and/or any other embodiment of the database system 10 described herein.

When performing a query operation, such as a CTAS or INSERT INTO SELECT, to load result set data as segments for future access, certain system metadata transactions should be performed, e.g. create a table, make created storage visible, etc. It can be advantageous for these asynchronous transactions to be done in coordination with, and in response to, specific events happening during the lifetime of the query, where various query signals should be detected and responded to accordingly in real time.

The query execution module 2504 can be implemented to coordinate performance of these asynchronous transactions, for example, based on executing a corresponding a load coordinator operator inserted in the query plan that is executed as part a part of the query execution by the query execution module 2504, for example, via a corresponding virtual machine. This can improve the technology of database systems because all tasks associated with the CTAS and/or other loading of result set data for storage are carried out by the same execution engine that executes other queries that, for example, don't require loading of result sets. In particular, no special infrastructure is needed to coordinate the query lifetime with its associated external transactions, since the load coordinator fits into the query framework. Furthermore, this can be advantageous over other solutions that would execute all management tasks for the operation independent of the query itself, as they would have a more complicated workflow, with execution occurring in multiple areas of the system. As it would be challenging to observe or cancel the operation while it is processing tasks beyond the loading itself in such cases, the technology of database systems is improved by designating the transactional coordination to the query execution module alone to ensure cancellation of tasks can be easily implemented in a transactional manner.

FIG. 30A illustrates an embodiment of database system 10 where the query execution module 2504 performs loading coordination processes 3120 based on this performance of the perform loading coordination processes 3120 being indicated in query execution plan data generated for a corresponding query having a store result set instruction 2917. The loading coordination processes 3120 can include transactional exchanges 3112 corresponding to storage scope management with the segment storage system 2508. The loading coordination processes 3120 can include transactional exchanges 3111 corresponding to metadata management with a metadata management system 2509.

The metadata management system 2509 can be implemented via one or more computing devices 18 and/or other processing and/or memory resources of the database system 10. The processing and/or memory resources implementing the metadata management system 2509 can be shared with or distinct from the processing and/or memory resources of the query execution plan generator module 2503, of the query execution module 2504, of the record processing system 2507, and/or of the segment storage system 2508. The metadata management system 2509 can include at least one memory storing operational instructions that, when executed by at least one processor of the metadata management system 2509, cause the metadata management system 2509 to perform some or all of its functionality.

Some or all features and/or functionality of the query execution module 2405 of FIG. 30A can be performed by a single node, such as the root node at the root level of a query execution plan 2405. For example, while the result set may be generated in a query execution plan by many nodes, some or all of the loading coordination process 3120 are optionally performed by a single node and/or process performed by query execution module 2504, where each of the transactional exchanges 3111 and 3112 are only exchanged with the metadata management system 2509 and 2508 once.

FIG. 30B illustrates an embodiment of query execution module that implements the loading coordination processes 3120 of FIG. 30A as pre-result set generation loading coordination processes 3120.A and/or post-result set generation loading coordination processes 3120.B. The pre-result set generation loading coordination processes 3120.A can be performed prior to result set generation and transmission 3125, and/or the post-result set generation loading coordination processes 3120.B can be performed after this result set generation and transmission 3125. The result set generation and transmission 3125 can be implemented by the portion of a query operator execution flow 3115 for generating the result set and/or loading the result set, for example, as discussed in conjunction with FIG. 28H.

FIG. 30C illustrates an example of a query execution module 2504 that executes a query based on implementing a query operator execution flow 3115 generated by a query execution plan generator module 2503 based on a query request 2915. In particular, the query operator execution flow 3115 includes at least one load coordinator operators 3124 based on the query indicating the store result set instruction 2917. Some or all features and/or functionality of the query execution plan generator module 2503 and/or the query execution module 2504 of FIG. 30C to facilitate loading of query result sets can be implemented by the query execution plan generator module 2503 and/or the query execution module 2504 of FIG. 28E, FIG. 28H and/or of any other embodiment of database system 10 described herein. The execution of the load coordinator operator(s) of FIG. 30C can implement the pre-result set generation loading coordination processes 3120.A and/or post-result set generation loading coordination processes 3120.B. The execution of the IO operators 3122, other operators 3129, and/or loading operator 3127 can implement the result set generation and transmission 3125 of FIG. 30B.

While FIG. 30C illustrates load coordinator operators inserted into the top and bottom of the query execution plan to illustrate implementation of the pre-result set generation loading coordination processes 3120.A and the post-result set generation loading coordination processes 3120.B before and after other operators for the query, a single load coordinator operator 3124 can be inserted in the query operator execution flow 3115 for the query plan, but can cause the execution of the query by the query execution module 2504 to implement the pre-result set generation loading coordination processes 3120.A and the post-result set generation loading coordination processes 3120.B. For example, execution of a single load coordinator operator 3124 at the beginning of the query operator execution flow 3115, serially before some or all other operators, can cause all of the pre-result set generation loading coordination processes 3120.A and the post-result set generation loading coordination processes 3120.B to be performed before and after, respectively, the execution of the IO operators 3122, other operators 3129, and/or loading operator 3127.

Execution of the loading coordination operator at the base of the query operator execution flow 3115, and/or any other loading coordination operators appearing in the query, can cause the query execution module to execute loading coordination processes 3120 while executing the corresponding query by: first consuming initialization signal from the query execution module and/or a corresponding virtual machine, where any pull signals will be consumed and delayed from this point on; kicking off a rights verification request to the metadata management system 2509 and/or corresponding admin; receive rights check response, where, if user does not have permission to create/insert, fail query, and otherwise continue; send a create table request (if query includes CTAS instruction) and wait for response; send create storage scope request and wait for response; on failure for any of the prior requests, fail query, and otherwise, trigger delayed pull signals to start query execution for the load itself; wait for an end of file or other signal from the query execution module based on the query execution for the load itself, where on this signal, draining of segments by the record processing module is triggered; poll status of scope in the storage cluster until all data has been converted to segments; commit the storage scope, making data visible to queries; make new table visible (if query includes CTAS instruction); send results (indicating rows loaded) upstream and notify query is complete.

Execution of the loading coordination operator at the base of the query operator execution flow 3115, and/or any other loading coordination operators appearing in the query, can alternatively or additional cause the query execution module to execute loading coordination processes 3120 while executing the corresponding query by, if at any point in the steps indicated above a fatal failure is seen, fail the query. Upon failure or query cancellation, the following cleanup steps can be taken: if a table was created, send a drop table request; if any data was loaded, send a delete storage scope request; wait for responses to all in-progress network requests, then finalize.

Examples of executing loading coordination processes 3120 by the query execution module, for example, based on execution of a load coordinator operator 3124, is illustrated in FIGS. 30D-30H. Some or all features and/or functionality of the execution of loading coordination processes 3120 of FIGS. 30D-30H can be utilized to implement the execution of loading coordination processes 3120 of FIGS. 30A and/or 30B, and/or can be utilized to implement the execution of one or more load coordinator operators 3124 of FIG. 30C.

The result set generation and transmission 3125 can collectively be performed by nodes the IO level of a query execution plan and/or by nodes at some or all inner levels of the query execution plan. In some embodiments, the IO operators 3122 are processed by IO level nodes at the IO level of a query execution plan, and some or all and/or other operators 3129 are processed by these IO level nodes at the IO level of a query execution plan and/or by nodes at one or more inner levels. In some embodiments, the loading operator 3127 is processed by a plurality of inner level nodes, for example, at a final inner level before the root level, where the value of the number of rows stored is determined by executing loading operator 3127 and is emitted to the root node.

In some embodiments, the load coordination operator 3124 is processed by a root level node, and/or is processed via exactly one process by the query execution module 2504. For example, before initiating execution of IO operators, the root level node executes the load coordination operator 3124 to perform the pre-result set generation loading coordination processes 3120.A. Once these are performed and/or once success is determined, the root level node initiates execution of the query itself starting with the IO operators, for example, by sending the query execution plan data to nodes participating in the query execution plan. This root node can later receive the emitted values of the number of rows stored from its child nodes executing the loading operator, and can determine all rows of the entire result set have been stored in pages based on receiving such confirmation from all of its child nodes. The root node can then initiate finalization of the query by performing the post-result set generation loading coordination processes 3120.B.

As illustrated in FIG. 30D, performing the pre-result set generation loading coordination processes 3120.A can include first sending a rights verification request 3141 to the metadata management system 2509. A user privilege verification module 3151 of the metadata management system 2509 can generate and send a rights verification response 3142 to this rights verification request based on accessing user privilege data 3152 to determine whether a corresponding user and/or entity has rights to perform the query and/or to write data into tables of the database system, based on, for example, permissions data 3162 mapped to different user IDs 3161. The rights verification request 3141 can indicate the user ID or type of user, and/or can indicate the type of operations being requested, such as the CTAS, the Insert Into Select, or other instruction to write new rows to the database system. The rights verification response 3142 can indicate whether the rights verification request 3141 was successful or not, based on whether user has rights to execute the query or not.

Alternatively or in addition, the pre-result set generation loading coordination processes 3120.A can include sending a create new table request 3143 to the metadata management system 2509. A table management module 3153 can generate and send a create new table response 3144, for example, based on accessing table metadata to create the new table. The new table can be denoted with a visibility flag 3165 of hidden due to the table not yet being stored as segments. Subsequent queries requesting access to this table with corresponding table ID 3164.T can fail and/or do not access this table while the corresponding visibility flag 3165.T indicates this table is hidden. The create new table response 3144 can indicate whether the create new table request 3143 was successful or not. The create new table request 3143 and create new table response 3144 are optionally only exchanged for CTAS queries, and not for Insert Into Select queries. The create new table request 3143 can indicate a name or other identifier of the new table, a name or other identifier of each column of the new table, and/or a datatype designated for each column of the new table, for example, based on being indicated a CTAS instruction or other parameter of the query. This information can be optionally stored for the corresponding table in table metadata 3154.

Alternatively or in addition, the pre-result set generation loading coordination processes 3120.A can include sending a create storage scope request 3145 to the segment storage system 2508. A scope management module 3041 can generate and send a create storage scope response 3146, for example, based on accessing scope visibility data to create the new storage scope. The new storage scope can be denoted with a visibility flag 3042 of hidden due to the corresponding result set not yet being stored as segments. The scope management module 3041 and/or corresponding scope visibility data can be implemented as discussed in conjunction with FIGS. 29A-29H. The create new storage scope response 3146 can indicate whether the create storage scope request 3145 was successful or not.

Query execution can be initiated once responses to all requests are received and processed, where the query execution module proceeds to result set generation and transmission 3125 for the query. In some cases, this query execution is only initiated if all responses indicate success.

FIG. 30E illustrates a flow of processing these transactional exchanges of FIG. 30D via a rights verification module 3181, a table creation module 3182, and a scope creation module 3183. If any response indicates a corresponding request fails, a query failure management module 3190 is implemented by query execution module 2504 to reverse any creation made thus far (e.g. drop a created table, delete the created storage scope). The query failure management module 3190 is discussed in further detail in conjunction with FIG. 30H.

In other embodiments, requests and responses of FIGS. 30D and 30E can be sent and received in a different ordering than depicted in FIGS. 30D and 30E. While FIG. 30E depicts that each subsequent request is only transmitted once success of the response of a previously received request is determined, in other embodiments, some or all requests are transmitted to their respective entities without first waiting for responses to other requests, where responses may be received at different times in a different ordering than depicted in FIGS. 30D and/or 30E.

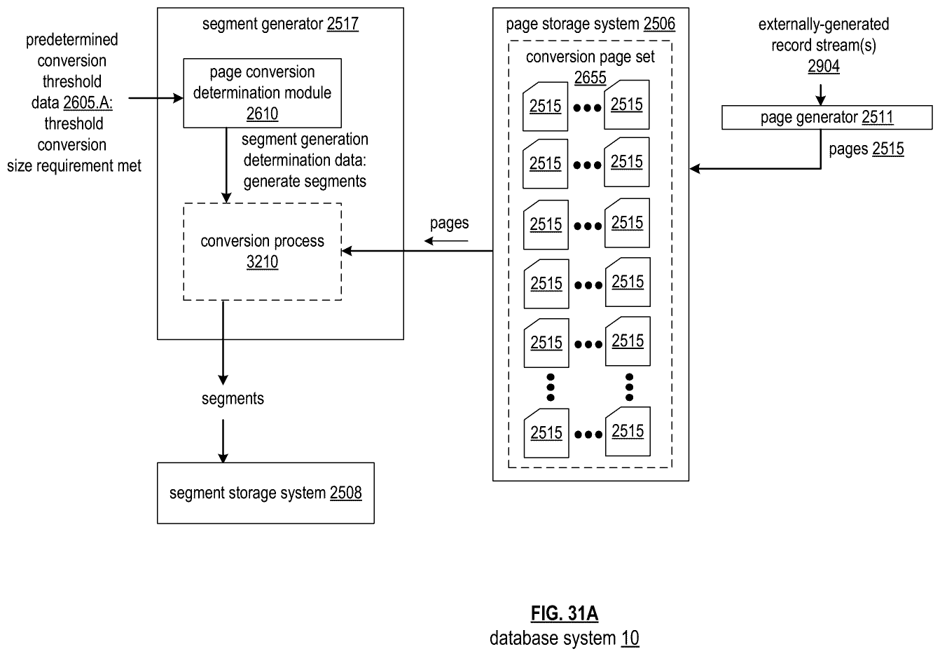

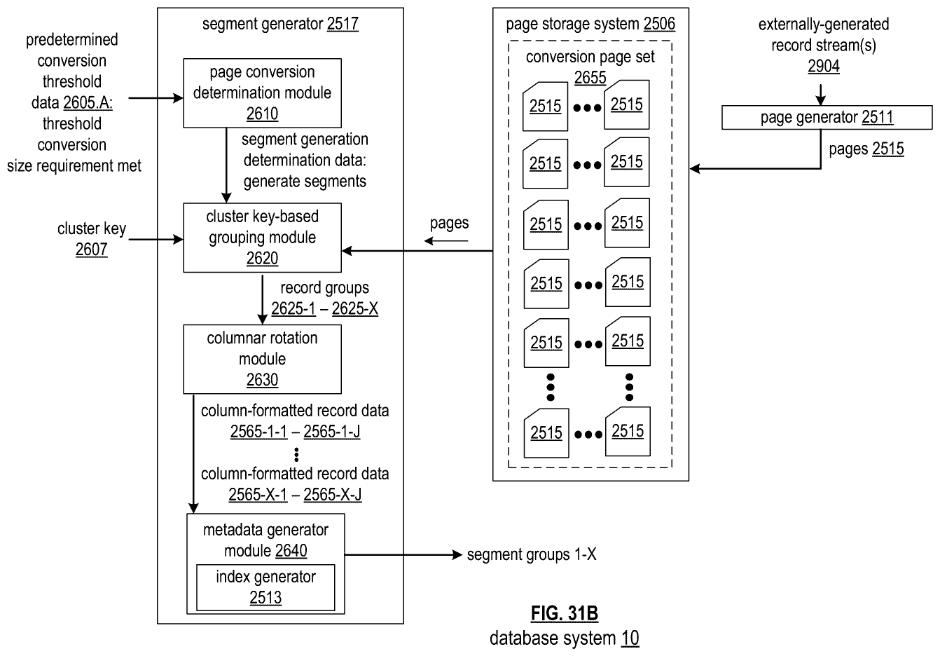

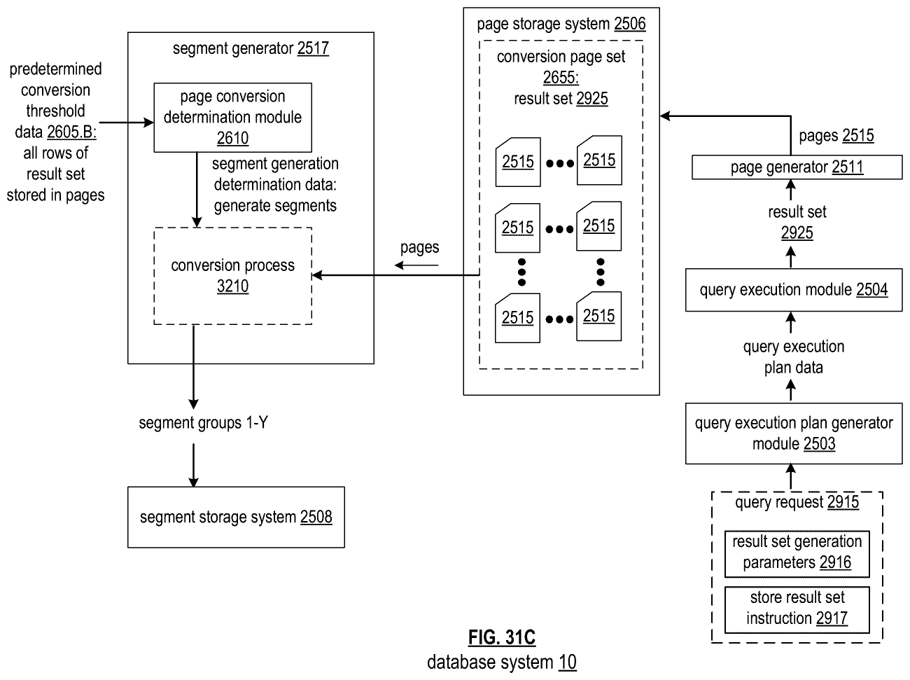

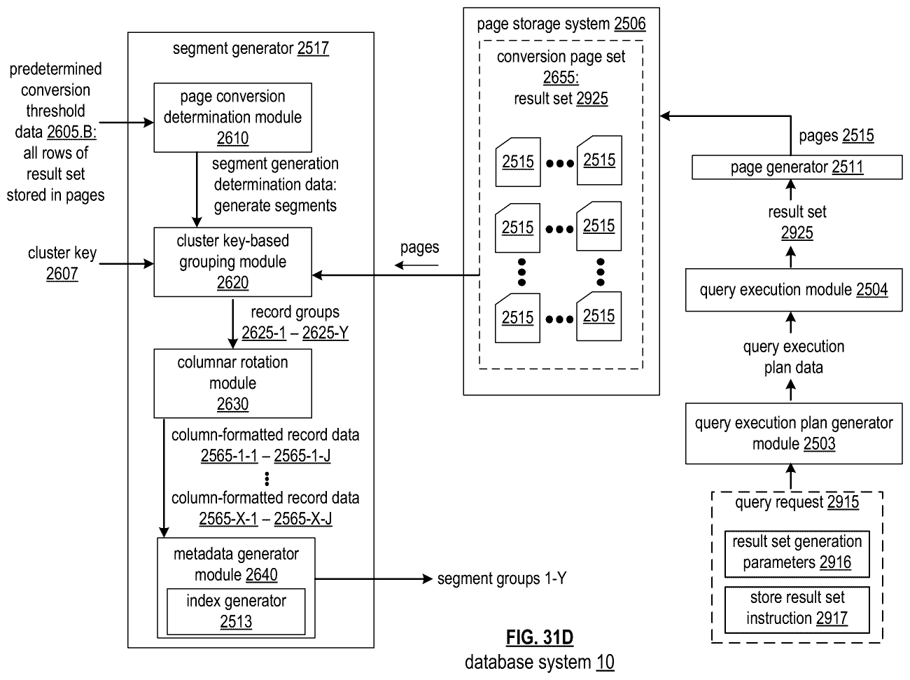

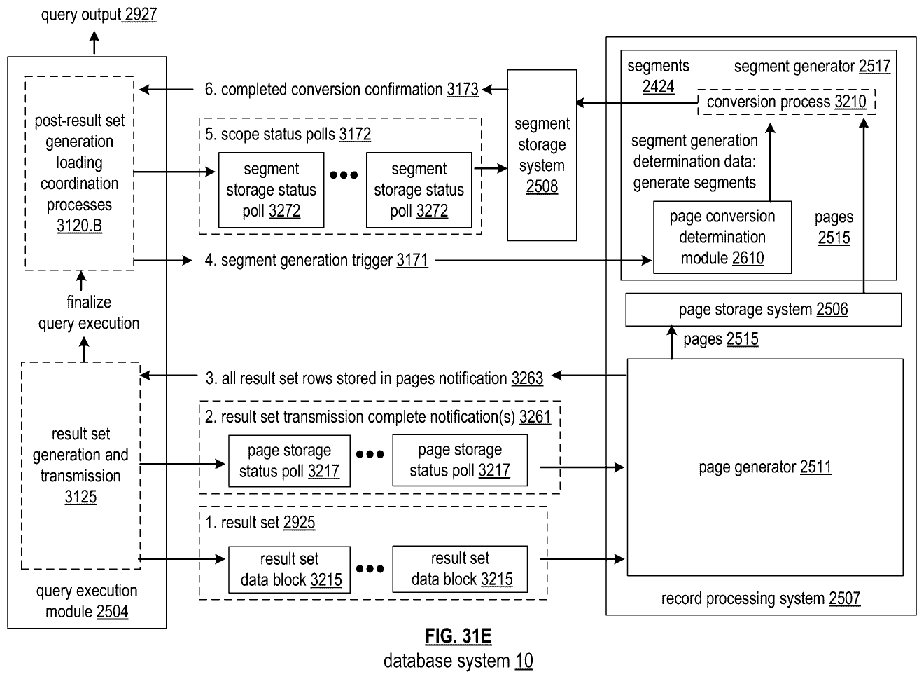

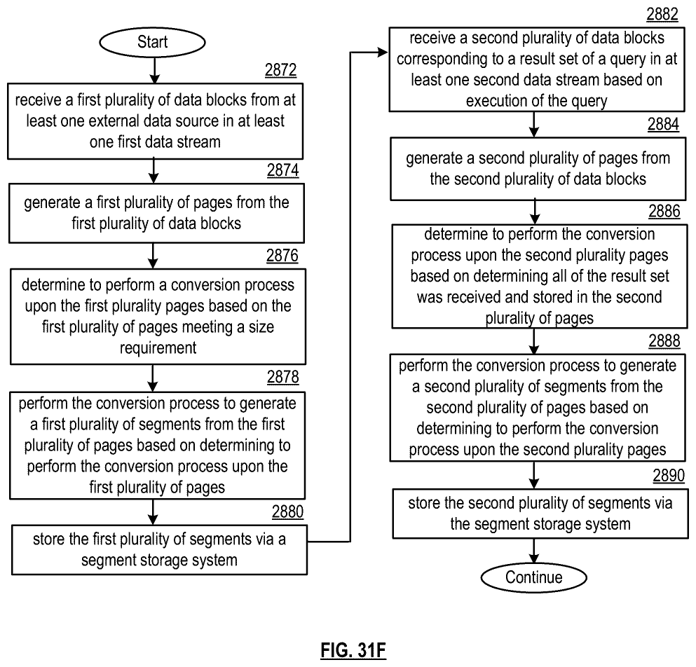

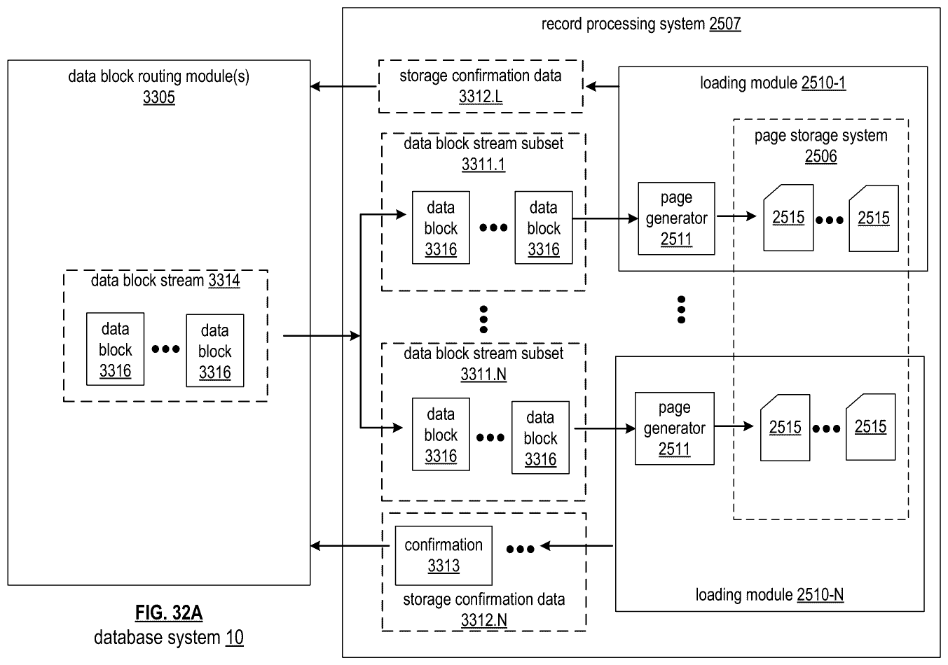

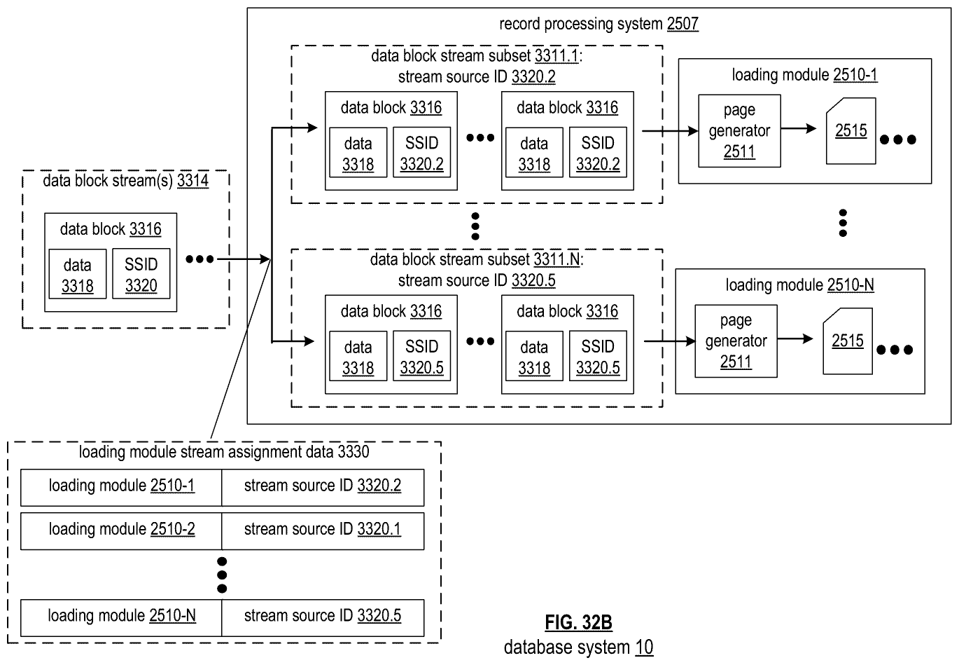

As illustrated in FIG. 30F, performing the post-result set generation loading coordination processes 3120.B can include first sending a segment generation trigger 3171 to the record processing system 2507, which can cause the record processing system to perform the conversion process upon all pages 2515 storing the result set to generate corresponding segments for storage. For example, this segment generation trigger 3171 is not initiated until the result set storage status 3126 indicating that all received data blocks of the result set are stored in pages is received, based on prior execution of loading operator 3127 before finalizing query execution as illustrated in FIG. 30C. The conversion process being initiated when all result set data for the query is included in pages is discussed in further detail in conjunction with FIGS. 31A-31E.

Alternatively or in addition, the post-result set generation loading coordination processes 3120.B can include sending one or more scope status polls 3172, for example, as a stream of status polls over time, such as once every second or another short, fixed time frame, polling the segment storage system 2508 for whether all segments of the scope have been generated from the pages via the conversion process initiated by the segment generation trigger 3171. The scope status polls 3172 can indicate the scope ID 3015 of the corresponding scope created via the create storage scope request 3145. The segment storage system can generate and send completed conversion confirmation 3173 in response, indicating when all segments of the scope have been generated and stored.

Alternatively or in addition, the post-result set generation loading coordination processes 3120.B can include sending a commit scope request 3174 to the segment storage system 2508 to make the scope visible. The commit scope request 3174 can indicate the scope ID 3015 of the corresponding scope created via the create storage scope request 3145. The segment storage system can update the visibility data 3045 in response to change the visibility flag 3042 for the given scope ID 3015 from hidden to visible, for example, in the consensus storage layer, via a data ownership information generation process, and/or by updating data ownership information via execution of a consensus protocol medicated by a plurality of nodes of the segment storage system as discussed in FIGS. 29E and/or 29F.

Alternatively or in addition, the post-result set generation loading coordination processes 3120.B can include sending a make table visible request 3175 to the metadata management system 2509 to make the scope visible. The make table visible request 3175 can indicate the table ID 3164 of the newly created table created in table metadata via the create new table request 3143. The metadata management system 2509 can update the visibility data 3045 in response to change the visibility flag 3165 for the given table ID 3164 from hidden to visible. Subsequent queries requesting access to this table with corresponding table ID 3164.T can be processed successfully and/or can access this table once the corresponding visibility flag 3165.T indicates this table is visible. The make table visible request 3175 is optionally only sent for CTAS queries, and not for Insert Into Select queries.

FIG. 30E illustrates a flow of processing these transactional exchanges of FIG. 30D via a conversion monitoring module 3184, a scope commitment module 3185, and/or a make table visible module 3186. While not depicted in FIG. 30F, the post-result set generation loading coordination processes 3120.B can include waiting for responses to the commit scope request 3174 and/or the make table visible request 3175 to determine whether these requests were processed successfully.

If the execution of the query itself fails in operators of the result set generation and transmission 3125, and/or if any response indicates a corresponding request fails, the query failure management module 3190 can be implemented by query execution module 2504 to reverse any creation made thus far (e.g. drop a created table, delete the created storage scope). The query failure management module 3190 is discussed in further detail in conjunction with FIG. 30H.

If the query execution and all requests are successful, a successful query output module 3186 can be implemented to emit the query output 2927, such as the number of rows created and stored.

In other embodiments, requests and responses of FIGS. 30F and 30G can be sent and received in a different ordering than depicted in FIGS. 30F and 30G. While FIG. 30G depicts that each subsequent request is only transmitted once success of the response of a previously received request is determined, in other embodiments, some or all requests are transmitted to their respective entities without first waiting for responses to other requests, where responses may be received at different times in a different ordering than depicted in FIGS. 30F and/or 30G.

FIG. 30H illustrates a flow implemented via the query failure management module 3190 of FIGS. 30E and/or 30G. If a new table was created via a create new table request 3143 and successful create new table response 3144, a table drop module 3186 can be implemented to send a table drop request 3191 to the metadata management system 2509, and the table management module 3153 can delete the corresponding table from table metadata 3154 accordingly, to reverse the prior creation of this table in the failed query. The table drop request 3191 can indicate the table ID 3164, such as the table name, for the table previously created via the create new table request 3143. The table management module 3153 can further send a table drop response 3192 indicating the corresponding table was deleted from table metadata successfully.

Alternatively or in addition, if anew scope was created via a create storage scope request 3145 and successful create storage scope response 3146, a scope deletion module 3187 can be implemented to send a scope deletion request 3193 to the segment storage system 2508, and the segment storage system 2508 can delete the segments having the corresponding scope identifier accordingly, to reverse the prior creation of this scope in the failed query and/or to reverse creation of any segments generated from the result set. The segment storage system 2508 can further delete the scope identifier and/or corresponding visibility from the scope visibility data managed via the scope management module. The scope deletion request 3193 can indicate the scope ID 3015 for the storage scope previously created via the create storage scope request 3145. The segment storage system 2508 can further send a scope deletion response 3194 indicating the segments of the corresponding scope were deleted from storage successfully.

Determining whether the new table and/or some or all segments of the new scope were created can be based on execution progress data 3189 and/or any other information regarding how far the query progressed before failure and/or whether these actions were required for the query request at all. For example, the drop table request is not sent for a CTAS query if the query execution module did not progress far enough to send a new table request and/or did not receive a new table response confirming creation of the new table. As another example, the scope deletion request is not sent if no segments were generated and stored for the corresponding scope, if no pages were generated for the corresponding scope for eventual conversion into segments, and/or if no scope creation request was sent indicating the upcoming creation of the scope.

FIGS. 31A-31E illustrate embodiments of a database system 10 that triggers segment generation from a set of pages via a conversion process 3210 based on determining all of a fixed-length data set, such as a result set generated via a query execution for storage as new segments, is stored in the conversion page set. Some or all features and/or functionality of the segment generator 2517 and/or corresponding conversion process 3210 of FIGS. 31A-31E can be utilized to implement the segment generator 2517 of FIGS. 28A-28K and/or any other embodiments of the segment generator 2517 and/or conversion process of pages into segments described herein.

As pages are generated and ultimately converted into segments as discussed in conjunction with FIGS. 25A-26C, the corresponding loading process can include delays to potentially wait for more data before proceeding to the next stage. As discussed in conjunction with FIGS. 26A-26C, when loading new data received in record streams over time, it can in fact be advantageous to wait for as many pages as possible before performing segment conversion. However, while this intentional delay can be ideal for loading continuous data stream with no designated end point, such as a record stream received over time from an external data source, over time via multiple conversion processes, if this same process is applied to pages generated from sets of data with a fixed-size, such as query result sets of queries indicating CTAS instructions, Insert Into Select instructions, or other instructions to load the data set, and/or such as fixed sets of data being loaded in bulk rather than in a continuous data stream, the corresponding delays to be able to access the corresponding data can be unideal. In particular, as discussed in conjunction with FIGS. 29A-30I, new result sets can be loaded in an atomic manner, where query access to the corresponding new segments is not activated until the entire result set is loaded into result sets and is available, and/or where query output is not finalized until the storage scope is committed and/or corresponding table is made visible.

Instead of waiting for generation of enough other pages via other data sets prior to performing segment conversion, the well-defined end-of-stream of result sets can be leveraged to initiate the segment generation process once all corresponding data has been loaded into pages. This improves the technology of database systems by reducing delays in corresponding query executions, where these queries can be finalized sooner and the new rows generated via these query executions can be access in subsequent query executions sooner, preventing additional timeouts before completion and unnecessarily increases to overall runtime induced via delaying the page conversion process.

For example, once all data has been sent to the record processing system, the load operator can indicate that each stream is completed on its indexer status polls. Upon receiving the stream completed notification, one or more loading modules of record processing system will flush all data for the streams to durable pages. Once all data is in pages, the load operator can notify end of file (EOF) to the query execution module, and/or a corresponding virtual machine. Upon receiving EOF, the load coordinator can trigger a segment drain on all loading modules involved in the for the data in the result set scope. The load coordinator can wait for the segment drain to complete before it finalizes the query. It can do so by polling the status of the scope in the storage layer each second. Once it sees that all pages in the scope have been converted to segments, it can complete the query.

FIG. 31A illustrates an embodiment of a segment generator that generates a set of segments from pages in a conversion page set 2655 of a page storage system that were generated from one or more externally-generated record streams 2904 and/or other record streams with no fixed size and/or with no well-defined end-of-stream. A page conversion determination module 2610 of the segment generator 2517 can utilize predetermined conversion threshold data 2605.A to determine when to initiate a corresponding conversion process 3210. The predetermined conversion threshold data 2605.A can be utilized instead of predetermined conversion threshold data 2605.B of FIGS. 31C and 31D in this case based on the pages includes data of the externally-generated record streams 2904 and/or the other record streams with no fixed size and/or with no well-defined end-of-stream. The predetermined conversion threshold data 2605.A can indicate a threshold conversion size requirement, that, when met by the conversion page set 2655 as pages are added over time, triggers the performance of the conversion process 3210. For example, the page conversion determination module 2610 of the segment generator 2517 of FIG. 31A is implemented as discussed in conjunction with FIGS. 26A-26C.

The threshold conversion size requirement can correspond to a threshold minimum number of bytes, threshold minimum number of pages, threshold maximum amount of remaining storage resources, or other threshold dictating that the conversion process be performed once the amount of pages is sufficiently large, and/or as large as possible to not induce memory overflow and/or failures. The threshold conversion size requirement can be fixed or can change over time based on various factors such as changes in memory availability of the page storage system.

FIG. 31B illustrates an example embodiment of the segment generator 2517 of FIG. 31A generating segments once the predetermined conversion threshold data 2605.A is met. The cluster key-based grouping module 2620, the columnar rotation module 2630, and/or the metadata generator module 2640 of the segment generator 2517 of FIG. 31B can be implemented in a same or similar fashion as discussed in conjunction with FIG. 26A.

FIG. 31C illustrates different behavior of the segment generator 2517 for determining to perform the conversion process 3210 for pages storing a result set 2925 generated via a query execution of a query request indicating a corresponding store result set instruction 2917, and/or for pages storing other record streams with a fixed size and/or with a well-defined end-of-stream. In particular, the page conversion determination module 2610 of the segment generator 2517 can instead utilize predetermined conversion threshold data 2605.B to determine when to perform the conversion process, based on The predetermined conversion threshold data 2605.A can be utilized instead of the predetermined conversion threshold data 2605.A of FIGS. 31A and 31B in this case based on the pages including data of the a result set 2925 and/or the other record streams with a fixed size and/or with a well-defined end-of-stream. The predetermined conversion threshold data 2605.B can indicate that the performance of the conversion process 3210 be triggered once all rows of the result set, or other fixed size data set with a well-defined end, are stored in pages. Thus, the conversion process 3210 can be performed upon a conversion page set 2655 that does not meet the threshold conversion size requirement of the predetermined conversion threshold data 2605.A, based on the predetermined conversion threshold data 2605.B being enforced rather than the predetermined conversion threshold data 2605.A being enforced.

FIG. 31D illustrates an example embodiment of the segment generator 2517 of FIG. 31C generating segments once the predetermined conversion threshold data 2605.B is met, and/or once a corresponding trigger to initiate the segment conversion process is otherwise received. The cluster key-based grouping module 2620, the columnar rotation module 2630, and/or the metadata generator module 2640 of the segment generator 2517 of FIG. 31D can be implemented in a same or similar fashion as discussed in conjunction with FIG. 26A and/or FIG. 31B.

FIG. 31E illustrates an embodiment of initiating a page conversion process based on determining all of a result set is stored in pages during a corresponding query execution. Some or all features and/or functionality of the query execution module 2405 of FIG. 31E can implement the query execution module 2405 of FIGS. 28H, 30A-30H, and/or any other embodiment of the query execution module 2405 discussed herein. or all features and/or functionality of the record processing system 2507 of FIG. 31E can implement the record processing system 2507 of FIG. 28H, FIGS. 31A-31D, and/or any other embodiment of the record processing system 2507 described herein.

The result set generation and transmission 3125 performed by a query execution module executing a query with a store result set instruction can include sending a plurality of result set data blocks 3215 of result set 2925 to the record processing system 2507 for processing by the page generator. The sending of the result set 2925 can be performed and/or initiated based on executing the loading operator 3127 in a corresponding query operator execution flow 3115. The result set data blocks 3215 can be implemented as column-major formatted data blocks 2918 of one or more column data streams 2931 as discussed in conjunction with FIG. 28J.

As the page generator 2511 receives result set data blocks 3215, pages 2515 can be generated accordingly. In some embodiments, a set of loading modules each receive respective subsets of the plurality of result set data blocks sent by one or more nodes of the query execution module, where each loading module 2510 can be operable to generate and/or store its own pages from data blocks of the result set.

An end of the result set 2925 can be indicated to the record processing system 2507 by an end-of-stream data block following the result set data blocks, such as in each column stream, and/or by receiving a page storage status polls 3217.

Once all of the result set is transmitted, the result set generation and transmission 3125 performed by a query execution module can include sending result set transmission complete notifications 3261, such as a plurality of page storage status polls 3217 sent over time, such as once a second or other time frame, to poll whether all of the result set data blocks are stored in pages by one or more loading modules 2510 of the page generator 2511 processing the result set data blocks 3215 of the result set. For example, the page storage status polls 3217 are sent every second, or in another time frame. Alternatively, a single request to notify when page storage is complete is sent. result set data blocks 3215 where each loading module 2510 can be operable to generate its own pages from data blocks of the result set.

Once the page generator 2511 stores all of the emitted result set data blocks of the result set 2925 as pages 2515 in the page storage system 2506, the record processing system 2507 can send an all result set rows stored in pages notification 3263. The record processing system 2507 can respond to every poll, where a first set of responses indicate that not every record is yet stored, and where the record processing system 2507 ultimately sends the all result set rows stored in pages notification 3263 indicating that all result set rows have been stored in pages. Alternatively, the record processing system 2507 only responds with the all result set rows stored in pages notification 3263, once storage of all records in pages is complete. The all result set rows stored in pages notification 3263 can implement the result set storage status 2926 of FIG. 28H. The all result set rows stored in pages notification 3263 can optionally be received from one or more given loading modules 2510 generating pages from their respective data blocks of the stream.

Once the result set generation and transmission 3125 processes receive the all result set rows stored in pages notification 3263, the query execution can be finalized. For example, a corresponding node forwards the number of rows stored to the root node. Finalization of the query can otherwise be initiated.

The post-result set generation loading coordination processes 3120.B can be performed to send the segment generation trigger 3171. The page conversion determination module 2610 can be operable to treat this segment generation trigger 3171 as an indication that the predetermined conversion threshold data 2605.B of FIGS. 31C and 31D is met, and/or the segment generation trigger 3171 can override the enforcement of the threshold size requirement of predetermined conversion threshold data 2605.A to trigger segment generation “early” due to the pages having the complete result set.

Based on receiving the segment generation trigger 3171 and thus determining that the predetermined conversion threshold data 2605.B has been met, the conversion process 3210 can be initiated. This can optionally include converting only pages of the page storage system belonging to the corresponding result set, such as pages tagged with the corresponding scope identifier or otherwise being determined to belong to the result set, where other pages are optionally not yet converted in this conversion process. This can optionally include notifying all loading modules 2510 of the page storage system 2511 that generated pages 2515 to flush their pages for segment generation.

As segments are generated via the segment generator 2517 performing the conversion process, they can be stored via the segment storage system 2508. Once the segment generation trigger 3171 is sent via the post-result set generation loading coordination processes 3120.B, the post-result set generation loading coordination processes 3120.B can further include sending scope status polls 3172, such as a stream of segment storage status polls 3272 to the segment storage system 2508 over time, such as once a second or other time frame.

Once the segment generator 2517 completes the conversion process to generate and store all segments converted from the set of pages storing the result set via the segment storage system 2508, segment storage system 2508 can send a completed conversion confirmation 3173. This can include utilizing the scope management module 3041 to identify the stored segments in the set and/or determine whether all segments are stored. The segment generator 2517 can optionally send a notification to the segment storage system 2508 indicating all generated segments for the conversion process have been sent, utilized by the segment storage system 2508 to determine whether all segments for the scope are durably stored.

The segment generator 2517 can respond to every poll, where a first set of responses indicate that not every segment is yet stored, and where the segment generator 2517 ultimately sends the completed conversion confirmation 3173 indicating that pages including all result set rows have been converted into segments stored by the segment storage system. Alternatively, the record processing system 2507 only responds with the completed conversion confirmation 3173, once generation and storage of all segments is complete.

Some or all features and/or functionality of the query execution module 2405 of FIG. 31E can be performed collectively by a plurality of nodes, for example, each executing their own query operator execution flow 2433 to generate portions of the result set that are sent to record processing system. For example, the result set generation and transmission 3125 is performed by a plurality of nodes, such as inner level nodes at an inner level immediately before the root level of a query execution plan, each generating and sending result sets to the record processing system, and each polling the record processing system for storage status. Some or all of the features and/or functionality of the query execution module 2405 of FIG. 31E can be performed by a single node and/or by a single entity. For example, the post-result set generation loading coordination processes 3120.B are performed by a single node, such as the root level node at the root level of a query execution plan, to ensure segment generation is triggered exactly once. Finalization of the query and initiation of the post-result set generation loading coordination processes 3120.B can be performed only once the number of stored rows, and/or or other confirmation of the respective portion of the result set being stored in pages confirmation, is received from all child nodes responsible for sending result set data blocks for storage.

FIG. 30I illustrates a method for execution by at least one processing module of a database system 10. Some or all of the method of FIG. 30I can be performed by the query execution module 2504, for example, based on communicating with the segment storage system 508, the metadata management system 2509, and/or the record processing system 2507. Some or all steps of FIG. 30I can be performed by any one or more processing modules database system 10 in accordance with other embodiments of the database system 10 discussed herein.

In some embodiments, the database system 10 can utilize at least one processing module of one or more nodes 37 of one or more computing devices 18, where the one or more nodes execute operational instructions stored in memory accessible by the one or more nodes, and where the execution of the operational instructions causes the one or more nodes 37 to execute, independently or in conjunction, the steps of FIG. 30I. As a particular example, a node 37 can execute some or all of the steps of FIG. 30I, where multiple nodes 37 independently execute some or all step some or all the steps of FIG. 30I, for example, to facilitate execution of a query as participants in a query execution plan 2405. Some or all steps of FIG. 30I can be performed in conjunction with performing some or all steps of FIG. 28O. Some or all steps of FIG. 30I can be performed in conjunction with performing any other method described herein.

Step 2842 includes determining a query for execution indicating parameters for generating a result set, and further indicating an instruction to store the result set. Step 2844 includes executing the query.

Performing step 2844 can include performing some or all of steps 2846, 2848, 2850, 2852, 2854, and/or 2856. Step 2846 includes sending a first set of requests based on the query indicating the instruction to store the result set. Step 2848 includes processing a first set of responses received for the first set of requests to determine success of the first set of requests. Step 2850 includes, in response to determining success of the first set of requests, executing a plurality of query operators corresponding to generating the result set. Step 2852 includes, in response to sending the set of rows to a record processing system for storage, sending a second set of requests based on the query indicating the instruction to store the result set. Step 2854 includes processing a second set of responses received for the second set of requests to determine success of the second set of requests. Step 2856 includes, in response to determining success of the second set of requests, finalizing the query by sending query output for the query.

Performing step 2850 can include performing some or all of steps 2858, 2860, and/or 2862. Step 2858 includes accessing a plurality of rows via the segment storage system based on the parameters. Step 2860 includes processing the plurality of rows based on the parameters to generate a set of rows as the result set. Step 2862 includes sending the set of rows to a record processing system for storage.

In various embodiments, the first set of requests include at least one request to a metadata management system, where the first set of responses include at least one response received from the metadata management system corresponding to the at least one request. In various embodiments, the first set of requests include at least one request to a segment storage system, where the first set of responses include at least one response received from the segment storage system corresponding to the at least one request. In various embodiments, the first set of requests includes a create new table request, a rights verification request, and/or a create storage scope request. In various embodiments, the first set of requests are sent in a serialized ordering, where each subsequent one of the first set of requests is sent based on determining success is indicated by all received ones of the first set of responses for the previously sent ones of the first set of requests.

In various embodiments, the second set of requests include at least one request to a metadata management system, where the second set of responses include at least one response received from the metadata management system corresponding to the at least one request. In various embodiments, the second set of requests include at least one request to a segment storage system, where the second set of responses include at least one response received from the segment storage system corresponding to the at least one request. In various embodiments, the second set of requests include at least one of: a segment generation trigger, at least one scope status poll, a commit scope request, or a make table visible request. In various embodiments, the second set of requests are sent in a serialized ordering, where each subsequent one of the second set of requests is sent based on determining success is indicated by all received ones of the second set of responses for the previously sent ones of the second set of requests.

In various embodiments, executing the query includes executing a loading coordination operator included in accordance with query operator execution flow that includes the loading coordination operator serially before the plurality of query operators. The loading coordination operator can be included in the query operator execution flow based on the query indicating the instruction to store the result set. The sending of the first set of requests, the processing of the first set of responses are processed, the sending of the second set of requests, and/or the processing of the second set of responses can be based on executing of the loading coordination operator.

In various embodiments, the method further includes determining a second query for execution indicating second parameters for generating a second result set, and further indicating the instruction to store the second result set. The second query can be executed based on: sending another first set of requests based on the second query indicating the instruction to store the second result set; processing another first set of responses received for the another first set of requests to determine failure of at least one of the another first set of requests; and/or terminating the execution of the query by foregoing executing a second plurality of query operators corresponding to generating the second result set based on determining the failure of the at least one of the another first set of requests.

In various embodiments, one of the another first set of requests is a create new table request. A corresponding one of the another first set of requests can indicate the create new table request is successful. The method can further include sending a drop table request to undo the create new table request based on determining failure of the at least one of the another first set of requests, where the at least one of the another first set of requests is distinct from the at least one of the another first set of requests.

In various embodiments, the method further includes determining a second query for execution indicating second parameters for generating a second result set, and further indicating the instruction to store the second result set. The method can further include executing the second query based on: sending another first set of requests based on the second query indicating the instruction to store the second result set; processing another first set of responses received for the another first set of requests to determine success of the another first set of requests; in response to determining success of the another first set of requests, initiating execution a second plurality of query operators corresponding to generating the second result set; determining a failure in executing at least one of the second plurality of query operators; and, in response to determining the failure, sending at least one additional request to undo at least one of the another first set of requests, and/or storage of any ones of the second result set based on initiating execution a second plurality of query operators.

In various embodiments, the another first set of requests includes a create new table request. The at least one additional request can include a drop table request to undo the create new table request.

In various embodiments the another first set of requests includes a create storage scope request, and wherein a scope identifier is created for the second result set based on the storage scope request. Initiating execution of the second plurality of query operators can include sending at least one row of second result set to the record processing system for storage indicating the scope identifier. The record processing system can generate at least one segments from the at least one row indicating the scope identifier. The at least one segment can be stored by a segment storage system based on being generated by the record processing system;

In various embodiments, the at least one additional request further includes a scope deletion request indicating the scope identifier to facilitate deletion of the at least one segment by the segment storage system based on the segment storage system deleting only ones of a plurality of segments stored by the segment storage system having the scope identifier.

In various embodiments, initiating execution a second plurality of query operators includes sending at least one row of the second result set to the record processing system for storage, where the record processing system generates at least one segment from the at least one row, and/or where the at least one segment is stored by a segment storage system based on being generated by the record processing system. In various embodiments, the another first set of requests includes a create storage scope request, and/or the at least one additional request further includes a scope deletion request to delete the at least one segment.

In various embodiments, the method further includes determining a second query for execution indicating second parameters for generating a second result set, and further indicating the instruction to store the second result set. The second query can be executed based on: sending another first set of requests based on the second query indicating the instruction to store the second result set; processing another first set of responses received for the another first set of requests to determine success of the another first set of requests; in response to determining success of the another first set of requests, executing a second plurality of query operators corresponding to generating the second result set based on accessing a second plurality of rows via the segment storage system based on the second parameters, processing the second plurality of rows based on the second parameters to generate a second set of rows as the result set, and/or sending the second set of rows to a record processing system for storage; in response to sending the set of rows to a record processing system for storage, sending another second set of requests based on the second query indicating the instruction to store the result set; processing a second set of responses received for the second set of requests to determine a failure of at least one of the second set of requests; and/or in response to determining failure of the second set of requests, sending at least one additional request to undo at least one: at least one of the another first set of requests, or the storage of second set of rows.

In various embodiments the another first set of requests includes a create new table request, and wherein the at least one additional request includes a drop table request to undo the create new table request.

In various embodiments, the another first set of requests includes a create storage scope request, and a scope identifier is created for the second result set based on the storage scope request. Executing of the second plurality of query operators can include sending the second result set to the record processing system for storage indicating the scope identifier, where the record processing system generates a set of segments from the second result set indicating the scope identifier, and/or where the set of segments is stored by a segment storage system based on being generated by the record processing system. The at least one additional request can further include a scope deletion request indicating the scope identifier to facilitate deletion of the set of segments by the segment storage system based on the segment storage system deleting only ones of a plurality of segments stored by the segment storage system having the scope identifier.

In various embodiments, executing the query includes: sending a set of requests to a metadata management module based on the query; and receiving a set of responses to the set of requests from the metadata management module; where he plurality of rows are accessed and processed based on set of requests being determined to be successful based on the set of responses.

In various embodiments, the query is requested for execution by a corresponding user, where the instruction indicates a request to generate and store a new database table, and where the set of requests include: a rights verification request, where the set of responses includes a rights verification response generated and sent by the metadata management module based on determining whether the corresponding user has permission to generate and store a new set of rows; a create table request, where the set of responses includes a create table response generated and sent the metadata management module based on creating a corresponding new table in system metadata; and/or a create storage scope request, where the set of responses includes a storage scope response generated and sent the segment storage system based on creating a storage scope for the corresponding new set of rows.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 30I described above.

In various embodiments, a query execution module includes at least one processor and at least one memory storing operational instructions. The operational instructions, when executed by the at least one processor, can cause the database system to perform some or all steps of FIG. 30I. The operational instructions, when executed by the at least one processor, can cause the database system to: determine a query for execution, where the query indicates parameters for generating a result set, and further indicates an instruction to store the result set. The operational instructions, when executed by the at least one processor, can further cause the database system to execute the query. Executing the query can be based on: sending a first set of requests based on the query indicating the instruction to store the result set; processing a first set of responses received for the first set of requests to determine success of the first set of requests; in response to determining success of the first set of requests, executing a plurality of query operators corresponding to generating the result set; in response to sending the set of rows to a record processing system for storage, sending a second set of requests based on the query indicating the instruction to store the result set; processing a second set of responses received for the second set of requests to determine success of the second set of requests; and, in response to determining success of the second set of requests, finalizing the query by sending query output for the query. Executing the plurality of query operators corresponding to generating the result set can include accessing a plurality of rows via the segment storage system based on the parameters; processing the plurality of rows based on the parameters to generate a set of rows as the result set; and sending the set of rows to a record processing system for storage.

FIG. 31F illustrates a method for execution by at least one processing module of a database system 10. Some or all of the method of FIG. 31F can be performed by the record processing and storage system 2506, the record processing system 2507 and/or the segment storage system 2508. Some or all steps of FIG. 30I can be performed by any one or more processing modules database system 10 in accordance with other embodiments of the database system 10 discussed herein.

In some embodiments, the database system 10 can utilize at least one processing module of one or more loading modules 2510 of a record processing and storage system 2505 and/or of one or more nodes 37 of one or more computing devices 18, where the one or more nodes and/or loading modules execute operational instructions stored in memory accessible by the one or more nodes and/or loading modules, and where the execution of the operational instructions causes the one or more nodes 37 and/or loading modules to execute, independently or in conjunction, the steps of FIG. 31F. As a particular example, a loading module 2510 can execute some or all of the steps of FIG. 31F, where multiple loading modules independently execute some or all step some or all the steps of FIG. 31F, for example, to collectively generate segments from pages for storage via conversion processes. Some or all steps of FIG. 31F can be performed in conjunction with performing some or all steps of FIGS. 28L, 28M, 28P and/or 28Q. Some or all steps of FIG. 31F can be performed in conjunction with performing any other method described herein.

Step 2872 includes receiving a first plurality of data blocks from at least one external data source in at least one first data stream. Step 2874 includes generating a first plurality of pages from the first plurality of data blocks. Step 2876 includes determining to perform a conversion process upon the first plurality pages based on the first plurality of pages meeting a size requirement. Step 2878 includes performing the conversion process to generate a first plurality of segments from the first plurality of pages based on determining to perform the conversion process upon the first plurality of pages. Step 2880 includes storing the first plurality of segments via a segment storage system.

Step 2882 includes receiving a second plurality of data blocks in at least one second data stream corresponding to a result set of a query based on execution of the query. Step 2884 includes generating a second plurality of pages from the second plurality of data blocks. Step 2886 includes determining to perform the conversion process upon the second plurality pages based on determining all of the result set was received and stored in the second plurality of pages. Step 2888 includes performing the conversion process to generate a second plurality of segments from the second plurality of pages based on determining to perform the conversion process upon the second plurality pages. Step 2890 includes storing the second plurality of segments via the segment storage system.

In various embodiments, the second plurality of pages can fall below the size requirement, and the conversion process is determined to be performed upon the second plurality pages despite falling below the size requirement, due to determining the second plurality of pages includes a complete result set.

In various embodiments, the second plurality of data blocks are generated via a query execution module. The method can further include generating this second plurality of data blocks by implementing the query execution module, where the method is executed by the database system 10 as a whole. Alternatively, the method can further include receiving this second plurality of data blocks by communicating with the query execution module, where the method is executed by the record processing and storage system 2506. In various embodiments, the second plurality of data blocks are generated based on at least one of the first plurality of data blocks being accessed via the segment storage system during execution of the query.

In various embodiments, the method further includes determining the at least one first data stream does not have a specified end, and/or determining to enforce the size requirement in determining to perform the conversion process for the first plurality of pages based on the determining the at least one first data stream does not have the specified end. In various embodiments, the method further includes determining the second plurality of data blocks has a specified end based on the second plurality of data blocks corresponding to the result set, and/or determining not to enforce the size requirement in determining to perform the conversion process for the second plurality of pages based on the determining the second plurality of data blocks have the specified end.

In various embodiments, determining to perform the conversion process upon the second plurality pages is based on determining the specified end of the at least one second data stream has been received and stored as a final at least one data block in at least one of the second plurality of pages.

In various embodiments, the method further includes receiving a subsequent plurality of data blocks via the at least one first data stream after performing the conversation process upon the first plurality of data blocks based on the at least one first data stream not having the specified end. The method can further include generating a subsequent plurality of pages from the subsequent plurality of data blocks. The method can further include determining to perform a conversion process upon the subsequent plurality pages based on determining to enforce the size requirement for the at least one first data stream and based on the subsequent plurality of pages meeting the size requirement. The method can further include performing the conversion process to generate a subsequent plurality of segments from the subsequent plurality of pages based on determining to perform the conversion process. The method can further include storing the subsequent plurality of segments via the segment storage system.

In various embodiments, the first plurality of data blocks is received over a first temporal period, the second plurality of data blocks is received over a second temporal period, and the first temporal period overlaps with the second temporal period. The method can further include determining to perform the conversion process upon pages generated from the at least one second data stream separately from performing the conversion process upon pages generated from the at least one first data stream based on the from the at least one second data stream having the specified end. The method can further include generating the separate plurality of pages separately from the first plurality of pages based on determining to perform the conversion process upon pages generated from the at least one second data stream separately from performing the conversion process upon pages generated from the at least one first data stream.

In various embodiments, the method further includes receiving a third plurality of data blocks corresponding to a result set of a second query in at least one third data stream based on execution of the second query; generating a third plurality of pages from the third plurality of data blocks, where at least one first subset of the first plurality of pages is generated prior to a remaining subset of the first plurality of pages; determining to perform the conversion process upon the at least one first subset of the third plurality pages based on determining the at least one first subset of the third plurality pages meet the size requirement; performing the conversion process upon the at least one first subset to generate at least one third plurality of segments from the at least one first subset of the third of pages based on determining to perform the conversion process upon the at least one first subset of the third plurality pages; storing the third plurality of segments via a segment storage system; determining to perform the conversion process upon the remaining subset of the third plurality pages based on determining all of the result set is included in a union of the first subset of the third plurality pages and the remaining subset of the third plurality pages include all of the result set, where the remaining subset of the third plurality pages does not meet the size threshold; performing the conversion process to generate a remaining plurality of segments from the remaining subset of the third plurality of pages based on determining to perform the conversion process upon the remaining subset of the third plurality pages; and/or storing the remaining plurality of segments via the segment storage system.

In various embodiments, determining all of the result set was received and stored in the second plurality of pages is based on receiving at least one notification from a query execution module that all data blocks for the result set were sent in the at least one second data stream. In various embodiments, the method further includes, in response to receiving the at least one notification, determining whether all data blocks received in the at least one second data stream have been stored in pages of the second plurality of pages. The method can further include transmitting a confirmation that all data blocks received in the at least one second data stream are stored in pages based on determining all data blocks received in the at least one second data stream have been stored in the pages of the second plurality of pages. The method can further include receiving a segment generation trigger from the query execution module, wherein the query execution module sent the segment generation trigger based on the query execution module receiving the confirmation that all data blocks received in the at least one second data stream are stored in pages. The conversion process can be performed upon the second plurality of pages based on receiving the segment generation trigger.

In various embodiments, the at least one notification is received in a plurality of status polls sent by the query execution module. Confirmation that all data blocks received in the at least one second data stream are stored in pages can be sent in response to one of the plurality of status polls once all data blocks received in the at least one second data stream have been determined to be stored in the pages of the second plurality of pages. For prior times corresponding to other ones of the plurality of status polls prior to the one of the plurality of status polls, it can be determined that not all data blocks received in the at least one second data stream are yet stored in the pages of the second plurality of pages.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 30I described above.

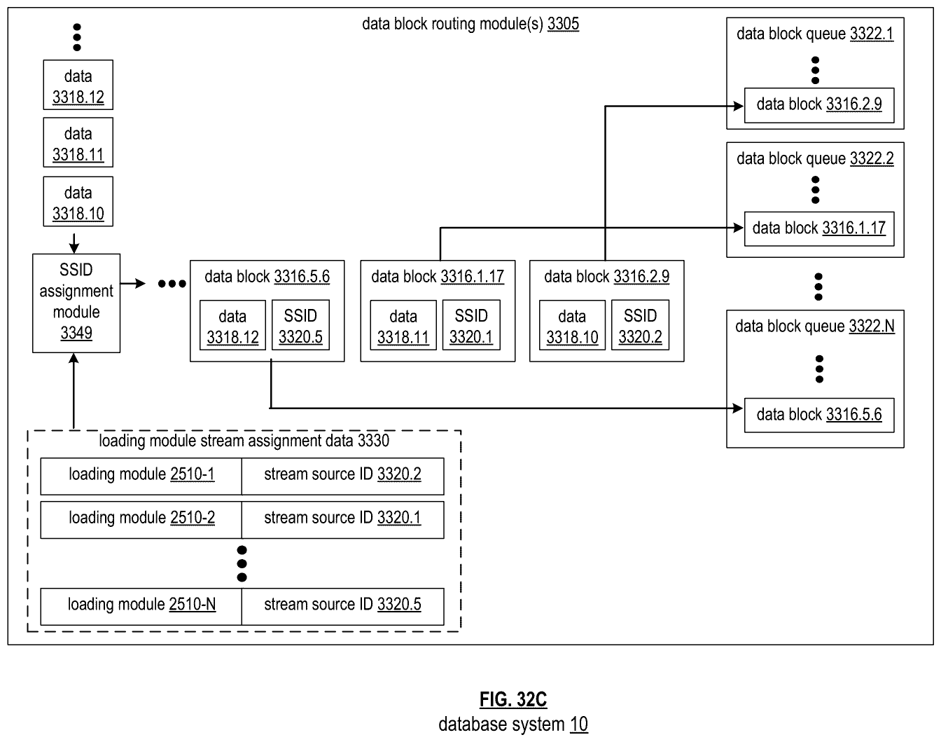

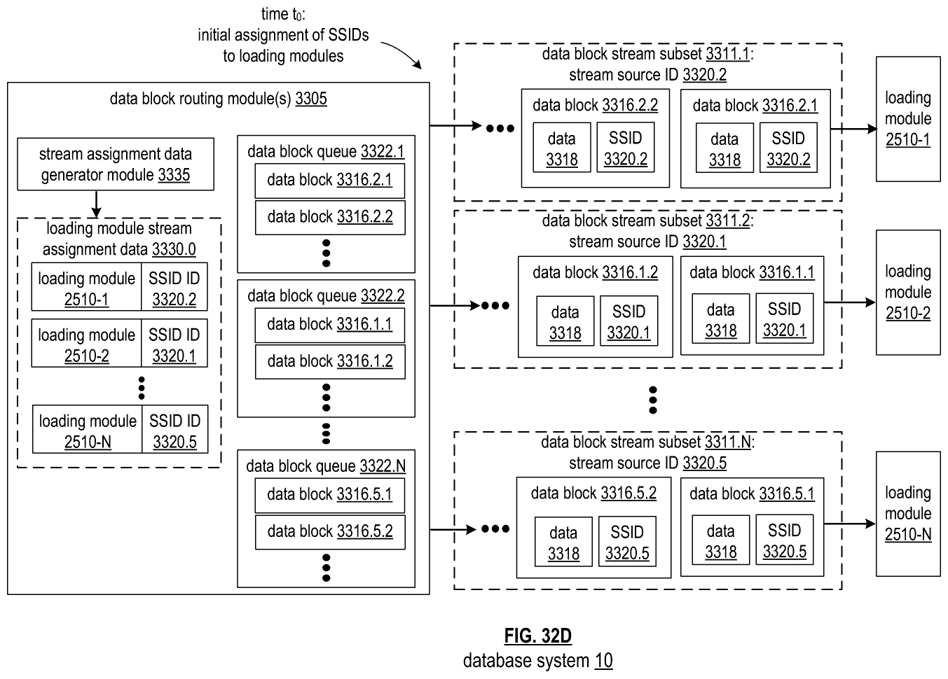

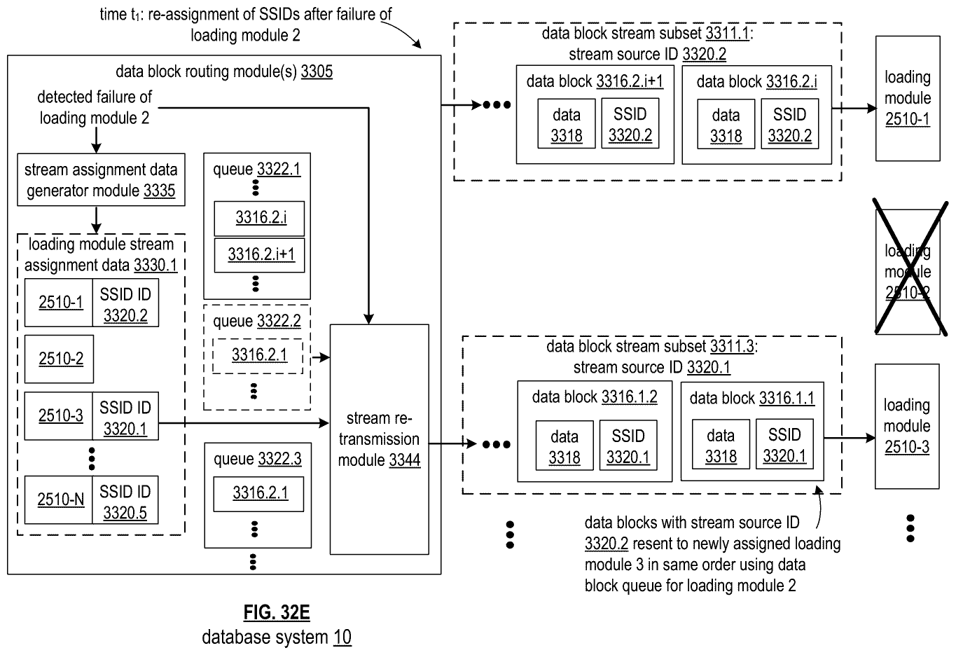

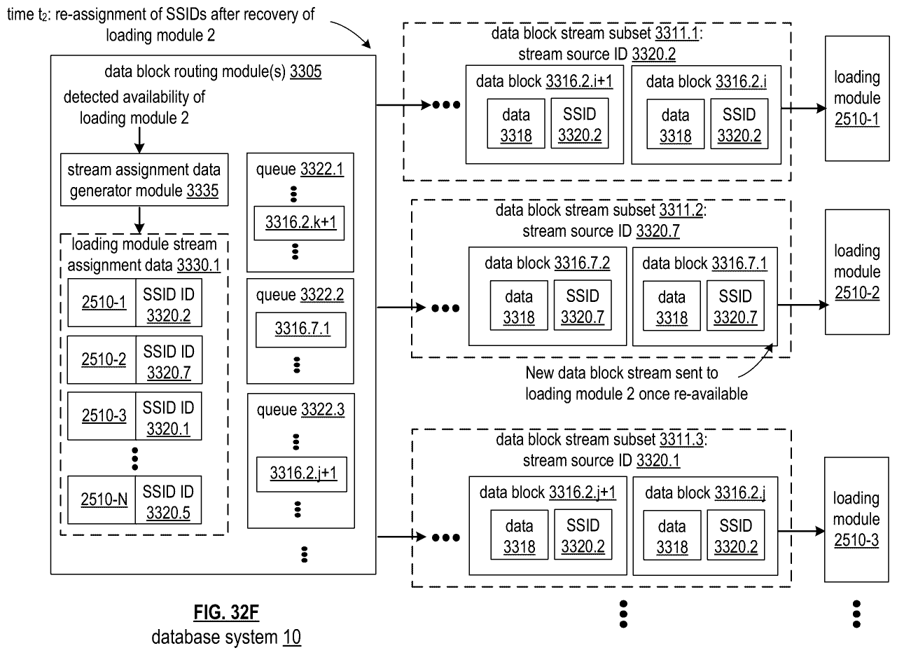

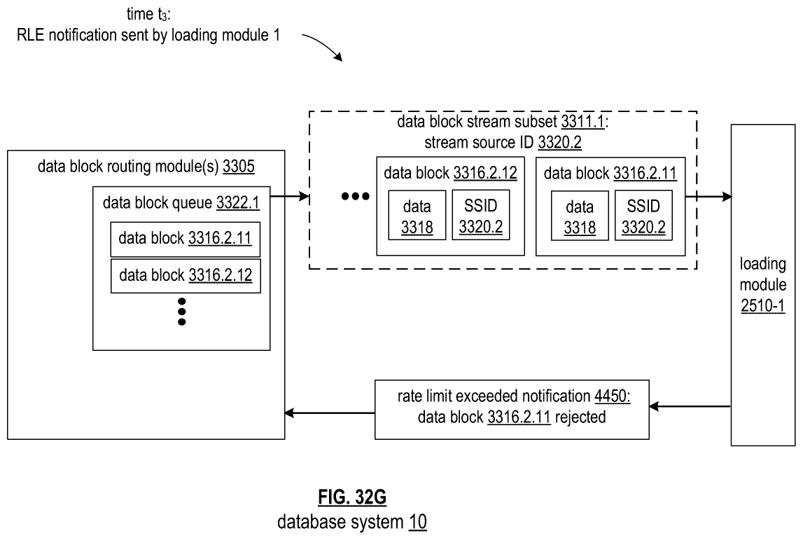

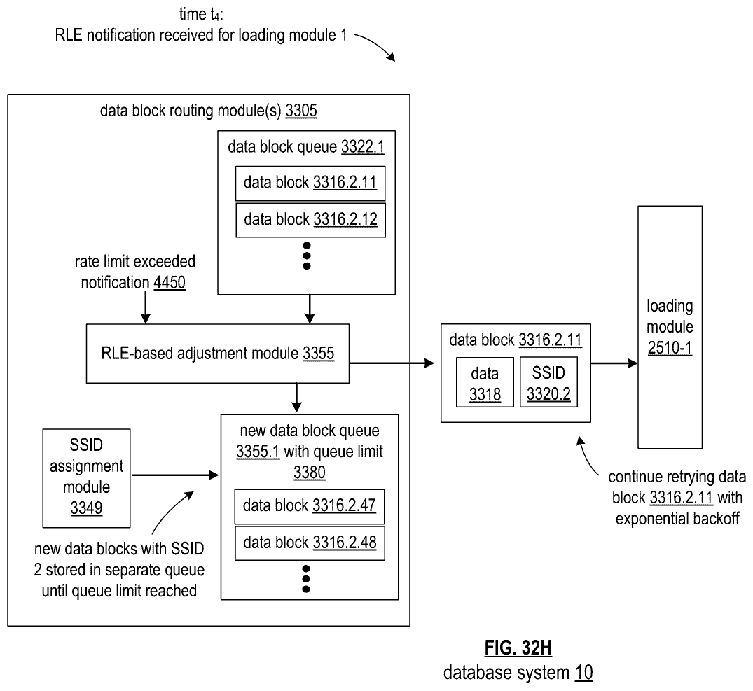

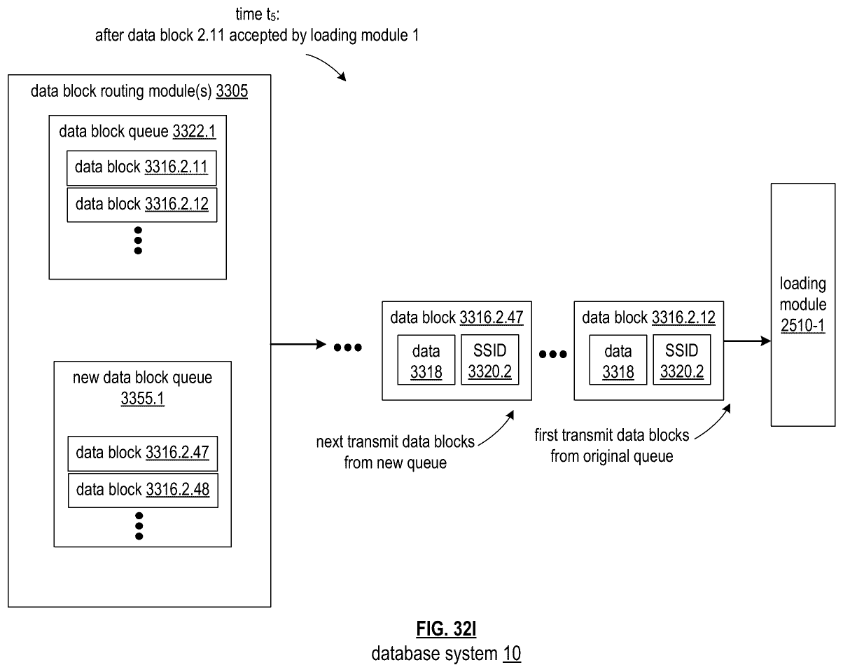

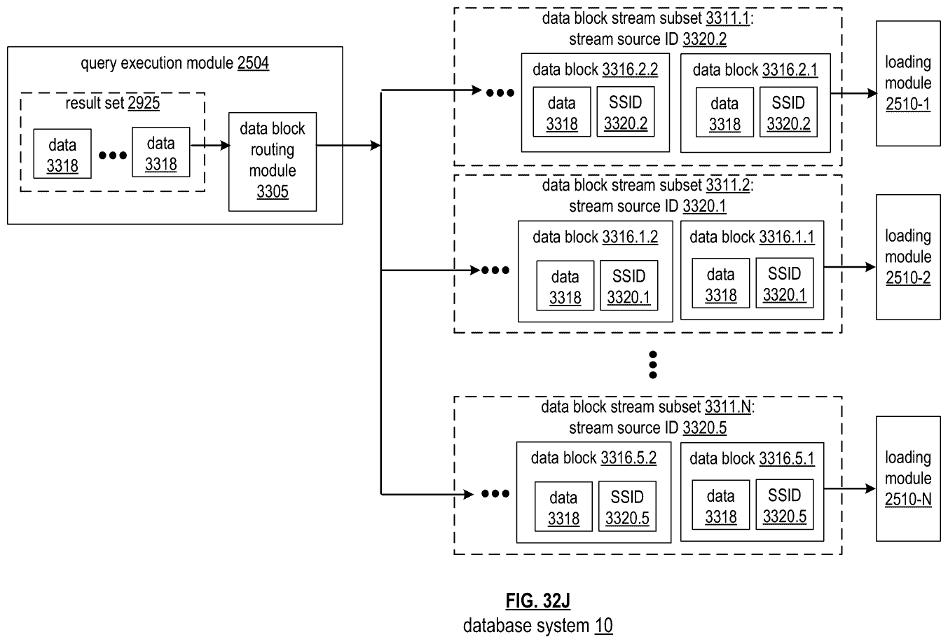

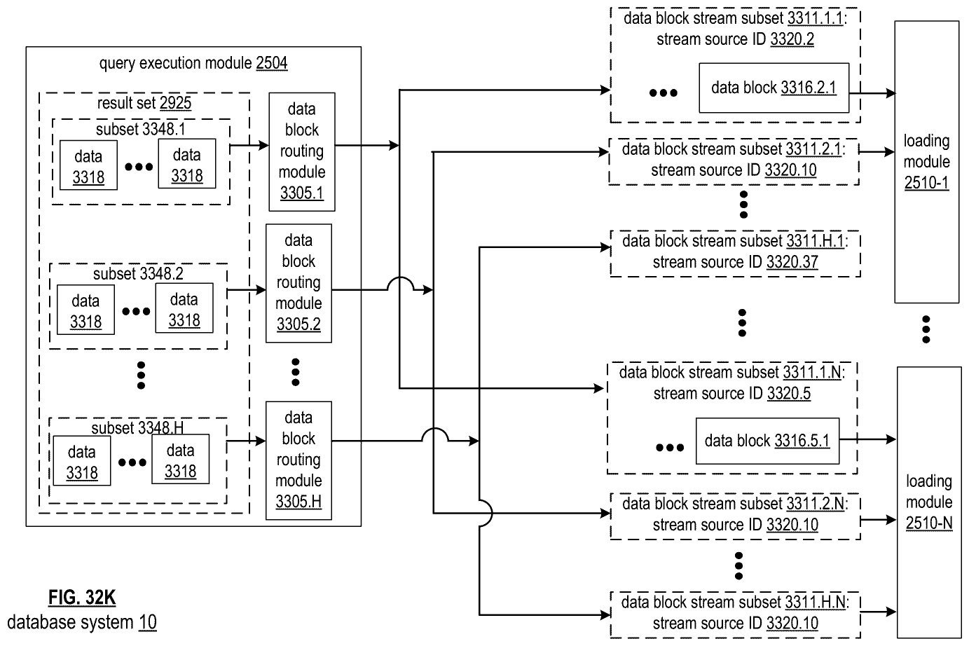

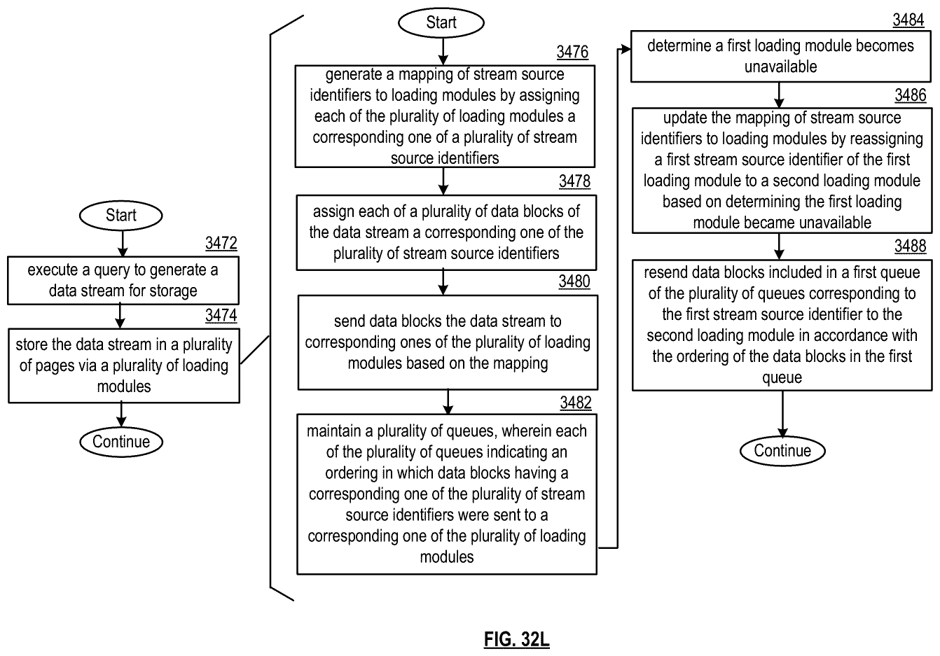

In various embodiments, a database system includes at least one processor and at least one memory storing operational instructions. The operational instructions, when executed by the at least one processor, can cause the database system to perform some or all steps of FIG. 32L. In various embodiments, the database system includes a record processing system operable to: receive a first plurality of data blocks from at least one external data source in at least one first data stream; generate a first plurality of pages from the first plurality of data blocks; determine to perform a conversion process upon the first plurality pages based on the first plurality of page meeting a size requirement; perform the conversion process to generate a first plurality of segments from the first plurality of pages based on determining to perform the conversion process upon the first plurality pages; send the first plurality of segments to a segment storage system for storage; receive a second plurality of data blocks corresponding to a result set of a query in at least one second data stream based on execution of the query; generate a second plurality of pages from the second plurality of data blocks; determine to perform the conversion process upon the second plurality pages based on determining all of the result set was received and stored in the second plurality of pages, where the second plurality of pages fall below the size requirement; perform the conversion process to generate a second plurality of segments from the second plurality of pages based on determining to perform the conversion process upon the second plurality pages; and/or send the second plurality of segments to the segment storage system for storage. The database system can further include a segment storage system operable to store the first plurality of segments to a segment storage system for storage and the second plurality of segments.

FIGS. 32A-32K illustrate embodiments of a database system operable to prevent loss of portions of the result set in the event of loading module 2510 failure when to balancing the load of result set processing across multiple loading modules 2510. Some or all features and/or functionality of the database system 10 of FIGS. 32A-32K can be utilized to implement any embodiment of the database system 10 described herein.

When result set of a query, such as a CTAS or INSERT base query, is sent directly to a loading module 2510 of the record processing system 2507 to be loaded into the system, an additional dependency on the loading module 2510 being available and able to accept data is created. At any point during a query execution, as result set data is being streamed to a given loading module 2510 for storage in pages, a loading module 2510 may crash or encounter another error preventing processing. In such cases, the query execution module has no way of knowing how far any data blocks have made it through the loading process which were sent to the indexer prior to the failure but not yet reported as durable. To handle such situations without duplicate or missing rows, the loading module can implement mechanisms requiring that each row belongs to a fixed stream source, and that the rows within a stream source have a predetermined order and can only be sent to the loading module 2510 in that order. Additionally, a loading module 2510 may be saturated with work and temporarily stop accepting new data. The query execution module can gracefully respond to failure and saturation conditions and utilize available hardware in a balanced way, while respecting contractual requirements for interfacing with loading modules 2510, based on assigning data blocks to stream source identifiers, maintaining queues of data blocks not yet made durable, and handling Rate Limit Exceeded (RLE) rejections of data blocks by loading modules 2510.

This improves the technology of database systems by helping to ensure that a CTAS or Insert Into Select query will always succeed eventually, regardless of the state of the loading modules 2510 over the lifetime of the query, assuming that all loading modules 2510 are not indefinitely unavailable. In particular, if queues of in-progress data blocks were not maintained, the system may not be able to recover from an error on the loading side, even if there were other loading modules available to take on the error-ed blocks. The balancing of load enabled by the solution improves the technology of database systems by enabling the query execution to dynamically adapt to varying loading module availability and load, reducing the impact imposed by a lagging or overloaded indexer.

FIG. 32A illustrates an embodiment of a record processing system 2507 that implements a plurality of loading modules 2510-1-2510-N that each process a respective data block stream subsets 3311 of a plurality of data block stream subset 3311.1-33111.N of data blocks 3316. The plurality of loading modules 2510-1-2510-N can be implemented via some or all features and/or functionality of the loading modules 2510-1-2510-N of FIG. 25B. The data blocks can be implemented as result set data blocks 3215 and/or column-major formatted data blocks 2918.

In various embodiments, the processing of incoming data block streams by multiple loading modules or other processing entities in parallel to generate pages 2515 as discussed herein, such the processing of one or more result set record streams 2929 can be implemented via any features and/or functionality of the page generator processing labeled row data to generate pages, and/or via any functionality of processing incoming row data to generate pages, disclosed by U.S. Utility application Ser. No. 16/985,930, entitled “RECORD DEDUPLICATION IN DATABASE SYSTEMS”, filed Aug. 5, 2020, which is hereby incorporated herein by reference in its entirety and made part of the present U.S. Utility patent application for all purposes.

As illustrated in FIG. 32A, the database system 10 can further implement at least one data block routing module 3305 that routes data blocks 3316 of a data block stream to respective loading modules 2510 in respective data block stream subsets 3311. The load of data block stream 3314 is balanced across the N loading modules equally and/or substantially equally in accordance with assigning data blocks 3316 to loading modules 2510, for example, in accordance with a round robin scheme.

Each loading module 2510 can generate and send storage confirmation data 3312 as a stream of confirmation data 3313 over time back to the data block routing module 3305, indicating data blocks that are durably stored in pages over time. The data block routing module can utilize the storage confirmation data 3312 to confirm whether data blocks need be resent, re-allocate which data blocks are assigned to which loading module 2510, and/or otherwise adapt routing of the data stream to loading modules 2510 over time as the result set 2925 continues to be transmitted.

The data block routing module 3305 can optionally be implemented via the query execution module, for example, in conjunction with execution of a loading operator 3127 and/or in conjunction with transmitting result set 2925 to the record processing system 2507 as part of the result set generation and transmission 3125. For example, one or more nodes of the query execution module each implement the data block routing module 3305 to route their own respective portions of the result set for processing across different loading modules. Alternatively or in addition, the data block routing module 3305 can optionally be implemented via the record processing system 2507, where, once received by a central entity of the record processing system 2507, data blocks are distributed across loading modules 2510 for processing. The data block routing module 3305 can optionally be implemented by one or more external data sources and/or other data sources transmitting other data blocks that include rows for storage.

The data block routing module 3305 can be implemented via some or all features and/or functionality of the row transmission module 2706 of FIGS. 27A-27E. The data blocks 3316 can optionally be implemented via some or all features of the labeled row data 3010. For example, the data blocks 3316 include increasing row numbers and/or stream source identifiers. The confirmation data 3313 can optionally be implemented via some or all features of the row confirmation data 3030. Each loading module 2510 can be implemented vis some or all features and/or functionality of the record processing and storage system 2505 communicating with the row transmission module 2706 as discussed in conjunction with FIGS. 27A-27E.

FIG. 32B illustrates an embodiment of the database system 10 where data blocks 3316 include data 3318 and a stream source identifier (SSID) 3320. The data 3318 can be in a row-major format or a column-major format, and indicate values of rows for storage. The data 3318 can be implemented via some or all features or functionality of the row data 2910 of FIGS. 27A-27E, even if in a column-major format for conversion into row-major format by the loading module 2510 once received, for example, via the input data format conversion module 2938, before being included in pages 2515. Some or all features and/or functionality of the record processing system 2507 of FIG. 27B can be utilized to implement the record processing system 2507 of FIG. 27A and/or any other embodiment of the record processing system described herein.

The SSID can be implemented via some or all features of source ID 3014. For example, for a given loading module 2510, the SSID 3320 included in data blocks received from the data block routing module sending a result set 2925 can be indistinguishable from, and/or treated in the same way as, the source ID 3014 included in data blocks received from a set of external data sources 2501. However, rather than corresponding to a particular data source 2501 that generated the corresponding data 3318, all data 3318 may have been generated by a same entity, such as the query processing module that sends the data block stream 3314 and/or a particular node of the query processing module that sends the data block stream 3314.

Loading module stream assignment data 3330 can dictate how data blocks 3316 are routed to loading modules 2510. In particular, the SSIDs can be utilized to assign and track data blocks sent to each loading module 2510, where each loading module 2510 is assigned one or more stream source IDs 3320 at a given time, and where each SSID 3320 maps to one loading module 2510 at a given time. In this example, the data block stream subset 3311.1 routed to loading module 2510-1 includes data blocks 3316 having stream source ID 3320.2 based on stream source ID 3320.2 being assigned to loading module 2510-1, and the datablock stream subset 3311.2 routed to loading module 2510-2 includes data blocks 3316 having stream source ID 3320.5 based on stream source ID 3320.5 being assigned to loading module 2510-2.

FIG. 32C illustrates the assignment of source IDs to data blocks, and use of data block queues to track the data blocks not yet durably stored. Some or all features and/or functionality of the data block routing module 3305 of FIG. 27C can be utilized to implement the data block routing module 3305 of FIG. 27A and/or any other embodiment of the data block routing module described herein.

An SSID assignment module 3349 can tag data 3318 of the result set 2925 with SSIDs 3320, for example, in accordance with a uniform distribution of all SSIDs and/or in a round robin means. Alternatively, the assignment is not uniform, for example, based on assigning more data blocks to loading modules with a lighter load and/or assigning fewer data blocks to loading modules with a heavier load to maintain load balancing over time. The SSIDs assigned to data blocks can correspond to the of SSIDs indicated to be mapped to loading modules in the loading module stream assignment data 3330.

Each data block queue 3322 can store all data blocks 3316 of the corresponding SSID assigned for transmission, and/or data blocks that have already been transmitted but are not durably stored. Data can be sent from a data block queue in accordance with an order in which it enters the queue. Corresponding row numbers or other increasing numbers can be tagged to each data block to track an ordering in which data blocks of a given SSID were transmitted.

Each data block queue 3322 can be implemented as a confirmation-pending row list 3020 of FIGS. 27A-27E, and/or each data block queue 3322 can be maintained by the data block routing module 3305 as data blocks 3316 are transmitted and/or as confirmations 3313 are received over time via some or all features and/or functionality of the row transmission module 2706 updating the confirmation pending row list based on row confirmation data 3030 as discussed in conjunction with FIGS. 27A-27E. This can include maintaining a tracked transmission starting point indicator 3025 for each data block queue 3322 based on confirmations 3313 received from the corresponding loading module 2510 over time. Data blocks with a given SSID can be retransmitted to a given loading module 2510 based on confirmation data 3313 indicating certain rows were not confirmed by resending the corresponding these data blocks from the data block queue 3322 based on some or all features an/or functionality discussed in conjunction with FIGS. 27A-27E.

FIGS. 32D-32F present an example embodiment of a data block routing module 3305 over time to illustrate how failure of a loading module during transmission of a given result set is handled to ensure all data blocks are transmitted and stored as pages. Some or all features and/or functionality of the data block routing module 3305 of FIGS. 32D-32F can be utilized to implement the data block routing module 3305 of FIG. 32A and/or any other embodiment of the data block routing module 3305 described herein.

Initially, each loading module 2510 can be associated with a single stream source ID 3320, All data assigned to a given loading module 2510 is sent under its associated stream source ID. Data can be assigned to loading module 2510 using a round-robin selection scheme. For each indexer, a queue of all data blocks that have been sent to the indexer but are not yet reported as durable can be maintained, for example, as a corresponding data block queue 3322. This durable storage can correspond to being stored in pages, being deduplicated, being stored in segments, or otherwise being determined to be durable as discussed previously. Durable storage of data blocks can be determined based on confirmations 3313 that have been received.

If a loading module becomes temporarily unavailable or permanently errored, the data that it was responsible for is redirected to a different loading module, chosen using round-robin from the available loading modules, or from the unavailable loading modules if none are available. The data is resent to the new loading module under the same stream source ID and in the same order as it was originally sent, enabling the new loading module to perform deduplication correctly. New data is not assigned to and/or sent to the failed loading module while it is in an error state.

If an unavailable loading module recovers, a new SSID can be associated with that loading module. Because its original errored stream source could still be in the process of resending its blocks, assigning new blocks to that stream source in parallel to the retries violates the guarantee of fixed ordering within a stream source. While blocks reassigned to this loading module from another failed loading module would use their original SSID, any newly enqueued data blocks can use the newly generated SSID associated with this loading module.

As illustrated in FIG. 32D, at time to when SSIDs are initially assigned to loading modules, a stream assignment data generator module 3335 generates an initial version of the loading module stream assignment data 3330.0. In this example, Data blocks 3316 having SSID 3320.2 are routed to loading module 2510-1, data blocks 3316 having SSID 3320.1 are routed to loading module 2510-2, and data blocks 3316 having SSID 3320.5 are routed to loading module 2510-N. Corresponding data block queues store data blocks that have been transmitted that have not yet been made durable, for example, based on not yet receiving confirmations 3313 indicating these data block have been made durable.

As illustrated in FIG. 32E, at time t₁ after time to, after a failure of loading module 2510-2 is detected, the stream assignment data generator module 3335 updates the loading module stream assignment data as loading module stream assignment data 3330.1 based on this detected failure, where SSID 3320.1 is reassigned to loading module 2510-3, and where loading module 2510-2 is no longer assigned an SSID. A stream re-transmission module 3344 utilizes the queue 3322.2 previously sent to loading module 2510-1 storing the previously transmitted data blocks with SSID 3320.1 to retransmit all some or all data blocks indicated in the queue 3322.2 previously transmitted data blocks 3316 having SSID 3315.1 in the original order, as indicated by their ordering in the queue 3322.2. This can include retransmitting only previously transmitted data blocks 3316 having SSID 3315.1 not yet stored durably. New data blocks are not placed in this queue 3322.2 and/or no new data blocks are transmitted to the failed loading module 2510-2. The data streams transmitted to other loading modules continues to progress, with their queues being updated respectively over time.

As illustrated in FIG. 32E, at time t₂ after time t₁, after loading module 2510-2 recovers and is again available, the stream assignment data generator module 3335 updates the loading module stream assignment data as loading module stream assignment data 3330.1 based on this detected failure, where a new SSID 3320.7 is assigned to loading module 2510.7. New data blocks not yet transmitted can be assigned this new SSID 3320.7, for example in accordance with the round-robin selection. Data blocks having SSID 3320.7 are thus sent to loading module 2510-2, and the corresponding queue 3322.2 is populated with these transmitted data blocks, for example, based on not yet being made durable. The data streams transmitted to other loading modules continues to progress, with their queues being updated respectively over time.

FIGS. 32G-321 present an example embodiment of a data block routing module 3305 over time to illustrate how a rate limit exceeded condition of a loading module during transmission of a given result set is handled to balance loading of transmitted data blocks. Some or all features and/or functionality of the data block routing module 3305 of FIGS. 32G-321 can be utilized to implement the data block routing module 3305 of FIG. 32A and/or any other embodiment of the data block routing module 3305 described herein.

If a loading module 2510 rejects a data block with rate limited exceeded (RLE), the data block routing module 3305 can continue retrying the rejected block with exponential backoff until it is accepted. Any subsequent data blocks which were already in flight to the loading module 2510 before receiving the RLE will receive failure responses and are kept in a queue to be resent after the RLE′d block succeeds. In the meantime, new data blocks assigned to the stream source enter a separate queue. When the queue of new blocks reaches a finite limit, no new blocks may be assigned to the stream source until the overflow resolves. As soon as the RLE′d block is accepted by the loading module 2510, the data block routing module 3305 can being sending the subsequent blocks off the queues—first those that were in flight after the RLE′d block, and then those enqueued during the overflow. Thus ordering requirements are maintained. The overflow is then resolved, and new blocks may be assigned to the stream source again.

As illustrated in FIG. 32G, at time t₃ a RLE notification 4450 is sent by loading module 2510-1 indicating rejection of data block 3315.2.11. Other data blocks with SSID 3315.2 routed to loading module 2510 may also already be in flight, such as data block 3515.12. These data blocks that were transmitted but not yet made durable are stored in data block queue 3322.1.

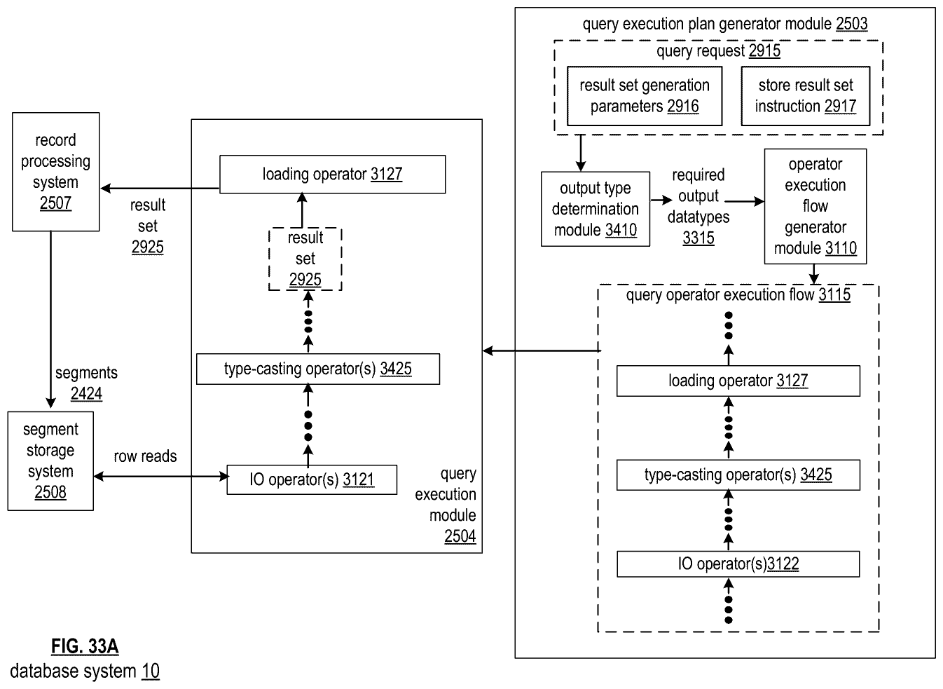

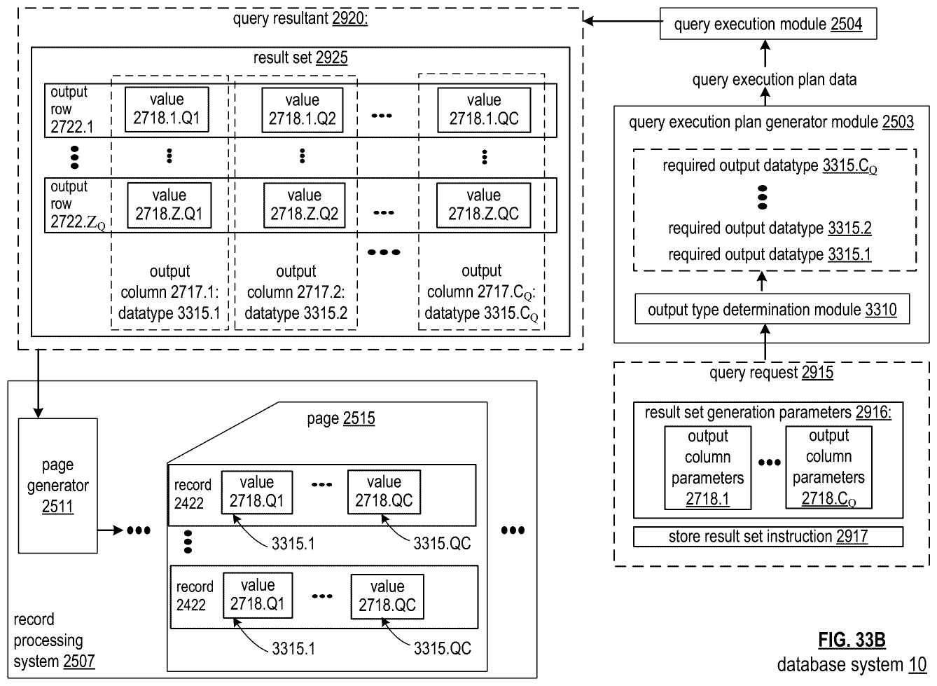

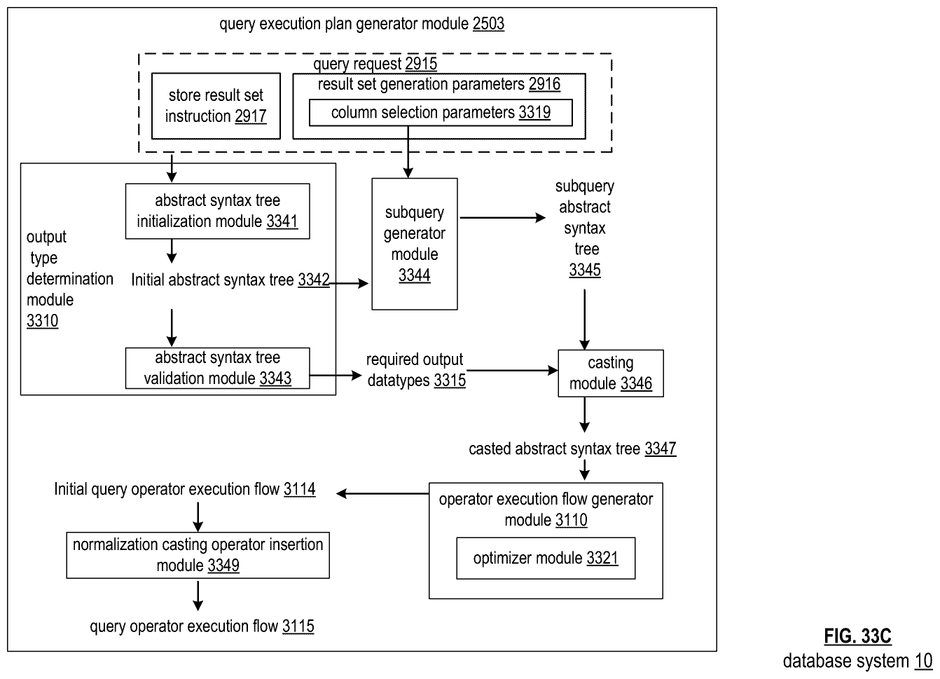

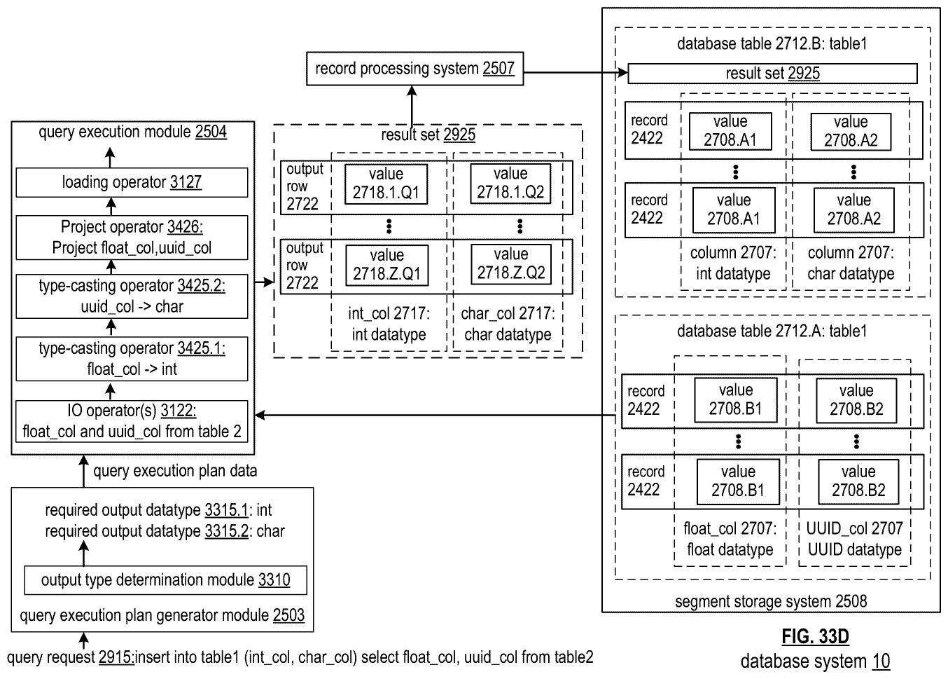

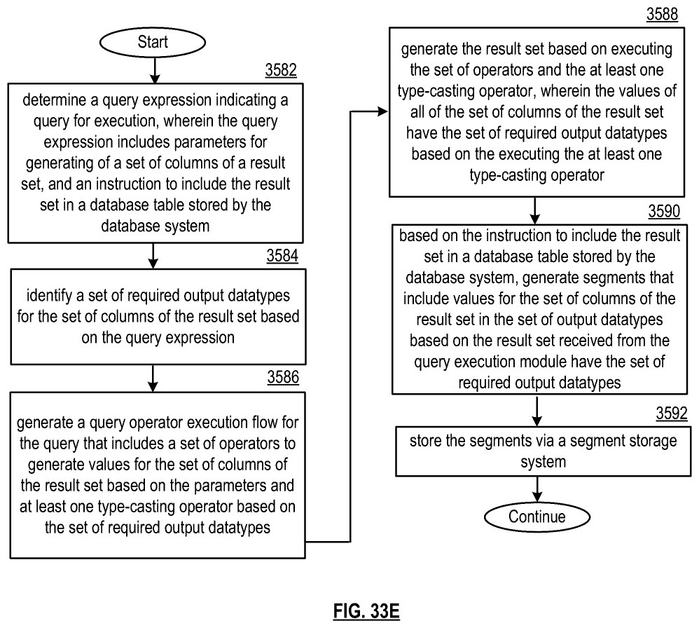

As illustrated in FIG. 33H, at time t₄ after time t₃, the RLE notification 4450 is received and processed by data block routing module 3305 via an RLE-based adjustment module 3355. In particular, based on receiving the RLE notification 4450, the data block routing module 3305 continues retrying data bock 3315.2.11 with exponential backoff. A new data block queue 3355.1 stores new data blocks with SSID 3315.2. The new data block queue 3355.1 can have a queue limit 3380, for example, indicating a maximum storage size and/or maximum number of datablocks. Once this limit is reached, the SSID assignment module can be notified to not assign any further data blocks with SSID 3315.2, for example, until the loading module 2510-1 again beings accepting data blocks.

As illustrated in FIG. 33H, at time t₅ after time t₄, after data block data bock 3315.2.11 is ultimately accepted by loading module 2510-1, the data blocks in data block queue 3322.1 are first sent to the loading module, in order, to resend the previously attempted transmissions of data blocks including data block 3315.2.12. After these data blocks of the block queue 3322.1 are retransmitted, the data blocks of new data block queue 3355.1 are transmitted to the loading module 2510-1.

FIG. 32J illustrates an embodiment of a database system 10 where a query execution module 2504 implements the data block routing module 3305 to route a stream of data 3318 of result set 2925 to loading modules 2510-1-2510-N via some or all features and/or functionality discussed in conjunction with FIG. 32A-32I. Alternatively or in addition, any other processing resources of database system 10 can implement the data block routing module 3305 for result sets 2925 generated in query executions for loading, and/or for any other data sets generated and/or received for storage.

FIG. 32K illustrates an embodiment of a database system 10 where a query execution module 2504 implements a plurality of data block routing modules 3305.1-3305.H to route a respective stream of data 3318 of a corresponding subset 3348 of the result set 2925. For example, the result set of a CTAS or INSERT query may be divided among several sinks, each communicating their subset of the result set to the indexers in parallel. The scheme implemented by the data block routing modules 3305 as described in conjunction with FIG. 32A-32I can be carried out on a per-sink basis. Each data block routing module can independently assign SSIDs and route its own subset 3348 of data blocks to a set of loading modules 2510 via some or all features and/or functionality discussed in conjunction with FIG. 32A-32I. The set of loading modules to which each data block routing module 3305 sends its data can be the same set of loading modules 2510-1-2510-N as illustrated in FIG. 32K, and/or can be non-equal sets of loading modules 2510 having non-null set differences and/or null or non-null intersections.

Each data block routing modules 3305 can optionally be implemented by a corresponding node 37 generating a result set, such as a node at an inner level of the query execution plan that executes the loading operator upon its own result set generated based on data block received from child nodes. For example, H nodes operate at the inner level of a query execution plan to each send their corresponding subset 3348 of the result set 2925 amongst the set of loading modules 2510-1-2510-H in parallel. The set of parallelized data block routing modules 3305.1-3305.H can be implemented by any other parallelized processing resources of the query execution module 2504 and/or the database system 10.

FIG. 32L illustrates a method for execution by at least one processing module of a database system 10. Some or all of the method of FIG. 32L can be performed by the record processing and storage system 2506, for example, via a plurality of loading modules 2510 of the record processing and storage system 2506. Some or all of the method of FIG. 32L can be performed by a data block routing module 3305. Some or all steps of FIG. 32L can be performed by any one or more processing modules database system 10 in accordance with other embodiments of the database system 10 discussed herein.

In some embodiments, the database system 10 can utilize at least one processing module of one or more loading modules 2510 of a record processing and storage system 2505 and/or of one or more nodes 37 of one or more computing devices 18, where the one or more nodes and/or loading modules execute operational instructions stored in memory accessible by the one or more nodes and/or loading modules, and where the execution of the operational instructions causes the one or more nodes 37 and/or loading modules to execute, independently or in conjunction, the steps of FIG. 32L Some or all steps of FIG. 32L can be performed in conjunction with performing some or all steps of FIGS. 28L, 28M, 28P, 28Q, and/or 31F. Some or all steps of FIG. 32L can be performed in conjunction with performing any other method described herein.

Step 3472 includes executing a query to generate a data stream for storage. Step 3474 includes storing the data stream in a plurality of pages via a plurality of loading modules. The plurality of loading modules can include a first loading module and a second loading module.

Performing step 3474 can include performing some or all of steps 3476, 3478, 3480, 3482, 3484. Step 3476 includes generating a mapping of stream source identifiers to loading modules by assigning each of the plurality of loading modules a corresponding one of a plurality of stream source identifiers. A first stream source identifier of the plurality of stream source identifiers is assigned to the first loading module. Step 3478 includes assigning each of a plurality of data blocks of the data stream a corresponding one of the plurality of stream source identifiers. Data blocks of a first data subset of the plurality of data subsets can be assigned the first stream source identifier. Step 3480 includes sending data blocks the data stream to corresponding ones of the plurality of loading modules based on the mapping. Step 3482 includes maintaining a plurality of queues, where each of the plurality of queues indicating an ordering in which data blocks having a corresponding one of the plurality of stream source identifiers were sent to a corresponding one of the plurality of loading modules.

Step 3484 includes determining the first loading module of the plurality of loading modules becomes unavailable. Step 3486 includes updating the mapping of stream source identifiers to loading modules by reassigning the first stream source identifier to the second loading module based on determining the first loading module became unavailable. Step 3488 includes resending data blocks included in a first queue of the plurality of queues corresponding to the first stream source identifier to the second loading module in accordance with the ordering of the data blocks in the first queue.

In various embodiments, each of the plurality of data blocks of the data stream are assigned a corresponding one of the plurality of stream source identifiers based on a round-robin scheme.

In various embodiments, the first queue indicates only a proper subset of the data blocks of the first data subset that were sent to the first loading module corresponding to ones of the data blocks of the first data subset not durably stored by the first loading module. In various embodiments, a second proper subset of the data blocks of the first data subset that were sent to the first loading module were durably stored by the first loading module. The first proper subset and the second proper subset can be mutually exclusive and collectively exhaustive with respect to the data blocks of the first data subset that were sent to the first loading module. In various embodiments, the second proper subset of the data blocks of the first data subset that were sent to the first loading module are not indicated in the first queue based on receiving at least one storage confirmation data from the first loading module indicating durable storage of the second proper subset of the data blocks.

In various embodiments, durable storage of the second proper subset of the data blocks is based on at least one of: generation of at least one page by the first loading module that includes the second proper subset of the data blocks; deduplication of the at least one page by the first loading module; generation of at least one segment by the first loading module from the at least one page; and/or storage of the at least one segment in a segment storage system.

In various embodiments, the method further includes determining the first loading module becomes re-available, and further updating the mapping of stream source identifiers to loading modules by assigning a different stream source identifier to the first loading module based on determining the first loading module became available, where the different stream source identifier is different from the first stream source identifier. In various embodiments, the different stream source identifier is a new stream source identifier that is distinct from all of the plurality of stream source identifiers in an original mapping of stream source identifiers to loading modules.

In various embodiments, the mapping of stream source identifiers to loading modules indicates a third stream source identifier of the plurality of stream source identifiers assigned to a third loading module of the plurality of loading modules. The method can further include receiving a rate limit exceeded notification from the third loading module in response to sending of a given data block of a third subset of the plurality of data subsets to the third loading module. A third queue of the plurality of queues corresponding to the third stream source identifier can indicate the given data block and a plurality of subsequently transmitted data blocks in a corresponding ordering. The method can further include resending the given data block to the third loading module in a plurality of attempts in accordance with an exponential drop off during a temporal period. The method can further include, during the temporal period, including new ones of the plurality of data blocks assigned the third stream source identifier in a new queue generated for the third loading module based on receiving a rate limit exceeded notification. The method can further include determining acceptance of the given data blocks by the third loading module in one of the plurality of attempts. The method can further include, in response to determining acceptance of the given data blocks by the third loading module, resending the plurality of subsequently transmitted data blocks indicated in the third queue in accordance with the corresponding ordering. The method can further include, after resending the plurality of subsequently transmitted data blocks indicated in the third queue, sending the new ones of the plurality of data blocks assigned the third stream source identifier in the new queue.

In various embodiments, the method further includes enforcing a predetermined size limit for the new queue by determining the predetermined size limit is reached by the new queue during the first temporal period, and/or by foregoing assignment of the third stream source identifier to any subsequent ones of the plurality of data blocks in the data stream based on determining the predetermined size limit is reached.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 30I described above.

In various embodiments, a database system includes at least one processor and at least one memory storing operational instructions. The operational instructions, when executed by the at least one processor, can cause the database system to perform some or all steps of FIG. 32L. In various embodiments, the database system includes a query execution module operable to generate a data stream for storage by executing a query, a plurality of stream loading modules operable to collectively store data blocks of a data stream in a plurality of pages, and/or a data block routing module. The data block routing module can be operable to: generate a mapping of stream source identifiers to loading modules by assigning each of the plurality of loading modules a corresponding one of a plurality of stream source identifiers, wherein a first stream source identifier of the plurality of stream source identifiers is assigned to a first loading module of the plurality of loading modules; assign each of a plurality of data blocks of the data stream a corresponding one of the plurality of stream source identifiers, wherein datablocks of a first data subset of the plurality of data subsets are assigned the first stream source identifier; send data blocks the data stream to a corresponding one of the plurality of loading modules based on the mapping; maintain a plurality of queues, wherein each of the plurality of queues indicating an ordering in which data blocks having a corresponding one of the plurality of stream source identifiers were sent to a corresponding one of the plurality of loading modules; determine the first loading module becomes unavailable; update the mapping of stream source identifiers to loading modules by reassigning the first stream source identifier to a second loading module of the plurality of loading modules based on determining the first loading module became unavailable; and/or resending data blocks included in a first queue corresponding to the first stream source identifier to the second loading module in accordance with the ordering of the data blocks in the first queue.

FIGS. 33A-33D present embodiments of a database system 10 that auto-casts datatypes of a result set during query execution for storage in segments for access during future query executions. Some or all features and/or functionality of the database system 10 of FIGS. 33A-33D can implement the database system 10 of FIGS. 28A-28K and/or any other embodiment of the database system 10 described herein.

The result set of a query, such as a CTAS or INSERT base query, can be sent directly to the record processing system 2507 to be loaded into the system. These result sets can have well-defined column data types based on whatever computation was done in accordance with the query execution. The record processing system 2507 also requires that incoming data have well-defined types based on the column types in the targeted table. Because the query result set and the indexer both require well-defined data types, this can cause unnecessary failures if there is a mismatch. The embodiments of 33A-33D present an additional step to detect these situations and perform the additional transformations implicitly, improving the technology of database systems by preventing datatype mismatch-based failures when generating result sets for storage.

In particular, the query operator execution flow 3115 can be implemented to perform necessary type-casting operators to ensure the outputted result set sent to the record processing system for loading and conversion into segments need not be further converted into necessary data types for storage. This can further improve the technology of database systems by ensuring no special handling is needed at load time for type mismatches, and by reducing processing by the record processing module that would be necessary in detecting type mismatches, determining and attempting to perform the correct cast, handle invalid type conversions, etc. Pushing this work into the query execution plan can improve the technology of database systems by not only reduces complexity of the overall process, but also ensures consistency with casting behavior that a user would expect to see from a query.

As a particular example of implementing this functionality, an abstract syntax tree (AST) built for the base CTAS query or Insert query can be validated to detect selected column types. The initial select statement in the AST can be made into a subquery, then all the columns from that subquery can be selected cast to the desired target table types. These can be the target table column types for an insert or the user-requested types for a CTAS—if not specified, the detected query output types can be utilized. The casted AST can be re-validated—if a cast doesn't exist, the query can be failed during validation. A query plan can be generated and optimization can be performed to automatically insert the correct casts into the plan for any columns that have mismatched types. After optimization completes, casts can also be inserted to normalize the representation when the target and source specify the same type with different parameters or that may have become inconsistent through computation—for example, to adjust the final precision and scale of a decimal column. Some or all of this building of the final query execution plan data and/or corresponding operator execution flow can be implemented via the query execution plan generator module 2503, for example, as discussed in conjunction with FIG. 33C. At query time, the query execution module 2504 and/or a corresponding virtual machine can execute the casts as specified in the plan before sending the data to the load operators. Data sent to the record processing system can be already in correct type format for the target table, and values can be copied directly into the output page.

FIG. 33A illustrates an embodiment of a database system 10 that generates a query operator execution flow 3115 that includes at least one type-casting operator 3425 based on required output datatypes 3315 determined via an output type determination module 3310 based on the query request 2915. These type-casting operators 3425 can be executed to convert data blocks having one datatype into data blocks of another data-type, and/or to assign a datatype to one or more output columns of the a corresponding result set as a well-defined datatypes. This result set can be processed via the record processing system for storage as segments via the segment storage system based on the store result set instruction 2917 indicated in the query request as discussed previously.

The output type determination module 3310 can determine required output datatypes 3315 based on the column types for the table in which the result set is to be stored. In the case where the result set is being inserted into an existing table, for example, in conjunction with executing an Insert Into Select instruction, the datatypes for this existing table are determined and utilized as the required output datatypes 3315. This can include accessing table metadata, for example, via the metadata management system 2509, to determine the datatypes of each of the set of columns of this existing table.

In the case where the result set is being created as a new table, for example, in conjunction with executing a CTAS instruction, the datatypes for columns of this new table can determined and utilized as the required output datatypes 3315. These datatypes for the columns of this new table can be defined via user selection, for example, as part of the query request indicating the datatypes of the new columns of the new table being created. In the case where no user selection of column types is indicated, the output type determination module 3310 can determine output datatypes, for example, based on the datatypes of values being accessed via IO operators as required by the query request, and/or based on the output of particular types of functions and/or computations performed upon these datatypes as required by the by the query request.

FIG. 33B illustrates an example of generating a result set 2925 for storage that includes a set of output columns 2717.1-2717.C_{Q} each having a corresponding well-defined datatype 3315. Different columns can have different datatypes. The datatypes of the set of output columns 2717.1-2717.C_{Q} can correspond to a set of required output datatypes 3315.1-3315.C_{Q} generated via the output type determination module 3310 based on the query request, where the datatypes of the set of output columns 2717.1-2717.C_{Q} of the query resultant match these types based on the query execution module 2405 executing corresponding type-casting operators 3425 as necessary as discussed in conjunction with FIG. 33A. As the result set is stored into pages, no further type-casting or type conversion is necessary due to the result set already having columns with the required output datatypes 3315. Thus, the pages 2515 store the values for each record 2422 corresponding to output rows 2722 of the result set with the same output datatypes for these values in the result set 2925.

FIG. 33C illustrates an example embodiment of a query execution plan generator module 2503 that determines the query operator execution flow for a query with an instruction to store the result set with type-casting operators 3425 as necessary to ensure the outputted result set stored in pages and ultimately converted into segments matches the required output datatypes 3315. Some or all features and/or functionality of a query execution plan generator module 2503 of FIG. 33C can implement the query execution plan generator module 2503 of FIG. 33A and/or any other embodiment of query execution plan generator module 2503 described herein.

The query request can be processed by the output type determination module to determine the required output datatypes based on an abstract syntax tree initialization module 3341 determining an initial abstract syntax tree (AST) 3342 for the query based on the query request 2915, for example, based on parsing a corresponding query expression in SQL or another query language. An abstract syntax tree validation module 3343 can perform validation upon the initial AST 3342 to determine the required output datatypes.

A subquery generator module 334 can utilize the result set generation parameters 2916 to generate a subquery abstract syntax tree 3345, for example, corresponding to the portion of the query corresponding to the SELECT statement and/or otherwise defining how the result set being loaded is to be created during query execution. This can include processing column selection parameters 3319 indicating how each output column be created, which columns from tables are read to generate each output column, and/or which types of computation are performed from the corresponding one or more read columns to generate the corresponding output column. A casting module 3346 can be applied to generate a casted abstract syntax tree 3347 from the subquery abstract syntax tree 3345 based on casting each output column, to be created via corresponding column selection parameters 3319, to the required output datatypes determined by the output type determination module 3310. For example, type-casts can be inserted for every output column to their corresponding required output datatype 3315. The operator execution flow generator module 3110 can re-validate the query, where the query can be failed on re-validation if a cast doesn't exist.

The operator execution flow generator module 3110 can further implement an optimizer module 3321 to perform optimization and output an initial query operator execution flow 3114 for execution via a corresponding query execution plan. In some cases, some or all casting in the casted abstract syntax tree 3347 is removed during optimization if this casting is not required, where casting operators are only included for instances of type mismatches between the generated result set and the required output datatypes. The type-casting operators that remain can be based on first factors, such as having type-casts for any output column having a required output datatype 3315 mismatching the data type that would be generated by default in the result set from input data read from segments, and/or having type-casts for any output column having a required output datatype 3315 mismatching the data type of a corresponding column whose values are read from segments to generate this output column.

This initial query operator execution flow 3114 can be further processed via a normalization casting operator insertion module 3349 to further insert one or more additional casting operators into the initial query operator execution flow 3114 to render the final query operator execution flow 3115 to be executed. These additional casting operators inserted after optimization can be inserted based on second factors, such as factors pertaining to normalizing the representation when the target and source specify the same type with different parameters or that may have become inconsistent through computation by one or more other operators induced as required to generate the result set as specified in the query, for example, to adjust the final precision and scale of a decimal column.

FIG. 33D illustrates an embodiment of an example query execution where query request 2915 indicates a query expression that includes, for example, “insert into table1 (int_col, char_col) select float_col, uuid_col from table2”. The float_col and uuid_col of table2 can have datatypes of float and uuid, respectively. The int_col and char_col of table1 can have datatypes of int and char, respectively.

The output type determination module 3310 determining the required output datatypes for the result set are int and char, based on these being the defined datatypes for the respective columns of existing table1. The resulting query execution plan data can indicate execution of a query operator execution flow 3115 for execution by the query execution module 2504 that includes a first type-casting operator 3425.1 that casts values of the float_col read from table2 into the int datatype, and/or that includes a second type-casting operator 3425.2 that casts values of the uuid_col read from table2 into the char datatype. These type-casting operators 3425 can be included in the query operator execution flow 3115 executed by the query execution module 2504 based on the type of the float_col mismatching the required output datatype of int for the respective output column 2717.1, and/or based on the type of the uuid_col mismatching the required output datatype of char for the respective output column 2717.2.

These casted values of these columns can then be projected via a project operator 3426 for loading via loading operator 3127. The outputted result set sent to the record processing system can include output rows 2722 with values 2718 for insertion in the int_col of Table1 already being of the int datatype based on the execution of type-casting operator 3425.1, and values 2718 for insertion in the char_col of Table1 already being of the char datatype based on the execution of type-casting operator 3425.2. The corresponding result set stored additional segments depicting new rows of Table1 can thus be of the correct type, based on the pages from which these segments were generated being of the correct type. No additional type-casting is required by the record processing system 2507, yet no type mismatch is present, based on all casting being performed during query execution.

FIG. 33E illustrates a method for execution by at least one processing module of a database system 10. Some or all of the method of FIG. 33E can be performed by the query execution plan generator module 2503, the query execution module 2504, the record processing system 2507, and/or the segment storage system 2508. Some or all steps of FIG. 33E can be performed by any one or more processing modules database system 10 in accordance with other embodiments of the database system 10 discussed herein.

In some embodiments, the database system 10 can utilize at least one processing module of one or more loading modules 2510 of a record processing and storage system 2505 and/or of one or more nodes 37 of one or more computing devices 18, where the one or more nodes and/or loading modules execute operational instructions stored in memory accessible by the one or more nodes and/or loading modules, and where the execution of the operational instructions causes the one or more nodes 37 and/or loading modules to execute, independently or in conjunction, the steps of FIG. 33E. As a particular example, a node 37 can execute some or all of the steps of FIG. 30I, where multiple nodes 37 independently execute some or all step some or all the steps of FIG. 30I, for example, to facilitate execution of a query as participants in a query execution plan 2405. As another example, a loading module 2510 can execute some or all of the steps of FIG. 33E, where multiple loading modules independently execute some or all step some or all the steps of FIG. 33E, for example, to collectively generate segments from pages for storage via conversion processes. Some or all steps of FIG. 33E can be performed in conjunction with performing some or all steps of FIG. 28N, 28O, 28P, 28Q, and/or 30L. Some or all steps of FIG. 33E can be performed in conjunction with performing any other method described herein.

Step 3582 includes determining a query expression indicating a query for execution, The query expression includes parameters for generating of a set of columns of a result set, and/or an instruction to include the result set in a database table stored by the database system. Step 3584 includes identifying a set of required output datatypes for the set of columns of the result set based on the query expression. Step 3586 includes generating a query operator execution flow for the query that includes a set of operators to generate values for the set of columns of the result set based on the parameters and at least one type-casting operator based on the set of required output datatypes. Step 3588 includes generating the result set based on executing the set of operators and the at least one type-casting operator, where the values of all of the set of columns of the result set have the set of required output datatypes based on the executing the at least one type-casting operator. Step 3590 includes, based on the instruction to include the result set in a database table stored by the database system, generating segments that include values for the set of columns of the result set in the set of output datatypes based on the result set received from the query execution module have the set of required output datatypes. Step 3592 includes storing the segments via a segment storage system.

In various embodiments, at least one memory device, memory section, and/or memory resource (e.g., a non-transitory computer readable storage medium) can store operational instructions that, when executed by one or more processing modules of one or more computing devices of a database system, cause the one or more computing devices to perform any or all of the method steps of FIG. 33E described above. In various embodiments, the database system includes a query execution plan generator module, a query execution module, a record processing system, and a segment storage system.

The query execution plan generator module can be operable to determine a query expression indicating a query for execution. The query expression can include parameters for generating of a set of columns of a result set and/or an instruction to include the result set in a database table stored by the database system. The query execution plan generator module can be further operable to identify a set of required output datatypes for the set of columns of the result set based on the query expression, and generate a query operator execution flow for the query. The query operator execution flow can include a set of operators to generate values for the set of columns of the result set based on the parameters; at least one type-casting operator based on the set of required output datatypes; and/or a loading operator based on the instruction to include the result set in the database table.

The query execution module can be operable to generate the result set based on executing the set of operators and the at least one type-casting operator, where the values of all of the set of columns of the result set have the set of required output datatypes based on the executing the at least one type-casting operator. The query execution module can be further operable to execute the loading operator to send the result set to the record processing system.

The record processing system can be operable to receive the result set from the query execution module; and generate segments that include values for the set of columns of the result set in the set of output datatypes based on the result set received from the query execution module have the set of required output datatypes. The segment storage system can be operable to store the segments.

In various embodiments, the query expression is in accordance with the Structured Query Language, and wherein the instruction is indicated by a Create Table As Select statement denoting creation of a new table for storage by the database system to include the result set. In various embodiments, identifying the set of required output datatypes for the set of columns of the result set is based on at least one user-defined datatype indicated in the query expression in accordance with the Create Table As Select statement. In various embodiments, identifying the set of required output datatypes for the set of columns of the result set is based on a detected query output type determined for the query expression.

In various embodiments, the query expression is in accordance with the Structured Query Language, where the instruction is indicated by an Insert statement denoting insertion of the result set into an existing table stored by the database system. In various embodiments, identifying the set of required output datatypes for the set of columns of the result set is based on a set of defined column datatypes of the existing table.

In various embodiments, generating the query operator execution flow for the query is based on identifying a set of default output datatypes that would result from generating the set of columns of the result set. Identifying the set of default output datatypes can be based on at least one of: at least one datatype of at least one source column of a source database table indicated by the query expression for access to generate the result set; or at least one output datatype of at least one transformation indicated by the query expression to be applied to the at least on one column of a database table. Generating the query operator execution flow for the query can be further based on including the at least one type-casting operator for only columns of the set of columns with corresponding ones of the set default output datatypes mismatching corresponding ones of the set of required output datatypes.

In various embodiments, the query execution plan generator module is further operable to: determine a second query expression indicating a second query for execution. The second query expression can include second parameters for generating of a second set of columns of a second result set and/or the instruction to include the result set in a second database table stored by the database system. The query execution plan generator module can be further operable to identify a second set of required output datatypes for the second set of columns of the second result set based on the query expression, and generate a second query operator execution flow for the second query. Generating the second query operator execution flow for the second query can be based on identifying a second set of default output datatypes resulting from generating the second set of columns of the second result set; and/or including no type-casting operators for any columns of the second set of columns based on all columns of the second set of columns having corresponding ones of the second set default output datatypes matching corresponding ones of the second set of required output datatypes.

In various embodiments, identifying the set of required output datatypes for the set of columns of the result set is based on building an abstract syntax tree for the query expression and/or validating the abstract syntax tree to detect the set of required output datatypes. In various embodiments, generating the query operator execution flow for the query is based on identifying a subquery of the query expression based on a Select statement of the query expression denoting the result set that be generated for storage, generating an updated abstract syntax tree that includes casting of each of the set of columns outputted by the subquery to corresponding ones of the set of required output datatypes, and/or validating the updated abstract syntax tree to determine whether all casts of the set of columns to the set of required output datatypes exist.

In various embodiments. the at least one type-casting operator includes at least one first type-casting operator and at least one second type-casting operator. Generating the query operator execution flow for the query can be based on identifying the first at least one first type-casting operator for inclusion in the query operator execution flow during an optimization process performed to generate an initial query operator execution flow based on first factor, and identifying the second at least one type-casting operator for inclusion in the query operator execution flow after performing the optimization process based on second factors. In various embodiments, the first factors include target table datatype factors, where the first at least one type-casting operator is included to cast at least one input column into at least one of the required output datatypes based on the target table datatype factors. In various embodiments, the second factors include normalization factors, where the second at least one type-casting operator is inserted to normalize the representation when the target and source specify the same type with different parameters or that may have become inconsistent through computation, for example, to adjust the final precision and/or scale of a decimal column based on the normalization factors.

In various embodiments, generating the query operator execution flow for the query is further based on determining a set of source column datatypes of a set of source columns indicated in the parameters of the query for access during execution of the query, where each column in the set of columns of the result set are generated from at least one corresponding one of a set of source column datatypes. Generating the query operator execution flow for the query can be further based on generating an abstract syntax tree that includes casting operations to cast corresponding ones of the set of source columns into a corresponding one of the set of required datatypes for a corresponding column. Generating the query operator execution flow for the query can be further based on performing the optimization process to optimize the abstract syntax tree to automatically include the at least one first type-casting operator in the initial query operator execution flow for only columns of the set of columns with corresponding ones of the set of required output datatypes mismatching corresponding ones of the set of source column datatypes. Generating the query operator execution flow for the query can be further based on updating the initial query operator execution flow as the query operator execution flow that further includes the at least one second type-casting operator for columns of the set of columns with corresponding ones of a set of source data types matching the corresponding ones of the set of required output datatypes based on the corresponding ones of a set of source data types and/or the corresponding ones of the set of required output datatypes having potential type inconsistency due to at least one computation performed upon the corresponding ones of a set of source data types to generate the corresponding ones of the set of required output datatypes.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “C” only, “a” and “b”, “a” and “c”, “b” and “c”, and/or “a”, “b”, and “c”.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, a set of memory locations within a memory device or a memory section. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A database system comprising:
a record processing system operable to:
receive a first plurality of rows of a set of database tables for storage; and
generate a first plurality of column-formatted segments from the first plurality of rows in accordance with at least one column of the set of database tables;
a segment storage system operable to store the first plurality of column-formatted segments for access in future query executions;
a query execution plan generator module operable to:
determine a first query for execution indicating parameters for generating a result set from at least one of the set of database tables, and further indicating an instruction to store the result set in conjunction with the set of database tables; and
generate a query operator execution flow for the first query that includes a first plurality of operators based on the parameters, and that further includes a loading operator, serially after the first plurality of operators, based on the instruction to store the result set; and
a query execution module operable to execute the first query based on:
executing the first plurality of operators of the first query by:
accessing at least one of the first plurality of rows via the segment storage system; and
processing the at least one of the first plurality of rows to generate a second plurality of rows as the result set; and
executing the loading operator by sending the second plurality of rows to the record processing system;
wherein the record processing system is further operable to:
receive the second plurality of rows from the query execution module; and
generate at least one new column-formatted segment from the second plurality of rows; and
wherein the segment storage system is further operable to store the at least one new column-formatted segment for access in the future query executions.

2. The database system of claim 1, wherein the first query is executed and the at least one new column-formatted segment is stored during a first temporal period, and wherein, in a second temporal period after the first temporal period, the query execution plan generator module is further operable to:
determine a second query for execution indicating second parameters for generating a second result set from another at least one of the set of database tables; and
generate a query operator execution flow for the second query that includes a second plurality of operators based on the second parameters;
wherein the query execution module is further operable to execute the second query based on:
executing the second plurality of operators of the second query by:
accessing at least one of the second plurality of rows via the segment storage system; and
processing the at least one of the second plurality of rows to generate a third plurality of rows as the second result set.

3. The database system of claim 2,
wherein the second query further indicates an instruction to store the second result set in conjunction with the set of database tables;
wherein the query operator execution flow for the second query is generated to further include the loading operator, serially after the second plurality of operators, based on the instruction to store the second result set;
wherein the query execution module executes the second query further based on executing the loading operator by sending the third plurality of rows to the record processing system;
wherein the record processing system is further operable to:
receive the third plurality of rows from the query execution module; and
generate another at least one new column-formatted segment from the third plurality of rows;
wherein the segment storage system is further operable to store the another at least one new column-formatted segment for access in future query executions.

4. The database system of claim 2, wherein the at least one new column-formatted segment includes a second plurality of column-formatted segments, and wherein the second plurality of column-formatted segments are only made visible for access in the future query executions once all of the second plurality of column-formatted segments are stored via the segment storage system, and wherein the at least one of the second plurality of rows is accessed via the segment storage system based on the second plurality of column-formatted segments being made visible for the future query executions.

5. The database system of claim 1, wherein the database system is further operable to receive a command that includes a query expression generated via user input that indicates the first query in accordance with a query language.

6. The database system of claim 5, wherein the query language is the Structured Query Language (SQL), and wherein the instruction to store the result set is based on at least one of: a Create Table As Select (CTAS) statement; or an Insert statement.

7. The database system of claim 1, wherein the instruction to store the result set in conjunction with the set of database tables indicates the result set be stored as a new database table of the set of database tables; and wherein the at least one new column-formatted segment is generated from the second plurality of rows in accordance with at least one column of the new database table.

8. The database system of claim 7, further comprising:
a metadata management module operable to:
receive metadata management instructions from the query execution module regarding the new database table in conjunction with execution of the first query by the query execution module; and
perform at least one metadata management operation for the new database table based on the metadata management instructions, wherein the at least one metadata management operation includes at least one of:
creating the new database table in system metadata;
altering visibility of the new database table; or
verifying user privileges for the new database table.

9. The database system of claim 1, wherein the first plurality of rows are included in multiple tables of the set of database tables, wherein the parameters of the first query indicate column identifiers for at least two of the multiple tables, and wherein the at least one of the first plurality of rows include rows from the at least two of the multiple tables.

10. The database system of claim 1,
wherein the record processing system generates the first plurality of column-formatted segments based on:
generating a first plurality of pages from the first plurality of rows for storage via a page storage system; and
performing a page conversion process upon the first plurality of pages to generate the first plurality of column-formatted segments in accordance with a column-based format.
wherein the record processing system generates the at least one new column-formatted segment based on:
generating a second plurality of pages from the second plurality of rows for storage via the page storage system by converting data blocks indicating the second plurality of rows; and
performing the page conversion process upon the first plurality of pages to generate the at least one new column-formatted segment in accordance with the column-based format.

11. The database system of claim 10, wherein the first plurality of pages and the second plurality of pages are in accordance with a row-major format, wherein the second plurality of rows includes a set of columns, and wherein the record processing system generates the second plurality of pages from the second plurality of rows based on:
receiving the second plurality of rows from the query execution module as a plurality of column-major data blocks of a plurality of column streams corresponding to the set of columns;
converting the column-major data blocks into the second plurality of pages in accordance with the row-major format based on iterating over each column stream of the plurality of column streams.

12. The database system of claim 11, wherein the first plurality of rows are received in a stream of row data from at least one external data source that generates and transmits the stream of row data to the database system, and wherein the record processing system generates the first plurality of pages from the first plurality of rows based on preserving the row-major format of the stream of row data.

13. The database system of claim 1,
wherein the record processing system generates the first plurality of column-formatted segments in parallel via a first plurality of parallelized resources during a first temporal period;
wherein the a query execution module executes the first query in parallel via a second first plurality of parallelized recourses distinct from the first plurality of parallelized resources in a second temporal period after the first temporal period; and
wherein the record processing system generates the at least one new column-formatted segment in parallel via the first plurality of parallelized resources during a third temporal period after the second temporal period.

14. The database system of claim 1, wherein the query execution module is implemented via a plurality of nodes in a plurality of hierarchical levels of a query execution plan, wherein a first plurality of nodes at an IO level of the query execution plan access the at least one of the first plurality of rows via the segment storage system in conjunction with executing at least one IO operator of the first plurality of operators in accordance with the query execution plan; and wherein a second plurality of nodes at an inner level of the query execution plan send the second plurality of rows to the record processing system in in conjunction with executing the loading operator of the first plurality of operators in accordance with the query execution plan.

15. The database system of claim 1, wherein execution of the loading operator by the query execution module includes:
determining when the second plurality of rows is durably stored; and
sending the second plurality of rows as output data.

16. The database system of claim 15, wherein determining when the second plurality of rows is dumbly stored is based on:
sending at least one status poll to the record processing system in conjunction with executing the loading operator; and
receiving at least one response from the record processing system indicating the second plurality of rows is durably stored based on the segment storage system storing the at least one new column-formatted segment.

17. The database system of claim 1, wherein generating the second plurality of rows includes:
determining a datatype for at least one column of the second plurality of rows; and
casting the at least one column of the second plurality of rows as the datatype, wherein the at least one new column-formatted segment is generated in accordance with values of the at least one column being stored in accordance with the datatype.

18. The database system of claim 1, wherein the loading operator is serially after the first plurality of operators.

19. A method comprising:
receiving, by a record processing system, a first plurality of rows of a set of database tables for storage;
generating, by the record processing system, a first plurality of column-formatted segments from the first plurality of rows in accordance with at least one column of the set of database tables;
storing, by a segment storage system, the first plurality of column-formatted segments for access in future query executions;
determining, by a query execution plan generator module, a first query for execution indicating parameters for generating a result set from at least one of the set of database tables, and further indicating an instruction to store the result set in conjunction with the set of database tables;
generating, by the query execution plan generator module, a query operator execution flow for the first query that includes a first plurality of operators based on the parameters, and that further includes a loading operator, serially after the first plurality of operators, based on the instruction to store the result set; and
executing, by a query execution module, the first query based on:
executing the first plurality of operators of the first query by:
accessing at least one of the first plurality of rows; and
processing the at least one of the first plurality of rows to generate a second plurality of rows as the result set; and
executing the loading operator by sending the second plurality of rows to the record processing system;
receiving, by the record processing system, the second plurality of rows from the query execution module; and
generating, by the record processing system, at least one new column-formatted segment from the second plurality of rows; and
storing, by the segment storage system, the at least one new column-formatted segment for access in the future query executions.

20. A database system comprises:
at least one processor; and
a memory that stores operational instructions that, when executed by the at least one processor, cause the record processing and storage system to:
receive a first plurality of rows of a set of database tables for storage;
generate a first plurality of column-formatted segments from the first plurality of rows in accordance with at least one column of the set of database tables;
store the first plurality of column-formatted segments for access in future query executions;
determine a first query for execution indicating parameters for generating a result set from at least one of the set of database tables, and further indicating an instruction to store the result set in conjunction with the set of database tables;
generate a query operator execution flow for the first query that includes a first plurality of operators based on the parameters, and that further includes a loading operator, serially after the first plurality of operators, based on the instruction to store the result set; and
execute the first query based on:
executing the first plurality of operators of the first query by:
accessing at least one of the first plurality of rows; and
processing the at least one of the first plurality of rows to generate a second plurality of rows as the result set; and
executing the loading operator;
generate at least one new column-formatted segment from the second plurality of rows based on execution of the loading operator; and
store the at least one new column-formatted segment for access in the future query executions.
